(19) United States
(12) Patent Application Publication
(10) Pub. No.: US 2026/0134493 A1
(43) Pub. Date: May 14, 2026

(54) SYSTEM, METHOD, AND USER DISPLAYS FOR ELECTRONIC MANAGEMENT OF EVIDENCE IN PATENT LITIGATION

(71) Applicant: LitAgility, LLC, Beverly, MA (US)

(72) Inventors: Lawrence W. Collins, Topsfield, MA (US); James B. Gillespie, Newburyport, MA (US); Andrea Thurber, Boylston, MA (US); Srinivas Achanta, Newburyport, MA (US); Vamsi Krishna Kambadur, Telangana (IN); Santhosh Mudavath, Telangana (IN); Sameer Khan Yousuf Khan, Maharashtra (IN); Shaik Jan Siddaiah, Telangana (IN); Syed Imtiaz Ahamed, Andhra Pradesh (IN)

(21) Appl. No.: 19/387,176

(22) Filed: Nov. 12, 2025

Related U.S. Application Data
(60) Provisional application No. 63/720,078, filed on Nov. 13, 2024.

(51) Int. Cl. G06Q 50/18; G06F 16/215

(52) U.S. Cl. CPC G06Q 50/184; G06F 16/215

(57) ABSTRACT

Systems and methods for reducing duplication of data in a data repository storing evidence corresponding to claim elements of a patent document. The systems and methods include a first user interface with a first plurality of rows corresponding to a plurality of first claim elements of a first patent document and a second plurality of columns corresponding to a plurality of second claim elements of a second patent document. The first plurality of rows and the first plurality of columns are arranged in a matrix format and form a plurality of cells. The user interface includes a user selectable input area for the plurality of cells. A pointer can be created in the data repository that links a first claim element of the plurality of first claim elements with a second claim element of the plurality of second claim elements responsive to an input in the user selectable input area.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The present disclosure relates to the field of electronic data management.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A patent litigation process begins when the patent holder, also known as the plaintiff, identifies one or more defendant(s) who are infringing on one or more claims or patent rights of the patent holder. Patent litigation can be a complex, long, and expensive process, which requires the participation of several members of both parties, i.e. plaintiff and defendant, and their outside counsel.

A patent litigation lifecycle encompasses a series of critical steps, beginning with the pre-suit phase, an essential due diligence phase, which involves analyzing the patent claims assessing alleged infringements against the features or specifications of an accused product or process, and reviewing prior-art to evaluate the patent's validity. Once the groundwork is laid, litigation is initiated by filing a complaint in an appropriate court that details the infringed patent claims and specifies the nature of the infringement. Following this, both parties, i.e. plaintiff and defendant(s) engage in document discovery to collect and exchange pertinent documents such as product manuals, specifications and other documents as preparation for the trial process.

Other activities include parties exchanging contentions which include detailed statements outlining their infringement and invalidity theories. The plaintiff submits infringement contentions with claim charts that illustrate how the product or process infringes on the patent claims, while the defendant provides invalidity contentions that challenge the validity of these claims based on relevant prior-art. A noteworthy pre-trial event is the claim construction, or Markman hearing, where parties argue their interpretations of key patent claim terms.

Additional activities also include the depositions of fact witnesses and the involvement of expert witnesses who produce detailed reports and undergo depositions to bolster claims related to the patent's technical aspects and its validity. Prior to the trial, parties may file pre-trial motions to address and clarify legal issues, and there is also substantial effort put into the preparation of witnesses to ensure effective testimony. Each of these stages plays a vital role in the trial phase of patent litigation, exemplifying the complexity and the challenges involved in navigating through the patent litigation process.

The process of patent litigation requires various size teams of technical experts and legal professionals. Patents involve complex technical details that require a deep understanding of the specific technology. On a patent litigation case, during the discovery process, technical experts and legal professionals work together to collect, manage, analyze and interpret a large volume of documents, detailed technical data, and numerous depositions. Technical experts are involved in a patent litigation case, to review and understand the subject matter of the patent. Lawyers and experts who are well-versed in patent law conduct thorough analysis to interpret and assess the alleged infringement or validity of a patent and patent claims from a legal standpoint. The patent litigation process is a highly iterative process, wherein, there is a lot of exchange of documents and evidence for analysis that is both resource and time intensive. It can be difficult to access information in real time.

Interpretation of patent claims has a great influence on the outcome of a patent litigation case. Hence, creating terms and definitions for various phrases in patent claims is essential and requires a systematic approach of capturing and managing the terms and definitions from various intrinsic and extrinsic sources.

Considering the complexity of the patent litigation process, and the variety of skill sets required to interpret the various aspects of the case, there exists a need for a tool, system, or platform that reduces data storage requirements and reduces the time it takes to retrieve data.

The various patent litigation and evidence management tools, systems, or platforms currently available offer features and functionalities that address only some aspects of the various stages of the patent litigation process. For example, there are tools, systems, or platforms available that facilitate the management of patent litigation cases by organizing client information, tracking timelines, and performing other administrative tasks. Alternatively, other tools, systems or platforms in the prior-art exist that are used solely to organize and manage large volumes of documents during the discovery process. In addition, there are other tools, systems or platforms that provide access to legal resources, case law, statutes, and other information that would aid in conducting legal proceedings.

Existing systems have been developed for organizing and managing claim elements in conjunction with corresponding reference objects. Such systems establish and maintain database associations between claim elements and reference objects based on identified relationships. The established associations are stored within a database for subsequent retrieval and analysis. Furthermore, these systems provide user interfaces configured to display claim elements and reference objects in a manner that visually represents the associations existing between them.

However, such prior systems are limited in their ability to maintain consistency and integrity of data across multiple modules and workflows. The existing tools do not adequately address issues such as duplication of data, synchronization between different databases or user interfaces for an integrated workflow process such as a patent litigation workflow. There is a need for a new software and/or database architecture for efficient management of a patent litigation workflow. Such new software architecture can improve real time data access and reduce data redundancy.

### SUMMARY

The present disclosure is related to a system and method of electronic management of workflow process of a patent litigation case including evidence management, wherein said Patent litigation and evidence management system and method enable users selected from either side of the party i.e. plaintiff or defendant(s), to independently utilize the system to perform functions comprising of analysis of the asserted patent(s), management of evidence during discovery process, claim construction, evidence management, preparation of infringement contentions, invalidity contentions, reports on damages, claim charts, slides or documents that are used during hearings, and other tasks specific to a patent litigation case. The electronic management system for patent litigation of the present disclosure, also referred to as Patent litigation and evidence management system or system hereinafter, leverages advanced interactive Graphical User Interface (GUI) technology to solve problems discussed above, such as duplication of data and slow retrieval speed of data. Said system facilitates efficient data storage and quick retrieval, optimizing performance by improving latency and reducing redundancy. Users of the integrated system include but not limited to attorneys, paralegals, technical experts, or authorized representatives of either party, such as the plaintiff or defendant(s). This streamlines the handling of complex techno-legal data, thereby enabling users of legal and technical teams in managing and navigating extensive litigation processes more effectively. Some of the features of a Patent litigation and evidence management system include, but are not limited to, patent case setup module, library module, flexible and scalable analytical module of Master Pointer Matrix (MPM), Terms Construction Module, Infringement Setup Module, Invalidity Setup Module, Validity Setup Module, Evidence Analysis and Management Module, Build Charts Module, and Damages Module are described below in detail. The present disclosure and its advantages are best understood from the following detailed description taken in conjunction with the accompanying drawings and the knowledge of skilled artisans.

The Master Pointer Matrix (MPM) of the present disclosure is a real-time, interactive, flexible, and scalable matrix designed for patent litigation analysis. It enhances the management and visualization of claim elements and their corresponding evidence throughout all stages of patent litigation, including claim-chart generation, infringement analysis, and validity assessment. The Master Pointer Matrix (MPM) overcomes the challenges of displaying large matrices and extensive datasets on varying display resolutions by employing adaptive and responsive features. The Master Pointer Matrix (MPM), rendered as an interactive Graphical User Interface (GUI), enhances system performance and reduces latency by selectively rendering only the cells visible to the user based on the display size and resolution, using innovative techniques such as virtualization and simulating user scrolling, thus optimizing resource use and improving usability. Furthermore, the Master Pointer Matrix (MPM) provides vertical or horizontal scrolling while rendering updated information in real-time. This is achieved by simulating natural user scrolling within a fixed dimension container, wherein rendering is confined to the dimensions of the container. The system dynamically calculates row and column indices from respective arrays rendered along the y-axis and x-axis, effectively slicing the array elements for display as needed. As the user scrolls, the Master Pointer Matrix (MPM) Module 210 updates the visible portion of the grid, rendering only the cells currently in view. This approach significantly reduces resource consumption and ensures smooth, responsive navigation through large datasets, which is supported by advanced virtual memory techniques, ensuring that most current data is displayed with minimal latency. Furthermore, the scrolling feature of the Master Pointer Matrix (MPM) is simulated through a series of calculated adjustments to the visual representation of the matrix, rather than by physically adjusting data elements. This approach optimizes memory efficiency, performance, and responsiveness by minimizing computational load and reducing latency for large datasets. Moreover, the architecture of Master Pointer Matrix (MPM) minimizes data storage redundancy and latency in data retrieval while providing flexibility for exclusive datasets, by creating pointers to the data rather than duplicating datasets for each claim element. These pointers allow for easy replication and automatic update of evidence across all related claim elements, ensuring accuracy and consistency, which eliminates the need for manual updates and reduces significant time for users. The Master Pointer Matrix (MPM) enables user interaction with the matrix through clicking, dragging, and scrolling. The matrix responds by updating states and efficiently re-rendering the display using virtual Document Object Model (DOM) capabilities. This results in immediate visual feedback and seamless adjustments without a complete matrix re-render, thus enhancing usability and performance in data-intensive applications. The Master Pointer Matrix (MPM) interface enables intuitive evidence linking by automatically identifying and displaying corresponding claim elements with identical or similar text, significantly accelerating evidence assignment, loading, management, and review. Further, the interactive GUI of Master Pointer Matrix (MPM) enables users to create, modify, and delete pointer sets, including secure and reversible deletion of auto-created sets, or dynamically manage the linking of claim elements and evidence across patent documents. Moreover, Master Pointer Matrix (MPM) is configured to utilize one or more artificial intelligence (AI) and machine learning (ML) algorithms, including but not limited to Large Language Models (LLMs), to analyze and map patent claims. Specifically, the Master Pointer Matrix (MPM) is configured to map a first set of claims from a first reference patent to a second set of claims from a second related patent, wherein the second related patent includes, but not limited to a family patent, a continuation-in-part (CIP), or a similar related application.

The present disclosure relates to a method and system of reducing duplication of data in a data repository configured to store evidence relevant to a patent lawsuit. The method involves generating a matrix on a user interface wherein a first plurality of claim elements that correspond to one or more claims of a first patent are mapped to the rows, and a second plurality of claim elements that correspond to one or more claims of a second patent are mapped to the columns.

The method involves displaying a matrix where each cell is defined by a row label. Upon receiving a first user selection of a cell in a row, the method determines and highlights the corresponding first claim element, associated with the row. While the first cell remains highlighted, the method receives subsequent selections of other cells in the same row. In response to these subsequent selections, the method identifies the second claim elements, associated with the respective columns, corresponding to those subsequently selected cells.

An aspect of the system is the creation of a pointer in the data repository that links one or more second claim elements with the first claim element. Evidence is then linked between these elements based on the created pointer, ensuring that only a single instance of the evidence is stored, and a copy is not duplicated for each of the linked second claim elements, thereby achieving a substantial reduction in data duplication.

The system of the present disclosure incorporates features to enhance legal accuracy and performance. When the first and second patents are the same, the matrix displays a diagonal portion that splits it two portions, with one of the portions being non-editable to prevent self-referential linking errors. When the first and second patents are different, the matrix consists four quadrants based on different combinations of claim element mapping, with one specific quadrant being non-editable to mitigate legal errors. Furthermore, for performance optimization with potentially large matrices, the system loads only a portion of the matrix into the Document Object Model (DOM), utilizing a spacer portion whose upper and lower heights are a function of the number of scrolled items. The system also encompasses a configuration wherein evidence received for a first claim element is automatically linked to a second claim element via the created pointer, reinforcing the single-instance storage of the evidence.

The system and method of the present disclosure achieve a significant reduction in data duplication within a data repository configured to store evidence. This is accomplished by creating a pointer in the repository that links multiple claim elements to a single instance of evidence, thereby eliminating the need to store duplicate copies for each linked element. Additionally, the system and method enhance legal accuracy through matrix configurations designed to prevent self-referential linking and other legal errors. System performance for large matrices is further improved through a virtualization technique that loads only the visible portion of the matrix into the Document Object Model (DOM).

### BRIEF DESCRIPTION OF THE DRAWINGS

To provide a more complete understanding of the present disclosure, and to highlight various embodiments, features and advantages, reference is now made to the following descriptions, taken in conjunction with the accompanying drawings which are incorporated herein by reference, wherein:

FIG. 1 is a block diagram illustrating the architecture of a Patent litigation and evidence management system, according to the various aspects of the present disclosure;

FIG. 2 is a block diagram illustrating the various components of a Patent litigation and evidence management system, according to the various aspects of the present disclosure;

FIG. 3 illustrates a workflow process of the Patent Case Setup Module of a Patent litigation and evidence management system, according to various aspects of the present disclosure;

FIG. 4 illustrates a database schema comprising of various tables used in the Patent Case Setup Module, according to an embodiment of a Patent litigation and evidence management system of the present disclosure;

FIG. 5 illustrates an interactive Graphical User Interface (GUI) for the modification or verification of the bibliographic information as part of the Patent Case Setup Module, according to an embodiment of a Patent litigation and evidence management system of the present disclosure;

FIG. 6 illustrates an interactive Graphical User Interface (GUI) for the modification or verification of the claims as part of the Patent Case Setup Module, according to an embodiment of a Patent litigation and evidence management system of the present disclosure;

FIG. 7 illustrates an interactive Graphical User Interface (GUI) for the modification or verification of the specification as part of the Patent Case Setup Module, according to an embodiment of a Patent litigation and evidence management system of the present disclosure;

FIG. 8 illustrates an interactive Graphical User Interface (GUI) for the modification or verification of the patent images as part of the Patent Case Setup Module, according to an embodiment of a Patent litigation and evidence management system of the present disclosure;

FIG. 9 illustrates an interactive Graphical User Interface (GUI) for the modification or addition of the representative figures by users, as part of the Patent Case Setup Module, according to an embodiment of a Patent litigation and evidence management system of the present disclosure;

FIG. 10 illustrates an interactive Graphical User Interface (GUI) showing the Set Asserted claims feature used for the identification of asserted claims by users, as part of the Patent Case Setup Module, according to an embodiment of a Patent litigation and evidence management system of the present disclosure;

FIG. 11 illustrates an interactive Graphical User Interface (GUI) showing the Break Claim Elements feature as part of the Patent Case Setup Module, according to an embodiment of a Patent litigation and evidence management system of the present disclosure;

FIG. 12 illustrates an interactive Graphical User Interface (GUI) showing the Merge Claim Elements feature as part of the Patent Case Setup Module, according to an embodiment of a Patent litigation and evidence management system of the present disclosure;

FIG. 13 illustrates a workflow process of the Term Construction Setup Module, according to an embodiment of a Patent litigation and evidence management system of the present disclosure;

FIG. 14 illustrates a diagram of a database schema showing technical relationships between at least a portion of the database tables in the database schema for the functionality related to Term Construction Setup Module, according to an embodiment of a Patent litigation and evidence management system of the present disclosure;

FIG. 15 illustrates an interactive Graphical User Interface (GUI) to create simple terms, a feature for Term Construction Setup Module, according to an embodiment of a Patent litigation and evidence management system of the present disclosure;

FIG. 16 illustrates an interactive Graphical User Interface (GUI) to create complex terms, a feature for Term Construction Setup Module, according to an embodiment of a Patent litigation and evidence management system of the present disclosure;

FIG. 17 illustrates an interactive Graphical User Interface (GUI) to create group terms, a feature for Term Construction Setup Module, according to an embodiment of a Patent litigation and evidence management system of the present disclosure;

FIG. 18 illustrates a workflow process of the Infringement Setup Module, according to an embodiment of a Patent litigation and evidence management system of the present disclosure;

FIG. 19 illustrates a database schema showing technical relationships between at least a portion of the database tables in the database schema for the functionality related to Infringement Setup Module, according to an embodiment of a Patent litigation and evidence management system of the present disclosure;

FIG. 20 illustrates an interactive Graphical User Interface (GUI) for Infringement Setup Module, according to an embodiment of a Patent litigation and evidence management system of the present disclosure;

FIG. 21 illustrates a workflow process of the Invalidity Setup module, according to an embodiment of a Patent litigation and evidence management system of the present disclosure;

FIG. 22 illustrates a database schema showing technical relationships between at least a portion of the database tables in the database schema for the functionality related to invalidity setup module, according to an embodiment of a Patent litigation and evidence management system of the present disclosure;

FIG. 23 illustrates an interactive Graphical User Interface (GUI) for showing Validity setup feature that can include management of defenses such as subject matter eligibility, anticipation, obviousness, best mode enablement, and inequitable conduct as part of the validity setup module, according to an embodiment of a Patent litigation and evidence management system of the present disclosure;

FIG. 24 illustrates an interactive Graphical User Interface (GUI) for setting up obviousness defenses, which is one of the defenses as part of the validity setup module, according to an embodiment of a Patent litigation and evidence management system of the present disclosure;

FIG. 25 illustrates an interactive Graphical User Interface (GUI) for the Obviousness Evidence Management Matrix (OEMM) as part of the validity setup module, according to an embodiment of a Patent litigation and evidence management system of the present disclosure;

FIG. 26 illustrates a workflow process of the Library Module, according to an embodiment of a Patent litigation and evidence management system of the present disclosure;

FIG. 27 illustrates a database schema showing technical relationships between at least a portion of the database tables in the database schema for the functionality related to the Library Module, according to an embodiment of a Patent litigation and evidence management system of the present disclosure;

FIG. 28 illustrates an interactive Graphical User Interface (GUI) for the Library Module, according to an embodiment of a Patent litigation and evidence management system of the present disclosure;

FIG. 29 illustrates a workflow process of a Build Charts Module, according to an embodiment of a Patent litigation and evidence management system of the present disclosure;

FIG. 30 illustrates a database schema showing technical relationships between at least a portion of the database tables in the database schema for the functionality related to Build Charts Module, according to an embodiment of a Patent litigation and evidence management system of the present disclosure;

FIG. 31 illustrates an interactive Graphical User Interface (GUI) for the Build Charts Module, according to an embodiment of a Patent litigation and evidence management system of the present disclosure;

FIG. 32 illustrates an interactive Graphical User Interface (GUI) for the Preview of the claims charts as part of the Build Charts Module, according to an embodiment of a Patent litigation and evidence management system of the present disclosure;

FIG. 33 illustrates an interactive Graphical User Interface (GUI) for the Analysis module related to an Evidence Analysis and Management Module, according to an embodiment of a Patent litigation and evidence management system of the present disclosure;

FIG. 34 illustrates a flow chart for the Master Pointer Matrix process, according to an embodiment of a Patent litigation and evidence management system of the present disclosure;

FIG. 35 illustrates a feature used for the selection of source patent and target patent to generate a Master Pointer Matrix (MPM), according to an embodiment of a Patent litigation and evidence management system of the present disclosure;

FIG. 36 illustrates a m×n Master Pointer Matrix (MPM) between the claim elements of master patent also referred to as source patent, when the source patent and the target patent are the same, according to an embodiment of a Patent litigation and evidence management system of the present disclosure;

FIG. 36A illustrates a conventional rendering technique of a large dataset on a user display, showing the prior art approach of rendering all list items simultaneously to the Document Object Model regardless of their visibility within the User Viewport;

FIG. 36B illustrates a virtualization rendering technique of a large dataset on a user display, wherein large datasets, such as those present in the Master Pointer Matrix, are displayed by rendering only the items currently visible within the User Viewport, along with a minimal buffer items, and calculated number of spacer DIVs, according to an embodiment of a Patent litigation and evidence management system of the present disclosure;

FIG. 37 illustrates an overview of the relational database schema of Master Pointer Matrix (MPM), according to an embodiment of a Patent litigation and evidence management system of the present disclosure;

FIG. 38 illustrates a Master Pointer Matrix (MPM) when the source patent and target patent are different, according to an embodiment of a Patent litigation and evidence management system of the present disclosure;

FIG. 39 illustrates a system, method and user displays for patent claim analysis and evidence identification, extraction, analysis, and charting according to various aspects of the present disclosure;

FIG. 40 illustrates a workflow process of an automated Patent Load Module, of a system, method and user displays for patent claim analysis and evidence identification, extraction, analysis, and charting according to various aspects of the present disclosure;

FIG. 40a illustrates an interactive Graphical User Interface (GUI) for a user to upload a patent as part of the Patent Load Module, of a system, method and user displays for patent claim analysis and evidence identification, extraction, analysis, and charting according to various aspects of the present disclosure;

FIG. 40b illustrates a database schema showing technical relationships between at least a portion of the database tables for the functionality related to Patent Load Module, of a system, method and user displays for patent claim analysis and evidence identification, extraction, analysis, and charting according to various aspects of the present disclosure;

FIG. 40c illustrates an interactive Graphical User Interface (GUI) for users to create or edit parsed elements, as part of a system, method and user displays for patent claim analysis and evidence identification, extraction, analysis, and charting according to various aspects of the present disclosure;

FIG. 40d illustrates an interactive Graphical User Interface (GUI) for users to create or edit synonyms, as part of a system, method and user displays for patent claim analysis and evidence identification, extraction, analysis, and charting according to various aspects of the present disclosure;

FIG. 41 illustrates a workflow process of an automated Document Processing Module, of a system, method and user displays for patent claim analysis and evidence identification, extraction, analysis, and charting according to various aspects of the present disclosure;

FIG. 41a illustrates a workflow process of the automated Document Processing Module for a document category of brochure, manuals or product specifications, of a system, method and user displays for patent claim analysis and evidence identification, extraction, analysis, and charting according to various aspects of the present disclosure;

FIG. 41b illustrates a workflow process of the automated Document Processing Module for a document category of patent grants and patent applications, of a system, method and user displays for patent claim analysis and evidence identification, extraction, analysis, and charting according to various aspects of the present disclosure;

FIG. 41c illustrates a workflow process of the automated Document Processing Module for a document category of emails, of a system, method and user displays for patent claim analysis and evidence identification, extraction, analysis, and charting according to various aspects of the present disclosure;

FIG. 41d illustrates a workflow process of the automated Document Processing Module for a document category of transcripts, of a system, method and user displays for patent claim analysis and evidence identification, extraction, analysis, and charting according to various aspects of the present disclosure;

FIG. 41e illustrates an interactive Graphical User Interface (GUI) of the automated Document Processing Module, of a system, method and user displays for patent claim analysis and evidence identification, extraction, analysis, and charting according to various aspects of the present disclosure;

FIG. 41f illustrates a database schema showing technical relationships between at least a portion of the database tables for the functionality related to the automated Document Processing Module, of a system, method and user displays for patent claim analysis and evidence identification, extraction, analysis, and charting according to various aspects of the present disclosure;

FIG. 42 illustrates a workflow process of the Claim Construction Analysis Module, of a system, method and user displays for patent claim analysis and evidence identification, extraction, analysis, and charting according to various aspects of the present disclosure;

FIG. 42a illustrates an interactive Graphical User Interface (GUI) of the Claim Construction Analysis Module, of a system, method and user displays for patent claim analysis and evidence identification, extraction, analysis, and charting according to various aspects of the present disclosure;

FIG. 42b illustrates a database schema showing technical relationships between at least a portion of the database tables for the functionality related to the Claim Construction Analysis Module, of a system, method and user displays for patent claim analysis and evidence identification, extraction, analysis, and charting according to various aspects of the present disclosure;

FIG. 43 illustrates a workflow process of the Infringement Analysis Module, of a system, method and user displays for patent claim analysis and evidence identification, extraction, analysis, and charting according to various aspects of the present disclosure;

FIG. 43a illustrates an interactive Graphical User Interface (GUI) of the Infringement Analysis Module, of a system, method and user displays for patent claim analysis and evidence identification, extraction, analysis, and charting according to various aspects of the present disclosure;

FIG. 43b illustrates an interactive Graphical User Interface (GUI) of the results statistics page by Claims option of the Infringement Analysis Module, of a system, method and user displays for patent claim analysis and evidence identification, extraction, analysis, and charting according to various aspects of the present disclosure;

FIG. 43c illustrates another view of an interactive Graphical User Interface (GUI) of the results statistics page by Documents option of the Infringement Analysis Module, of a system, method and user displays for patent claim analysis and evidence identification, extraction, analysis, and charting according to various aspects of the present disclosure;

FIG. 43d illustrates an interactive Graphical User Interface (GUI) of the Review Analysis page of the Infringement Analysis Module, of a system, method and user displays for patent claim analysis and evidence identification, extraction, analysis, and charting according to various aspects of the present disclosure;

FIG. 43e illustrates another view of an interactive Graphical User Interface (GUI) of the Review Analysis page related to User Adds of the Infringement Analysis Module, of a system, method and user displays for patent claim analysis and evidence identification, extraction, analysis, and charting according to various aspects of the present disclosure;

FIG. 43f illustrates a Build Chart interactive Graphical User Interface (GUI) of the Infringement Analysis Module, of a system, method and user displays for patent claim analysis and evidence identification, extraction, analysis, and charting according to various aspects of the present disclosure;

FIG. 43g illustrates a database schema showing technical relationships between at least a portion of the database tables for the functionality related to the Infringement analysis Module, and Invalidity Analysis Module, of a system, method and user displays for patent claim analysis and evidence identification, extraction, analysis, and charting according to various aspects of the present disclosure;

FIG. 44 illustrates a workflow process of an Invalidity Analysis Module, of a system, method and user displays for patent claim analysis and evidence identification, extraction, analysis, and charting according to various aspects of the present disclosure;

FIG. 44a illustrates an interactive Graphical User Interface (GUI) configured to manage invalidity analysis, of a system, method and user displays for patent claim analysis and evidence identification, extraction, analysis, and charting according to various aspects of the present disclosure;

FIG. 44b illustrates an interactive Graphical User Interface (GUI) of a Review Analysis interface of the Invalidity Analysis Module, of a system, method and user displays for patent claim analysis and evidence identification, extraction, analysis, and charting according to various aspects of the present disclosure;

FIG. 44c illustrates an interactive Graphical User Interface (GUI) of the Result Statistics page of the Invalidity Analysis Module, of a system, method and user displays for patent claim analysis and evidence identification, extraction, analysis, and charting according to various aspects of the present disclosure;

FIG. 44d illustrates an interactive Graphical User Interface (GUI) of another view of the Result Statistics page by Claims, of the Invalidity Analysis Module, of a system, method and user displays for patent claim analysis and evidence identification, extraction, analysis, and charting according to various aspects of the present disclosure;

FIG. 44e illustrates an interactive Graphical User Interface (GUI) of another view of the Result Statistics page by Documents, of the Invalidity Analysis Module, of a system, method and user displays for patent claim analysis and evidence identification, extraction, analysis, and charting according to various aspects of the present disclosure;

FIG. 44f illustrates an interactive Graphical User Interface (GUI) of another view of the Result Statistics page by Documents in an expanded form, of the Invalidity Analysis Module, of a system, method and user displays for patent claim analysis and evidence identification, extraction, analysis, and charting according to various aspects of the present disclosure;

FIG. 45 illustrates a workflow process of a Search Analysis Module configured to search, identify and extract evidence based on a word, phrase, or concept, of a system, method and user displays for patent claim analysis and evidence identification, extraction, analysis, and charting according to various aspects of the present disclosure;

FIG. 45a illustrates an interactive Graphical User Interface (GUI) of a Search Analysis Module, configured to search based on a word, phrase, or concept from uploaded documents, of a system, method and user displays for patent claim analysis and evidence identification, extraction, analysis, and charting according to various aspects of the present disclosure;

FIG. 45b illustrates another view of the interactive Graphical User Interface (GUI) of the Search Analysis Module, configured to enable user activation of a field selection for proximity operators within the By Word/Phrase option, of a system, method, and user displays for patent claim analysis and evidence identification, extraction, analysis, and charting according to various aspects of the present disclosure;

FIG. 45c illustrates another view of the interactive Graphical User Interface (GUI) of the Search Analysis Module, configured to enable user activation of a field selection for document types and respective sub-sections within the By Word/Phrase option, of a system, method, and user displays for patent claim analysis and evidence identification, extraction, analysis, and charting according to various aspects of the present disclosure;

FIG. 45d illustrates an interactive Graphical User Interface (GUI) configured to display one or more words or phrases entered by the user, of the Search Analysis Module, of a system, method, and user displays for patent claim analysis and evidence identification, extraction, analysis, and charting according to various aspects of the present disclosure;

FIG. 45e illustrates an interactive Graphical User Interface (GUI), of the Search Analysis Module, that is configured to enable user to conduct search based on a concept, within the By concept option, of a system, method, and user displays for patent claim analysis and evidence identification, extraction, analysis, and charting according to various aspects of the present disclosure;

FIG. 45f illustrates an interactive Graphical User Interface (GUI), a Search Returns page of the Result Statistics interface, of the Search Analysis Module, which is configured to display a summary of evidence identified from the uploaded documents, of a system, method, and user displays for patent claim analysis and evidence identification, extraction, analysis, and charting according to various aspects of the present disclosure;

FIG. 45g illustrates an interactive Graphical User Interface (GUI), a Result Statistics interface, of the Search Analysis Module, configured to display the uploaded documents within a Documents section, of a system, method, and user displays for patent claim analysis and evidence identification, extraction, analysis, and charting according to various aspects of the present disclosure;

FIG. 45h illustrates an interactive Graphical User Interface (GUI), Review Analysis interface, of the Search Analysis Module, configured to present a word, phrase, or concept analysis window, of a system, method, and user displays for patent claim analysis and evidence identification, extraction, analysis, and charting according to various aspects of the present disclosure;

FIG. 45i illustrates an interactive Graphical User Interface (GUI), a User Adds feature within the Review Analysis interface, of the Search Analysis Module, configured to enable a user to manually add evidence from uploaded documents, of a system, method, and user displays for patent claim analysis and evidence identification, extraction, analysis, and charting according to various aspects of the present disclosure;

FIG. 45j illustrates an interactive Graphical User Interface (GUI) of the Search Analysis Module, Build Chart interface, which is configured to present an analysis profile window, of a system, method, and user displays for patent claim analysis and evidence identification, extraction, analysis, and charting according to various aspects of the present disclosure;

FIG. 45k illustrates another view of an interactive Graphical User Interface (GUI) of the Search Analysis Module, wherein edit option is configured to enable a user to manage uploaded files, of a system, method, and user displays for patent claim analysis and evidence identification, extraction, analysis, and charting according to various aspects of the present disclosure; and

FIG. 45l further illustrates an interactive Graphical User Interface (GUI), display interface, presented upon selection of an edit option within the Review Analysis interface, of the Search Analysis Module, of a system, method, and user displays for patent claim analysis and evidence identification, extraction, analysis, and charting according to various aspects of the present disclosure.

### DETAILED DESCRIPTION

While certain embodiments and examples are disclosed herein, it is to be understood that these embodiments and examples are only illustrative, and the inventive subject matter is not limited to the specifically disclosed embodiments. Rather, the scope of the disclosure extends to other alternative embodiments, uses, modifications, and equivalents thereof. Accordingly, the scope of the present disclosure is not limited by any of the particular embodiments described herein. For example, in any method or process disclosed, the acts or steps may be performed in any suitable sequence and are not limited to the specific sequences disclosed herein. The description of various operations as discrete steps is for clarity and should not be construed as requiring a particular sequence. Furthermore, the structures, systems, and devices disclosed herein may be implemented as integrated components or separate components. Therefore, various embodiments may be implemented in a manner that achieves or optimizes one or more advantages as described herein, without necessarily achieving all the advantages or aspects that may also be disclosed or suggested. There are many aspects of litigation as discussed herein. For example, construction phase might require extracting evidence, managing evidence, reviewing evidence, and charting evidence. For three people working on a three patent lawsuit, this could result in 24 printed and digital PDFs [(3 people×(3 patents+3 file histories))+(3 working documents of constructions and support)+(3 pieces of extrinsic evidence)]. For Infringement & invalidity stage of the litigation, there could be at least 102 printed and digital copies [(3 infringement people×(20 docs))+(3 validation people×(10 docs))+(6 Claim Const docs)+(6 claim charts)]. For Damages, it could be 4 people managing an average of 40 documents, making it 160 copies. There is also deposition prep and witness prep, which might be 3 people×30 does=90 printed and digital does for each prep. In some of the implementations, the solutions described herein can result in a 60% reduction in storage space. Furthermore, in some of the implementation of embodiments described herein, a user can save 25 to 75% time from the specific improvement in technology, such as the use of pointers to manage evidence.

The following definitions apply for purposes of this disclosure:
JSON refers to a lightweight, text-based, language-independent data interchange and representation format, such as JavaScript Object Notation, and is not limited to any particular implementation or syntax variant.
AJAX refers to any asynchronous or dynamic data-fetching technique, mechanism or process by which a client, server or other entity exchanges information without requiring a full reload or re-initialization of an interactive Graphical User Interface (GUI), page or application context, and is not limited to any particular protocol, transport mechanism or data format.
Data frame refers to a tabular or structured data representation, typically arranged in rows and columns (or equivalent axes), where each column may represent a variable or attribute and each row may represent an observation, record or element, and is not limited to any particular programming language, library or environment.
Zip refers to an archive, compression, packaging or bundling mechanism, file format or container by which one or more files, directories, data objects or streams are combined, optionally compressed and/or stored, transported or retrieved as a single entity, and is not limited to any particular compression algorithm, file extension, implementation or platform.
Patent documents refers broadly to any patent applications, granted patents, provisional filings, publications, patent office records, prosecution histories, re-examinations, continuations and equivalent documents worldwide, including without limitation those maintained in digital or paper form, and is not limited to any particular jurisdiction, patent office or document format.
Success or successful code refers broadly to any numeric, alphanumeric, symbolic or other type of code, indicator or value, for example, but not limited to 6000 that is assigned, generated or returned by the system, module or method of the present disclosure in order to signify that a given process, transaction or operation has completed without error and as intended.
Error or failure code refers broadly to any numeric, alphanumeric, symbolic or other type of code, indicator or value, for example, but not limited to 7000, or 7001 that is assigned, generated or returned to signify that a given process, transaction or operation has failed, encountered an error, been rejected or otherwise not completed as intended.
Color-coding scheme refers to any color-coding scheme or any other format as defined by the user. For example, the color-coding scheme such as green, yellow, or grey is provided solely for illustration and is not intended to limit the term in any way.

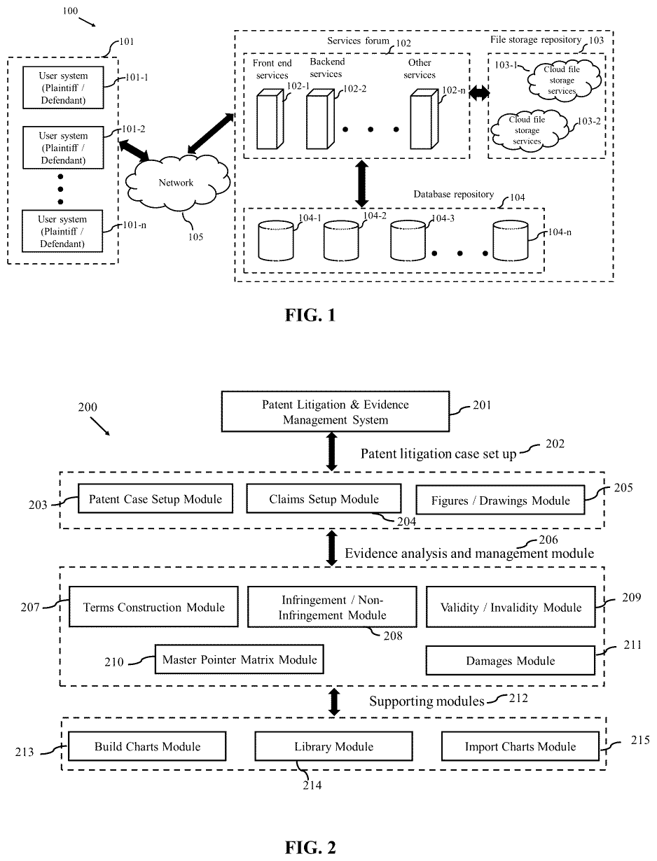

FIG. 1 is a block diagram illustrating the architecture 100 of a Patent litigation and evidence management system according to various aspects of the present disclosure. Users of a Patent litigation and evidence management system include but are not limited to attorneys, paralegals, technical experts, and authorized representatives of either party, such as the plaintiff or defendant(s) 101-1, . . . , 101-n, accessing a Patent litigation and evidence management system over a network 105, through an interactive Graphical User Interface (GUI) rendered over a user system 101. A Patent litigation and evidence management system includes at least one database repository 104 comprising a plurality of databases 104-1, . . . , 104-n to store and retrieve data related to a specific patent litigation case, at least one centralized cloud based file storage repository 103 to store and retrieve a plurality of documents and relevant extracts, one or more computer processors in a services forum 102 comprising of one or more programming instruction units configured for execution by a computer processor, and a plurality of services executable upon one or more computer processors either independently or in communication with each other to process data or documents. The user system 101 can be a rendering unit configured to enable the computer processor to generate an interactive Graphical User Interface (GUI) accessible to one or more users, and display information on a web page, wherein the interactive Graphical User Interface (GUI) is configured to receive user input over a network 105. The computer processors described herein can include one or more hardware processors. The processes described herein can be implemented with the one or more hardware processors and stored as instructions in memory. The one or more hardware processors can be distributed across a network.

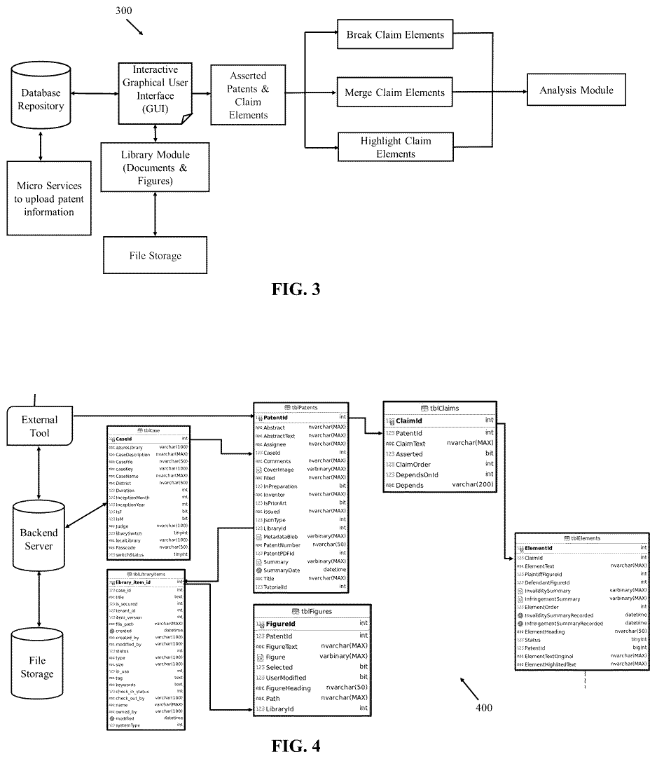

FIG. 2 is a block diagram 200 illustrating the various components of a Patent litigation and evidence management system 201 of the present disclosure. The Patent litigation case setup 202 workflow process can include a Patent Case Setup Module 203, a Claims Setup Module 204, and a Figures/Drawings module 205 also referred to as Figures Module hereinafter, as described below in detail.

According to an aspect of the present disclosure, for plaintiff users, a Patent litigation and evidence management system 201 comprises an Evidence analysis module 206 also referred to as Evidence Analysis and Management module hereinafter, comprising a Terms Construction Module 207 also referred to as Term Construction Setup Module, an Infringement Module 208 also referred to as Infringement Setup Module hereinafter, a Validity Module 209 also referred to as Validity Setup Module hereinafter, a Master Pointer Matrix Module 210, and a Damages Module 211.

According to another aspect of the present disclosure, for defendant users, a Patent litigation and evidence management system 201 comprises an Evidence analysis module 206 also referred to as Evidence Analysis and Management Module 206 hereinafter, comprising a Terms Construction Module 207 also referred to as Term Construction Setup Module, a Non-Infringement Module 208 also referred to as Infringement Setup Module hereinafter, an Invalidity Module 209 also referred to as Invalidity Setup module hereinafter, a Master Pointer Matrix Module 210, and a Damages Module 211.

According to an aspect of the present disclosure, a Patent litigation and evidence management system 201 further includes supporting modules 212 for evidence management. The supporting modules can include a Build Charts Module 213, a Library Module 214, and an Import Charts Module 215.

### 1. Patent Case Setup Module of a Patent Litigation and Evidence Management System

The standard workflow process of a patent litigation case typically involves identifying asserted patents and identifying the asserted claims which are reviewed and further analyzed. Conventionally, the tasks involved in a patent litigation process are performed using word processing software and involve reviewing multiple files, a process that is cumbersome, time-consuming, and prone to errors. Moreover, manually analyzing drawings, and matching them with their descriptions, to correlate with various components, significantly increases the workload of an analyst and complexity of the task. Furthermore, it can increase duplication of documents that need to be stored and/or managed.

According to an embodiment of the present disclosure, the workflow process of a patent litigation process can include identifying asserted patents, identifying the asserted claims, and reviewing identified asserted claims to separate out elements from said asserted claims for further analysis by users. These elements are also referred to hereinafter as claim elements.

A patent litigation case begins by identifying specific patents, hereinafter mentioned as asserted patents, and asserted claims that the plaintiff alleges the defendant has infringed. Patents typically comprise multiple claims, each describing various aspects or features of the invention. The plaintiff must specify which claims are being litigated. This step narrows the scope of the litigation to the relevant claims hereinafter mentioned as asserted claims.

Once the asserted claims are identified, each claim may be separated into individual elements, interchangeably herein referred to as claim elements or elements. Patent claims are generally composed of a plurality of elements that collectively define the invention. Separating out the elements from the asserted claims enables understanding the specific technical and legal boundaries of the claimed invention. This process of separating elements from asserted claims enables users to perform tasks such as comparing the asserted claims against the accused product or process to determine if infringement has occurred, or comparing the asserted claims of the asserted patent against the prior-art for invalidity, or for analyzing separated out elements at any other stage of litigation lifecycle.

Further, the detailed descriptions of the invention, along with any drawings or figures are reviewed to help in the interpretation of the technical aspects of the patent.

The Patent Case Setup Module 203 as shown in FIG. 2 of the electronic management for Patent litigation and evidence management system 201, also referred to as system offers a user-friendly and efficient solution designed to streamline the process of setting up a patent litigation case in a Patent litigation and evidence management system 201 by allowing users to enter one or more patent numbers of the asserted patents or upload one or more patent documents directly into the system. Patent Case Setup Module 203 automatically fetches, processes, and stores relevant details for the specified asserted patent into the system. The Patent Case Setup Module 203 extracts relevant details such as bibliographic information, specification including description, examples and tables, claims, and drawings from the asserted patent document. The Patent Case Setup Module 203 enables users to verify or edit extracted information from the original document to ensure that accurate details of the asserted patent are captured for further processing. The Patent Case Setup Module 203 processes and preserves the specification in the format of columns and lines for quick and easy extraction and use as a citation of relevant text by a user. The interactive Graphical User Interface (GUI) of the Patent Case Setup Module 203 simplifies the process of identifying asserted claims for the user. A user can effortlessly select and identify specific claims to further separate out claims into elements and sub-elements by using the interactive highlighting tools available in the GUI. Users can perform multiple analyses corresponding to relevant evidence by separating out claims into elements or sub-elements. These interactive Graphical User Interface (GUI) features of the Patent Case Setup Module 203 minimize manual intervention of users, improve user interaction, reduce number of clicks by the users for uploading or retrieving relevant data, thereby enhancing both accuracy and efficiency.

Further, the auto-labeling feature of the Patent Case Setup Module 203 processes the figures and drawings available in the patent and labels the various components of the drawings or figures as described in the patent specification. This functionality not only simplifies the patent setup process but also reduces the time spent by users during the analysis process. The auto-labeled drawings could be linked with relevant citations from drawings as evidence, thereby improving the overall efficiency of the asserted patents claim analysis process.

The Patent Case Setup Module 203 streamlines the management and analysis of asserted patents in the patent litigation process. The essential features of the Patent Case Setup Module 203 in a Patent litigation and evidence management system 201, as discussed below in detail, enable users to efficiently establish and manage a patent litigation case including evidence within the system.

A patent case is setup in the Patent Case Setup Module 203 of the electronic Patent litigation and evidence management system 201, by users with privileged access, for example an administrator user of the patent litigation case.

Patent Processing and Setting Up Asserted Patents by Permissioned Users into a Patent Litigation and Evidence Management System

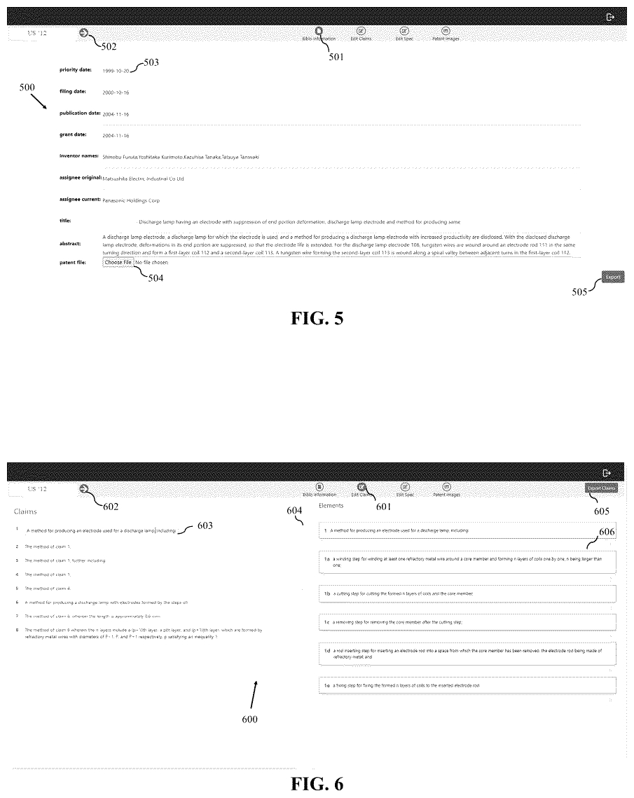

FIG. 3 illustrates a workflow process of the Patent Case Setup Module 203 of a Patent litigation and evidence management system 201 according to various aspects of the present disclosure. The patent setup workflow process 300 as outlined in FIG. 3, allows users to either enter a patent number or upload a patent document, such as a PDF, XML or other formats, through an interactive Graphical User Interface (GUI) into the system. The Patent Case Setup Module 203 automatically retrieves, processes, and saves the relevant details from the patent into the system through micro services. These details can then be edited by authorized users, which helps save time, reduce errors, and ensure data integrity.

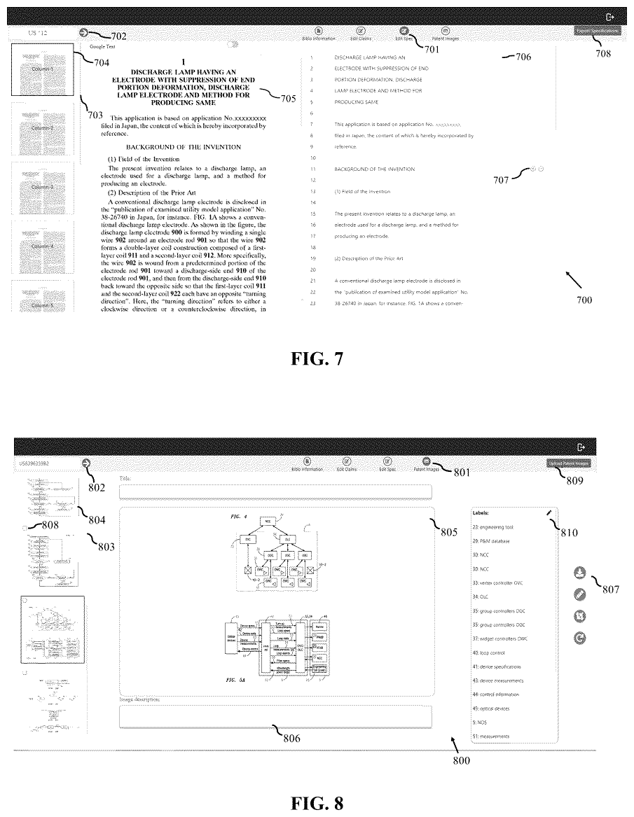

FIG. 4 illustrates a database schema 400 comprising various tables used in the Patent Case Setup Module 203, according to an embodiment of a Patent litigation and evidence management system 201 of the present disclosure.

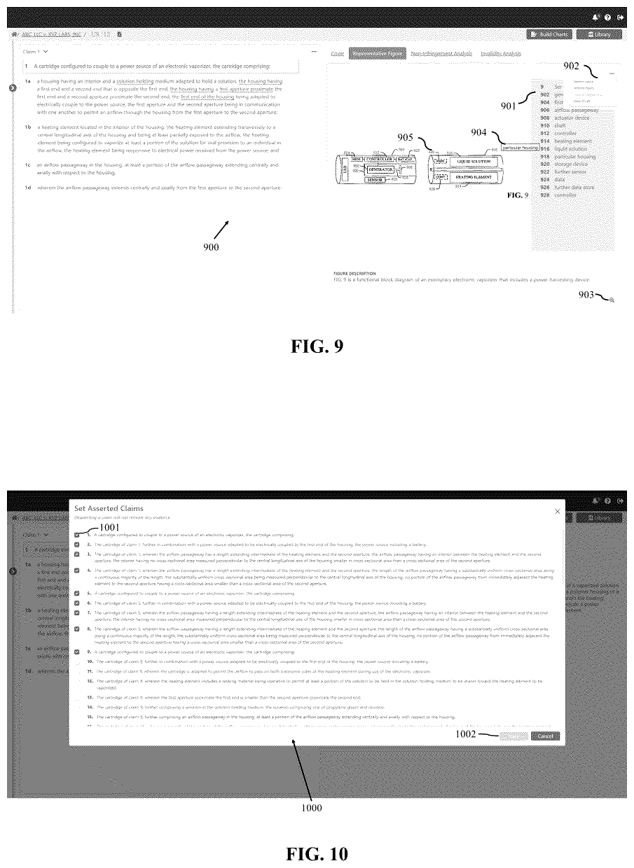

FIG. 5 illustrates an interactive Graphical User Interface (GUI) for the modification or verification of the bibliographic information 500 as part of the Patent Case Setup Module 203 of a Patent litigation and evidence management system 201 of the present disclosure. Bibliographic information details 503 typically includes priority date, filing date, publication date, grant date, inventor name, assignee original, assignee current, title, and abstract. Users can editor verify the bibliographic information details as shown in FIG. 5, on the Biblio Information tab 501, wherein, by inputting 502 another asserted patent number, the screen will refresh with the details of the specified asserted patent, users can upload the original patent document 504, and export 505 refreshed bibliography into a Patent litigation and evidence management system 201.

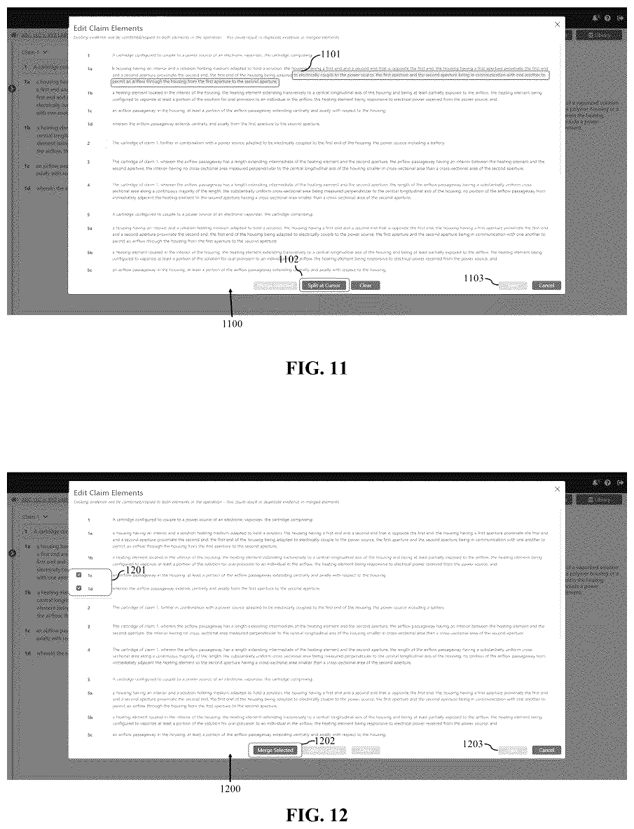

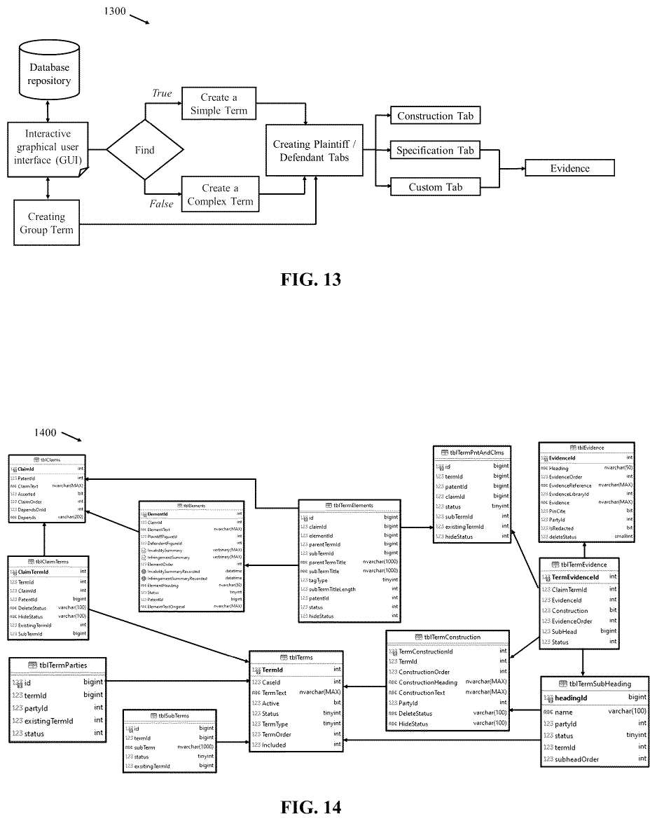

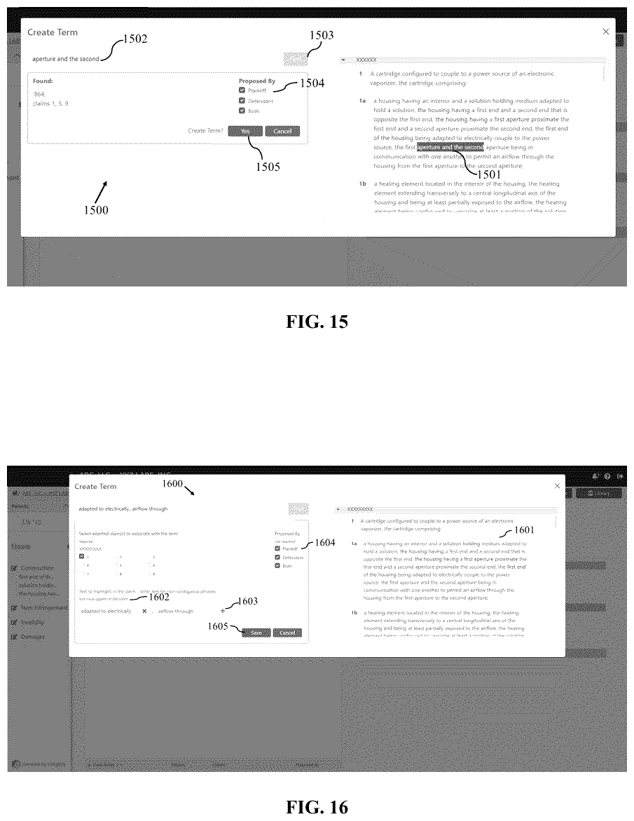

FIG. 6, FIG. 7 and FIG. 8 illustrate an interactive Graphical User Interface (GUI) for the modification or verification of the claims, specification, and drawings respectively, as part of the Patent Case Setup Module 203 of a Patent litigation and evidence management system 201 of the present disclosure. Users can edit or verify the asserted claims 600 that were auto extracted as shown in FIG. 6, on the Edit Claims screen 601. By inputting 602 another asserted patent number, the screen will refresh with the claims of the specified asserted patent. The screen is split into two parts which allows users to select a specific asserted claim on the left-side of the screen 603 or re-number for sorting purpose 604. The corresponding claim elements and sub-elements of the selected asserted claim appear on the right-side of the screen 606, which can be edited, labeled, or re-sequenced by users. The edited claim elements and sub-elements can be exported 605 into a Patent litigation and evidence management system 201.

Similarly, users can verify or edit the auto extracted specification 700 as shown in FIG. 7, on the Edit Spec screen 701. By inputting 702 another asserted patent number, the screen will refresh with the specification of the specified asserted patent. The screen is split into three parts. The left-side of the screen is a page list 703 of the specification that is broken down into columns. Users can select 704 one of the columns for editing. The center part of the screen 705 displays the relevant text from the specification in the form of columns and line numbers. The right-side of the screen 706 displays the corresponding selected specification in an editable form, that users can edit. Users can click on a button 707 to add or remove lines. The edited specification can be exported 708 into a Patent litigation and evidence management system 201.

Further, users can verify or edit the auto extracted drawings or figures 800 as shown in FIG. 8, on the Patent Images screen 801. By inputting 802 another asserted patent number, the screen will refresh with the figures and drawings of the specified asserted patent. The screen is split into two parts. The left-side of the screen is a list of all the drawings or figures 803 from the specific asserted patent. Users can select one of the figures 804 for editing. The right-side of the screen 805 displays the corresponding selected figure in an editable form, that users can verify or edit. Users can edit the title or Image description 806. Users can also select actions to label, crop, replace, re-do and others 807 on the selected figure. Users can select figures or drawings of interest to be exported by selecting respective check boxes 808, and editable labels 810. The edited or verified drawings could be exported 809 into a Patent litigation and evidence management system 201.

### User Interaction for Analysis Based on Access Level Controls

After a patent litigation case is initiated in the system, multiple users having appropriate access levels are assigned to the case to perform various tasks and in-depth analysis, as outlined below.

### a) Figures/Drawings Module

The Figures Module 205 as shown in FIG. 2 of a Patent litigation and evidence management system 201 of the present disclosure simplifies the interaction of users with patent drawings. It allows users to view and retrieve existing patent drawings, or upload custom figures or drawings annotated by users.

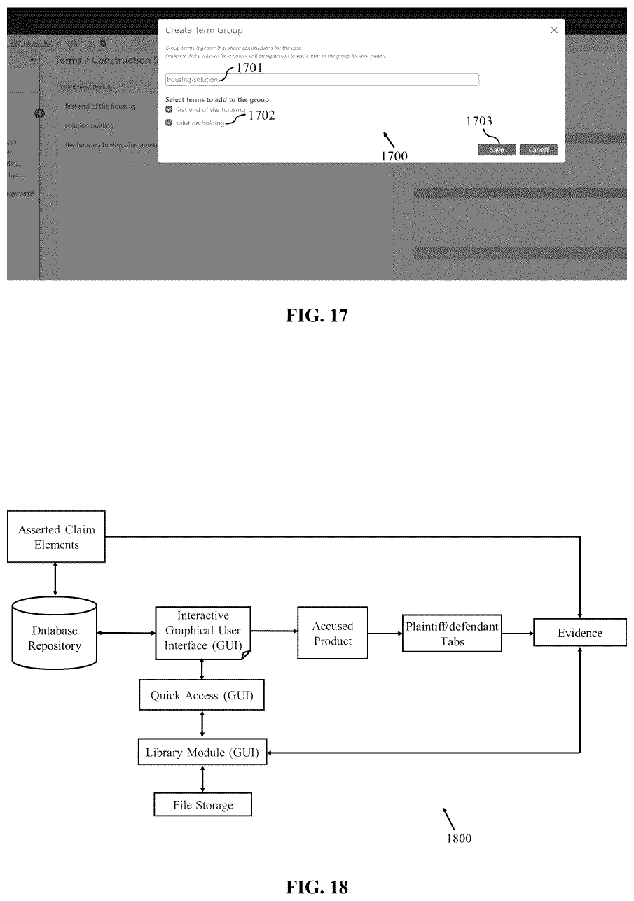

FIG. 9 illustrates an interactive Graphical User Interface (GUI) for the modification or addition of the representative figures by users, as part of the Patent Case Setup Module 203 of a Patent litigation and evidence management system 201 of the present disclosure. As shown in FIG. 9, users can select a claim element of interest and modify the representative figures 900. The block that displays a representative FIG. 901 displays the figure corresponding to the selected claim element. Users can use menu options 902 to navigate or perform actions to replace figures, remove highlighted elements, or show ID list. The Show ID list 903 displays a list of labels on the drawings extracted from the specification. Further, tool tips 904 are available on the numbered components of the figure for easy viewing of the details. The highlighted labels on the drawings 905 correspond to the show IDs extracted from the specification. Further, users can turn on/off image labels and zooming feature for better visualization.

This functionality enhances the analysis process, reducing the time spent by the analysts, and improving efficiency in patent litigation by allowing auto-labeled drawings to be used effectively as evidence with relevant citations.

A client-side code fetchFigures( ) as per the pseudocode in APPENDIX I d), fetches figures and updates the interactive Graphical User Interface (GUI) database. A corresponding server-side function fetchFigures( ), retrieves figures from a database using the input parameters such as the patent number and user modifications, ensuring accurate data retrieval. Additionally, the auto-labeling feature of the Figures Module 205 offers users detailed description of the various components of the figure that is auto-selected from the patent specification, thus enhancing user experience and making it time-efficient during the analysis process. A server-side function handleFetchElementFigure( ) as per the pseudocode in APPENDIX I e), fetches specific details related to the various features or components of the figures, labels, and highlights. Overall, the versatility of the Figures Module 205 has significant utility in patent litigation cases as it significantly impacts the presentation of key visual data and improves the analysis process.

With the Figures Module 205, annotated figures include the annotations and labels that are correlated to claim limitations or sub-limitations. When performing an evidence analysis in the infringement/non-infringement module, or validity/invalidity module, the representative figure can be better viewed or understood in the context of the claim limitation.

### User Functions on Asserted Claims

Patent litigation is an iterative and dynamic process that involves mapping new or existing evidence to specific elements or sub-elements of claims for in-depth analysis. Essential functionalities, such as identifying asserted claims, and segmenting or merging claims into specific elements or sub-elements allows users to conduct the necessary analysis. The Patent Case Setup Module 203 includes features to accomplish these tasks efficiently enabling users with the appropriate access levels to identify asserted claims, and segment or merge claim elements. Furthermore, version control capabilities integrated with the Patent Case Setup Module 203 permit all versions of the claims, whether modified or original to be saved or archived for future reference. This ensures tracking and management of claim modifications during the patent litigation lifecycle.

### b) Set Asserted Claims Feature

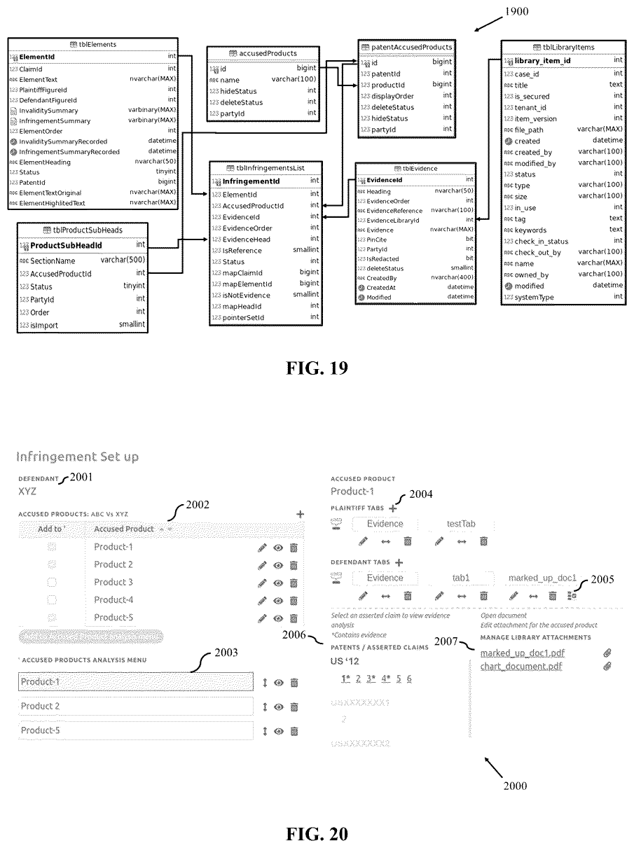

FIG. 10 illustrates an interactive Graphical User Interface (GUI) showing the Set Asserted claims feature 1000 used for the identification of asserted claims by users, as part of the Patent Case Setup Module 203 of a Patent litigation and evidence management system 201 of the present disclosure. The Patent Case Setup Module 203 includes a Set Asserted Claims feature as shown in FIG. 10 that enables users with the appropriate access levels to set asserted claims at an early stage of the patent litigation process. This feature works by displaying users a list of all claims accompanied with a check box. Users can select specific check boxes 1001 corresponding to the claims that are to be identified as asserted claims and click on the Save 1002 button to confirm their selections.

A client-side server function handleClaimSelection( ) to modify claim selections, operates on a list of claimID, wherein each claim is identified by its claim ID and a Boolean variable indicating whether it is an asserted claim. The function handleClaimSelection( ) asynchronously processes the list of claims by making an API call to update the claims. It then dispatches an action to fetch the updated claims and closes any open modals or windows.

A server-side function fetchClaimElements( ) as per the pseudocode in APPENDIX I a), takes a claimID as input and outputs the relevant data including terms and elements. This function receives a claimId as input and initializes necessary variables. The function queries a database table, tblClaims, to fetch a claim record corresponding to the provided claimId. It checks for dependencies within the fetched claim. If dependencies exist, they are processed either by splitting a dependency list or by updating the claim's dependencies based on other dependent claims and re-fetching the updated claim.

The method further involves querying another database table, tblElements, to fetch elements associated with the claim, considering any dependencies and their order. These elements are fetched with associated terms linked through a model, tblTermElements, ensuring that all related data is included.

### c) Break Claim Elements

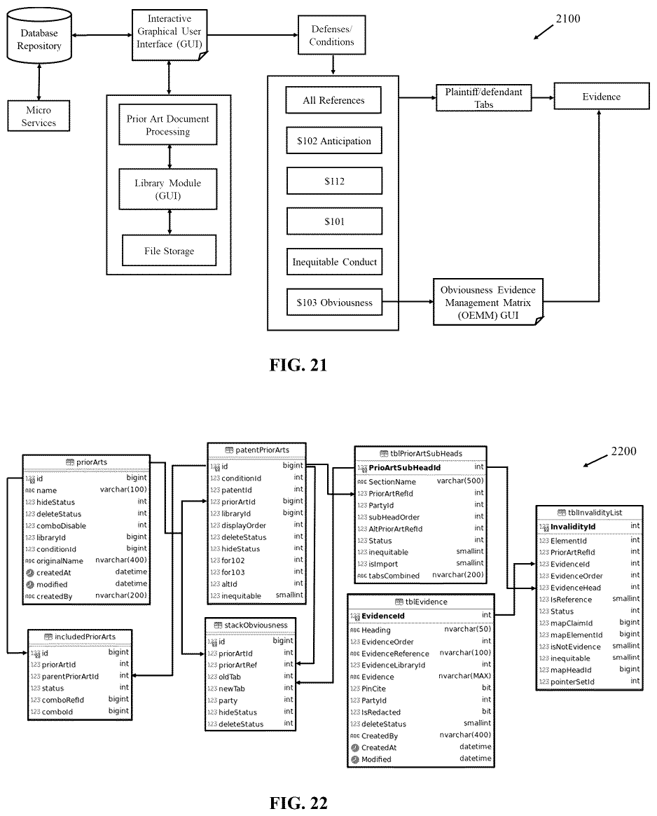

FIG. 11 illustrates an interactive Graphical User Interface (GUI) showing the Break Claim Elements feature 1100 as part of the Patent Case Setup Module 203 of a Patent litigation and evidence management system 201 of the present disclosure. Users can segment claim elements into two or more separate elements for claim charting with corresponding relevant evidence as shown in FIG. 11 by using the Break Claim Elements feature 1100 in the Patent Case Setup Module 203. On the Edit Claim Elements screen, users can highlight a portion of the text 1101 where the element should split, at which point the Split at Cursor 1102 button and Clear button become enabled for splitting and removing the selection, respectively. Clicking the Split at Cursor 1102 button allows users to add a heading for the new element and preview the result before saving it by clicking Save 1103 button.

An asynchronous function, handleSplitElements( ) as per the pseudocode in APPENDIX I b), is designed to split a claim element of a patent into multiple elements. A payload object is constructed with the necessary information for splitting into claim elements. An asynchronous API call is made to update the claim elements on the database with the constructed payload. After the API call, the function refreshes the client-side state by fetching the updated claims from the database server and the function handleCloseModal( ) is called to close any modal or dialog box that was used for the splitting process.

### d) Merge Claim Elements

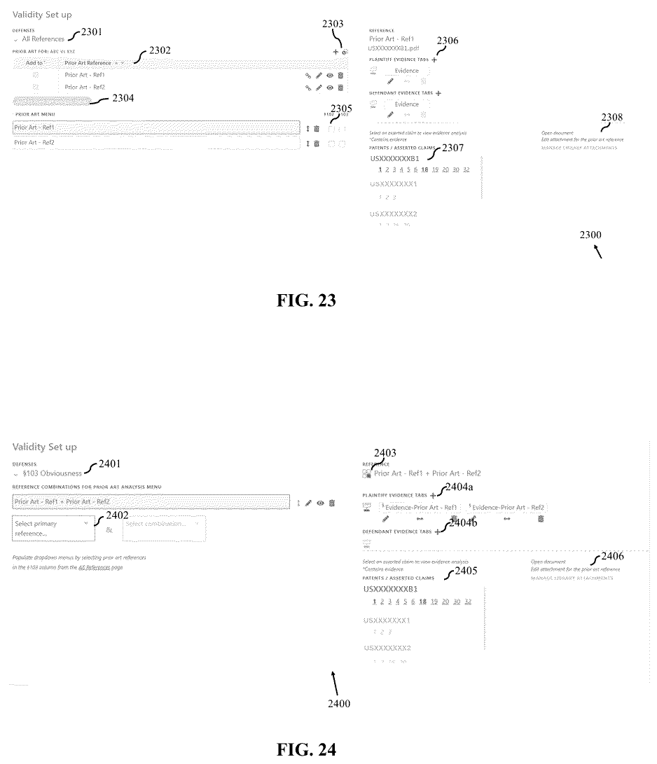

FIG. 12 illustrates an interactive Graphical User Interface (GUI) showing the Merge Claim Elements feature 1200 as part of the Patent Case Setup Module 203 of a Patent litigation and evidence management system 201 of the present disclosure. Contrary to the process of breaking down claims into elements or sub-elements during the analysis process, there are situations where elements or sub-elements may have to be merged to accurately map or correlate with the relevant evidence. The Merge claim elements feature 1200 as shown in FIG. 12 in the Patent Case Setup Module 203 provides users with the necessary flexibility to merge elements or sub-elements as required. On the Edit Claim Elements screen, users can select specific check boxes 1201 corresponding to the claim elements for merging, at which point the Merge selected 1202 button and Clear button become enabled for merging and removing the selections, respectively. Clicking the Merge selected 1202 button allows users to modify the numbering for the new claim element and preview the result before saving it using the save 1203 button.

The user can merge two or more claim elements by selecting specific claim elements, and submitting the claim elements to a server-side asynchronous function, handleMergeElements( ) as per the pseudocode in APPENDIX I c), which enables merging selected claim elements of a given patent. A payload object containing essential information required for merging claim elements, is created. An asynchronous API call is made to update the claim elements in the database with the constructed payload object. After the API call, the function refreshes the client-side state by fetching the updated claims from database server and the function handleCloseModal( ) is called to close any modal or dialog box that was used for the merging process.

### 2. Library Module

The patent litigation process relies heavily on analyzing a large number of confidential documents. It is therefore critical that the document storage system can efficiently process a large set of documents used in patent litigation while ensuring security and data integrity.

The Library Module 214 as shown in FIG. 2 of a Patent litigation and evidence management system 201 is designed with advanced features to store, organize, and retrieve a large set of documents used during a patent litigation process. This module is built on a cloud-based platform that serves as a centralized document repository to support storage of various types of documents and file extensions that provide quick hyperlinked access via evidence citations to the source document. The file management system is designed for optimal user interaction, enabling the creation, uploading, deletion, renaming, and downloading of files. All the files are securely stored in the cloud-based sever with necessary encryption and authentication features.

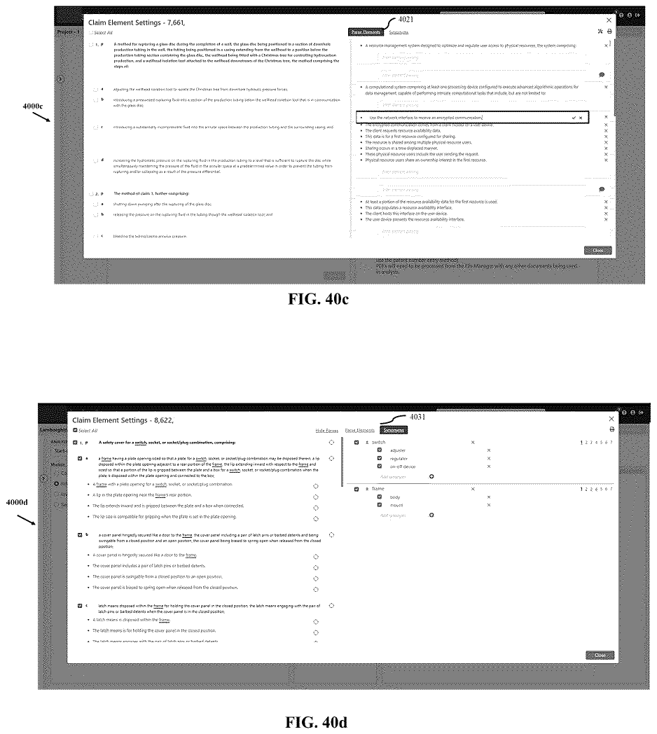

Key features of the Library Module 214 include advanced filtering options allowing users to perform keyword searches, metadata filtering, and context-based searches, thus enabling users to quickly and effortlessly access relevant documents. Additionally, the Library Module 214 enables users to categorize and tag documents, thus making the retrieval process efficient. FIG. 26 is a workflow process 2600 of the Library Module 214 of a Patent litigation and evidence management system 201 of the present disclosure.

Moreover, the Library Module 214 is designed to maintain the security of confidential information. The Library Module 214 has advanced access controls features to ensure that confidential data is both protected and accessible only to authorized personnel. Such access level control features play a key role in maintaining operational integrity, compliance, and usability, which helps preserve the confidentiality of confidential information while supporting the effectiveness and efficiency of the litigation process.

The Library Module 214 is designed for any of the digital assets uploaded such as files, documents, images, videos, and other file formats which will not be deleted, but will be archived and versioned. Any accidental overwriting or deletion can be easily reverted to the previous version. The Library Module 214 enables users to edit the digital assets using the check-in or check-out features, which prevents accidental overwriting or deletion of the digital assets.

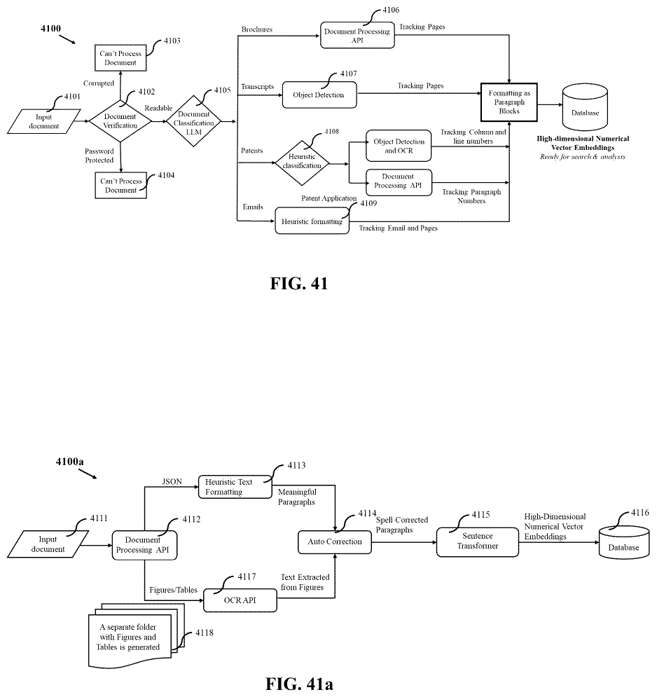

FIG. 27 is a schematic representation of a database schema 2700 showing the technical relationships between at least a portion of the database tables for the functionality related to the Library Module 214 of a Patent litigation and evidence management system 201 of the present disclosure.

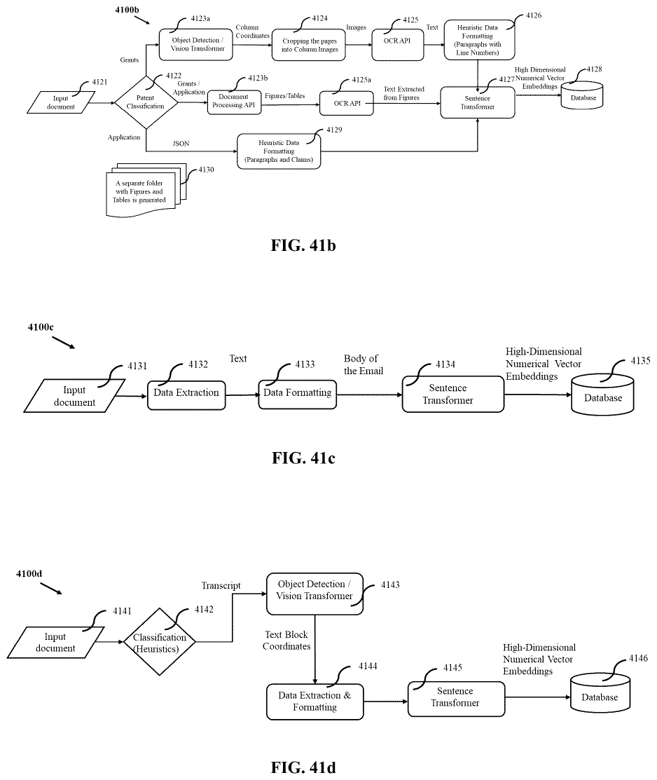

FIG. 28 illustrates an interactive Graphical User Interface (GUI) for the Library Module 214 of a Patent litigation and evidence management system 201 of the present disclosure. The FIG. 28 is a screen shot 2800 of the Library Module 214, which shows the folder structure represented by 2801, context menu 2802 for user operations such as copy, paste, rename, and other file or folder operations, and quick or advanced search options from the menu 2803. The menu 2804 for module level operations such as export assets or list, notification, activity log, upload files, or preview, and other functions.

A client-side function mainRootList( ) as per the pseudocode in APPENDIX II a), manages the interactive Graphical User Interface (GUI) for all the file management tasks. The function loads payload object with the input identifiers related to the project and case, and makes a GET request to an API to obtain response data while performing error management.

A server-side function getAllRootFolders( ) as per the pseudocode in APPENDIX II b), authenticates users and extracts input parameters such as case_id and storage path. The function initializes an array to store project data and executes a database query to gather project specific data including necessary error handling mechanisms. The function ensures that only authorized users can have access to appropriate modules, and filters data as per the security settings. The function compiles the filtered data into the array, performs checks for any errors, and sends a response back to the client-side function.

Although file management systems and methods are well recognized in the art and familiar to those skilled in the pertinent field, the present disclosure, when considered holistically and in conjunction with its accompanying features and modules as detailed herein, constitutes a novel and non-obvious advancement over the prior-art for the functionality described herein.

### 3. The Flexible and Scalable Analytical Module of Master Pointer Matrix (MPM)

In a patent litigation case, multiple patents and their respective claims are analyzed to prepare various documents such as infringement and validity contentions. Each claim is separated out into elements which are then mapped to corresponding supporting evidence from diverse sources such as prior-art for invalidity, or product manuals, technical specifications and marketing materials for infringement. The mapping of the claim elements to corresponding supporting evidence from diverse sources is a crucial step to create comprehensive claim charts for analysis and comparison. Traditionally, this process is manual, time-consuming, and prone to errors and duplications, especially when dealing with overlapping features among claim elements across different patents.

Current methods of developing claim charts typically involve manually building and maintaining extensive documentation in a word processing software, which becomes cumbersome and inefficient when modifications are required across multiple patents or when coordinating among large teams. Furthermore, the visualization of the relationships between the claim elements and the corresponding evidence in these documents is not user-friendly or dynamic due to static presentation of data.

Moreover, managing claim charts throughout the patent litigation lifecycle is a tedious and time-consuming process, when done manually. With evidence replicated across multiple claims, adding or updating evidence manually becomes complex and inefficient, potentially resulting in errors.

The Master Pointer Matrix (MPM) Module 210 of a Patent litigation and evidence management system 201 of the present disclosure as shown in FIG. 2, is a real-time, interactive, flexible, and scalable grid that is used during various types of analyses during the patent litigation as it enhances the management and visualization of claim elements and their corresponding evidence. The Master Pointer Matrix (MPM) Module 210 also referred to as MPM or Master Pointer Matrix (MPM) Module hereinafter. The Master Pointer Matrix (MPM) is useful for the preparation of infringement and validity contentions as it links evidence to the claim elements and enables users to visualize these relationships through an intuitive interface. The Master Pointer Matrix (MPM) is a grid or matrix displayed on the user's screen, consisting of cells formed at each intersection of multiple rows along the y-axis and columns along the x-axis. The term grid is used interchangeably with matrix hereinafter. The Master Pointer Matrix (MPM) is rendered as an interactive Graphical User Interface (GUI) on the computing device of a user, providing a dynamic and responsive matrix that adapts to various screen sizes and resolutions using innovative rendering techniques such as virtualization and simulating user scrolling. The adaptive and responsive features of the Master Pointer Matrix (MPM) ensure usability and accessibility in various environments during the entire course of a patent litigation lifecycle.

The Master Pointer Matrix (MPM) overcomes several challenges associated with the display of large matrices and managing extensive datasets, particularly with varying screen resolutions. Traditional grid-based layouts, which might require rendering up to 100 million cells in a 10,000×10,000 grid, are resource-intensive and result in significant latency. The Master Pointer Matrix (MPM) enhances system performance by selectively rendering cells visible to the user based on the display size and resolution, thus optimizing resource use and improving the overall user experience.

The Master Pointer Matrix (MPM) is displayed as a grid or matrix on the user's screen, and is capable of adjusting dynamically to the resolution and dimensions of the screen. This responsiveness ensures that the Master Pointer Matrix (MPM) remains readable and usable regardless of the screen size by employing a Virtualization technique as discussed below in further detail. The virtualization technique adjusts the display of the Master Pointer Matrix (MPM) relative to the number of claim elements and the screen size.

Moreover, user interaction with the Master Pointer Matrix (MPM) allows vertical or horizontal scrolling, with the Master Pointer Matrix (MPM) Module 210 rendering updated information in real-time. This capability is supported by incorporating a method of simulating natural user scrolling within a fixed-dimension parent table container, wherein rendering is confined to the dimensions of the container. The system dynamically calculates row and column indices from respective arrays rendered along the y-axis and x-axis, effectively slicing the array elements for display as needed. As the user scrolls, the Master Pointer Matrix (MPM) Module 210 updates the visible portion of the grid, rendering only the cells currently in view. This approach significantly reduces resource consumption and enhances user interaction with large datasets thereby ensuring smooth and responsive navigation through the grid. This enhanced capability is supported by advanced virtual memory techniques that refresh data in milliseconds, thereby ensuring that the most current data is displayed with minimal latency.

Furthermore, the architecture of the Master Pointer Matrix (MPM) minimizes redundancy in data storage and reduces latency in data retrieval and updating of data. This is achieved by creating pointers to the data rather than duplicating sets of data for each claim element. The pointers allow users to easily replicate evidence across claim elements, ensuring accuracy and consistency. Moreover, for any updates on the claim charts, the pointers automatically update the evidence and citations across all the related claim elements, eliminating the need for manual updates thereby reducing significant time for users.

While the Master Pointer Matrix (MPM) features minimize redundancy, it also provides the flexibility to create exclusive datasets. Additionally, the Master Pointer Matrix (MPM) can include robust features to prevent deletion of accidental data, and facilitate easy reversion of changes when necessary.

Moreover, Master Pointer Matrix (MPM) is configured to utilize one or more artificial intelligence (AI) and machine learning (ML) algorithms, including but not limited to Large Language Models (LLMs) or Small Language Models (SLMs), to analyze and map patent claims. Specifically, the Master Pointer Matrix (MPM) is configured to map a first set of claims from a first reference patent to a second set of claims from a second related patent, wherein the second related patent includes, but not limited to a family patent, a continuation-in-part (CIP), or a similar related application. A technical challenge arises when mapping claims that are semantically equivalent, i.e., have the same meaning or inventive concept, but are syntactically divergent, i.e., use different wording or structure. While conventional statistical models may successfully map claims with linguistic similarity, they often fail to identify these complex, semantic relationships. This failure is often due to a lack of specialized domain knowledge. The Master Pointer Matrix (MPM) of the present disclosure overcomes the limitations of existing techniques, by employing an MIL model, such as an LLM that has been custom-trained on a specialized domain-specific data, particularly data from the field of intellectual property and the relevant technical art. This results in a significantly more accurate and reliable mapping for the Master Pointer Matrix (MPM). The techniques described herein are not limited to patent claim mapping and may be advantageously applied to other natural language processing applications requiring high accuracy or domain-specific semantic analysis.

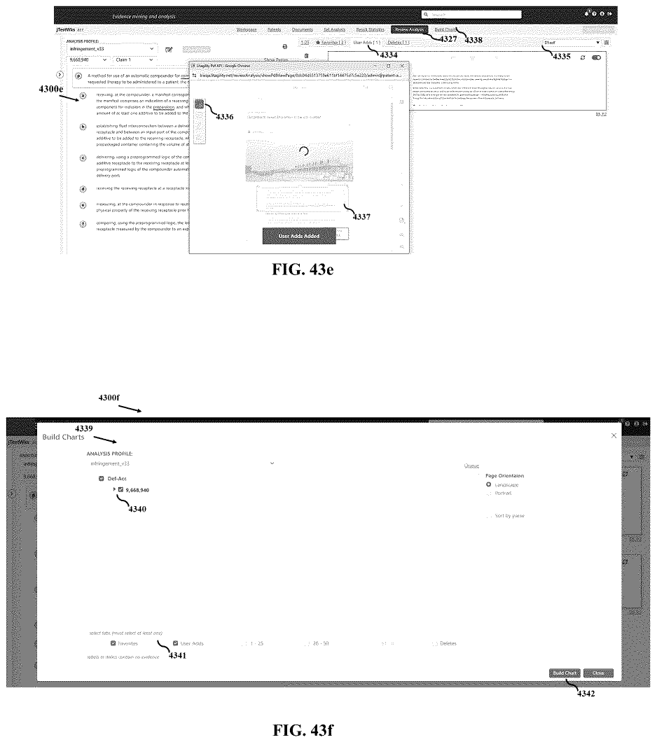

### Working Method of the Flexible and Scalable Analytical Module of Master Pointer Matrix (MPM) Module as Illustrated in FIG. 34 Represents the Flow Chart of the MPM Process

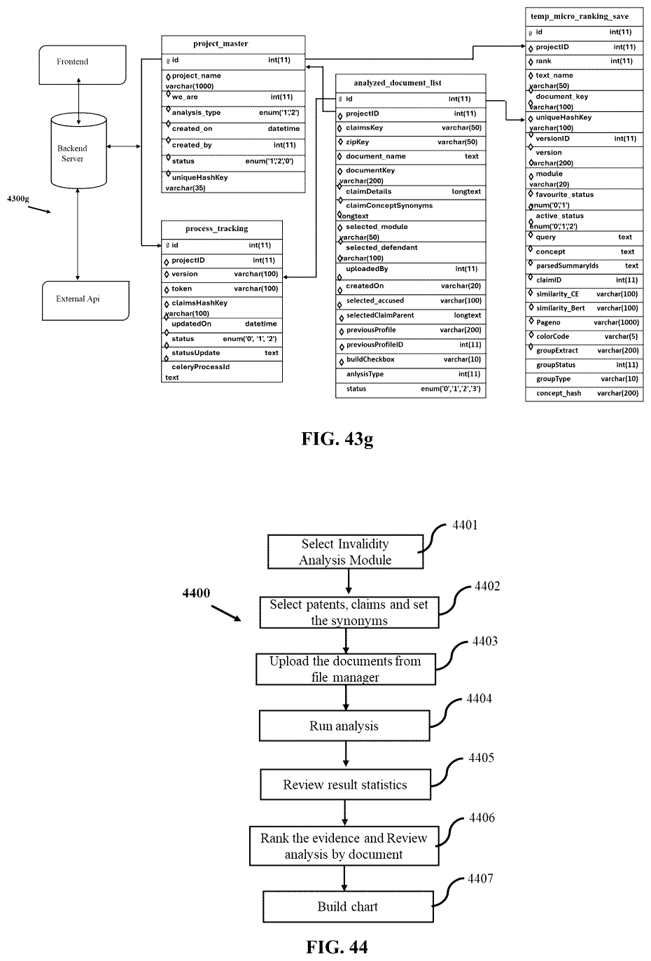

FIG. 34 illustrates a flow chart for the Master Pointer Matrix (MPM) process, an embodiment of a Patent litigation and evidence management system 201 of the present disclosure. The interactive Graphical User Interface (GUI) of the Master Pointer Matrix (MPM) is unique as it simplifies the display and correlation of the claim elements between two asserted patents. FIG. 34 illustrates the working flow chart of the Master Pointer Matrix (MPM) Module 210. FIG. 35 illustrates the feature used for the selection of source patent and target patent to generate a Master Pointer Matrix (MPM), according to an embodiment of a Patent litigation and evidence management system 201 of the present disclosure. To generate a Master Pointer Matrix, as illustrated in FIG. 35, the user selects a source patent as the current patent 3501 from a dropdown list on the interactive Graphical User Interface (GUI) 3500. The term source patent is hereinafter referred to as master patent. Additionally, the user selects a target patent 3502 from another dropdown list available on the same interactive Graphical User Interface (GUI).

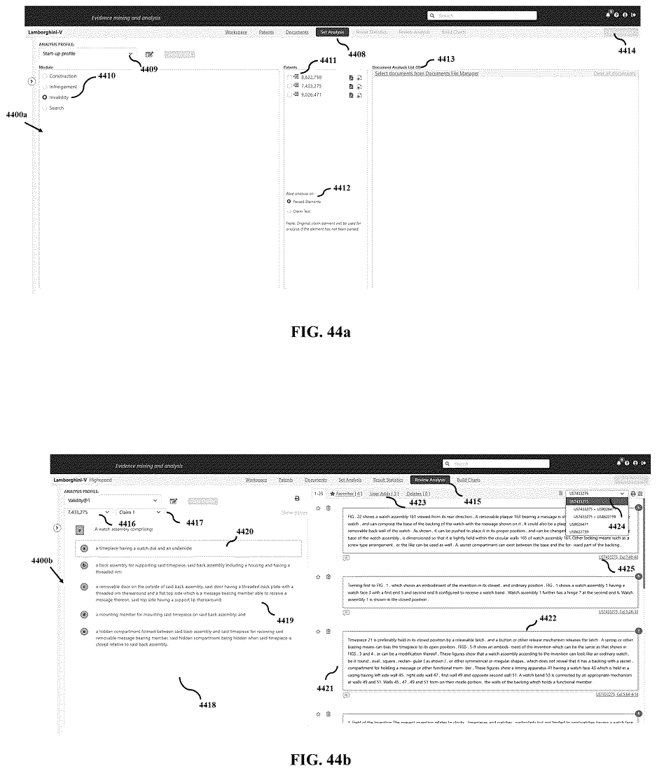

After selecting the master patent and target patent, the user clicks the Create Matrix 3503 button to submit the information via an HTTP GET request. The server-side server retrieves the claim elements for each of the master and target patents along with the stored pointer data from the database and returns the data to the requested client-side service. The client-side services will process the received data from the server and displays the data on the interactive Graphical User Interface (GUI) as a Master Pointer Matrix (MPM). The Master Pointer Matrix (MPM) is designed to be intuitively user-friendly and easy to understand. FIG. 36 illustrates a m×n Master Pointer Matrix (MPM) 3600 between the claim elements of master patent also referred to as source patent, when the source patent and the target patent are the same, according to an embodiment of a Patent litigation and evidence management system 201 of the present disclosure. If the master patent contains ‘m’ claim elements and the target patent contains ‘n’ claim elements, then an m×n Master Pointer Matrix (MPM) is rendered, as shown in FIG. 36 represented as 3600.

The client-side services submit user input data, userInputData, as query parameters, over an HTTP GET request. The userInputData includes sourcePatentId, targetPatentId, and asserted status that is submitted to a server-side function getMPMData(userInputData) as per the pseudocode in APPENDIX III a). The function getMPMData(userInputData) extracts query parameters from userInputData. Subsequently, the function executes SQL queries based on the asserted status to retrieve claims elements from the master patent. For each claim retrieved, SQL queries are performed to retrieve corresponding claim elements and details, which are stored in elementDetails object. The elementDetails object includes pointerData, which contains pointer information linking elements across different patents. The retrieved elementDetails object is stored as sourceList object, which is a multi-dimensional array.

The same method and function as described above is applied to populate targetList object with the data from the target patent. The function getMPMData(userInputData) returns structured and formatted data to the client-side, comprising of sourceList and targetList which are nested multi-dimensional arrays. This data is rendered on the client-side in the form of a m×n Master Pointer Matrix (MPM) by a function MatrixTable( ) as per pseudocode in APPENDIX III b).

The function MatrixTable( ) renders the complex grid, Master Pointer Matrix (MPM), on an interactive Graphical User Interface (GUI) for dynamic data visualization and user interaction, while ensuring efficient state management and improved latency during the processing of large datasets. The function MatrixTable( ) serves as a framework that maintains various states to store information about the data matrix, user selections, and manage interactive Graphical User Interface (GUI) settings. It leverages virtual document object model (DOM) capabilities to facilitate efficient updates to the matrix display in response to state changes, including modifications to rows, columns, and individual cell contents.

Users interact with the matrix through mechanisms such as clicking, dragging, and scrolling. The Master Pointer Matrix (MPM) Module 210 responds by updating the relevant states and re-rendering the matrix as necessary. Functional capabilities of the Master Pointer Matrix (MPM) include the interactive selection of data points, real-time data modification with immediate reflection in the matrix, and optimized scroll management for navigating large matrices. This component-based architecture, potentially implemented in frameworks such as React, ensures that user interactions result in immediate visual feedback and seamless adjustments without requiring a complete matrix re-render, thus enhancing usability and performance in data-intensive applications.

The various steps involved in the function MatrixTable( ) comprise state management, dynamic rendering and user scrolling as described below.

### State Management:

The function MatrixTable( ) initializes state variables to manage the data matrix, user selections, and interactive Graphical User Interface (GUI) settings. These state variables store pointers to data rows and columns, track selected elements, and configure display settings and manage user interaction.

### Dynamic Rendering;

The function MatrixTable( ) performs several steps for dynamic rendering. It utilizes virtual DOM capabilities to efficiently update the matrix display in response to the changes in the state. These changes include adding, removing, or modifying rows and columns, as well as updating the contents of individual cells. Additionally, the function MatrixTable( ) performs initializations and calculations necessary for setting up the parent table container. It calculates the maximum height and width of the parent table container in pixels, determines the dimensions of individual table cells, and computes the number of visible rows and columns, which remain fixed. The function MatrixTable( ) also initializes the height and weight for the first child table container. The height and width are calculated based on the size of a single cell of the parent table and elements in the sourceList and targetList as below:

$$totalHeightOfTable = sourceList . length * cellHeight \\ totalWidthOfTable = targetList . length * cellWidth$$

### User Scrolling:

The function MatrixTable( ) facilitates both vertical and horizontal scrolling, enabling users to efficiently navigate large matrices. The system dynamically loads and unloads data based on the scroll position to optimize performance. Additionally, buffer rows and buffer columns are defined to enhance rendering performance by maintaining a set of off-screen rows and off-screen columns that prepare the interface for smooth scrolling transitions. Sub-functions such as scrollTopPosition( ) and scrollLeftPosition( ) set the positions of the vertical scroll bar and horizontal scroll bar respectively. The sub-functions columnsScrolled( ) and rowsScrolled( ) calculate the number of columns and rows scrolled out of view respectively, which is essential for updating only the visible portion of the matrix thus minimizing usage of the memory and other resources.

Further, said method includes steps to determine the starting and ending indices of rows and columns that are to be rendered. Another step generates lists of elements to be rendered on the y-axis and x-axis by slicing the sourceList and targetList respectively using the starting and ending indices of corresponding columns and rows.

### Simulation of Scrolling Behavior in a Master Pointer Matrix (MPM) Display:

The scrolling behavior within the function MatrixTable( ) is simulated through a series of calculated adjustments to the visual representation of the matrix, rather than by physically adjusting data elements within the data structure. This approach optimizes memory efficiency, performance and responsiveness by minimizing the computational load, thereby reducing the latency and enhancing user experience when rendering large datasets. The simulation process involves calculation of virtual dimensions, which includes the vertical space and horizontal space, and the adjustment of first child table container dimensions.

To simulate the scrolling behavior effectively, the method specifies the necessary padding and adjusts the dimensions of the table container accordingly. The first child table is responsible for simulating the actual height of the table as though all the items were rendered without list virtualization. This simulated height is achieved by multiplying the total number of items in the sourceList array by the height of a single row, ensuring that the scrollbar appears on the screen.

Also, by using starting indices, said function tracks the number of items that have been scrolled previously and the number of items that have been removed from the document object model (DOM), beginning from the top and left corners of the table. For the removed items, this function maintains the necessary empty space by adding height to the first row and width to the first column, which is referred to as firstTopRowHeight and firstLeftColumnWidth, respectively.

Similarly, to maintain the bottom height and right padding of the table, the function uses the end indices. The space is filled by adding bottom padding and right padding for the items that are located beyond the end indices, using paddingBottom and paddingRight, respectively. This unique padding method ensures that the table maintains its intended dimensions and user interface integrity throughout the scrolling process.

Working Method of the User Interaction with Master Pointer Matrix (MPM) to Create Multiple Pointer Sets, Delete Pointer Sets, or Break Pointer Sets

The Master Pointer Matrix (MPM) enables user interaction, by allowing creation, modification, and deletion of pointer sets within the interactive Graphical User Interface (GUI). A detailed elaboration on how users interact with the Master Pointer Matrix (MPM) and manage data effectively is herein detailed.

Users can interact with the Master Pointer Matrix (MPM) through clicking, dragging, and scrolling. These actions trigger the component to refresh its state and re-render the matrix as necessary to reflect the changes.

Users can select individual or multiple cells within the matrix for data modification on the database and real-time update of the underlying data model, ensuring an interactive and responsive experience.

The steps involved in the interactive Graphical User Interface (GUI) operations such as creating pointer sets, deleting pointer sets, and breaking pointer sets comprise:

### 1. Initialization and Identification of Exemplar:

Exemplars are cells located at the intersections of the y-axis and x-axis along the diagonal of the matrix, representing dead cells which are not editable.
The system initializes local state variables with default values and identifies the appropriate data structure for operation.
A function createDeadCell( ) is used to define and initialize exemplars as inactive cells.

### 2. Pointer Set Creation and Editing:

A function handleCreatePointerSetBtn( ) converts these exemplars into active states, making a portion of the row cells editable. This allows the row cells adjacent to the exemplar to become editable. All cells on the right-hand side of the exemplar excluding the exemplar are editable.
A function handleExemplarSelection( ) enables users to select an exemplar and edit the entire row, excluding the exemplar. This function does not allow the creation of a pointer set directly from the exemplar.

### 3. Visual Changes and Row Editing:

Upon clicking the function handleOkBtnClick( ), the selected exemplar is activated and highlighted in green.
A function handleGreenRowEnabling( ) visually marks the entire row in green, indicating that it is active and editable.
A function handleCellHighLightWithinEnabledRow( ) allows for the selection of specific elements within the enabled row for further actions.

### 4. Pointer Set Management:

Clicking on an empty cell within an active row will create a new pointer set, while clicking on a filled cell will remove it from the existing pointer set.
A function handleSaveBtnClick( ) triggers a pop-up modal that offers options to either delete the entire pointer set and its content, or break the pointer set for a specific element while retaining the content exclusive for the specific element.

### 5. Data Saving:

The function handleOKBtnClick async(userInputData) makes an asynchronous APT call to a function createPointerElementMatrix( ) which queries the database to save the modified data, ensuring that all the changes are securely stored.

### Creating Pointer Sets:

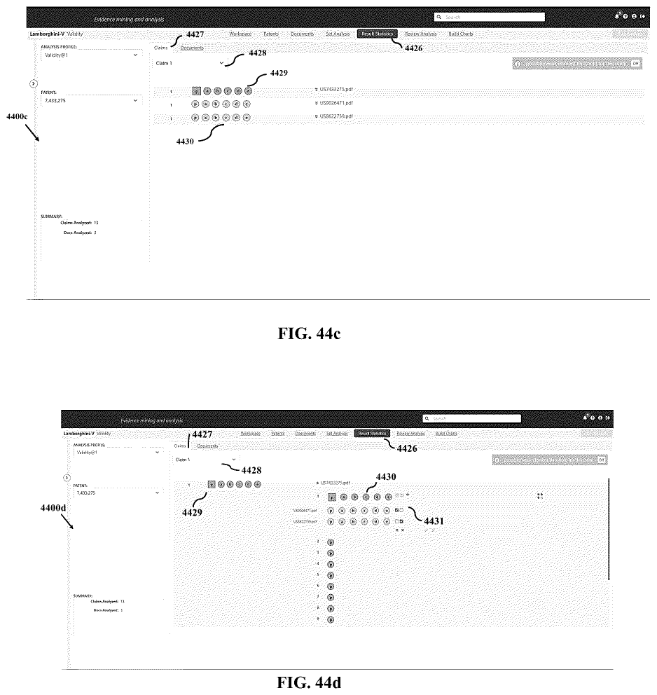

A function createPointerElementMatrix( ) as per the pseudocode in APPENDIX III c), facilitates the creation and management of pointer sets within the Master Pointer Matrix (MPM) system. And FIG. 37 illustrates an overview of the relational database schema of Master Pointer Matrix (MPM), according to an embodiment of a Patent litigation and evidence management system 201 of the present disclosure. The function createPointerElementMatrix( ) processes user requests to dynamically link elements from various patent documents based on specified criteria and actions. The function can include the below steps:
1. Validation of input variables
   Said function extracts and validates information from the request such as the srcPatentId and targetPatentId, and automaticPointerCreation, a flag indicating whether pointer creation should be automatic.
2. Pointer creation process:
   Said function initializes an array to bold pointers that are to be added and iterates over each targetElementId to check for the specified action.
   If the action is add, the function creates a new pointer object containing all relevant data, including the source element ID and the target element ID, the source patent ID and the target patent ID, timestamps, user information, and the element heading. This pointer object is then added to the array of pointers to be created. Said function performs bulk creation of pointers by adding to the pointerMasterElementMatrix database table.
3. Automatic pointer creation:
   If automatic pointer creation is enabled, said function processes each newly created pointer to link additional data automatically.
   Said function retrieves claimIDs and checks for related subheads in the database. Subheads are different sections used in an Evidence Analysis and Management Module 206 of a Patent litigation and evidence management system 201 of the present disclosure.
   For each relevant subhead, the function creates references to evidence records, linking them back to the original pointer and ensuring all the relationships and dependencies are correctly established.

### Deleting Pointer Sets:

A function deletePointerElementMatrix( ) as per pseudocode in APPENDIX III d), manages the deletion of multiple pointer sets, which are used to link claim elements and evidence. The function can include the below steps:
1. Initialization and validation:
   Said function begins by initializing an array, pointerArrayToDelete, which will store the pointers marked for deletion.
   It validates the required parameters such as targetElementIds, srcElementId, and targetPatentId.
2. Pointer deletion process:
   Said function iterates over each targetElementId and extracts details such as the target element ID, the element heading, and the specified action.
   If the action is delete, said function creates a new pointer object with the necessary attributes for deletion and adds this object to the pointerArrayToDelete.
3. Database process:
   Said function processes each pointer in the pointerArrayToDelete and updates pointerMasterElementMatrix to set the status as 0 indicating deletion.
   If the pointerSetId exists in pointerMasterElementMatrix, it updates related tables such as tblInfringementsList and tblInvalidityList, setting their status to 0 to indicate the deactivation of related entries and commits all the transactions.

The deletePointerElementMatrix( ) function allows for secure deletion of pointer sets with validations, and handles multi-step database transactions reliably, ensuring efficient and reversible management of the transactions.

### Breaking Pointer Sets:

A function breakingPointerElementMatrix( ) as per pseudocode in APPENDIX III e), manages the deletion of auto-created pointer sets, in a secure and reversible manner. The function can include the below steps:
1. Initialization and validation:
   Said function begins by initializing an array, pointerArrayToBreak, which will store the pointers marked for deletion.
   It validates the required parameters such as targetElementIds, srcElementId, and targetPatentId.
2. Pointer identification process:
   Said function iterates over each targetElementId and extracts details such as targetElementId, ElementHeading, and action.
   If the action is break, the function creates a new pointer object pointerObjToBreak with the necessary attributes and adds this object to the pointerArrayToBreak.
3. Database process as per the relational database schema of pointerMasterElementMatrix as shown in FIG. 37:
   The function processes each pointer in the pointerArrayToBreak to find a matching pointer set ID in the pointerMasterElementMatrix table. All the pointers that have matching attributes are added to the pointerSetIds array.
   For each pointerSetId in the PointerSetIds array, related pointers are searched for in the tables such as tblInfringementsList and tblInvalidityList, where the pointerSetId matches and the status is active.
   For each matching pointer, a payload for evidence splitting is prepared, pointer evidence is fetched, and the respective table is updated to set the status as inactive.
   pointerMasterElementMatrix is updated to set the status as inactive for IDs in pointerSetIds and commit all the transactions.

The function breakPointerElementMatrix( ) allows for managing pointer relationships in the database by providing a method that not only breaks pointers securely and efficiently but also allows all the changes to be reversed if necessary.

### Embodiments of the Master Pointer Matrix (MPM)

In various embodiments, the generation of a Master Pointer Matrix (MPM) varies by the selection of the master patent and the target patent, which influences the resultant Master Pointer Matrix (MPM) and its editable features.

### Scenario 1:

In one embodiment, a user selects the same patent for both the master patent and the target patent. This scenario facilitates the generation of a Master Pointer Matrix (MPM) where the comparative analysis is internally focused within the same patent, allowing for a specific type of self-referential review and editing.

### Scenario 2:

In another embodiment, a user selects one patent as the master patent and a different patent as the target patent. This configuration is used to generate an Master Pointer Matrix (MPM) that provides a comparative analysis between two distinct patents. The differences in the Master Pointer Matrix (MPM) rendered under this scenario allow for varied editing capabilities tailored to the distinct elements and claims of each patent involved.

### Scenario 1: User Selects Patent A as the Master Patent and Patent A as the Target Patent Also for the Generation of Master Pointer Matrix (MPM) as Shown in FIG. 36

### Functionality of Master Pointer Matrix (MPM) for Scenario 1:

The user selects a master patent and a target patent, which in this scenario are the same. The user may choose either asserted claims or all the claims and then click the Create matrix button.

A HTTP GET request is initiated by the client-side server and submitted to a server-side function getMPMData( ) to retrieve Master Pointer Matrix (MPM) data using user inputs of the master patent and the target patent. The function getMPMData( ) returns structured and formatted data to the client-side, and can include sourceList and targetList which are nested multi-dimensional arrays. This data is rendered as an interactive Graphical User Interface (GUI), on the client-side in the form of a m×n Master Pointer Matrix (MPM) by the MatrixTable( ) function.

In instances where the master patent and the target patent are the same 3600, the Master Pointer Matrix (MPM) produced is divided diagonally into two equal sections as shown in FIG. 36. As the claim elements of the master and target patents are identical, this division allows for an equal split along the diagonal 3602. The lower half of this diagonal matrix is non-editable by users as both technically and legally, only the claim elements of subsequent claims can refer to the claim elements of preceding claims. Therefore, any correlation between the claim elements of the master patent and the target patent can only be performed in the upper portion of the diagonal Master Pointer Matrix (MPM) as indicated by editable cells 3603. This design ensures an intuitive and interactive Graphical User Interface (GUI) that is easy to understand by the user. Users can perform functions such as deleting pointer sets 3604 or saving pointer sets 3605.

The function MatrixTable( ) as discussed above in detail, serves as a framework that maintains various states to store information about the data matrix, user selections, and manage the interactive Graphical User Interface (GUI) settings. Said function allows for dynamic rendering, managing user scrolling, user interactions, and data modification functionality as discussed above in detail.

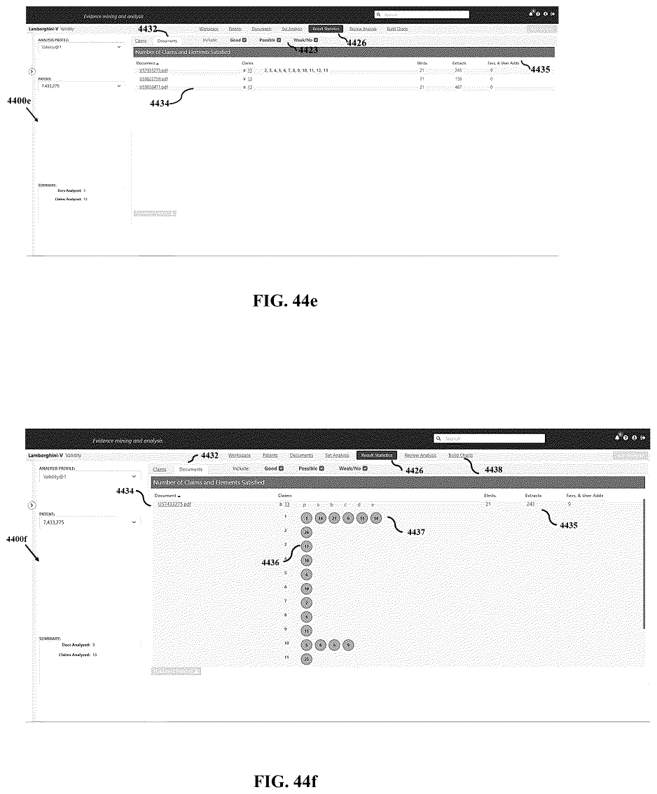

### Scenario 2: User Selects Patent a as the Source Patent and a Different Patent B as the Target Patent for the Generation of Master Pointer Matrix (MPM) as Illustrated in FIG. 38

FIG. 38 illustrates a Master Pointer Matrix (MPM) when the source patent and target patent are different, according to an embodiment of a Patent litigation and evidence management system 201 of the present disclosure. In the described embodiment where the Master Patent A and the target Patent B are distinct entities, the Matrix Pointer Matrix (MPM) is divided into four quadrants as illustrated in FIG. 38. These quadrants are designated as Top Left Quadrant 1 3801, Top Right Quadrant 2 3802, Bottom Right Quadrant 3 3803, and Bottom Left Quadrant 4 3804. Top Left Quadrant 1 3801 hereinafter referred to as Quadrant 1, Top Right Quadrant 2 3802 hereinafter referred to as Quadrant 2, Bottom Right Quadrant 3 3803 hereinafter referred to as Quadrant 3, and Bottom Left Quadrant 4 3804 hereinafter referred to as Quadrant 4.

Top Left Quadrant 1 3801: This illustrates the Master Pointer Matrix (MPM) between Master Patent A and Master Patent A. Quadrant 1 visualizes the internal claim relationships within Master Patent A and is similar in functionality to the embodiment described in Scenario 1.

Top Right Quadrant 2 3802: This illustrates the Master Pointer Matrix (MPM) interactions between Master Patent A and target Patent B. Quadrant 2 is crucial for analyzing the claim elements of Master Patent A in relation to those of target Patent B.

Bottom Right Quadrant 3 3803: This illustrates the Master Pointer Matrix (MPM) interactions within target Patent B and target patent B. Similar in functionality to Quadrant 1, Quadrant 3 provides insights into the internal claim relationships within target Patent B and is also same as the embodiment described in Scenario 1.

Bottom Left Quadrant 4 3804: This illustrates the Master Pointer Matrix (MPM) interactions from target Patent B back to Master Patent A. Notably, Quadrant 4 is non-editable and non-mappable, reflecting the one-directional nature of the claim analysis which typically does not support reverse mappings from the target patent back to the master patent in this configuration.

### Functionality of Master Pointer Matrix (MPM) for Scenario 2:

Top Left Quadrant 1 3801: Quadrant 1 displays the claim elements of Master Patent A on both the y-axis and the x-axis, effectively mapping the patent to itself. The functionality of Top Left Quadrant 1 mirrors that of the Master Pointer Matrix (MPM) in functionality, as outlined in Scenario 1. Consequently, the process for creating pointer sets within this quadrant remains consistent with the methods described in Scenario 1, facilitating the analysis and mapping of claim elements within the same patent.

Bottom Right Quadrant 3 3803: Quadrant 3 displays the claim elements of target Patent B on both the y-axis and the x-axis, effectively mapping the patent to itself. The functionality of Bottom Right Quadrant 3 mirrors that of the Master Pointer Matrix (MPM), as outlined in Scenario 1. Consequently, the process for creating pointer sets within this quadrant remains consistent with the methods described in Scenario 1, facilitating the analysis and mapping of claim elements within the same patent.

Top Right Quadrant 2 3802: Quadrant 2 displays the claim elements of Master Patent A are displayed on the y-axis, while the claim elements of target Patent B are displayed on the x-axis. This setup facilitates the display of the Master Pointer Matrix (MPM) between Master Patent A and target Patent B and allows for mapping the claim elements of Master Patent A to that of target Patent B. Given the distinct nature of the claim elements between the two patents, users are permitted to edit all the cells within this quadrant of the matrix or grid.

Bottom Left Quadrant 4 3804: Quadrant 4 displays matrix interactions from target Patent B back to Master Patent A. Notably, Quadrant 4 is non-editable and non-mappable, reflecting the one-directional nature of the claim analysis which typically does not support reverse mappings from the target patent back to the master patent in this configuration.

### Creating Pointer Sets or Editing Pointer Sets in Master Pointer Matrix (MPM):

Users can modify the Master Pointer Matrix (MPM) to create pointer sets, which enable the mirroring (copying) of evidence from the claim elements of the Master (source) patent to the target patent. Pointer sets can be created or edited throughout the entire matrix or grid using the following steps:
a) A user selects a claim element, referred to as exemplar or exemplar claim element, from Master Patent A on the y-axis of the grid. This action disables editing the remaining rows of the grid thereby restricting the creation of pointer sets to one row at a time.
b) To create one or more pointer sets for the exemplar, the user clicks on one or more cells along the x-axis. This action generates one or more pointer sets linking the exemplar to the corresponding claim elements of the target patent.
c) After the user identifies and selects the desired intersection cells and clicks the save button, a request is sent by the server to the database to save a reference.
d) Users can repeat steps a, b, and c for each claim element of the Master Patent to establish mappings (correlations) to the target patent. By selecting Select elements to link, a server request is sent to the database to store the mappings.
e) Additionally, users have the option to edit the automated mappings. This behavior, can be overridden by the end user at the target claim element, allowing for the disassociation of the mapping from the source and making it independent of the selected element.
f) This embodiment is versatile and not restricted to mapping just one claim element at a time. It can map multiple claim elements simultaneously. This flexibility enhances the utility and applicability of the Master Pointer Matrix (MPM) in various patent analysis scenarios.

### Virtualization Technique of Master Pointer Matrix

In one embodiment of the present disclosure, the Master Pointer Matrix (MPM) is rendered using a Virtualization technique, such as, but not limited to List Virtualization, wherein large datasets, such as those present in the Master Pointer Matrix (MPM), are displayed by rendering only the items currently visible within the user viewport 3606, along with a minimal buffer items 3609 to ensure smooth scrolling and optimize system performance as shown in FIG. 36B. The conventional rendering technique 3600A of the prior-art, as illustrated in FIG. 36A, loads all list items to the parent table container 3611 within the Document Object Model (DOM) 3610 at once, while displaying only a subset of all list items within the User Viewport 3606. This approach reserves a significant portion of system memory and processing power for saving remaining items outside of User Viewport 3606, thus compromising on system performance, especially when large datasets are involved.

FIG. 36B illustrates a virtualization rendering technique of a large dataset on a user display, wherein large datasets, such as those present in the Master Pointer Matrix (MPM), are displayed by rendering only the items currently visible within the User Viewport 3606, along with a minimal buffer items 3609, and calculated number of spacer DIVs, according to an embodiment of a Patent litigation and evidence management system 201 of the present disclosure. The List Virtualization technique 3600B of the present disclosure, as illustrated in FIG. 36B, overcomes the performance and usability issues associated with the conventional rendering technique of the prior-art, as illustrated in FIG. 36A. A Document Object Model (DOM) 3610 as defined in the present disclosure, serves as a front-end data storage element within the programming interface of the interactive GUI. A Parent table container 3611 is further defined as a data storage element that is placed within DOM. The User Viewport 3606 is defined as the visible area of the user's display device or the screen that enables rendering of the Master Pointer Matrix (MPM).

The implementation of List Virtualization technique 3600B, of the present disclosure, comprises the following steps:
Loading of Document Object Model: First, the dimensions of the parent table container are calculated as per the screen resolution and screen dimensions of the user's display device to determine User Viewport 3606. Thereafter, only a subset of a total list items is loaded to the parent table container at any given time, as illustrated in FIG. 36B. The specific subset of the total list items loaded to the parent table container 3611 is determined by multiple factors, including, but not limited to, the dimensions of a placeholder element 3612 for each item of the subset, the dimensions of the margin 3613 between each place holder, the dimensions of the User Viewport 3606, the number of buffer items 3609 to be loaded, and the dimensions associated with placeholder elements, such as Upper Spacer DIV (H1) 3607, and Lower Spacer DIV (H2) 3608.
Display of content upon User scrolling: As the user initiates scrolling action, a subset of list items that exit the User Viewport 3606 are unloaded from the parent table container 3611. Concurrently, a subset of list items that newly enter the User Viewport 3606 are loaded to the parent table container 3611 and dynamically rendered within the User Viewport 3606.
Scroll Index Calculation: In response to the user scrolling, the Master Pointer Matrix (MPM) Module 210 dynamically determines the first item of the subset and the last item of the subset to be displayed on the User Viewport 3606. To display the refreshed subset of list items, the Master Pointer Matrix (MPM) Module 210, calculates the respective indices of the determined first item and the last item. These calculated indices are subsequently utilized to slice the total list items, thereby obtaining an optimal subset of items to be loaded onto the parent table container 3611 and subsequently rendered on User Viewport 3606.
Scrollbar Dimensions Calculation: To ensure the scrollbar functions as if the entire list were rendered, or loaded in the parent table container 3611 of DOM 3610, the Master Pointer Matrix (MPM) Module 210 utilizes placeholder height elements, such as, Spacer DIVs. The Master Pointer Matrix (MPM) Module 210 determines and calculates the height of an Upper Spacer DIV (H1) 3607 and a Lower Spacer DIV (H2) 3608.
Height Calculation of Spacer DIVs: To ensure the scrollbar operates and provides a user experience as if the entirety of the list were rendered or loaded in the parent table container 3611 of DOM 3610, the Master Pointer Matrix (MPM) Module 210 employs placeholder height elements, specifically designated as Spacer DIVs. The Master Pointer Matrix (MPM) Module 210 determines and calculates the height of an Upper Spacer DIV (H1) 3607 and a Lower Spacer DIV (H2) 3608. These calculated heights simulate the vertical space occupied by the unrendered list items above and below the currently rendered subset of items. The height of these spacers is calculated based on the number of scrolled items, visible items, and total list items to maintain the position of the scrollbar and simulate accurate scrolling behavior. For example:
   Upper Spacer DIV Height Calculation: The height of the Upper Spacer DIV (H1) 3607 is calculated based on the total height occupied by the list items that have been scrolled out of the user viewport 3606 and are not currently rendered.

$$Formula for H 1 :$$

$$H 1 = ( Number of scrolled items * Item height ) + ( Number of scrolled items * Item margin )$$

Lower Spacer DIV (H2) Height Calculation: First, the total virtual height of the entire list of items, the height it would occupy if all items were rendered, is calculated. This total height is then used to calculate the height of the Lower Spacer DIV (H2) 3608 by subtracting the height of the Upper Spacer DIV (H1) and the total height of currently rendered items.

$$Formula for Total Virtual Height ( {H}_{Total} ) :$$

$${H}_{Total} = ( Total number of items * Item height ) + ( Total number of items * Item margin )$$

$$Formula for Rendered Height ( {H}_{Rendered} ) -$$

$${H}_{Rendered} = ( Number of rendered indices * Item height ) + ( Number of rendered indices * Item margin )$$

The foregoing detailed description of the embodiment primarily illustrates the functionality of the List Virtualization technique as applied to vertical scrolling. It should be understood that a similar virtualization methodology, encompassing item loading or unloading, index calculation, and spacer dimension simulation, is analogously applied to implement efficient horizontal scrolling within the display of the Master Pointer Matrix.

### 4. Terms Construction Module

In a patent litigation case, claim construction is an important phase which involves defining the terms in the patent claims by the court to determine the scope of the patent rights. The construction of a term has a significant influence on the determination of patent infringement and validity of patent claims. A Markman hearing is where a judge defines these terms, considering both intrinsic evidence, such as the patents specification or file history, and extrinsic evidence such as expert testimony or other related sources and documents. The preparation process involves reviewing relevant evidence and defining claim construction essential for determining the infringement and validity of a patent.

The conventional method of claim construction, a manual process, in patent litigation faces several challenges. Specifically, the process requires the plaintiff and defendant parties to submit definitions for terms, which are then referenced across various claims during claim charting. This manual process of maintaining claim terms and their associated evidence is labor-intensive. Moreover, collecting and correlating the necessary evidence for each term, whether it is intrinsic evidence or extrinsic evidence, is a time-consuming task as it involves analyzing the patent specification to extract the relevant evidence. Additionally, the preparation of claim charts involves mapping the terms that exist in the asserted claims to the evidence, which when done manually consumes significant time and is inefficient.

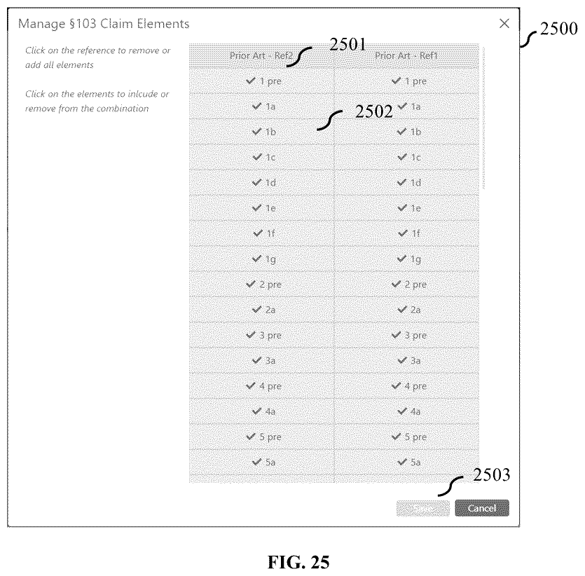

The Terms Construction Module 207 as shown in FIG. 2 also referred to as claim construction, or Term Construction Setup Module of the electronic Patent litigation and evidence management system 201 of the present disclosure, facilitates the claim or terms construction through an interactive Graphical User Interface (GUI) and improves the efficiency of the patent litigation process. The claim construction or Terms Construction Module 207 enables the creation of various types of terms—simple, group, and complex, automated loading and self-citing of evidence, wherein the evidence is hyperlinked to the relevant citations in order to contextually view the passage as it appears in the source document when clicked on the citation hyperlink, in aside-by-side layout to compare a term in the context of the claim text, plaintiff and defendant party constructions and evidence, highlighting key evidence and terms, and effective storage and retrieval methods of stored evidence, thus simplifying and automating complex tasks involved with the terms and construction in a patent litigation lifecycle. FIG. 13 illustrates a workflow process 1300 of the Terms Construction Module 207 of the present disclosure of a Patent litigation and evidence management system 201.

To view the created simple, complex, and group terms within the claim text, users click on Show term highlights menu item available in each of the modules such as infringement or validity or claim construction modules. On clicking the show term highlights button, the created terms are displayed as hyperlinks. Should there be overlapping terms, the subset of the overlapped term is displayed in bold font to differentiate the two different terms enabling users to navigate easily to the relevant term of interest to the user.

As the terms and constructions continue to be modified during a patent litigation lifecycle, the application has the flexibility to manage evidence corresponding to the terms dynamically. For example, terms or variations of the same term that share the same construction, and evidence can be setup as a group term. Any terms added to an existing group are merged along with any evidence into the new group term as per user selection. If one or more terms are removed from a group, or a group is deleted, the constructions and existing evidence for the group will remain with each term up to the point the removal occurred.

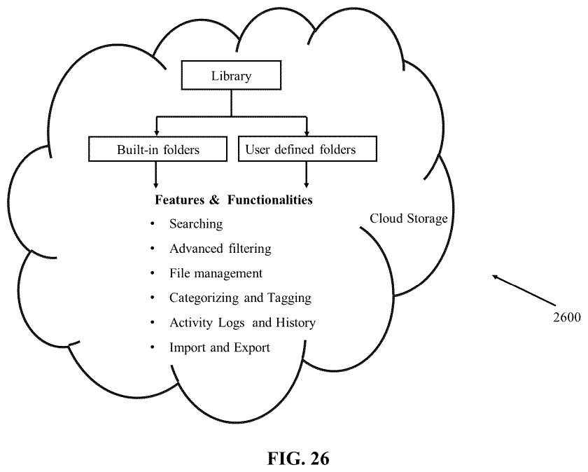

The interactive Graphical User Interface (GUT) of the term construction module is designed to be intuitive and easy to operate, for the creation and management of terms. The module accommodates terms from either party i.e., plaintiff or defendant could propose Simple terms, Complex terms, or Group terms. Terms are defined as either a single term or phrase from a claim element. Simple terms are derived from a single phrase or term of a claim element, or Complex terms constructed from two or more phrases within the same claim, or Group terms for combining two or more simple or complex terms within the same claim or across different claims that share term constructions and relevant evidence. The interactive Graphical User Interface (GUI) enables users to have a centralized management of terms. The Terms Construction Module 207 allows users to categorize terms by their relevance to the plaintiff, the defendant, or both. Further, FIG. 14 illustrates a database schema 1400 showing technical relationships between at least a portion of the database tables for the functionality related to the Term Construction Module.

a) Creation of Simple Terms by Selecting Single Phrase or Term from Claim Elements

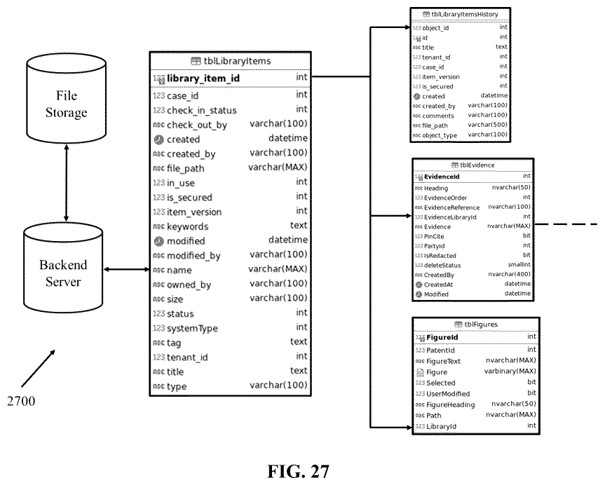

FIG. 15 illustrates an interactive Graphical User Interface (GUI) to create simple terms, a feature for Term Construction Setup Module of a Patent litigation and evidence management system 201 of the present disclosure. On the Create Term 1500 screen as shown in FIG. 15, users can select and highlight specific text 1501 from claim elements for which one or more terms are to be created and defined. Once highlighted, the text is automatically filled in a text box 1502. Users can then click on Find 1503 button. Alternatively, on right clicking the highlighted text, users can search for related terms. If the terms do not already exist, user can select the specific party proposing the term from, namely, Plaintiff, Defendant, or Both 1504 and click on the Yes 1505 button to create the term. By clicking on the Yes button, the term is created in the database along with linking it to the relevant text in the claim element which is available throughout the application, for easy access.

A client-side server function, handleCreateTerm( ) as per APPENDIX IV a), facilitates the creation of a term within the claims construction module. This function manages and organizes the terms related to patent claims in a patent litigation. The handleCreateTerm( ) is an asynchronous function that interacts with a server-side function via an API call to create a new term based on user input and send necessary associated details through a https POST request. The function handleCreateTerm( ) receives a structured set of input parameters that include a termTitle, caseId identifier, termType, subTerms, termPatentandclaim, termParties, and patentIds, and populates a payload object. The function executes an API call passing the payload object through a https POST request to submit the term data to the server, which processes and stores the term in the database schema.

A server-side function, createSimpleTerm( ) as per the pseudocode in APPENDIX IV b), manages the creation of terms in the database repository of a Patent litigation and evidence management system 201 of the present disclosure. This function adopts a transaction-based approach of extracting data from the payload object, such as termTitle, caseId, termType, subTerms, termPntAndClms, termParties, and patentIds, and performs processing and validation functions to maintain data integrity. If the term type is set to 1 and no sub-terms exist, it defaults the sub-terms to include the primary term title. It then verifies if the term already exists in the database to prevent duplication. If unique, the function proceeds to create a new term entry along with corresponding subheadings. Subsequent loops handle the creation of sub-terms, dynamically interacting with several database tables for dynamic allocation of data across the database tables such as Terms, SubTerms, and TermParties, to organize and store data efficiently. This comprehensive transactional approach includes error handling functions, and bulk operations for efficient database handling, thereby providing a reliable and efficient backend process for managing complex term data.

b) Creation of Complex Terms by Selecting Two or More Terms from within the Same Claim

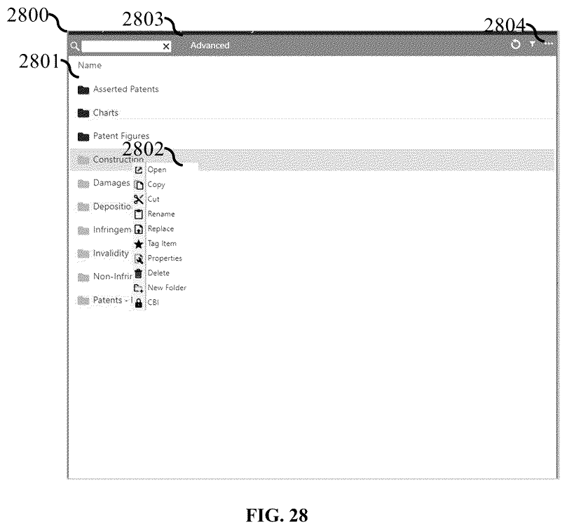

FIG. 16 illustrates an interactive Graphical User Interface (GUI) to create complex terms, a feature for Tenn Construction Setup Module of a Patent litigation and evidence management system 201 of the present disclosure. On the Create Term 1600 screen as shown in FIG. 16, users can select and highlight specific text 1601 from claim elements for which one or more terms are to be created and defined. Once highlighted, the text is automatically filled in a text box 1602. Users can add more text boxes 1603 to further add terms to create Complex term. Users can select the specific party proposing the term, namely, Plaintiff, Defendant, or Both 1604, and click on Save 1605 button to create a complex term. By clicking on the Save button, the term is created in the database along with linking it to the relevant text in the claim element which is available throughout the application for easy access.

A server-side function createComplexTerm( ) as per the pseudocode in APPENDIX IV c) manages the creation and duplication checks of complex terms within a patent database. It initiates extracting and trimming information provided from the request, such as termTitle, caseId, termType, subTerms, termPntAndClms, termParties, and patentIds. If the term already exists based on the trimmed title, it immediately returns a duplication message to avoid data redundancy. If the term is not present, the function calculates a new sequence order for the term and creates a new parent term entry in the database. Subsequently, the function iterates over arrays containing sub-terms, claim terms, and party associations, updating and linking each to the new parent term. Additional logic is included to optionally duplicate and link associated evidence if required. Finally, a success message is returned upon successful creation, indicating effective handling and storage of complex term data, ensuring organized and non-duplicated term management.

c) Creation of Group Terms by Selecting Two or More Terms from Multiple Claims

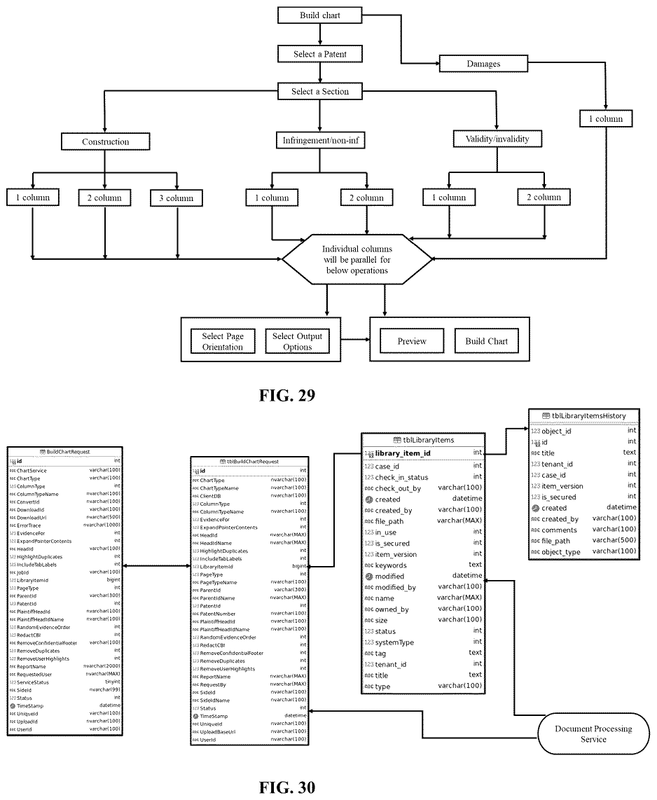

FIG. 17 illustrates an interactive Graphical User Interface (GUI) to create group terms, a feature for Term Construction Setup Module of a Patent litigation and evidence management system 201 of the present disclosure. In the Create Term Group 1700 screen, as shown in FIG. 17, users are required to provide a name for the group term in the text box 1701. Users can then add specific terms to this group by selecting the corresponding check boxes 1702 of previously created simple terms. Once the selections are made, users can finalize the process by clicking on the Save 1703 button.

A client-side function handleCreateGroupTerm( ) as per the pseudocode in APPENDIX IV d), is responsible for the creation and management of group terms within a Patent litigation and evidence management system 201 of the present disclosure. This asynchronous function constructs a payload containing essential details such as the term title, case ID, term type, and an array of subTerms, besides identifiers for associated patents. Upon initiating the function, it sets a loading state, then makes a https POST API call, passing the appropriate payload to create a new group term. Post-call actions include updating the state to reflect the changes in the selected term and refreshing the term list based on the patent IDs involved. In the case of an error during the API call, the function dispatches an error notification to the interactive Graphical User Interface (GUI). This handle ensures seamless interaction with the backend and maintains user experience by managing the modal state and loading state.

A server-side function, createGroupTerm( ) as per the pseudocode in APPENDIX IV e), handles the backend logic for creating and managing group terms in a patent-related database system. The process starts with extracting the data from the request and trimming any unnecessary whitespace from the term title. It then checks if the term already exists to prevent duplication. If unique, it determines the order of the new term based on the most recent entry, creates a new term record with related attributes, and updates the arrays for managing the sub-terms. The function iteratively updates the sub-terms, claim terms, parties, and other related elements using their respective functions, associating them with the new parent term ID. This includes marking the terms as included in relevant arrays, and updating database records to reflect the new associations. Successful creation results in returning a positive status message, signifying the server's ability to manage the complex term structures efficiently.

### 5. Infringement Setup Module

One of the steps involved in a patent litigation lifecycle is to conduct an infringement analysis which involves the analysis of patent claims and comparing these patent claims with the product or process accused of infringement. A plaintiff or defendant party begins by reviewing the patent claims. Next, they gather evidence such as specifications, manuals, or brochures related to the accused product or process for a thorough technical analysis. Then, a party creates claim charts that link the claim elements of the patent claims with the features of the accused product or process. These claim charts demonstrate how each claim element is either present or missing in the accused item, as argued by the respective parties.

Typically, these claim charts are produced using word processing software in a multiple column format. One of the columns lists the elements of the patent claims, while the other column shows related citations from the evidence. Citations interchangeably referred to as References are page numbers, line numbers, figure numbers, paragraph numbers, or other specific location details to identify the relevant text from the evidence that matches with a specific claim element.

During a patent litigation case, multiple team members from either the plaintiff or defendant party work on different aspects of the case and manually add or update evidence and citations to the asserted claim elements. This manual process is challenging because it requires a lot of coordination and communication among the team members, which can lead to inadvertent mistakes, inconsistencies, and difficulties in updating when there are changes required to the evidence or citations.

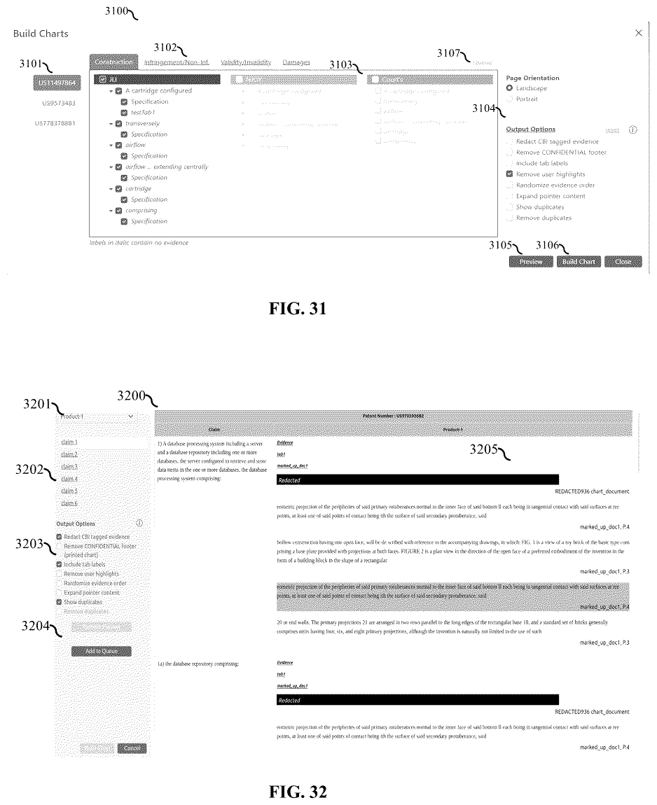

The Infringement Setup Module 208 as shown in FIG. 2 of a Patent litigation and evidence management system of the present disclosure is designed to streamline the patent infringement analysis by providing an interactive Graphical User Interface (GUI) and efficient manner of saving correlations between the claim elements and citations of the evidence. FIG. 18 illustrates the workflow process 1800 of an infringement analysis in a Patent litigation and evidence management system of the present disclosure.

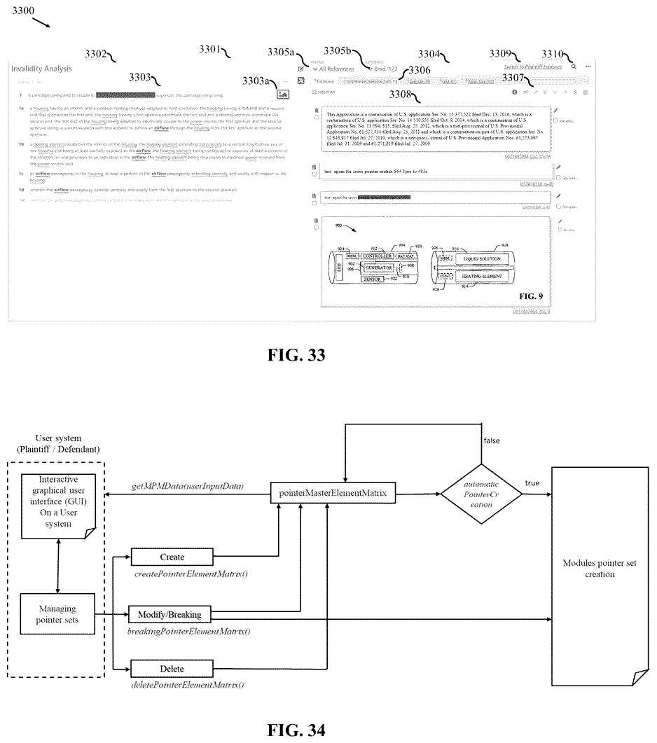

The interactive Graphical User Interface (GUI) offers a side-by-side visualization of claim elements and citations of the evidence for easy understanding of the correlations allowing the team members to instantly access and view evidence related to the specific claim elements, ensuring that all the team members are well-informed and can work efficiently. The Infringement Setup Module facilitates the organization of accused product references, evidence tabs, and source documents, allowing users on the analysis page to easily navigate and identify similarities or differences between the patent claims and the evidence. FIG. 19 illustrates the database schema 1900 for the Infringement Setup Module in a Patent litigation and evidence management system of the present disclosure.

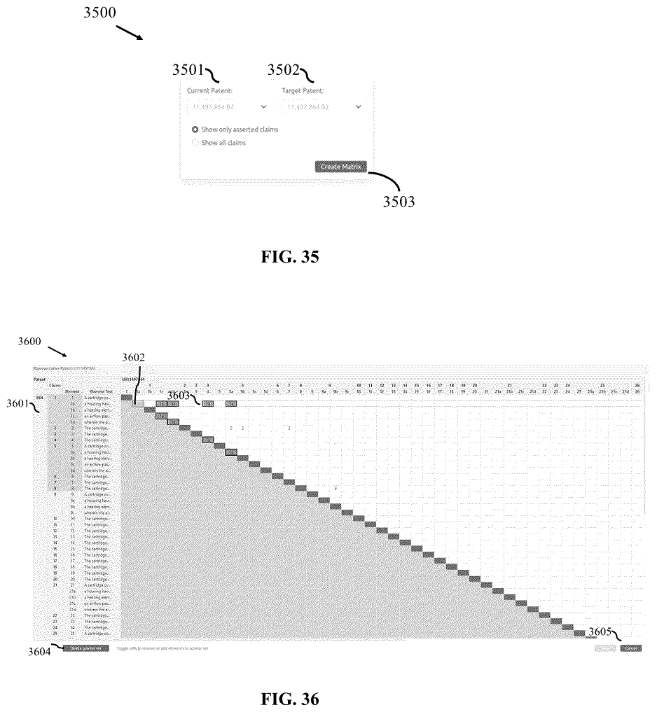

The interactive Graphical User Interface (GUI) 2000 of the Infringement Setup Module 208, as detailed in FIG. 20 of a Patent litigation and evidence management system 201 of the present disclosure, is an interactive Graphical User Interface (GUI) that significantly enhances the management of accused products and analysis in patent infringement cases. The interactive Graphical User Interface (GUI) 2000 enables users to manage and analyze a comprehensive, master list of accused products 2002 of one or more defendants 2001. Users can select subsets of these products 2003 for detailed analysis during the litigation process. Users can create or manage one or more tabs 2004, such as, a plaintiff tab or a defendant tab using the interactive Graphical User Interface (GUI) to organize the evidence by the plaintiff or the defendant party, systematically. Moreover, the users can import and process the opposing party claim charts 2005 automatically for easy access and comparative analysis, thereby saving time and reducing manual errors. The interactive Graphical User Interface (GUI) facilitates the correlation 2006 of the evidence with the patent claim elements of the specific asserted patents. The centralized document management system 2007 manages the references, evidence, and citations, making it simpler to access and organize important documents throughout the litigation process. The interactive Graphical User Interface (GUI) enables users to sort the list of accused products, hide or remove an accused product from the analysis menu. Hiding an accused product removes the reference and any associated evidence from the global analysis menu but preserves it for future analysis or reference. Deleting an accused product from the analysis menu removes the reference and any associated evidence from the view. However, a delete is not treated as a hard delete and can be retrieved using a roll back operation.

Overall, this module is a powerful tool designed to enhance the efficiency and effectiveness of handling patent infringement cases by providing detailed and organized management of accused products and related evidence.

The Infringement Setup Module 208 enables users to fetch, create, and manage accused products for infringement analysis. A client-side function, fetchAccusedProductList( ) as per the pseudocode in APPENDIX V a), retrieves a list of accused products based on specified input parameters through an asynchronous GET request. For this, a server-side function productList( ) as per the pseudocode in APPENDIX V c), fetches a comprehensive list of accused products based on the database queries, while performing the required validity checks.

Another client-side function, createAccusedProductList( ) as per the pseudocode in APPENDIX V b), creates and updates a list of accused products through an asynchronous POST request, using specific input parameters such as the accused product name and party ID. For this, a server-side function, createAccusedProduct( ) as per the pseudocode in APPENDIX V d), performs required validity and duplication checks before creating a new accused product.

Overall, the Infringement Setup Module 208 streamlines the process of managing the accused products of a patent litigation by offering features that reduce manual effort, minimize errors, and facilitate effective coordination amongst litigation team members.

In another embodiment of the Infringement Setup Module 208 of the present disclosure, the defendant in a patent litigation case can use the Infringement Setup Module to demonstrate non-infringement. In such a situation, the defendant demonstrates that the accused product or process does not infringe upon the patent claims, either literally or under the doctrine of equivalents by creating claim charts that explain the differences between the features of the defendant's product and the patent claims.

### 6. Invalidity Setup Module

In a patent litigation case, a defendant is an individual or entity alleged to have infringed upon the patent rights held by a plaintiff. Upon facing infringement allegations, a defendant conducts a detailed analysis of the patent claims to identify grounds for challenging the case. The defensive strategies include creating non-infringement positions and creating invalidity contentions as described below in detail.

Creating plaintiff contentions: The defendant demonstrates that the accused product or process does not infringe upon the patent claims, either literally or under the doctrine of equivalents by creating claim charts that explain differences between the features of the defendant's product and the patent claims.

Creating defendant contentions: The defendant challenges the validity of the patent through prior-art searches, evidence gathering, and detailed analyses to demonstrate that the patent claims do not satisfy the statutory requirements for patentability as presented below, while the plaintiff challenges the invalidity of the patent.

The various embodiments of the present disclosure related to invalidity contentions can be better understood with reference to, but not limited to, the US laws and procedure disclosed herein. The defenses according to an embodiment of the present disclosure related to the US procedures include the following:
Either party, i.e. plaintiff or defendant provides their arguments related to the subject matter eligibility criteria outlined in 35 U.S.C. § 101.
Either party, i.e. plaintiff or defendant provides their arguments related to 35 U.S.C. § 102.
Either party, i.e. plaintiff or defendant provides their arguments related to 35 U.S.C. § 103.
Either party, i.e. plaintiff or defendant provides their arguments related to the enablement requirement under 35 U.S.C. § 112.
Either party, i.e. plaintiff or defendant provides their arguments related to inequitable conduct during the patenting process.

These contentions form the basis for either party's argument to demonstrate that the patent is valid or invalid.

Preparing invalidity contentions requires collaboration among a team of technical experts, who possess deep knowledge of the technical aspects of the patents, and legal professionals well-versed in patent law. This manual process demands significant coordination and communication. Additionally, creating claim charts using a word processing software proves to be a cumbersome and labor-intensive method.

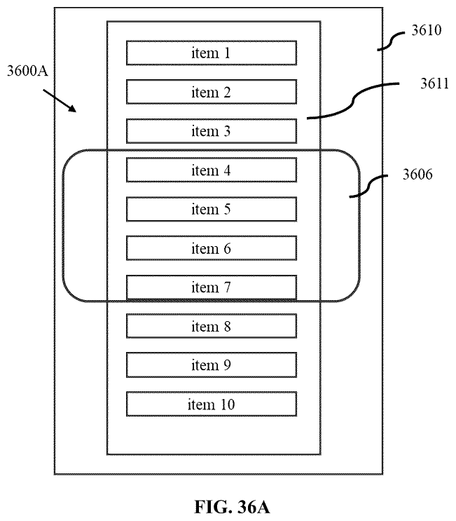

FIG. 21 illustrates a workflow process 2100 of the invalidity analysis module 209 of a Patent litigation and evidence management system 201 of the present disclosure.

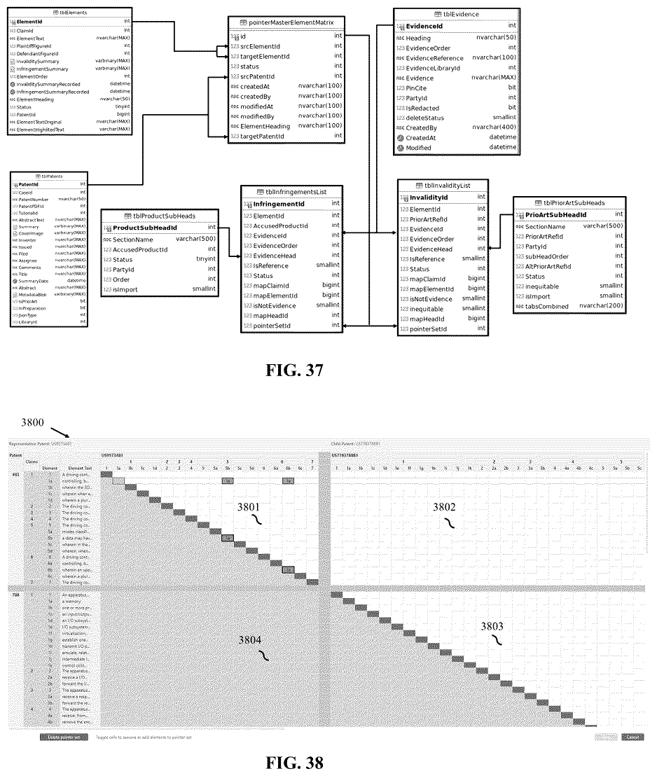

The interactive Graphical User Interface (GUI) 2300 for invalidity setup module 209, as detailed in FIG. 23 of a Patent litigation and evidence management system 201 of the present disclosure, features an advanced interactive Graphical User Interface (GUI) 2300 and a robust server architecture, designed to streamline the complex tasks associated with managing legal defenses concerning patent invalidity. The interactive Graphical User Interface (GUI) 2300 provides the users with an intuitive and user-friendly platform for system interaction, making the analysis and management tasks more efficient. The users can create, manage, and interlink prior-art references 2302 to specific defenses 2301, such as subject matter eligibility, anticipation, obviousness, best mode enablement, and inequitable conduct, as cited under the patent laws. The Prior Art Processing feature 2303 processes the prior-art references, allowing annotations and citations down to the column and line numbers for issued patents. All the other references are cited by the paragraph or page number. The users can assign prior-art references to their respective defenses 2304 or specifically to sections 35 U.S.C. § 102 or 35 U.S.C. § 103 by selecting the appropriate checkboxes 2305. The interactive Graphical User Interface (GUI) also offers organizational features to create tabs or sections 2306. Furthermore, the interface facilitates uploading, editing, storing, and linking documents to conduct comprehensive and organized analyses, essential for preparing the invalidity contentions during patent litigation.

The interactive Graphical User Interface (GUI) 2300 for the invalidity setup module of a Patent litigation and evidence management system 201 of the present disclosure can include an advanced interactive Graphical User Interface (GUI) 2300 and server architecture that facilitates efficient creation, management, and interlinking of the Prior Art Reference 2302 to specific defenses 2301, thereby streamlining the invalidity analysis process of the asserted patent claims 2307. The system further can include a feature 2308 that allows users to edit and attach prior-art references directly within the interface, facilitating a more comprehensive and dynamic approach to patent claim analysis and litigation management.

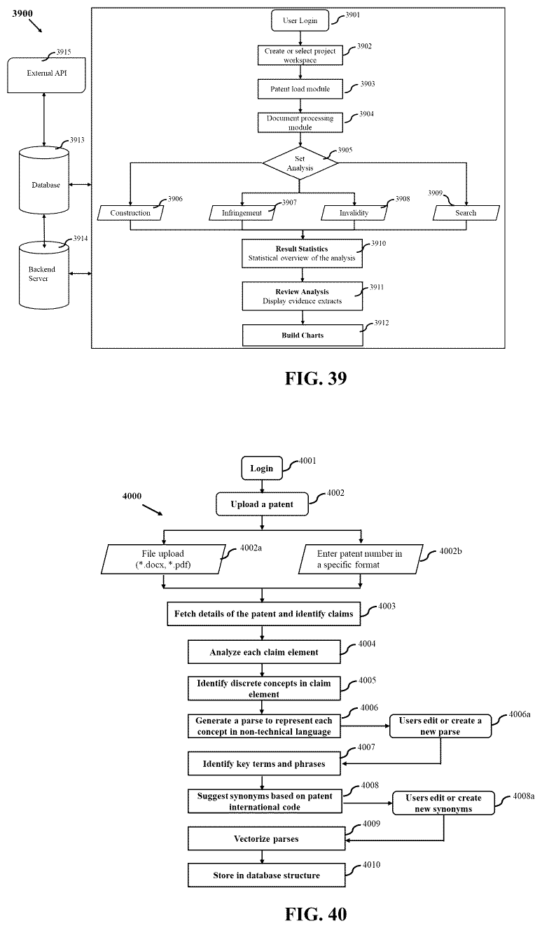

FIG. 24 illustrates an interactive Graphical User Interface (GUI) for setting up obviousness defenses, which is one of the defenses as part of the validity setup module of a Patent litigation and evidence management system 201 of the present disclosure. The Obviousness Analysis Module 2400 as shown in FIG. 24 is integrated to improve and refine the management of evidence based on the combined elements of the reference claims for obviousness analysis. This function is crucial in structuring evidence and formulating legal arguments, ensuring detailed and precise analysis. Within the defenses 2401, users can designate a primary reference 2402 for 35 U.S.C. § 103 defenses, select at least one or more supplemental Prior Art references 2402, and utilize OEMM analysis 2403 (combine two or more references) for comprehensive evaluation. The module also supports a plaintiff evidence tab 2404a and a defendant evidence tab 2404b to facilitate a more cohesive analysis. Additionally, the module further can include features for accessing the elements of the asserted patent claims 2405 and a cited reference document list 2406 for replacing any cited documents easily and quickly.

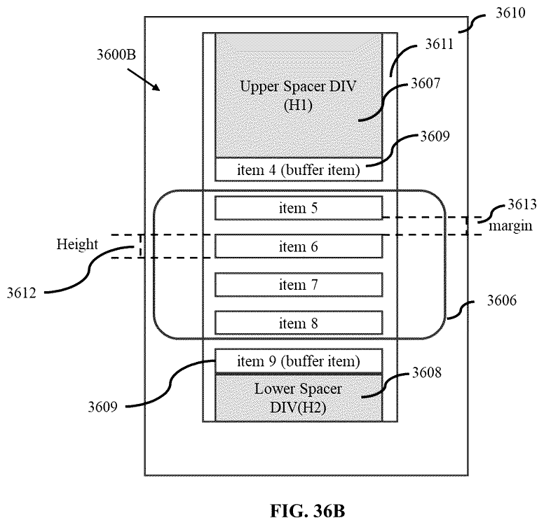

According to various aspects of the present disclosure, the database schema 2200 showing the technical relationships between at least a portion of the database tables for the functionality related to the invalidity setup module is represented in FIG. 22.

### a) Creating Prior Art Reference Under all References

The interactive Graphical User Interface (GUI) 2300 of the invalidity module of a Patent litigation and evidence management system 201 of the present disclosure facilitates the creation and maintenance of prior-art references within a digital environment. The interactive Graphical User Interface (GUI) allows the creation of prior-art references via an asynchronous client-side function handleCreatePriorArt( ) as per the pseudocode in APPENDIX VI a), that initializes by creating structured data for prior-art, including details of a specific patent and a common reference indicator. It then sends this data to the server via a POST request and updates the client-side display using a dispatch function.

A server-side function createPriorArt( ) as per the pseudocode in APPENDIX VI a), validates the request data, to prevent duplicate entries, and facilitates the database processes. Depending on whether the prior-art is marked as a common reference and the other input parameters such as the name, conditionID, and patent ID, the function createPriorArt( ) creates a new prior-art entry, and links the prior-art to specific patents, or generates subheads under the prior-art.

The structured process ensures that only unique data is entered into the system, enhancing the integrity of the database and preventing redundant information. The system supports complex associations between different prior-arts and patents, facilitating an efficient method for maintaining an accurate and accessible patent documentation.

### b) Prior Art Reference Document Processing

The interactive Graphical User Interface (GUI) 2300 of the Invalidity Module 209 of a Patent litigation and evidence management system 201 of the present disclosure facilitates uploading, processing, and storing of prior-art references in a digital environment. The interactive Graphical User Interface (GUI) facilitates uploading of one or more prior-art documents. A client-side function handle UploadPriorArtDoc( ) as per the pseudocode in APPENDIX VI b), is an asynchronous function that takes a list of file objects as input and creates FormData object for each file, appends the file, and sends it to the server for upload using the POST request. Once the server-side file uploads are complete, an array is returned, containing the responses for each file, which include the server response data and the file name.

A server side, function uploadPriorArtFile( ) as per the pseudocode in APPENDIX VI b), checks if the file already exists in a specified storage path. If not, it verifies the existence of a dedicated folder. If the folder does not exist, it creates a folder and a corresponding library entry. Then, the function copies the uploaded file to the specified path in the directory and creates a library item for the file including properties such as the name, size, and type. If the operations succeed, it returns a Success message.

Overall, the functionality manages the uploading and storage of the prior-art documents by checking for duplication, organizing the files in specific folders, and updating the library entries accordingly, all while ensuring that the file data is processed securely and efficiently. Moreover, it is linked to the evidence management module for automatically linking to the citations and evidence extraction.

c) Creating Combination of Prior Art Reference Under 35 U.S.C. § 103 Obviousness by Selecting from all References Interactive Graphical User Interface (GUI)

The functionality provides a framework for assessing § 103 Obviousness by allowing users to combine various prior-art references. A client-side function, createPriorArtCombination( ) as per the pseudocode in APPENDIX VI c), constructs a request with the input parameters of the patent and prior-art such as the patent IDs, condition IDs, and operations that specify the actions to be performed on grouped prior-art documents which are passed on to a server-side function through an asynchronous API call. A corresponding server-side function createPriorArtCombination( ) as per the pseudocode in APPENDIX VI c), processes this request by performing a series of validations, creating new prior-art references, managing combinations of prior-art references, and operations based on the user's input. This involves complex transaction management that ensures data integrity and complex database transaction management.

d) Obviousness Evidence Management Matrix (OEMM): Managing Evidence According to Claim Elements in the 35 U.S.C. § 103 Combination—with Options to Hide or Show the Evidence

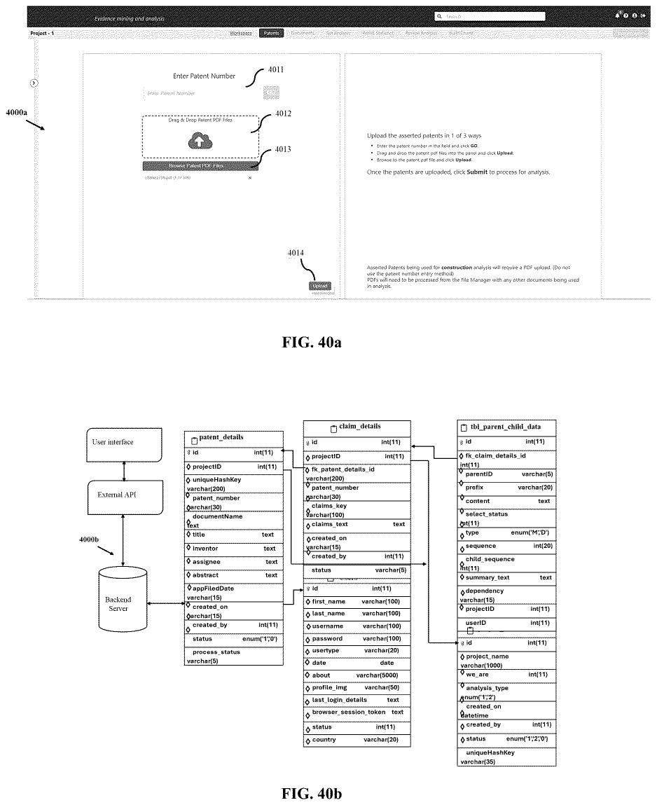

According to various aspects of the present disclosure, an interactive Graphical User Interface (GUI), known as the Obviousness Evidence Management Matrix (OEMM) 2500 as illustrated in FIG. 25 enables users to manage evidence related to patent claim elements. The OEMM 2500 dynamically refreshes the interface with the data from the database to display, modify, or update information linked with the specific prior-art references as part of an obviousness analysis, for example under 35 U.S.C. § 103 of US patent law.

The OEMM 2500 displays the prior-art selected for obviousness in each of the Prior Art Reference column 2501 of the matrix. During analysis, the users can use the toggle connection between the Prior Art Reference 2502 to select or deselect the asserted claim elements and click on the save 2503 button.

This functionality is achieved through several integrated client-side and server-side functions. A server-side function, handleGetMatrix( ) as per the pseudocode in APPENDIX VI d), retrieves relevant matrix data based on a reference identifier. On the client-side, handleLocalFetchMatrixData( ) as per the pseudocode in APPENDIX VI d) manages the retrieval and display of this data. Additional server-side functions, getMatrix( ) and updateMatrix( ), as per the pseudocode in APPENDIX VI d), process requests for matrix data based on user actions and specific reference identifiers, and manage user-initiated updates to the matrix, such as changes in the status of evidence associated with the patent claims. Collectively, these functions contribute to an interactive, adaptable system designed to synchronize evidence handling, thereby increasing the efficiency and accuracy of prior-art management.

### e) Managing Defenses

The interactive Graphical User Interface (GUI) 2300 of the Invalidity Module 209 of a Patent litigation and evidence management system 201 of the present disclosure efficiently manages the prior-art documents to facilitate analyses related to the patent eligibility (35 U.S.C. § 101), anticipation (35 U.S.C. § 102), obviousness (35 U.S.C. § 103), best mode enablement (35 U.S.C. § 112), and inequitable conduct. The interactive Graphical User Interface (GUI) allows users to assess, edit, organize, and manage the prior-art documents effectively thereby improving the effectiveness of the analyses process.

### 7. An Evidence Analysis and Management Module

Evidence management in patent litigation presents significant challenges due to the need to gather and analyze a vast volume of complex technical documents, such as patents, journal articles, technical specifications, manuals, brochures, videos, images, and other related content, referred to as evidence. Evidence management involves organizing these files, securely preserving confidential data, and making them accessible to permitted users for review and extraction of relevant excerpts including citations. Various types of charts are prepared by mapping elements of a specific section to relevant excerpts from evidence to present the comparison and relevant technical information in a clear visual format, ensuring that it can be easily understood by a person of ordinary skill in the art.

Creating charts, such as claim charts, typically with a word processing software, presents several challenges due to the extensive number of documents that are typically required to be analyzed and interpreted. Steps such as accurately interpreting the technical subject matter to identify the relevant evidence and manually aligning each claim element with the corresponding evidence is time-consuming and prone to errors. Moreover, the dynamic nature of the patent litigation requires ongoing review and revisions to the claim charts up to the last possible point before a deadline. Working in a decentralized environment can complicate the process further, leading to inconsistencies and requiring increased coordination among team members. Selecting the appropriate methods and tools can significantly have an impact on the efficiency and accuracy of claim chart preparation.

An Evidence Analysis and Management Module 206 as shown in FIG. 2 of a Patent litigation and evidence management system 201 of the present disclosure offers comprehensive functionality for managing evidence in patent litigation cases. Integrated with supporting modules 212 such as Build Charts Module 213, Library Module 214, and Import Charts Module 215, along with robust security functions, it provides seamless functionality for handling evidence relevant to asserted patents and asserted claims. Key features include an advanced interactive Graphical User Interface (GUI) that simplifies user navigations and interaction. It offers a user-friendly solution to the challenges as described above and provides a platform for remote collaboration and coordination within a team of multiple team members.

Key features of an Evidence Analysis and Management Module 206 include side-by-side layouts to map or view relevant evidence by reference, against corresponding claim elements of asserted patents, and intuitive highlighting options make it easier for users to identify and annotate relevant excerpts. The module allows easy navigation between different sections, thereby improving user interaction and operational efficiency.

Further, the module streamlines evidence management according to various embodiments such as validity or invalidity, infringement or non-infringement, term construction, and damages. It ensures data integrity and security when appending evidence citations from the Library Module 214 and includes functionalities such as linking, assigning, copying, moving, organizing, and exporting evidence into templated chart formats. This versatility enables the users to seamlessly create and update the respective type of charts as selected by the user.

Additionally, the module supports evidence management across the sections for various business aspects with features for editing, updating citations, deleting, and adding evidence. Such a semi-automated method for processing patent specifications and efficient management of sections corresponding to different parties adds to its adaptability and user-friendliness.

### a) Side-by-Side Layout to View Evidence by Asserted Claim Element

An Evidence Analysis and Management Module 206 of a Patent litigation and evidence management system 201 of the present disclosure features a side-by-side layout that effectively combines the advanced interactive Graphical User Interface (GUI) and server-side capabilities to enhance the management and analysis of relevant evidence with the corresponding claim elements of the asserted patents. An Evidence Analysis and Management Module 206 is used by users as described below in a patent litigation case. In one embodiment of the present disclosure, users from the plaintiff party use an Evidence Analysis and Management Module 206 for infringement analysis wherein the evidence for each accused product and the claim elements of an asserted patent is organized in a side-by-side layout. In another embodiment, users from one or more defendant parties use an Evidence Analysis and Management Module 206 for invalidity analysis wherein the evidence from a prior-art reference and the claim elements of an asserted patent is organized in a side-by-side layout. In various other embodiments, an Evidence Analysis and Management Module 206 is used for non-infringement analysis by the users from one or more defendant parties, for validity analysis by the users from the plaintiff party, term construction used by the users from either the plaintiff or defendant parties, or for the analysis of damages.

Further, the various features of an Evidence Analysis and Management Module 206 disclosed herein can be used alone, or in varying combinations with each other, and are not intended to be limited to the specific combination described herein. Thus, the scope of the disclosure is not to be limited by the illustrated embodiments.

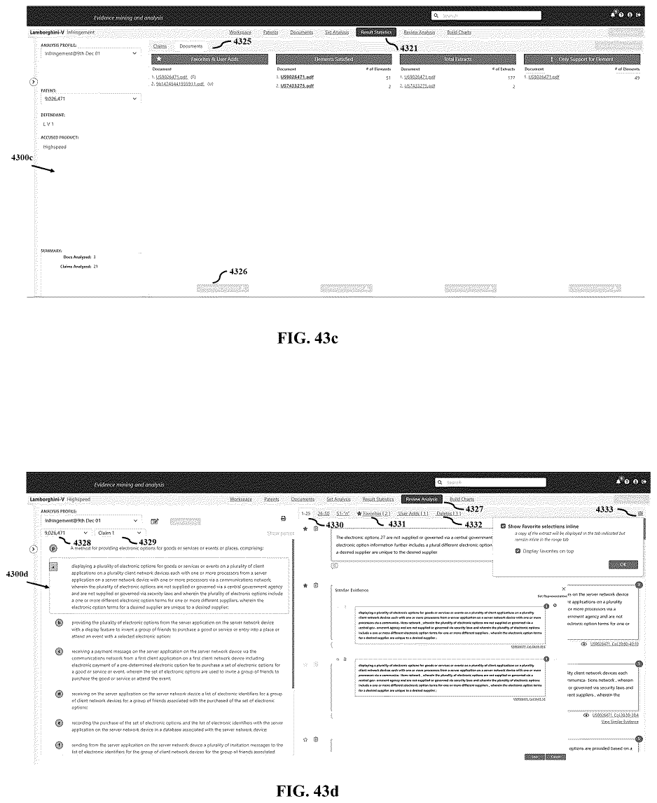

FIG. 33 illustrates an interactive Graphical User Interface (GUI) 3300 of an Evidence Analysis and Management Module 206 of a Patent litigation and evidence management system 201 of the present disclosure. The interactive Graphical User Interface (GUI) includes a side-by-side layout 3301 designed to enhance user interaction and improve the management and analysis of the claim elements of an asserted patent with the corresponding evidence. The left panel 3302 of the side-by-side layout, also referred to as asserted claims panel, displays claims or claim elements, allowing the users to navigate or select specific claims for detailed analysis. The right panel 3304 of the side-by-side layout, also referred to as evidence management panel, enables the users to add or display relevant evidence corresponding to the selected claims of an asserted patent, facilitating the users to navigate and perform various functions to manage and analyze the evidence. The evidence management panel includes various other features to perform user-defined evidence management functions.

For detailed analysis, users can select or navigate one of the sub-elements of the claims 3303 on the asserted claims panel, that enables and displays relevant evidence corresponding to the selected claims on the evidence management panel including enablement of the representative figure icon 3303a which is an identifier of the availability of a figure corresponding to the selected claim element.

Depending on the module, the users select Terms, Accused Products or Defenses 3305a from a dropdown box, populated with choices specifically based on any of the embodiments as described above. For Defenses, within the Invalidity/Validity module 209, the dropdown box allows users to select corresponding references from another dropdown box, References 3305b. Both Defense 3305a and Reference 3305b dropdown boxes are populated based on the requirements of the specific embodiment to support the analyses related to validity or invalidity. The single navigation dropdown within the infringement/non-infringement, terms construction, or damages would, depending on the module, list the terms or accused products being construed for the active patent, or the organizational components to the damages case. These user options facilitate categorizing, sorting and accessing evidence in accordance with the various embodiments of the present disclosure.

Furthermore, tabs 3306 enable users to create customized tabs to group or organize evidence logically for easy retrieval and analysis. A dedicated panel 3307 for managing evidence includes functions to add new evidence, assign evidence to the specific claims, copy or move the evidence for use in other contexts, sort the evidence based on the various user-defined criteria, or delete the evidence. The evidence view area 3308 displays all the evidence including the citations and representative figures. corresponding to the selected claims on the asserted claims panel 3302.

A toggle 3309 enables switching between plaintiff and defendant, while persisting claim element and reference selections, allowing the users to review evidence and adjust the interface functionalities to customize the displayed data and actions for either the plaintiff or the defendant parties. The users can utilize the search feature 3310 to locate or find the evidence and/or update the attorney arguments. This feature enables the users to search across the relevant evidence, with advanced filtering options that allow for refining the search results based on specific input parameters.

The interactive Graphical User Interface (GUI) 3300 of an Evidence Analysis and Management Module 206 is a well-designed side-by-side layout that separates the claim elements of the asserted patents and the corresponding evidence into distinct panels. This allows the users to perform specialized functions relevant to each panel, thus enhancing user interaction and improving the efficiency and effectiveness of evidence analysis and management for respective parties, such as the plaintiff or defendant, in a patent litigation case.

A client-side function as per pseudocode fetchClaimsElements( ) in APPENDIX VII a), asynchronously retrieves the claim-related details such as the claim elements of a specific asserted patent from a database server via an API, using a unique identifier, claimId. This API is supported by frameworks such as KOA and the like. This function is designed to display asserted claims and their corresponding evidence, such as citations, figures, and other related details. Said function also updates the state of the interactive Graphical User Interface (GUI) and stores data through the dispatched actions. The variable type specifies the type of update action, and the variable data includes the data to be stored or processed for the state management of the application. This ensures a non-blocking user experience, allowing for seamless user interaction, even during data retrieval.

A server-side function as per pseudocode fetchClaimsElements( ) in APPENDIX VII a), fetches and processes the claim-related details from the database while handling complex dependencies. Said function fetches the data from multiple tables such as tblClaims, tblClaimTerms and tblTerms to gather the claim-related data such as claim elements and linked terms thus achieving a comprehensive and accurate data retrieval.

### Infringement or Non-Infringement Analysis

In one embodiment of the present disclosure aimed at enhancing evidence management for infringement or non-infringement analysis, the evidence analysis and management module integrates a set of client-side and server-side functions. The client-side function extracts specific details from input query parameters such as the productID and partyID and retrieves the accused product and product subheadings from tblProductSubHeads database table, incorporating optimized checks to improve the query performance and to ensure data integrity. The server-side function handles complex, evidence-related parameters from the user queries. It performs validation of the input parameters, includes role-based access controls, provides real-time updates of evidence lists, and implements methods to distinguish between non-evidence and valid evidence. These features ensure data integrity and enhance the efficiency of the various functions of the module.

### Validity or Invalidity Analysis

According to an embodiment of the present disclosure designed for managing validity or invalidity evidence, the evidence analysis and management module integrates advanced functions for data fetching and processing tailored to user-specific needs, by utilizing one or more client-side and server-side functions that involve multiple database transactions. The client-side function extracts the user information and applies specific conditions to fetch the data related to the prior-art references from the tblConditions database table. This function implements enhanced data retrieval and error-handling mechanisms. On the server side, one function based on the user inputs, such as patentID and conditionIDs, fetches relevant data from the patentPriorArts database table. It includes the functionality to optimize the relevance of the fetched data, which is crucial for validating the evidence. Another server-side operation retrieves critical query parameters, such as priorArtRefId and partyId, and conducts searches in the tblPriorArtSubHeads table based on the predefined conditions. This approach ensures compliance with the pre-defined conditions and incorporates comprehensive error handling to log and correct any discrepancies during the retrieval process.

### Terms Construction Analysis

According to an embodiment of the present disclosure centered on managing terms and constructions evidence, an Evidence Analysis and Management Module integrates advanced functions to streamline the retrieval and organization of claim terms, term evidence, and term subheads in the database. A client-side function retrieves the data from the tblTerms database table, organizes the data by patents and claim terms such as complex terms, group terms, or others, and returns the processed data to the user. A server-side function extracts and manages the claim term evidence data from the tblTermEvidence database table, using the claim term IDs and other parameters such as the evidence head and patent ID while using access controls to retrieve confidential data. The function returns this data as a structured array of processed results while managing the errors. Another server-side function retrieves and organizes subheadings related to the terms from the tblTermSubHeading database table using the valid term IDs and patent IDs to ensure relevant subhead details are fetched. These functions collectively improve the efficiency of evidence management by effectively fetching, filtering, and presenting the data based on specific user queries.

### Damages Analysis

The functionality of a damages evidence management in an Evidence Analysis and Management Module, according to an embodiment of the present disclosure, is outlined that describes the advanced function to streamline the retrieval of the data related to the damages case. A server-side server function retrieves the sections of the damages from the tblDamagesSection table based on the case ID and party ID provided in the query. This function organizes the sections and fetches related headings from the tblDamagesHeading database table, including any error management. Another server-side function retrieves specific damage evidence while performing access control checks to access secure and confidential data, and other error handling mechanisms.

### a) Claim Elements and Evidence Highlighting

An Evidence Analysis and Management Module includes advanced features for highlighting and managing text within claim elements of the left side, the piece of evidence from right side, thereby enhancing user experience through a series of client-side and server-side functions for dynamic text management. A client-side asynchronous function updates the highlighted text for specific claim elements. Upon updating, it performs an API call to update the tblElements and tblEvidence database tables and refreshes the displayed claims. Similarly, other client-side functions enable users to toggle the visibility of highlighted text or hyperlinks in the claim elements and customize the view preferences of the users. The server-side function processes user interactions and updates the tblElements or tblEvidence database tables with the requests for the respective highlighted text while performing error handling for data integrity.

### b) A Simple Method to Change the Views as Per the Patent Litigating Party and Navigate Across Asserted Claims, Modules, Terms, Accused Products, Prior-Art References, and Evidence Tabs

An Evidence Analysis and Management Module features a user-friendly interface with simple navigation, allowing quick access to essential tabs such as terms, prior-art, accused products, sections, claims, and switching the views based on the party i.e. plaintiff or defendant. This streamlined navigation aids in effectively organizing and presenting evidence, enhancing productivity and effectiveness of a patent litigation process.

### c) Search, Find and Replace Evidence Content

The Search and Find 3310 feature of an Evidence Analysis and Management Module 206 enhances the ability to search and replace an evidence or attorney argument within the specific modules, or across the application. The Find and Replace Text functionality allows the users to seamlessly search and replace text, using interactive features such as toggle displays and customized search parameters. On the server side, functionalities for finding and updating text or retrieving evidence are performed by database interactions. These functionalities enhance the user experience by streamlining evidence management thus increasing the efficiency and accuracy of the patent litigation process.

d) Assigning Evidence from One Claim Element to Another or to Multiple Claim Elements

The method for assigning evidence to a dedicated panel 3307 as shown in FIG. 33 across multiple claim elements in an Evidence Analysis and Management module 206 significantly streamlines the management of the evidence, eliminating the need for manual updates and saving substantial time. This process performed by a server-side function involves complex operations such as the extraction and verification of multiple input query parameters and updates to the database tables such as tblInvalidityList, tblInfringementsList, tblConstruction and tblEvidence. The server-side function outlines a workflow where the evidence lists are fetched, and new evidence records are created based on the extracted parameters. For example, for assigning evidence related to validity or invalidity, or infringement or non-infringement, operations such as fetching existing evidence, creating new entries in the evidence lists, and conditionally performing bulk insertions are performed. This feature significantly improves the efficiency and accuracy of evidence management and minimizes efforts spent by the users for bulk updates, thus saving significant time.

### e) Master Pointer Matrix

The Master Pointer Matrix 210 interface as described above in detail provides a visual interface enabling the users to effortlessly set up and manage evidence linking between an exemplar element and elements with the same or similar text in a patent, or other patents of the case. When an exemplar element is selected, the feature provides an individually selectable list of claim elements that share the text to help expedite the process. This feature significantly improves the efficiency in evidence loading and management.

f) Copy and Move Evidence from One Tab to a Different Tab

The Copy and Move feature of an Evidence Analysis and Management Module 206 provides the users with versatile functionality to copy or move evidence between one or more evidence tabs using the options in the dedicated panel 3307. This functionality is facilitated through a server-side function that handles operations involving moving or copying of evidence based on specified contexts. This feature allows moving or copying evidence related to infringement, validity, damages, and construction, depending on the context and input parameters. The process begins with the validation of input parameters from the request, determining the type of operation, and identifying the source tab fromTab and destination tab toTab. The functionality involves retrieving the current evidence records from the respective tables such as tblInfringementsList, tblInvalidityList, tblDamagesEvidence, or tblTermsEvidence based on fromTab. It then determines the placement order in the toTab. Depending on whether the operation is a move or copy, the function either updates the existing records for movement or creates new records for copying and executes bulk creation of all the new entries. The operation is meticulously managed within a database transaction to ensure data consistency and integrity, thereby enhancing navigational ease and operational efficiency. This allows the users to organize and manage evidence more efficiently.

g) Evidence Ordering with Up, Down Arrow Marks or Drag and Drop

An Evidence Analysis and Management Module 206 features a user-friendly ordering function of a dedicated panel 3307 with multiple user functions that allows the users to organize and arrange evidence with ease using up and down arrow buttons available on the interactive Graphical User Interface (GUI) or through a drag-and-drop functionality available on the interactive Graphical User Interface (GUI). This intuitive approach provides versatility and convenience, enabling the users to prioritize and sequence evidence as needed. These features enhance user experience, enabling users to efficiently manage the presentation and flow of evidence, ensuring a more organized and structured approach to evidence management.

### h) Individual Evidence Management Operations

An Evidence Analysis and Management Module 206 support comprehensive evidence management operations such as editing, citation updates, deletions, and additions from evidence view area 3308. A server-side function processes the input parameters such as heading, reference, content, and other parameters, to effectively create or modify evidence records. It also includes capabilities to handle dynamic requirements such as an image or video upload, content replacement, and escape character removal. The system efficiently manages securing documents and related data and error handling during the evidence creation process. Modifications to the evidence records are facilitated through interactions with specific database tables such as tblInfringementsList, tblInvalidityList, tblDamagesEvidence, and tblTermEvidence.

i) Adding Evidence from the Patent Specification

An Evidence Analysis and Management Module 206 can include a semi-automated method for incorporating evidence from a patent specification using the option provided in the dedicated panel 3307 with multiple user functions. A server-side function within the interactive Graphical User Interface (GUI) initializes evidence creation based on the user-selected term within the Terms construction module 207 or prior-art reference within the Invalidity/Validity module 209. Depending on the module, an appropriate identifier makes an API call to display, create, and store the evidence automatically citing the passage by the column and line number. A server-side function processes the input parameters, retrieving patent information from tblPatents and associated tblLibraryItems database tables. Said function handles JSON data in various formats, extracting and filtering the relevant data while performing error handling, logging or user notification functions during the data retrieval process. An Evidence Analysis and Management Module 206 provides a streamlined and efficient way to manage and add evidence from patent specifications.

### j) Build Charts

Build Charts Module 213 as described below in detail features one-click export function to build charts and slides in common templated formats. Depending on the selected patent and embodiment, the user can select the evidence tabs for the terms, accused products, and prior-art defenses that should be part of the exported chart. The users can choose the page orientation i.e. landscape or portrait, and column number depending on whether the export evidence is the user's evidence or that of both the parties.

Build Charts Module 213 offers output options that can be selected by the user prior to the chart preview or export. These comprise removing the CONFIDENTIAL footer of the document, redacting evidence identified as confidential business information, including evidence tabs, labels, and other items. The module prompts the users with appropriate notifications and user confirmations. It provides randomizing the output evidence order within each evidence cell, expanding pointer content, identifying duplicate evidence within the same evidence cell, and removing duplicate evidence from an evidence cell. The Build Charts feature in combination with an Evidence Analysis and Management Module 206 simplifies the creation, organization and editing of evidence charts.

### 8. Build Charts Module

The Build Charts Module 213 as shown in FIG. 2 is a unique tool designed to assist parties such as plaintiffs or defendants in a patent litigation, to create detailed claim charts. Claim chart is a visual and textual method of presenting arguments related to the claim construction, infringement or non-infringement, validity or invalidity, or damages. For example, to demonstrate infringement, claim charts provide a comparison of the patent claims with the features of a product or a process. In another example, to demonstrate invalidity, claim charts provide a comparison of patent claims against cited passages from a relevant prior-art reference. Other types of charts include visual representation, for example, but not limited to terms construction, an organized output for damages, or other sections of a patent litigation case such as support for briefs and reports. The Build Charts Module 213 of the present disclosure provides a seamless, efficient, and customizable approach to create claim charts by the users.

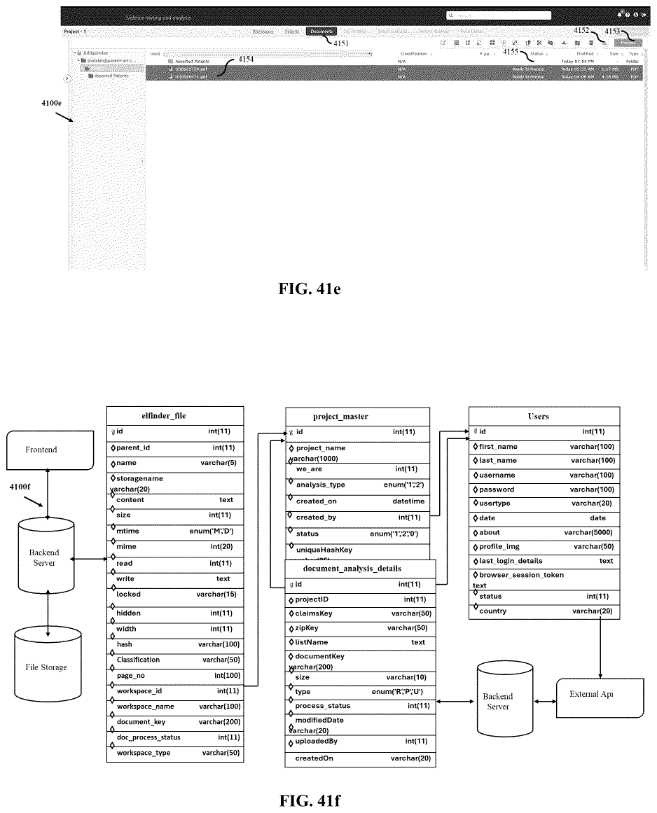

The Build Charts Module 213 offers a dynamic and interactive Graphical User Interface (GUI) as represented by FIG. 29 which is a workflow process of the Build Charts Module 213 of a Patent litigation and evidence management system 201 of the present disclosure. The Build charts Module 213 simplifies the process of developing one or more different types of charts by users based on the section selected by the users. To create claim charts, the users can efficiently select and organize the required patent claim elements and the corresponding evidence. It is built on a robust database schema that manages data integration and retrieval. The users benefit from the Flow Chart feature, which helps visualize connections between the elements of a section such as the patent claims and evidence, making both the chart creation and presentation clearer and more logical. The on-the-fly modifications feature is particularly useful in the fast-paced legal environment, allowing real-time updates and adjustments to the charts. The users also have the ability to utilize customized chart templates.

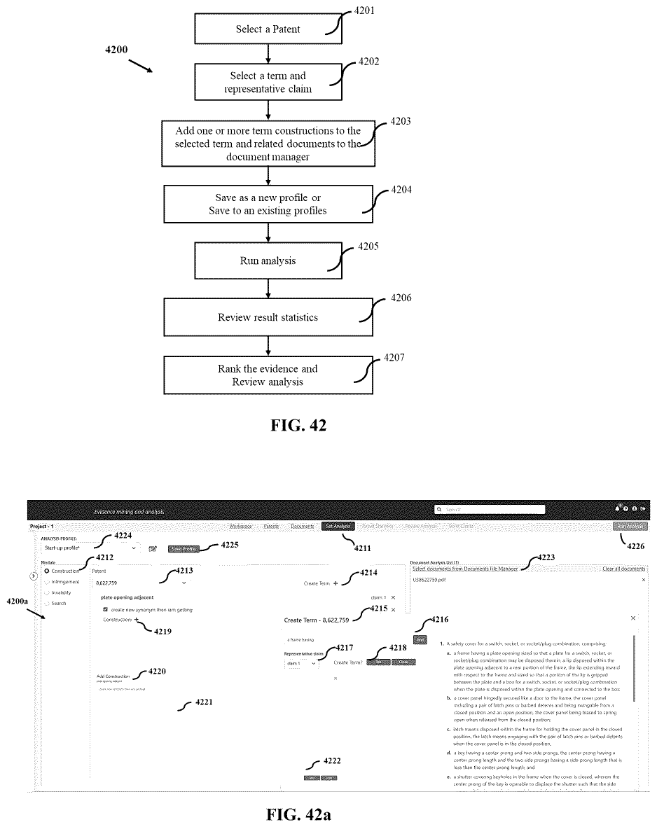

Overall, the Build Charts Module 213 provides enhanced user experience as On-the-Fly Modifications feature offers the users, customizable layouts, live previews of changes, and the ability to download the final product in a desired format. It makes preparing claim charts more efficient and effective for the users. FIG. 30 illustrates a database schema showing the technical relationships between at least a portion of the database tables for the functionality related to the Build Charts module 213 of a Patent litigation and evidence management system 201 of the present disclosure.

### a) an Interactive Graphical User Interface (GUI) to Select the Terms, Prior-Art, Accused Products, and Damages

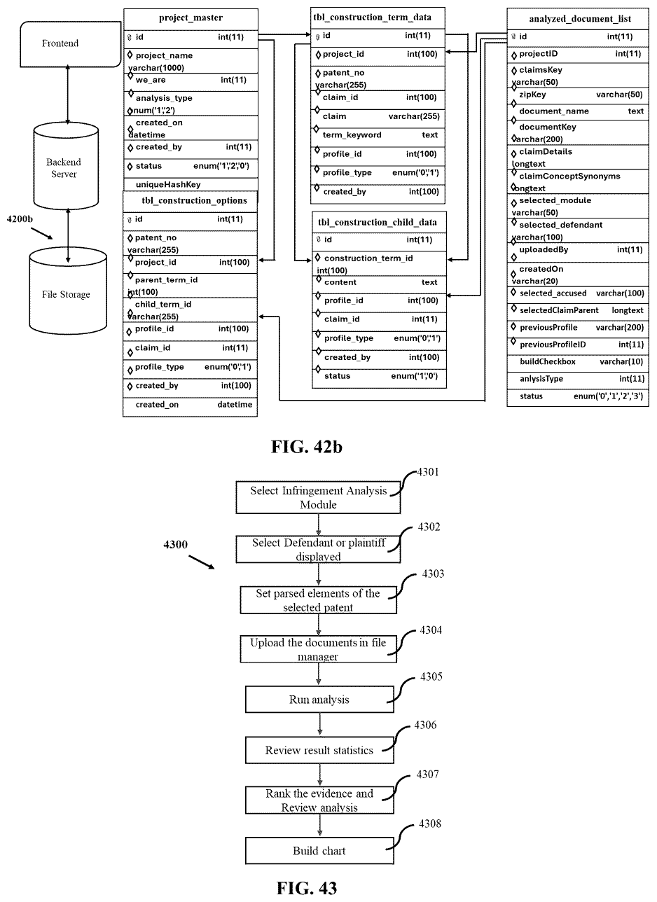

According to various aspects of the present disclosure, FIG. 31 illustrates a screen shot 3100 of the Build Charts Module 213, in which the users select an asserted patent 3101, and select one of the desired sections 3102. Thereafter, the users can select one of the related parties 3103, i.e. plaintiff, defendant, or court. The users can select or define the format of the chart by selecting one or more check boxes or radio buttons from the different options 3104 available, such as Page Orientation or Output Options. The users can preview the claim chart by clicking on the Preview 3105 button. The Build Chart 3106 button will create the chart as per the user selections and send to the queue 3107 for processing.

A client-side function handleChanges( ) as per APPENDIX VIII a), manages different sections such as the constructions, damages, infringement/non-infringement, and validity/invalidity of a Patent litigation and evidence management system 201. The function handleChanges( ) initializes arrays to dynamically populate data based on a specific section, i.e., constructions, damages, infringements, or validity, and the party involved in the case, i.e., plaintiff or defendant. The function uses adaptive data structuring methods and API calls to fetch, process, and format the display relevant data as per the party involved.

A server-side function, getPatentModulesBuildChartData( ) as per APPENDIX VIII a), processes patent-related data for various modules such as infringement, validity, and damages. The function first extracts input parameters such as the username, patentID, and moduleType from the client-side request. It fetches comprehensive data and constructs a structure dataset relevant to the specific module type, parties involved, and the data specific to a module such as accused products, prior-art, or damages corresponding to the patents. This structured data is then compiled and finally returned as the response body for visualization.

### b) Select or Deselect Individual and Multiple Items on Interactive Graphical User Interface (GUI)

A set of functions such as onDfCheckedChanged( ) and onCheckedChanged( ) as per the pseudocode in APPENDIX VIII b), manage the state of checkboxes across the interactive GUI. For any change in the state of the checkboxes due to user interactions, the functions ensure that the related parts of the data structure are updated accordingly.

For example, said functions consider multiple factors such as the current state of the checkbox, its hierarchical relationship to other checkboxes which is linked by an id, and specific business rules for enabling or disabling checkboxes based on the conditions specific to infringement or invalidity analysis. This design and functionality as illustrated in FIG. 31 ensure consistency across an interactive Graphical User Interface (GUI), thus facilitating complex interactions and managing interdependencies among data represented by checkboxes.

Additionally, said functions manage the functionality for different types of interactive Graphical User Interface (GUI), for example a three column chart type. In such a case, the user selections must be mirrored across related categories to maintain uniformity in user choices. This cross-referential logic is managed by seamless calls between the functions onCheckedChanged( ) and onDfCheckedChanged( ) when cascade changes are required, thus ensuring that any action in one section appropriately influences the related sections.

### c) Preview

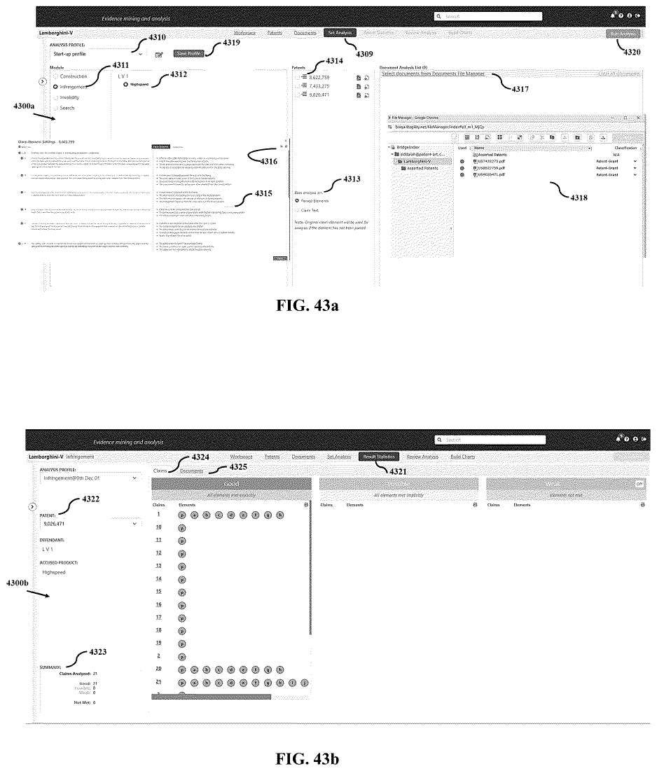

According to various aspects of the present disclosure, FIG. 32 illustrates a screen shot of a Preview module 3200 that allows users to preview the claim chart prior to exporting to a desired file format. The drop-down menu 3201 of the left-side of the screen, allows users to select a product or prior-art references as per the respective section selected by the users. The left-side of the screen, displays list of claims 3202 for the corresponding claim chart. The users have the ability to dynamically select or deselect Preview options 3203. The users can make the selections and add to the queue for processing and export using the button Add to Queue 3204. The right-side of the screen 3205 displays or previews the claim chart as defined by the users.

A client-side function fetchPreflightData( ) as per pseudocode in APPENDIX VIII c), in the Build Charts Module sets up the interactive Graphical User Interface (GUI) by preparing and managing data based on parameters such as screenType and chartType. A server-side function buildChartPreflight( ) as per the pseudocode in APPENDIX VIII c), asynchronously fetches and processes data, manages complex logic flows, executes database queries for different types of term data, and formats data as per the interactive Graphical User Interface (GUI) configurations. The function fetchPreflightData( ) uses conditional logic to adjust the data, determining headings and neatly organizing in accordance with user-defined conditions, user roles, and specific configuration requirements.

Together, these functionalities enable the Build Charts Module 213 to effectively navigate the complexities of a patent litigation and evidence management of the present disclosure, dynamically adapting to user interactions and specific interactive Graphical User Interface (GUI) configurations.

### 9. Damages Module

The Damages Module 211 as shown in FIG. 2, of a Patent litigation and evidence management system 201 of the present disclosure enables users to manage and organize damages for a patent litigation case. The module allows for the organization of damages by legal topics or proof points, promoting transparency and collaboration within the team. An embodiment of the disclosure describes the Damages Module 211 that streamlines the retrieval of data related to damages. The server-side functions retrieve and organize sections of damages from a database based on the case ID and party ID, as well as fetch related headings and specific damage evidence while ensuring access control and error management.

In accordance with the various embodiments of the present disclosure, a Patent litigation and evidence management system 201 of the present disclosure can include a Patent litigation case setup 202 comprising of a Patent Case Setup module 203, a Claims Setup Module 204, and a Figures Module 205. Further, the Patent litigation and evidence management system 201 of the present disclosure can include an Evidence analysis module 206 comprising of a Terms Construction Module 207, a Infringement Setup Module 208, a Validity Setup Module 209, a Master Pointer Matrix module 210, and a Damages Module 211. Additionally, the Patent litigation and evidence management system 201 of the present disclosure 201, can include a plurality of Supporting modules 212 for enhanced evidence management, comprising of a Build Charts Module 213, a Library Module 214, and an Import Charts Module 215. In accordance with the various embodiments of the present disclosure, the Patent litigation and evidence management system 201 of the present disclosure provides a collaborative platform that enables users selected from either side of the party i.e. plaintiff or defendant(s), to independently utilize the system to perform functions comprising of analysis of asserted patent(s), management of evidence during discovery process, claim construction, evidence management, preparation of infringement contentions, preparation of invalidity contentions, reports on damages, claim charts, slides or documents that are used during hearings, and other tasks specific to a patent litigation case as described in detail above. The Patent litigation and evidence management system 201 of the present disclosure provides an intuitive and interactive Graphical User Interface (GUI) to users. The intuitive and interactive Graphical User Interface (GUI) of a Patent litigation and evidence management system 201 of the present disclosure as described in detail above can include features that provide users side-by-side layout to organize and analyze the evidence by asserted claim elements, hyperlink the evidence citations to the related documents in the Library Module, develop claim matrix interfaces, export claim charts, interactive Graphical User Interface (GUI) designs to minimize number of user clicks, and other features specific to a patent litigation case as described in detail above. The Patent litigation and evidence management system 201 of the present disclosure provides the users selected from either side of the party i.e. plaintiff or defendant(s), to independently mange various aspects of a patent litigation case. The interactive Graphical User Interface (GUI)s and various modules as described in detail above of the Patent litigation and evidence management system 201 of the present disclosure provides benefits to users such as eliminating repetitive tasks, minimizing redundancies, improving collaboration, improving efficiency, improving productivity, and reducing training time during various aspects of a patent litigation case.

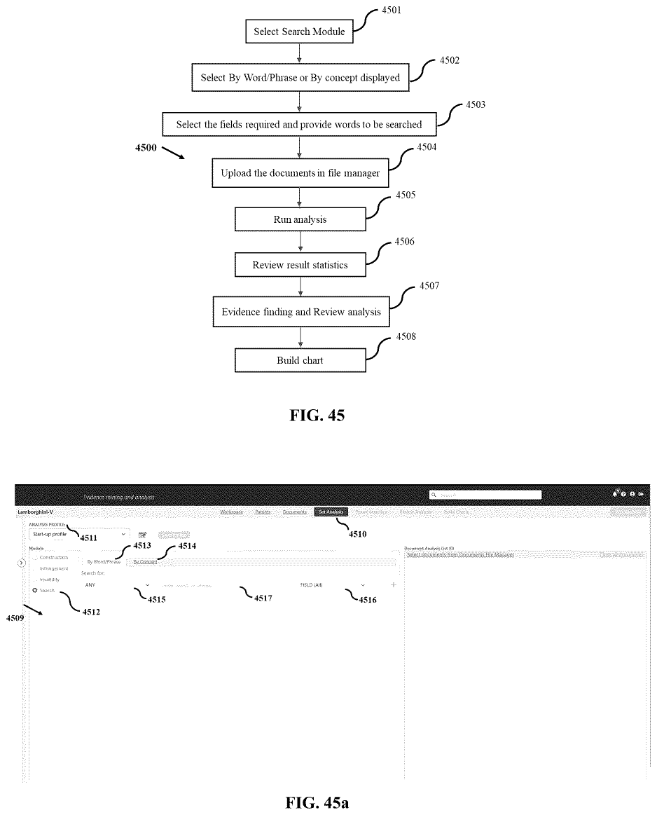

The present disclosure is also related to a system, method and user displays for patent claim analysis and evidence identification, extraction, analysis, and charting. In some embodiments, the system and method for patent claim analysis and evidence identification, extraction, analysis, and charting as disclosed, offers significant time savings through a comprehensive workflow that comprises automated evidence identification, extraction, and analysis, facilitates user review, automated charting, and the ability to store and present data in a format that saves time. FIG. 39 illustrates a system, method and user displays for patent claim analysis and evidence identification, extraction, analysis, and charting 3900 according to various aspects of the present disclosure. The system is designed to provide a comprehensive, end-to-end structured workflow for users, enabling them to perform analyses including, but not limited to, patent construction, infringement, and invalidity.

In one embodiment of the present disclosure, the system for patent claim analysis and evidence identification, extraction, analysis, and charting 3900 enable users to access the system with an interactive Graphical User Interface (GUI). Authorized users login 3901 through an interactive Graphical User Interface (GUI) and create a project workspace 3902 to begin using the system of the present disclosure.

The method for patent claim analysis and evidence identification, extraction, analysis, and charting 3900 begins with uploading one or more asserted patents. An asserted patent is a patent that a party, typically the patent owner, patentee, or plaintiff, whose claims have been infringed by another party, such as an accused infringer or defendant. These asserted patents are the subject of a litigation case and require detailed patent claim analysis to determine whether infringement has occurred, as well as to assess the validity of the patent.

In one embodiment of the present disclosure, an automated patent load module 3903 enables users to upload asserted patent(s) into the system for patent claim analysis and evidence identification, extraction, analysis, and charting 3900. The automated patent load module 3903 is configured to utilize Large Language Models (LLMs), Small Language Models (SLMs), generative Artificial Intelligence (AI) models, and vector embedding technologies, augmented with selective user intervention. The automated patent module 3903 is configured to receive patent data and retrieve patent details. The system then proceeds to analyze each claim by parsing it into discrete claim elements and identifying the underlying technical concepts, keywords, and synonyms based on the international classification code, which are validated by users. One of the key features of the automated patent module 3903 is the ability to generate accurate and simplified, non-technical parse for each concept which could be used to compare against non-patent literature and to improve semantic matching. To ensure accuracy, the automated patent module 3903 allows human intervention. A user can review, edit, or create new parses and synonyms. Once the claim elements, concepts, and synonyms are finalized, the automated patent module 3903 vectorizes the parses by converting them into high-dimensional numerical vector embeddings, which is stored in a dedicated database 3913 for semantic search and retrieval in subsequent analytical tasks.

In one embodiment of the present disclosure, an automated Document Processing Module 3904 is configured to process and analyze a plurality of electronic documents, including text-based PDFs, image-based PDFs, and other word processing formats. Upon receiving the documents, the automated Document Processing Module 3904, first verifies their machine readability and then uses a generative AI model, such as, but not limited to Large Language Model, Large Multimodal Model, etc., to classify each document into a specific category, such as patents, emails, or transcripts. Based on this classification, automated Document Processing Module 3904 executes a specialized workflow that leverages various methods, including but not limited to, one or more external API 3915, heuristic algorithms from Backend Server 3914, various AI models, and Optical Character Recognition (OCR) to accurately extract relevant evidence, including textual content, figures, and tables. The extracted text undergoes post-processing operations such as formatting and error correction before being converted into high-dimensional numerical vector embeddings for storage in a searchable database 3913. This enables advanced semantic search. Extracted figures and tables are also processed, using OCR for image-based elements, and stored in a digital asset management system. This multi-step approach of the automated Document Processing Module 3904 ensures accurate and resilient data extraction, converting raw content into a semantically enriched format for subsequent analysis.

In one embodiment of the present disclosure, a Set Analysis 3905 module provides a comprehensive framework for conducting an automated analysis of patent claims. The process is initiated by a user who selects a specific analysis type from a list including infringement 3907, invalidity 3908, construction 3906, or search 3909. The analysis types such as infringement 3907 hereinafter referred as Infringement Analysis Module, invalidity 3908 hereinafter referred as Invalidity Analysis Module, construction 3906 hereinafter referred as Claim Construction Analysis Module, or Search 3909 hereinafter referred as Search Analysis Module. The user then selects the patent, claims, and documents to be analyzed and proceeds to run the analysis. The Set Analysis 3905 module performs a detailed comparison of every claim element to the body of evidence. This involves conducting searches, such as, but not limited to, keyword-based search, semantic search and retrieval, in which each claim element is compared against every available evidence extract retrieved from the searches. Further, the Set Analysis 3905 module calculates a similarity coefficient between each parsed claim elements and each evidence extract. The system may iterate multiple times, based on a variable related to the length of the parse and the Set Analysis 3905 module conducts evidence ranking in which the calculated similarity coefficients are ranked by value, enabling the system of present disclosure to highlight the most relevant evidence. Subsequent to the process of comparison for a single element, the Set Analysis 3905 module determines whether the entire claim element has been satisfied by the collective strength of the ranked evidence. This strength is visually represented to the user through threshold values that correspond to a color-coded system, such as but not limited to Green for strong evidence, Yellow for moderate relevancy of evidence, and Grey for weak or no evidence. The Set Analysis 3905 module offers significant advantages, including but not limited to, time savings by allowing an attorney to analyze a massive list of exhibits for a single claim or for all claims at once. It efficiently identifies and highlights key passages in documents, directing user to the most important evidence and providing an evidence strength value. The system can be configured using analysis profiles to save and run specific analysis setups, further enhancing efficiency.

In one embodiment of the present disclosure, a Claim Construction Analysis Module 3906 is implemented within a Set Analysis module 3905 feature, which enables a user to create and manage an analytical profile for patent claim construction. The Claim Construction Analysis Module 3906 streamlines the conventional manual process of defining claim terms for litigation by providing a two-step method. This method allows a user to define a new term by selecting a phrase from a patent claim and associating it with a specific representative claim. Subsequently, the user can add one or more interpretations or constructions for that term, supported by evidence from patent specification or other documents. The Claim Construction Analysis Module 3906 is configured to provide an interactive Graphical User Interface (GUI) for term creation and a seamless backend for saving defined terms and their constructions to a database 3913. The module further integrates with an automated analysis feature that can save and run an AI-based processing pipeline. This integration of front-end and back-end functionalities ensures that all user-defined terms and their relationships are accurately stored, making the workflow for claim construction efficient, user-friendly, and robust.

In one embodiment of the present disclosure, an automated Infringement Analysis Module 3907 is implemented within a Set Analysis 3905 feature, which provides a centralized platform for managing and analyzing evidence. The automated Infringement Analysis Module 3907 is configured to perform a multi-level, AI-based analysis that iterates through each patent claim element and compares it against a body of evidence using vector embedding generated by Large Language Models (LLMs) to semantically score similar text. The automated Infringement Analysis Module 3907 features a unique state-aware analysis capability, which integrates user feedback such as favorites and deletions from previous sessions to refine current analysis. This ensures that the user's prior work is preserved and that the analysis is an iterative refinement rather than a new task. The automated infringement analysis module 3907 generates statistics, and formats the output with color-coded metrics and real-time interactive Graphical User Interface (GUI) updates, transforming raw data into actionable intelligence. This automated process, combined with an interactive UI, eliminates repetitive tasks, thereby saving time and enables users to efficiently perform in-depth infringement analysis by visually comparing and managing ranked evidence documents.

In one embodiment of the present disclosure, an Invalidity Analysis Module 3908 is implemented within a Set Analysis feature, which provides a centralized platform for managing and analyzing evidence to determine the validity of patents. The system utilizes a sophisticated, two-phased method to find and present relevant prior-art. In the first phase, an Evidence Retrieval and Initial Ranking function acts as a search engine to find potentially relevant evidence from a large body of prior-art documents. The Evidence Retrieval and Initial Ranking function uses a specialized AI model to compare each claim element against prior-art. A crucial feature is its ability to integrate and preserve user feedback, such as Favorites or Deletes, from prior analysis sessions to ensure valuable user feedback is retained. The function also employs a unique document-centric ranking, where evidence is ranked within each prior-art document rather than across the entire dataset. For data integrity and deeper analysis, all raw, ranked evidence is saved to a temporary database, and the results are aggregated into a single, comprehensive dataset. In the second phase, a Data Transformation and Report Generation function serves as a reporting engine. This function transforms the raw dataset from the first phase into a structured, intuitive, and multi-dimensional report for a user-friendly interactive Graphical User Interface (GUI). A key feature is data densification, where the function intelligently identifies and fills in gaps for claim elements with no corresponding evidence, ensuring the final report is a complete and accurate visual matrix. The Invalidity Analysis Module 3908 generates two distinct, nested views. The first view is a Document Analysis View, which organizes data by prior-art document, and a second view is a Claim Analysis View, which organizes data by patent claim. The function also applies business logic to enrich the data, translating raw similarity scores into intuitive color-coded metrics to provide clear and actionable insights for the user.

In one embodiment of the present disclosure, a Result Statistics 3910 feature provides a comprehensive and intuitive summary of the analytical results related to Infringement Analysis Module, Invalidity Analysis Module, Claim Construction Analysis Module or Search Analysis Module. Following the core analysis, the system calculates and structures key metrics for user presentation. In one embodiment of the present disclosure related to the Result Statistics 3910 feature of the Infringement Analysis Module, the system generates distinct analytical views, such as, but not limited to, Elements Satisfied (ES), which highlights documents containing evidence for the most claim elements, Total Extracts (TE), which ranks documents by the volume of relevant extracts, and Only Element (OE), which identifies documents that are the sole source of evidence for a particular claim element. The Result Statistics 3910 feature programmatically enhances the interactive Graphical User Interface (GUI) by visually emphasizing documents that satisfy all elements of a claim with features such as bolding or highlighting. The results are presented in a multi-column format that can be navigated either by claim or document. The Claims view displays claim elements with a visual indicator of evidence strength, while the Documents view features columns for user-added content, such as Favorites and User Adds, Elements Satisfied (ES), Total Extracts (TE), Only Support for Element, or Only Element (OE), thereby transforming complex analytical data into actionable, visual insights for the user. The Result Statistics 3910 feature is customized based on the type of analysis performed by the user, for example, for infringement analysis, the Result Statistics 3910 feature enables users to quickly assess the value of each document, preventing them from spending time on those without useful evidence and focusing their attention on the most important information.

In one embodiment of the present disclosure, a Review Analysis 3911 feature provides a streamlined and interactive Graphical User Interface (GUI) for the review of evidence. The interactive Graphical User Interface (GUI) is configured with a two-panel layout, to display a patent claim on the left panel and a list of corresponding evidence extracts on the right panel. A user may select a specific patent, claim, and analysis profile to initiate the review. Upon selecting a claim element, the Review Analysis 3911 displays the associated evidence in manageable or paginated buckets, such as 1-25, 26-50, etc. A key aspect of the Review Analysis 3911 is its focus on deselection. Unlike conventional methods that require a user to meticulously search for evidence and then manually build a case, this feature presents pre-analyzed charted evidence. The user reviews this pre-analyzed charted evidence and attempts to prove it wrong, thereby validating or invalidating the findings of the system. This inversion of the traditional workflow saves significant time and leads to more accurate results. The Review Analysis 3911 module allows users to interact with each evidence extract by marking it as a favorite, deleting it, or leaving it as is. Users can hide documents from which an extract originates if the document is not relevant. Unlike conventional systems that only identify paragraphs, the Review Analysis 3911 performs a deeper analysis. It classifies the type of similarity as explicit, implicit, or inferred and evaluates how a Person of Ordinary Skill in the Art (POSITA) would interpret the evidence. The Review Analysis 3911 also assesses how multiple pieces of evidence can be combined to satisfy a single claim element or an entire claim, and it provides a rationale for such combinations, creating a more legally robust identification process. A key feature is the ability for a user to click on a citation to view the native source document with the relevant text being automatically highlighted and linked to the claim element, which streamlines the review process and eliminates the need for manual cross-referencing. Users may also add new evidence from the source document by highlighting text and associating it with a claim.

In one embodiment of the present disclosure, User Displays and Analysis feature is implemented to provide an interactive and interactive Graphical User Interface (GUI) for analyzing evidence. This module is designed to provide users with a detailed overview of the analysis workflow and its results, enabling them to make informed decisions and develop high quality of claim charts. The user display feature serves as a dashboard or a set of dedicated panels that highlight key aspects of evidence analysis. One objective of the dashboard serves as the purpose of Evidence Tracking, which tracks and displays information such as, but not limited to who added evidence, what evidence was added along with time stamps, thereby providing a clear audit trail. Further, the Evidence Tracking feature, tracks recent additions, including, but not limited to, which documentary evidence was added and related specific evidentiary extracts. Another objective of the dashboard serves the purpose of providing Quality Metrics, which displays and presents data on how recently added evidence has impacted the overall quality score of a claim or claim element. The Quality Metrics feature ranks and highlight the evidence and identifies claim elements that are missing supporting evidence. To be able to fill the gap of missing supporting evidence, the dashboard includes a feature that serves as Gap Analysis, which programmatically identifies and displays strengths and weaknesses of evidence collection and analysis. The Gap Analysis identifies references with no evidence added, highlighting empty fields in the analysis where evidence may need to be added, and flagging inconsistencies in citation formats.

In one embodiment of the present disclosure, Build charts 3912 is configured to transform identified evidence into a court-ready claim chart by performing additional processing steps such as, but not limited to, cleaning extracted text, formatting citations, and linking evidence directly to claim elements. The Build charts 3912 designed provides a user-friendly and actionable view of the entire analysis, significantly improving the quality of claim charts and offering a significant competitive advantage in patent litigation.

In one embodiment of the present disclosure, the system and method of patent claim analysis and evidence identification, extraction, analysis, and charting 3900, is configured to employ technologies to provide a comprehensive and efficient solution for patent evidence analysis. This embodiment of the present disclosure integrates technologies including, but not limited to, Large Language Models (LLMs), Small Language Models (SLMs), Artificial Intelligence (AI), high-dimensional numerical vector embedding, heuristic algorithms in backend server 3914, and robust database 3913 storage to streamline and automate the workflow and method of patent claim analysis and evidence identification, extraction, analysis, and charting 3900.

In one embodiment of the present disclosure, the system and method of patent claim analysis and evidence identification, extraction, analysis, and charting 3900, is configured to employ Artificial Intelligence (AI), Small Language Models (SLMs), and Large Language Models (LLMs). AI, and LLMs are used for several essential functions, such as, but not limited to:
Content Generation, in which LLMs are configured to automatically parse patent claims into claim elements, extract concepts and suggest synonyms, translate complex patent language into technical terms, and generate summaries of findings. These LLMs parse complex patent claims into discrete, analyzable elements used for the purpose of patent claim analysis and evidence identification, extraction, analysis, and charting 3900 according to the present disclosure.
Automated Document Classification and Parsing, in which Generative AI models and LLMs are configured to automatically classify various types of documents, such as, but not limited to patents, brochures, emails, and transcripts.
Textual content, Images and Table Extraction, in which Artificial Intelligence APIs, such as Document Intelligence APIs are employed to extract textual content, images, and tables from documents. The extraction process utilizes API-generated structural tags to identify and segment text blocks, figures, and tabular data. The extracted content is subsequently processed to the internal representation requirements, such as standardized paragraph sizing, while preserving the original layout, structure, and spatial relationships of images and tables.
Figure or Drawing Number Identification, in which LLMs are configured to identify and extract figure or drawing numbers within patent documents. Accurate detection of figure or drawing numbers supports precise citation of evidence blocks related to specific figures or drawings in the document. Such LLMs, further generate concise summaries from the extracted figures or drawings. These summaries capture the essential technical information represented in the figures or drawings, and extract in textual format, thus, aligning with corresponding claim elements. Such LLMs identify potential evidence that is not easily discoverable as it is in an image, drawing or a table format.
Object Detection Models, in which AI is configured to train object detection models to perform multiple tasks, and accurately extract and structure visual and textual information from documents. One such example of AI-based Object Detection Model is Figure Segmentation, in which pages comprising multiple images are processed to isolate each figure into a single evidence block. This ensures precise representation of individual figures and facilitates accurate mapping to relevant claim elements or parsers. Another example of AI-based Object Detection Model involves Column Detection, which is configured to identify individual columns in patent documents, enabling accurate preservation of column and line number citations, which is critical for precise referencing of textual evidence. Another example of AI-based Object Detection Model is Deposition Text Detection, in which Object detection models are trained to accurately extract text blocks along with their corresponding line numbers and page numbers, ensuring reliable capture of structured information.
Optical Character Recognition (OCR), in which commercially available OCR engine is configured to extract alphanumeric labels and annotations embedded within patent figures or drawings. The extracted labels are processed by heuristic algorithms to map the extracted labels with the corresponding text in the patent document. These mapped labels are then displayed alongside the figures when they are identified as relevant evidence. Further, OCR engine is configured to extract the text contained within column bounding boxes of the patent documents
Semantic Analysis, in which vector embeddings generated from LLMs are configured for semantic search, to compare claim elements to evidence and score based on conceptual similarity, which is a major advancement over traditional keyword-based methods.
Reasoning and Similarity Scoring:
   With the conventional top-k algorithm, most relevant evidence paragraphs are initially identified based on semantic similarity search, this approach may not fully capture the nuanced technical details or provide explainability. To address this, these top-k extracted paragraphs are further analyzed using Large Language Models (LLMs). The LLMs are prompted with the relevant claim elements or parsers, along with task-specific instructions, such as various prompt strategies are employed for infringement or invalidity analysis.
   The LLMs return Reasoning, which is a textual explanation of why the evidence paragraph matches or does not match the claim element or parser.
   In addition, the LLMs return Similarity Score, which is a quantitative score between 0 and 1 indicating how well the evidence aligns with the claim element or parser.
   Further, these scores and reasoning are then visually summarized using a color-coded pie chart, such as green, yellow, and grey, for each claim element. The pie charts provide users with an intuitive, and visual representation of how well each claim element is supported by the evidence paragraphs, aiding assessment of asserted patents against prior-art or related documents in the context of infringement or invalidity.
Evidence Paragraph Combinations, in which LLMS are configured to evaluate the Reasoning and Similarity scores of each parser and suggest combinations of evidence paragraphs that collectively provide a more complete match for each patent claim element. For each proposed combination, the LLM generates reasoning that explains how the selected set of paragraphs together satisfies the claim element. This approach provides users with a more comprehensive understanding of the evidentiary support for each claim element.
Heuristics algorithms of the backend server 3914 are used along with AI and LLMs for tasks such as filtering low-confidence results, deduplicating evidence, and translating numerical similarity scores into intuitive, color-coded metrics, such as, but not limited to Green, Yellow, Red for intuitive visual representation.

In one embodiment of the present disclosure, the system and method of patent claim analysis and evidence identification, extraction, analysis, and charting 3900, is configured to employ Vector Embeddings, which performs the core semantic capabilities. Textual data is converted into high-dimensional numerical vectors, or vector embeddings, which represent the semantic meaning of the text. This process enables the system to perform concept-based searches to find relevant evidence even if there is no exact keyword match. These vector embeddings are generated in real-time and process large volumes of data.

In one embodiment of the present disclosure, the system and method of patent claim analysis and evidence identification, extraction, analysis, and charting 3900 is configured to employ several structured Data Storage mechanisms for data persistence and data integrity. Structured databases 3913 such as relational databases 3913 are configured to store Processed data, including text, metadata, vector embeddings, and various document types, such as emails, transcripts, and patents. Database mechanisms are employed to manage various states, store and retrieve user feedback, for example, favorites or deletes from previous analysis sessions. This enables the system to perform iterative, state-aware analyses without losing valuable user input. Database management offers Optimized Performance by using features such as batch processing, maintaining transactional integrity, and managing robust connections to efficiently store and manage large volumes of data. In addition, a digital asset management repository stores figures, tables and documents.

In one embodiment of the present disclosure, the system and method of patent claim analysis and evidence identification, extraction, analysis, and charting 3900, is further configured to employ Heuristic Algorithms from backend server 3914 and one or more external API 3915 such as but not limited to, Microsoft® Azure®, Adobe® PDF services API, object detection models, and vision transformers are configured to extract text, figures, and tables, from various documents. Some unique techniques such as Data Densification are employed to identify and fill in gaps in the data with zero-score entries to ensure that final reports and visualizations are complete and accurate.

In one embodiment of the present disclosure, the system and method of patent claim analysis and evidence identification, extraction, analysis, and charting 3900, is configured to employ one or more external API 3915 and asynchronous communication integration front-end services with backend services to provide a seamless and responsive user experience. This allows the Backend server 3914 to perform intensive processing tasks, such as, but not limited to AI or ML processing, semantic analysis, while the front-end provides real-time progress updates and dynamically renders interactive results.

Some of the features of the system, method, and user displays for patent claim analysis and evidence identification, extraction, analysis, and charting 3900 include, but are not limited to, Patent Load module 3903, Document Processing Module 3904, Construction Analysis Module 3906, Infringement Analysis Module 3907, Invalidity Analysis Module 3908, and Search Analysis Module 3909 are described below in detail. The present disclosure and its advantages are best understood from the following detailed description taken in conjunction with the accompanying drawings and the knowledge of skilled artisans.

Furthermore, in some of the implementation of embodiments described herein, a user can save 25% to 75% time from the specific improvement in technology and automates about 50% to 75% of the patent litigation workflow process.

### Patent Load Module

### A Workflow Process of an Automated Patent Load Module, of a System for Patent Claim Analysis and Evidence Identification, Extraction, Analysis, and Charting.

Patent claim analysis is critical for several applications and requires advanced methodologies to improve overall efficiency. Conventional methods for evaluating patent claims and identifying supporting evidence are often manual, time-consuming, and susceptible to human error. An automated Patent Load Module 3903 of the present disclosure integrates advanced automation capabilities, particularly leveraging generative Artificial Intelligence (AI) models and vector embedding techniques, augmented by selective human intervention. This automated Patent Load Module 3903 provides a robust and efficient workflow for the retrieval of patent details, and accurate capture of patent claims. The automated Patent Load Module 3903 employs generative AI models to extract technical concepts, keywords, and synonyms subject to selective human validation. These extracted elements are subsequently converted and stored as vector embeddings, thereby facilitating semantic search and retrieval, and optimizing storage utilization.

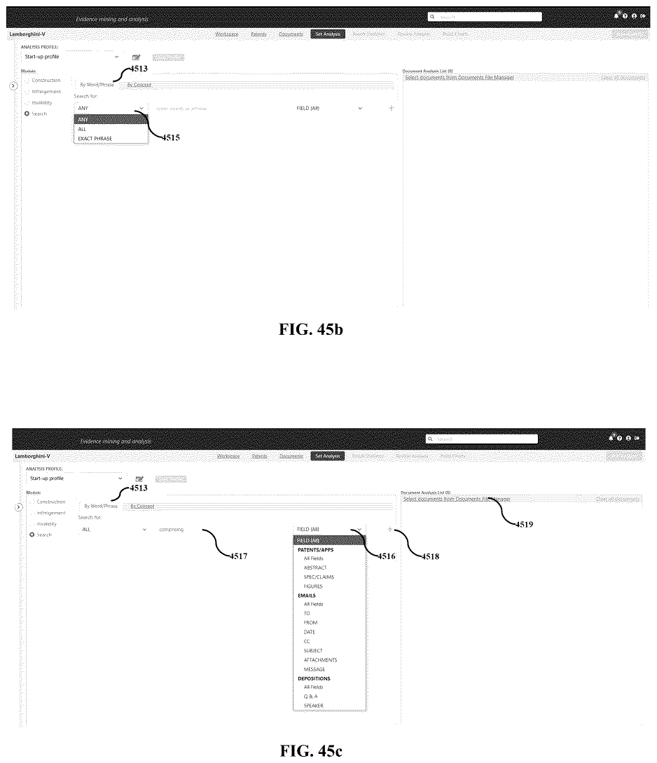

FIG. 40 illustrates a workflow process 4000 of an automated Patent Load Module 3903 of a system, method and user displays for patent claim analysis and evidence identification, extraction, analysis, and charting 3900 according to various aspects of the present disclosure.

According to an embodiment of the present disclosure, the workflow process of an automated Patent Load Module 3903 is initiated upon a user accessing a system for patent claim analysis and evidence identification, extraction, analysis, and charting 3900, via a secure Login 4001 provided through a web-enabled portal. Upon successful authentication, the user is prompted to create or select Project Workspace 3902. This step involves establishing a dedicated project environment, which includes defining a project name, associating one or more defendants therewith, and associating one or more products therewith for the analysis. Following the establishment of Project Workspace 3902, the user proceeds to the patents input step by uploading a target patent 4002. This target patent serves as the document whose claims will be subjected to patent claim analysis. The system of the present disclosure accommodates two methods for uploading a patent document. In the first method 4002a, the user uploads a patent document file through an interactive Graphical User Interface (GUI) that supports any formats such as, but not limited to, *.docx, or *.pdf In a second method 4002b, the user inputs a patent number formatted according to system-defined specifications.

The Patent Load Module 3903 facilitates the uploads of a patent document or a patent number, subsequently fetches the details of the corresponding patent, and automatically identifies and captures its claims. This is accomplished by employing an algorithm 4003 which retrieves the relevant webpage from at least one patent database, such as, but not limited to, Google Patents™, United States Patent and Trademark Office (USPTO) database, or World Intellectual Property Organization (WIPO) database, and performs web scraping to extract the patent claims. Further, the Patent Load Module 3903 analyzes each claim element 4004, and identifies discrete concepts in each claim element 4005. Thereafter, the Patent Load Module 3903 automatically generates a parse to represent each concept in non-technical language 4006, which is further refined and edited by users 4006a. Further, the Patent Load Module 3903 enables users to Identify Key terms and phrases 4007 in two different approaches. In one approach, the Patent Load Module 3903 automatically suggests terms, or in another approach, a user may manually input and define their own terms or phrases. Subsequently, the Patent Load Module 3903, identifies the important concepts and augments these concepts with synonyms based on various patent classification codes 4008, such as, but not limited to, International Patent Classification (IPC) code, which is further refined and edited by users 4008a. These synonyms, keywords, and concepts parsed are converted to high-dimensional numerical vector embeddings as part of the Vectorize parses 4009 step, which is stored in a dedicated database structure 4010 for semantic search and retrieval in subsequent analytical tasks. The Patent Load Module 3903 of the system for patent claim analysis and evidence identification, extraction, analysis, and charting 3900, improves the efficiency and accuracy of the patent claim analysis through a series of operations, including the use of advanced Large Language Models (LLMs) and vector embedding techniques, in combination with human intervention. The Patent Load Module utilizes a generative AI model such as a Generative Pre-trained Transformer (GPT) model or other generative AI model including Large Language Models (LLM). Currently, various large language models, such as, but not limited to OpenAI® ChatGPT, Microsoft® Bing Chat, Google® Bard, Google® Gemini, Meta® LLAMA, are commercially available. To facilitate concept identification, the Patent Load Module 3903 transmits the textual content of an individual claim element, along with its associated patent classification code (e.g., International Patent Classification (IPC) or Cooperative Patent Classification (CPC) code), to the selected LLM model. A specifically designed prompt is utilized to instruct the model to return the important technical concepts and keywords embedded within that claim element. A crucial aspect of the Patent Load Module 3903 is the provision for human intervention, enabling a user (e.g., a patent analyst) to review the concepts and keywords identified by the LLM. Such human intervention enables the user to edit the system generated concepts or synonyms, or create a new concept or synonym if the automated output is deemed incomplete or inaccurate, thereby ensuring a high degree of accuracy and relevance in the extracted information.

Subsequently, the Patent Load Module 3903 converts a claim element into one or more parsed elements in order to identify concepts representing each of the parsed elements. This simplification is achieved by employing a generative pre-trained transformer model, or Large Language model (LLM). In an optimized configuration, the Patent Load Module passes all identified claim elements from the patent document to the LLM model, thereby enabling parallel processing. A prompt is designed to instruct the LLM model to generate simplified concepts for each claim element.

To further refine the understanding of the claims, the Patent Load Module 3903 identifies key terms and phrases from the original claim element text. This identification is again accomplished by utilizing a Large Language model (LLM). The Patent Load Module 3903 transmits the claim element text, along with its patent classification code to the LLM model, and prompts the model to return important concepts and keywords, which may be synonymous with or a subset of those identified in a prior step.

To expand the semantic reach for subsequent search or comparison tasks, the Patent Load Module 3903 suggests synonyms based on the patent international classification ode and the identified keywords. This step leverages a Large Language model (LLM). The Patent Load Module transmits the relevant patent classification code and a specific keyword to the LLM model, prompting the LLM model to return a list of possible synonyms or semantically related terms relevant within that technical domain.

The Patent Load Module 3903 facilitates human intervention by enabling users to review the LLM-suggested synonyms. The users are permitted to edit these suggestions or create entirely new synonyms, thereby ensuring that the final set of terms accurately reflects the intended scope of the concepts.

Once the parses, keywords, concepts and synonyms are finalized incorporating human edits where necessary, the system proceeds to vectorize these parses, keywords, concepts and synonyms. This vectorization is achieved by utilizing a text-embedding-3-small model API, such as that provided by the Microsoft® Azure®, platform. Each finalized parse, keyword, concept, and synonym is transmitted to this embedding model, which returns a high-dimensional numerical vector embedding, for example, a vector with a dimension of 1536 representing the semantic meaning of that parse.

The processed information is managed within a database structure. Notably, the Patent Load Module optimizes memory and storage efficiency by generating vector embeddings for the parses on-the-fly as needed for analysis, rather than persistently storing these potentially numerous and large vectors within the database. Accordingly, only the core claim information, human-curated concepts, keywords, and synonyms are stored persistently, while the vector representations are dynamically generated.

Thus, the Patent Load Module 3903 provides a robust and efficient method for analyzing patent claims, combining the power of advanced Large Language Models (LLMs) for concept extraction, parsing into a non-technical language, and synonym generation with essential human validation. Furthermore, it leverages efficient on-the-fly vectorization for subsequent semantic operations.

### Client-Side Function—Upload of a Patent

FIG. 40a illustrates an interactive Graphical User Interface (GUI) 4000a for a Patent Load Module 3903 of a system, method and user displays for patent claim analysis and evidence identification, extraction, analysis, and charting 3900 according to the present disclosure. APPENDIX IX describes pseudocode for frontend and backend functions implemented for Patent Load Module 3903, of a system, method and user displays for patent claim analysis and evidence identification, extraction, analysis, and charting 3900 in accordance with the present disclosure.

An interactive Graphical User Interface (GUI) 4000a for patent upload is provided, enabling a user to submit a target patent whose claims are to be analyzed. The user submits the target patent to the automated Patent Load Module 3903, for analysis through one or more input methods. In the first input method, the user enters the corresponding patent number 4011 directly into the system using a predefined format. Alternatively, a second input method allows the user to upload patents 4012 as a document in a supported format such as .docx, .zip, .pdf, .xls or any other system-defined file format. In a third input method, the user uploads a patent document by browsing to a file directory system 4013 and selecting a file for upload and click on Upload 4014 button. In the first input method, when the user enters a patent number 4011 into a text field of the patent upload interactive Graphical User Interface (GUI), the module is configured to simulate a button click and execute a command or a function. Execution of this command or function is event based and is triggered upon detecting a press of the Enter key. Furthermore, this command or function is disabled when the user is focused on the patent number input field, which prevents accidental submission. For the second input method, the interactive Graphical User Interface (GUI) comprises a file upload component 4012 that is configured to accept plurality of files of predefined file types, such as PDF, ZIP or any other file format as defined by the module. Upon selection of one or more files for upload, a client-side function performs a validation process. If a file of an unsupported type is detected, an error notification is presented to the user. Upon successful upload, the module extracts a temporary folder name from the server's response and subsequently transmits an AJAX request to the backend server to archive and process the patent files. The front-end component manages various server responses, including, but not limited to, successfully loading the patent details page upon successful processing, displaying specific error messages for unreadable or password protected files, or displaying error alerts for upload failures, thereby ensuring user feedback and UI state management.

### Server-Side Functions to Manage Patent Upload Process

Following the successful validation process, the client-side function invokes a series of backend service functions. These functions manage the file upload process, validate, parse and extract patent related data, and perform error handling.

A function uploadAndExtractPatent( ), is configured to handle the initial backend processing of uploaded files. This function is configured to receive an uploaded patent document, validate the file for conformity to a predefined file format, and move the validated file to a secure, temporary server-side location for extraction. Upon successful initial processing, an asynchronous second function addArchiveAndSendPatent( ), is invoked, which archives the extracted content into a compressed format, prepares a payload containing this archive along with user and project metadata, and transmits this payload to an external data processing API.

In response to a successful transaction with the external API, an asynchronous third function savePatentDetailsInTemp( ), is invoked. This function is configured to parse the structured data returned by the API, which contains bibliographic details for the processed patent(s). The savePatentDetailsInTemp( ) function sanitizes key fields of a patent document such as title, abstract, inventor, relevant dates, and other published information, prior to inserting this information into a temporary database table. The overall method further ensures system integrity by deleting temporary files and archives upon both successful completion or failure of the API processing.

For a seamless user interaction, the client-side function error handling procedure involves presenting error notifications to the users. These notifications include messages corresponding to backend processing failures or file-level errors. Additionally, the procedure resets the file upload component on the interactive Graphical User Interface (GUI) to its initial state.

### Patent Bibliographic Extraction Function

A need exists for efficiently loading patent documents and extracting associated bibliographic information. Patent Bibliographic Extraction Function of the present disclosure efficiently loads patent documents and extracts associated bibliographic information. The function supports multiple input modalities, including single patent numbers for direct web scraping and compressed archives containing multiple patent documents in Portable Document Format (PDF). For single patent number inputs, the function fetches and parses web content from public patent databases to extract bibliographic details. For archived PDF inputs, the function extracts each PDF file, processes it using Optical Character Recognition for image-based PDFs, and subsequently extracts bibliographic information by either reading text from the PDF document or by fetching from external sources based on extracted patent numbers. The extracted data is structured and returned for further use. This approach significantly automates and streamlines the patent data ingestion and bibliographic extraction process, thereby enhancing accuracy and efficiency.

In an embodiment of the present disclosure, a Patent Bibliographic Extraction function performs automated loading of patent documents and the extraction of patent claims and bibliographic information. The Patent Bibliographic Extraction function implemented as patentData( ), efficiently handles various input formats and organizes the processed data within a dedicated user and project-specific workspace.

A series of steps are performed by the Patent Bibliographic Extraction Function patentData( ). The function begins with receiving input data associated with one or more patents from the interactive Graphical User Interface (GUI). The input data comprises user identification data and project identification data. The function patentData( ) creates a patent workspace environment within a non-transitory computer-readable medium such as a data storage device. The patent workspace comprises creating a primary hierarchical directory structure specific to the received user identification data, userID and project identification data projectID and proID. The primary hierarchical directory structure, referred to herein as, patents_tab_folder ensures data isolation and structured organization of data peruser and project. The primary hierarchical directory structure, patents_tab_folder comprises one or more subfolders for managing temporary files, and storing compressed archives, extracted content, or generated images associated with the patent processing operation. For example, patent_sub_folder stores general patent-related content, patent_tab_temp stores temporary files during processing, patent_zipfiles stores uploaded compressed archives, and patent images stores any extracted or generated images from patent documents. The primary hierarchical directory structure and several subfolders create a structured environment, thereby facilitating efficient management of files, and ensuring data isolation throughout the patent processing lifecycle.

This system is designed to handle two types of input modalities. The first type of input modality involves processing a single patent number, and a second type of input modality involves processing multiple patent documents uploaded as a ZIP file.

The patentData( ) function processes either the first type or the second type of input modality based on an input modality indicator. In the first input modality, as indicated by the input modality indicator, the input data comprises a single patent number received from the interactive Graphical User Interface (GUI) submitted by the user. The patentData( ) function receives the patent number and processes within an exception handling block of code statements, such as TRY and EXCEPT block to handle potential exceptions. The received patent number is formatted to conform to a standard structure. For example, if a country code is absent, the received patent number is prepended with a country code, such as US, EP, or the like. Subsequently, a network request is initiated to fetch content from an external data source, such as a public patent database or any other patent information provider accessible via a Uniform Resource Locator (URL) constructed using the formatted patent number. For example, a URL constructed using the formatted patent number for the publicly available Google Patents™ database would be https://patents.google.com/patent/US+patentNumber. The retrieved content, typically in Hypertext Markup Language (HTML) format, is parsed to extract specific bibliographic data fields. These extracted bibliographic data fields include, but are not limited to the Patent Number, the Title of the invention, the Abstract summarizing the invention, the Issue Date or, the Application Filing Date, the name(s) of the Inventor(s), the name(s) of the Assignee(s), Classification Code(s), and priority date. The extracted Patent Number is further refined into a canonical format. The extracted bibliographic data is structured into a data object, such as a dictionary, for easy manipulation and transfer. A JSON response is generated, comprising the structured data dictionary, a successful status code, and the input modality indicator. In the event of any processing exception, an exception handling block EXCEPT, generates an error response payload, comprising an error status code and an associated error message, to provide feedback on the failure.

In the second input modality, as indicated by the input modality indicator, the input data comprises a digital file received from the interactive Graphical User Interface (GUI) submitted by the user. The digital file comprises one or more patent documents, such as a compressed archive file, such as a ZIP file containing one or more Portable Document Format (PDF) files.

The server-side function patentData( ) is configured to process the second input modality within an exception handling block of code statements such as TRY block to handle exceptions. Within this exception handling block, the function patentData( ) comprises receiving and saving the uploaded compressed archive file to a temporary folder within the created patent workspace folder patents_tab_folder. The contents of the compressed archive file are extracted into a designated temporary folder patent_tab_temp within the patent workspace folder patents_tab_folder. The function patentData( ) identifies and lists all document files, specifically PDF files, present within the extracted contents. These document files may also be referred to as patent document files. The function patentData( ) then iterates through each identified document file within a document-specific exception handling block of code statements such as a TRY block, to ensure that a failure in processing one document file does not halt the entire batch process. Within this document-specific exception handling block, text is extracted from a designated portion of the patent document file, such as the first page. If the extracted text is determined to be insufficient or absent, indicating an image-based PDF, an Optical Character Recognition (OCR) process is applied to the document file to convert image-based content into machine-readable text. The OCR process utilizes python pdf reading libraries, such as PyMuPDF, or Tesseract, or any other suitable library, to extract images and text.

A patent identifier, comprising a patent number, is extracted from the processed text. The extracted patent identifier is formatted into a URL for accessing an external patent data source.

First, the extracted patent identifier is formatted to conform to a standard structure. For example, if a country code is absent from the extracted patent identifier, the extracted patent identifier is prepended with a country code such as US, EP, or the like to create a formatted patent number formattedPatentNumber. Subsequently, a network request is initiated to fetch content from an external data source, such as a public patent database or any other patent information provider accessible via a Uniform Resource Locator (URL) constructed using the formatted patent number. For example, a URL constructed using the formatted patent number, formattedPatentNumber for the publicly available Google Patents™ database would be https://patents.google.com/patent/US+formattedPatentNumber. The retrieved content, typically in Hypertext Markup Language (HTML) format, is parsed to extract specific bibliographic data fields. These extracted bibliographic data fields include, but are not limited to, the Patent Number, the Title of the invention, the Abstract summarizing the invention, the Issue Date or alternatively, the Application Filing Date, the name(s) of the Inventor(s), the name(s) of the Assignee(s), Classification Code(s), and priority date. The extracted Patent Number is further refined into a canonical format. The extracted bibliographic data is structured into a data object, such as a dictionary, for easy manipulation and transfer.

This data object includes a status indicator processedStatus set to YES to confirm successful processing for that document and the original document filename to a variable documentName. The structured data object is then added to a list of results, results. The processed document file is subsequently moved or renamed to a designated storage location patent_sub_folder within the patent workspace for persistent storage.

If a processing exception occurs for a particular document file within its TRY block, then an exception handling, EXCEPT, processes a structure of error data with all the fields set to NA and a processedStatus set to NO, along with the original document filename set to the variable documentName. This error data is also added to the results list, allowing the batch process to continue to the next document.

Upon completion of iterating through all identified document files, a final list of structured results, comprising the data objects for all documents is compiled. A JSON response payload is then generated. This payload comprises the final list of results, processedPatentsList, a successful status code, and the input modality indicator.

In case of any processing exception, an exception handling block EXCEPT generates an error response payload, comprising an error status code and an associated error message, providing feedback on the failure.

### Patent Claims Extraction Function

The extraction and analysis of claims from patent documents is a crucial step in patent infringement or validity analysis. Processing these claims, especially from numerous patents, is time-consuming. A Patent Claims Extraction function as disclosed herein performs patent claim extraction tasks to ensure comprehensive and efficient processing of patent claims.

In one embodiment of the present disclosure, the Patent Claims Extraction function implemented as claimsExtraction( ), is configured to manage the detailed extraction and processing of patent claims based on requests received from an interactive Graphical User Interface (GUI).

The claimsExtraction( ) function first extracts meta data related to a project and a user, as received from input data submitted by a user from the interactive Graphical User Interface (GUI). This metadata includes user identification data, userID and project identification data projectID and proID, which serve as key parameters for managing the claim extraction tasks within a specific project workspace. The claimsExtraction( ) function receives a set of patent identifiers or patent numbers typically as single concatenated string, which is split into an array, listOfPatentNumbers, for preparing each individual patent for claim processing. The claimsExtraction( ) function iterates through each patent number in the listOfPatentNumbers array to perform multiple tasks. For each patent number, eachPatent, a database is queried to determine the current processing state of the claims associated with that specific patent number for the given project identifier proID. Specifically, an identifier celeryTaskId associated with a previously initiated asynchronous task related to the specific patent number for the given proID. is retrieved from the database. If the celeryTaskId identifier does not exist, or if celeryTaskId indicates that the claims are in a NotInProcess state, a new asynchronous claim extraction task is triggered, and a new unique task identifier newTaskId is obtained from the task queuing system. This identifier newTaskId is linked to each patent and project ID identified by eachPatent and proID respectively and persisted into the database.

Conversely, if an existing task identifier celeryTaskId is found, the system performs a real-time status check with the task queuing system. If the task is still active, no further action is taken to prevent redundancy. However, if the task is no longer active, for example, due to task completion or failure, then a new asynchronous claim extraction task is re-triggered with a new identifier, and the database record is updated accordingly.

Upon completion of the iteration through all patent numbers in the listOfPatentNumbers array, the claimsExtraction( ) function generates and returns a response payload to the front-end or client-side server. The response payload includes a claimsKey of ‘NA’ to indicate asynchronous processing, or a status code to indicate successful initiation, along with the proID, thereby allowing the interactive Graphical User Interface (GUI) to proceed while claim extraction tasks execute asynchronously in the background.

The claimsExtraction( ) function is implemented to improve responsiveness by performing asynchronous tasks and avoids redundancy by checking the status of existing tasks. Furthermore, the claimsExtraction( ) function ensures that new asynchronous processing task is re-triggered despite the status of the previous task. The claimsExtraction( ) function tracks the progress of each task by storing a unique task identifier in a database that is linked to a specific task patent and project.

### Claim Tree Generation and Dependency Analysis Function

Patent claims are an important part of a patent, and it is necessary to extract patent claims to understand their dependencies and structure them for further analysis. A Claim tree generation and Dependency function, as disclosed herein, connects to a database, extracts raw claim text and dependency information from an external source, and then organizes this data into a structured hierarchical format suitable for storage and subsequent analysis.

In one embodiment of the present disclosure, the Claim tree generation and Dependency function, implemented as an asynchronous function queuedClaimExtraction( ), creates a folder for extracted claims, saves the raw text, and then inserts the parsed claim structure into a database. This multi-stage approach ensures accurate claim extraction, organized storage, and prepares the data for advanced analytical workflows, all performed asynchronously to optimize resource utilization.

The asynchronous function queuedClaimExtraction( ) is configured to perform detailed claim extraction and subsequent structural parsing for a specific patent. The function operates as a background task, receiving projectID, proID, userID, and the each_patent number as input parameters. A helper function dep_indep( ) as part of this function, is configured to process raw claim dependency maps and structured claim data.

The primary execution flow of the queuedClaimExtraction( ) function begins by establishing a connection to a data storage device, such as a database. This connection process includes a retry mechanism to ensure connection resilience. Subsequently, the input patent number is cleaned and formatted into a standardized patent number format for subsequent operations.

Next, a dedicated claim data extraction and structural parsing function claimsExtractionFunction( ) is invoked, using the standardized patent number format as input. This function is configured to retrieve the raw claim text and preliminary dependency map from an external source, and to parse the structural relationships between claims. The results are received as claimsText and a dependencyMap.

If the claimsExtractionFunction( ) function is unsuccessful, claimsText is set to null. The function then prepares a failed data structure and marks the patent's claim extraction as failed in storage and subsequently terminates and returns False. Conversely, if the claimsExtractionFunction( ) function is successful, the function queuedClaimExtraction( ) creates a dedicated file system structure within the workspace, writes the claimsText to a file at a constructed path, and adds the extracted text to an in-memory dictionary for immediate use.

Data is then prepared in a format suitable for the structural database insertion module. Subsequently, the function createTreeStructure( ) is invoked, which is responsible for traversing the parsed claim structure and inserting individual claim elements into a hierarchical data table, tbl_parent_child_data and updating claim_details table.

Following the successful insertion of the claim structure into the database, the queuedClaimExtraction( ) function queries the data storage device to retrieve the newly inserted structured claim data, the results of which are stored as fetched_results.

Following the retrieval of the structured claim data from the database, the queuedClaimExtraction( ) function triggers a semantic enrichment and summary generation process by invoking the claimBreakUp_updated( ) function.

The function claimBreakUp_updated( ), is configured to process the claim element text, by utilizing a Language Learning Model (LLM), and store the derived parsers in a dedicated parser table. Upon completion of this semantic enrichment, the database cursor and connection resources are closed. The module then logs a comprehensive completion message and returns a successful indicator of True.

### Claim Extraction and Tree Generation Function

Extracting patent claims and generating a hierarchical tree structure and dependency map is an essential feature required for legal analysis. Extracting patent claims and accurately mapping dependencies of independent and dependent claims manually is a time-consuming and error-prone process, especially given the varying formats and complex nesting often found in patent documents. A Claim Extraction and Tree Generation function of the present disclosure extracts patent claims and generates a hierarchical tree structure and dependency map. The Claim Extraction and Tree Generation function fetches original patent content from an external source, such as a public patent database, based on a provided patent number. The module uses advanced HTML parsing techniques to identify individual claims and create a hierarchical relationship between claims by distinguishing independent claims from dependent ones and systematically parsing nested claim elements. The module includes specialized logic to handle various numbering formats within claims and process claims with distinct content types, such as chemical structures and the like. The module produces an output that is structured with a tree-like representation of each claim and a comprehensive map of all claim dependencies, thereby enabling detailed analysis.

In one embodiment, the Claim Extraction and Tree Generation function is implemented as claimsExtractionFunction( ) to retrieve, parse, and structure the claims of a given patent from an external data source, to generate a hierarchical claim tree and a dependency map. The function claimsExtractionFunction( ), first initializes primary data structures EntireClaimsDict, and depIndep. The EntireClaimsDict is an empty dictionary to store the structured, tree-like representation of each extracted claim, and depIndep, is another empty dictionary for recording claim dependencies. The function claimsExtractionFunction( ) processes within an exception handling block of code statements such as TRY block to handle exceptions. The function claimsExtractionFunction( ) formats the input patentNumber and constructs a standardized URL. For example, a URL constructed using the formatted patent number from a publicly available data source such as Google Patents™ database would be https://patents.google.com/patent/US+patentNumber. Subsequently, a web session is established using a common browser user-agent, and the content from the constructed URL is fetched. An HTML parsing library such as BeautifulSoup or lxml libraries for Python is used to retrieve the parsed HTML content. Subsequently, the function claimsExtractionFunction( ) performs a claim identification method. It identifies a sample top-level claim element and checks whether its child claim elements are uniquely identified by an id attribute or a num attribute. This identified method, stored as decider, determines subsequent parsing. A sub-function, getUniqueIdsList( ), is invoked to traverse the parsed HTML, to locate all top-level claim elements, and extract their unique identifiers using the decider method. A uniqueIdsList containing these identifiers, along with a numberingList from 1 to the count of unique identifiers, is generated.

Further, the module includes several helper functions to perform parsing and formatting of claim text, such as identifying common numbering pattern (e.g., (a), 1., (i)), etc., converting Arabic numbers to Roman numerals; and generating formatted list of item identifiers. These functions collectively ensure accurate recognition and representation of complex claim structures. The module then performs its core processing loop, iterating through each unique top-level claim identifier from uniqueIdsList and its corresponding claim sequence number from numberingList. For each currentClaimNumber, an inner exception handling block is initiated. The module iterates through each unique top-level claim from uniqueIdsList, locating its corresponding HTML element using uniqueId and its corresponding claim sequence number from numberingList. For each currentClaimNumber, the function processes within an exception handling block of code statements such as TRY block, to handle exceptions. For each currentClaimNumber, the main HTML element corresponding to the current claim is preprocessed and subsequently, corresponding claim dependencies are extracted and parsed into a detailed hierarchical structure. A fallback mechanism is employed if complex parsing fails.

If chemical structures are present, the HTML is preprocessed for chemistry content and parsed into an adapted tree structure. Similar process as described above is followed for Biosequences. If no chemical structures or biosequences are present, the following steps are followed.

Claim Tree Generation for Claims with No Chemical Structures

The function for claim tree generation for Claims with no Chemical Structures processes comprise multiple steps.
During the HTML preprocessing for text extraction the main claim element is converted into a string. In this conversion, all non-div tags are replaced by their plain text content to flatten presentational markup while preserving the div hierarchy. This simplified HTML string is then re-parsed for hierarchical parsing.
Subsequently, complex nested claim structure parsing takes place. During this process, a new hierarchical tree data structure is initialized to create a hierarchy for the current claim. The function iterates through each paragraph, para, or block element to generate this hierarchical tree structure. Level 1, which is a Preamble or Main limitation is constructed, in which if a para element is a simple statement with no further nested div elements, its text is extracted and added as a root or top-level child node to the hierarchical tree structure. This forms the foundational element of the claim. Level 40, a sub-limitation, is constructed, in which if a para element contains nested div elements, i.e., sub-limitations its text is extracted and added as a parent node, designated as para2 in the hierarchical tree structure. The function then iterates though each sub-element, denoted as para1, within para2 until para1 has no further nested div elements, and then its text is extracted. The extracted text is formatted by prepending the currentClaimNumber and a sequential numbering variable, numberingVariable1, and added as a child to the para2 node in the hierarchical tree structure. Deeper Levels are created if a para1 element contains further nested div elements. The function iterates through multiple levels of sub-elements, i.e., para2, para3, etc. Text from these deeper elements is extracted, checked for numbering, and formatted with a progressive hierarchical numbering scheme. These formatted nodes are added as children to their respective parents, thereby creating the complete hierarchical tree structure. Once all nested elements of a top-level claim are processed, the entire generated hierarchical tree structure tree1 is converted into JSON format, and stored in EntireClaimsDict, indexed by the currentClaimNumber.
Fallback Parsing for Complex Parsing Failures: An exception handling block, such as, EXCEPT block, handles failures in the complex parsing process. If the primary complex parsing method fails, the exception handling block triggers a fallback mechanism. This mechanism initializes a new, simpler tree structure, tree2, and extracts the first element of the claims as the root of tree2. The function then iterates through each subsequent child element, extracts its text, and formats it with numbering. The formatted text of each child element is added as a child to the root node in tree2. Upon processing of all child elements for the current claim, the entire generated hierarchical tree structure tree2 is converted into JSON format, and stored in the EntireClaimsDict, indexed by the currentClaimNumber.

### If Chemical Structures are Present, Claim HTML is Preprocessed for Chemistry Content

If chemical structure tags are present within the HTML, the Claim HTML is preprocessed for chemistry content. The main claim element is converted into a string. For each identified chemistry tag, a claim element is replaced with a simplified structure, such as <div><a> . . . </a></div>, to preserve image links while simplifying surrounding markup. Other non-div tags are replaced with temporary placeholders to treat their content as text. The modified string is then parsed into an HTML structure.

### Modified Claim Structure is Parsed:

A new tree structure is initialized, and content parts are extracted from the preprocessed claim, distinguishing introductory text from itemized or numbered elements. Elements are added to the hierarchical tree structure, assigning numbering using currentClaimNumber.numberingVariable1. The generated hierarchical tree structure is converted to JSON format and stored in the EntireClaimsDict indexed by currentClaimNumber. The generated Tree which is converted to JSON is stored in EntireClaimsDict indexed by the currentClaimNumber.

An outer exception handling block for a specific claim ensures that if any error occurs during its processing, the raw text content of the main claim element is stored in EntireClaimsDict as a fallback.

The iteration through each top-level claim concludes. Upon completion of iterating through all top-level claims, the function returns the EntireClaimsDict, comprising the structured claims data, and the depIndep dictionary, containing the dependency information.

Any errors during specific claim processing result in storing the raw claim text as a fallback, and after all the claims are processed, the method returns the structured claims dictionary and dependency map, or None for both, if a global error occurs.

A global exception handling block of code statements such as TRY block handles exceptions and in the event of a global exception, the function returns None for both EntireClaimsDict and depIndep indicating a complete failure.

Inserting Claims into Database

After the extraction and parsing of patent claims into a structured, hierarchical tree structure, it is essential to store such complex hierarchical data in a robust database. The Claims Database function of the present disclosure comprises of a series of robust and coordinated methods to insert and manage the hierarchical relationships of parsed patent claims within a database, ensuring data integrity, traceability, and efficient retrieval for subsequent analysis.

FIG. 40b illustrates a database schema 4000b showing technical relationships between at least a portion of the database tables for the functionality related to Patent Load Module 3903 of the present disclosure. The database schema 4000b illustrates patent_details, claim_details, tbl_parent_child_data, and data flow diagrams through the interactions between the functions insertNewClaim( ), insertParentData( ), and createTreeStructure( ).

a) Master Claim Record Insertion insertNewClaim( )

The function insertNewClaim( ) is configured to create a master record for a specific patent within a given project and user context within a database table claim_details. The function insertNewClaim( ) receives a projectID, patentNumber, userID, and a database connection and cursor as input.

Initialization: The function insertNewClaim( ) initializes by obtaining the current date and time and sets creator identifier createdBy to the userID. Further, variables for database fields claims_key and claims_text are set to empty strings, which serve as a placeholder for storing a short key or the full original claim text.

Retrieve master record and create a new claim set record: The function insertNewClaim( ), then queries the patent_details table to retrieve the master id for the specific patent, storing this as patentDetailsID, which serves as a foreign key to link the claim data back to the original patent. A new row is then inserted into the claim_details table, and a record is created. This record includes fk_patent_details_id, projectID, patentNumber, and initialized claims_key and claims_text fields, created_on, and created_by. The record insertion is committed to the database.

The auto-generated primary key id of the newly inserted row in the claim_details table is retrieved and stored as claim_details_lastID. The function then updates the corresponding master record in the patent_details table, setting its status to 2 representing Claims Processing Started, and process status set to 1 representing Processing In Progress. This update transaction is committed, and the function returns the claim_details_lastID of the newly created record in the claim_details table.

b) Hierarchical Claim Element Insertion insertParentData( )

The function insertParentData( ), is configured to insert a single claim element from the parsed hierarchical claim tree into a parent-child database table tbl_parent_child_data. This function receives a parent node identifier, parentRecordID, elementText, projectID, claimSetRecordID, a sequenceNumber, userID, and a database connection and cursor as input. The input parameters comprise the parent node identifier, parentRecordID which a unique identifier referencing a parent element already stored in the same table, or a special value, such as ‘#’ indicating a root node for a particular claim structure, elementText the text content of the claim element, projectID project identifier, claimSetRecordID the identifier of the master claim set record claim_details record to which this element belongs, and sequenceNumber an ordinal index.

Insertion of claim element data: The function insertParentData( ), initializes a variable, mainContentOfElement for the main content of the element as an empty string. The input parameter, elementText is cleaned and parsed. The parsing involves searching for predefined patterns or delimiters and extracting any numbered prefix, and its corresponding sequence to derive the actual claim text which is stored as the mainContentOfElement. String manipulation is performed on the mainContentOfElement to escape characters, such as single quotes, that could interfere with database insertion syntax. A new row is inserted into the tbl_parent_child_data table. This new row stores, populates fields corresponding to the foreign key referencing the claim set record, i.e., the field fk_claim_details_id is set to claimSetRecordID, the parent identifier parentID is set to parentRecordID, the actual claim text as mainContentOfElement, the parsed sequence set, projectID, and userID. This insertion transaction is committed. The auto-generated primary key id of the newly inserted row in tbl_parent_child_data is retrieved and stored as lastInsertedElementID. The method returns the retrieved primary key identifier lastInsertedElementID.

c) Store Hierarchical Claim Tree Structure createTreeStructure( )

The function createTreeStructure( ), is configured to store the hierarchical claim data generated by upstream extraction processes—Patent Claims Extraction Module, and the Claim tree generation and Dependency analysis Module into a structured database. This module receives the parsed claim tree and dependencies extractedApiData and userID as its primary inputs.

The function createTreeStructure( ), establishes a connection with the data storage device (e.g., a relational database) and creates a cursor for executing database operations. It retrieves the projectID from the extractedApiData and checks its status. If the status indicates a failure during the claim extraction process, as indicated by a status code, then the function retrieves the patent number, and updates the corresponding record in the patent_details. The status is set to 3 indicating Claims Processing Failed, and the process status is set to 1 indicating ‘Processing Attempted/Completed’. This update transaction is committed, and the method terminates and returns False.

However, if the extractedApiData indicates successful claim extraction with a status of 7000, the function iterates through each patentNumber and its associated structured claimSetObject within the extractedApiData. This structure assumes extractedApiData[‘claims’] which is a dictionary wherein the keys are patent numbers and values are the parsed claim set objects.

For each patentNumber and claimSetObject in the iteration—
A master record for claims of patentNumber is first created in the database. The function invokes insertNewClaim( ) by passing the projectID, patentNumber, userID, the database connection and cursor. The returned primary key identifier of the newly created claim set record, current_claim_set_record_ID is stored, serving as a foreign key for all the claim elements belonging to this specific claim set.
The main functionality of the database population involves traversing and storing the claim hierarchy represented by the claimSetObject, which is typically a JSON-like tree where keys represent claim text segments and values represent nested children. The method iterates through top-level keys, topLevelKey and corresponding values topLevelValue within the claimSetObject. If the topLevelValue is a dictionary, it signifies that this element is a parent node within the claim structure, i.e. a claim preamble or a high-level limitation, having sub-elements or children. A parent database identifier is set to a special value, such as ‘#’ indicating it's a root element of the claim structure for the specific patent. The elementText is extracted from the firstLevelElementText, and an insertParentData( ) function is called to insert this first-level element into a tbl_parent_child_data table. This call passes the parent database identifier, the elementText, projectID, current_claim_set_record_ID, a sequence index, and the database connection and userID. The returned database ID for this newly inserted node, lastIDLevel1 is then used as the parent identifier for any subsequent nested elements.
If a first-level element is a data structure and indicates further nesting, a recursive sub-method, process_children( ), is configured to traverse these deeply nested data structures. For each identified child element, whether simple text or a nested component, insertParentData( ) is called, passing the appropriate parentElementDB_ID, the child's elementText, projectID, current_claim_set_record_ID, and relevant sequence information, to accurately record each claim tree node with its parentage in tbl_parent_child_data.
Conversely, if the topLevelValue is simple text, and not a dictionary, it implies that the claim itself is a single flat statement without further parsed hierarchical children.
After processing and inserting all the claim elements for the current patent, the module moves to the next patent available in extractedApiData[‘claims’]. Once all the patents in the extractedApiData[‘claims’] are processed, database resources are closed, a success message is logged, and the method returns True along with the current_claim_set_record_ID corresponding to the last patent processed in the iteration.

The steps described in the module ensure that the detailed, hierarchical patent claim tree including individual textual components and inter-element relationships, is accurately stored within a relational database schema, effectively linking the structure claim data back to the patent record and the specific processing instance, making it readily available for subsequent analysis, visualization, and reporting.

Parsing Claim Elements and Inserting into Database

In one embodiment of the present disclosure the, Claim elements Parsing function involves semantically summarizing claim elements into parsers by leveraging generative artificial intelligence (AI) or large language models (LLMs) to convert complex text into simple terms. This function receives structured claim element data from a database, categorizes elements based on their characteristics i.e. short preambles, or standard limitations, and dynamically formulates prompts for an LLM to generate rephrased or summarized text. This function efficiently processes numerous claim elements concurrently by submitting them to the LLM service in parallel. The LLM-generated output undergoes post-processing, including text cleaning and formatting, before being stored in a dedicated database table for summary data. This robust process enhances the utility of individual claim elements for advanced semantic search and analysis, seamlessly integrating AI capabilities into a structured data management workflow.

The Claim Element Parsing function of the present disclosure implemented as claimBreakUp_updated( ), is configured to process the textual content of individual claim elements retrieved from a data storage device. This function utilizes a generative artificial intelligence (AI) or large language model (LLM) models, to semantically summarize representations of this text, which are then stored in a summary data table within the data storage device. This function receives structured database query results, databaseResults, typically comprising individual claim elements with their text content content, database identifier id, and parent identifier parent_id. This function also receives projectID, userID, and an optionalPatentNumber for status tracking.

Initialization: The entire function operates within an exception handling block of code statements such as TRY block to handle exceptions. Upon initiation, this function initializes a client interface for interacting with an external generative AI or LLM service provider, such as one configured to utilize a Large Language Model. Data structure variables such as elements_list, ids_list, parent_ids_list, and masterLst_for_DB_insertion are initialized to hold intermediate processing results.

Data preparation of database results: The function begins by preparing data from the input database query results. This function iterates through each row res in databaseResults, which contains the content, identifier, and parent identifier for a claim element. For each row, the content content, ID id, and parent ID parent_id, are extracted and populated into elements_list, ids_list, and parent_ids_list, respectively. Unique parent identifiers are then identified and sorted into a unique_parent_ids_list. A data structure such as Pandas DataFrame, df, is constructed from these lists, to serve as a structured representation for lookup and manipulation, with columns related to ID, Content, and ParentID. An additional list, parsed_ids, is initialized to track the original database identifiers of elements processed by the LLM.

LLM processing logic defined: A sub-function process_claim_element(element_database_id), manages the interaction with the generative AI or LLM service for processing a single claim element. In this function, the claim_text corresponding to the input element_database_id is retrieved from the DataFrame, df Conditional logic is applied to formulate a tailored text prompt for the LLM.
Application of Condition 1 for a short Preamble: If an element_database_id is present in unique_parent_ids, indicating that it is a structural parent and if its claim_text is below a predetermined length threshold, e.g., less than 15 words, it is identified as a potential claim preamble. For such preambles, child elements linked to this preamble are retrieved from df A specific prompt is constructed instructing the LLM to rewrite the preamble text to include high-level functional context based on its claim_elements_text, with an objective to improve its descriptive relevance for semantic search. The element ID element_database_id and text claim_text are saved in parsed_ids.
Application of Condition 2 for a short text: If the claim_text is determined to be short, for example, if the text has 10 words or fewer, the function may bypass LLM processing and return the element ID with a None value, considering it insufficient for meaningful processing.
Application of Condition 3 for a Standard limitation: For all the other claim elements or standard limitations, a different prompt is constructed. This prompt instructs the LLM to generate, rephrase, and rearrange the given claim_text into meaningful sentences or points, explicitly requesting output in a point-based format and emphasizing the retention of technical essence. The element ID element_database_id and text claim_text are saved in parsed_id.

Following the prompt construction for the above three conditions, the LLM interaction occurs within an exception handling block of code statements, such as TRY block, to handle exceptions. The formulated text prompt final_prompt is transmitted to the LLM service via its API, for example, generative AI chat completion endpoint, and a generated response text is received from LLM. The function process_claim_element(element_database_id), returns the element_database_id( ) and the generated response content llm_content of the LLM. An exception handling block, such as CATCH block, handles API call failures, where an error is logged, and None is returned for the LLM content.

Process all claim elements concurrently using LLM: To optimize processing throughput, the method utilizes a concurrent execution framework, such as a ThreadPoolExecutor, which is configured with a predetermined number of worker threads (e.g., 50 workers). The process_claim_element function is submitted for execution within the concurrent framework for each element identifier element_id present in the ID column of the DataFrame df, enabling multiple and parallel interactions with the LLM service. The results from these concurrent tasks are collected as complete, storing pairs of element_id and llm_content, in a list parsed_output_from_llm.

Post processing of LLM outputs: The collected LLM outputs collected undergo post-processing. The parsed_output_from_llm list is sorted to the corresponding original claim structure. The function iterates through the original element information original_element_info and its corresponding LLM output. For each pairing, a base information list base_info_for_db is created, comprising the original element database identifier, projectID, and userID. The LLM response string llm_response_string is extracted and cleaned. For example, hyphens are replaced with spaces, and other formatting techniques defined including, but not limited to, the LLM response string segmented into potential sentences or points by splitting it based on newline characters. Each resulting segment is further cleaned as per defined formatting techniques. Each cleaned up sentence cleaned_sentence is then appended to a copy of base_info_for_db and this db_row_data is added to masterLst_for_DB_insertion for database insertion.

Insert processed data into database: Subsequently, the processed data is inserted into the database. A new database connection and cursors are established, with the autocommit function enabled. A Structured Query Language (SQL) INSERT query is defined for a summary data table tbl_claim_summary, specifying columns such as fk_parent_child_id, project_id, created_by, and summary_text. The INSERT query is executed using a batch execution method executemany( ) with masterLst_for_DB_insertion, efficiently inserting all generated summary sentences into the database, linking each record back to its specific claim element.

Update patent status: If the optionalPatentNumber is provided as input, a final status update is performed on the corresponding patent record in the patent_details table. An SQL UPDATE query sets a designated status field, such as ‘1’, indicating ‘Processing Complete’ or similar for the record matching with the corresponding project ID, user ID, and patent number.

Close database connections: The database cursor and connection resources are closed. A completion message is logged, and the method returns True to indicate success. A global exception handling block, such as CATCH ANY GLOBAL EXCEPTION within the TRY block ensures that in the event of an unhandled error, the patent status in the patent_details table is updated to ‘1’ to indicate an attempted or finished process. Subsequently, the database connection is closed, the error is logged, and False is returned. This method effectively leverages external generative AI and LLM capabilities to enhance the textual content of extracted claim elements, transforming them into a desirable format for advanced search and analysis, and stores the data into a relational database.

### Creating or Editing Parsed Claim Elements

FIG. 40c illustrates an interactive Graphical User Interface (GUI) 4000c for users to create or edit parsed elements, in accordance with the present disclosure. In one embodiment of the present disclosure, users can create or parse claim elements. An interactive Graphical User Interface (GUI) 4000c is configured to provide user interaction and backend processing functionality to create or edit parsed elements. This interactive Graphical User Interface (GUI) 4000c enables users to interactively create, edit, or manage either user-generated or system-generated parsed claim elements 4021 of patent claims, within a collaborative user environment. An integrated frontend and backend architecture ensures a seamless user experience along with backend processing and database updates.

In complex analytical workflows, particularly related to litigation, users quite often need to add, modify, or refine interpretations of data. For instance, following these step of the Claim elements Parsing function as described previously, the auto-parsed patent claims are further modified by human experts. This modification may involve providing additional context, correcting machine interpretations, or adding their own high-level parsed elements. The Create and Edit Parse User Interface 4000c as illustrated in FIG. 40c offers an interactive Graphical User Interface (GUI) for users to manage parsed content while ensuring seamless backend processing.

The Create and Edit Parse User Interface 4000c of the present disclosure provides a user-friendly frontend interface for users to interactively create and edit parsed elements or summaries associated patent claims. The Create and Edit Parse User Interface enables users to add new summary text or edit existing parsed elements 4021 via interactive input fields and buttons. All user modifications are securely transmitted to the backend server using asynchronous requests and encoded data. The backend server validates and processes these requests, performing database insertions or updates for the summary text, and subsequently retrieves the updated information to refresh the frontend display in real-time. This dynamic interaction ensures that user input is immediately reflected, maintaining data accuracy and enhancing the user's ability to refine and manage analytical content effectively and seamlessly within a collaborative workspace.

### Creating Parsed Claim Element

### Frontend Operation: Creating a Parse

A frontend function, addSummBtnFun(rowID), is configured to create new summary text. When a user adds a summary for a particular element identified by rowID, the frontend function addSummBtnFun(rowID) retrieves the value from a designated summary text input field inputTextID_rowID.

If the entered summaryText is not empty, both the summaryText and the rowID are encoded using Base64 or the like for transmission. An AJAX POST request common/addSummaryText is initiated and encoded data is transmitted for backend processing.

Upon a successful response from the backend, the JSON response is parsed. If the response.status is 6000 indicating success, the frontend dynamically updates the display. An empty <ul> HTML string is initialized. For each summary item returned in response.result, the function extracts the summary text and its ID. A <li> HTML block is then appended for each item, comprising of a span element displaying the summary text, configured to be clickable to enable an edit mode, a corresponding edit input area, and a delete button for removing the summary.

After iterating through all summary items, the <ul> block is closed, and the HTML content of the designated container dRSummaryList_rowID is updated with this new list. Subsequently, the input field inputTextID_rowID is cleared, along with the corresponding hidden fields, thereby providing immediate visual feedback to the user. Modal alerts are displayed to the user with an appropriate title and error message for all user validations that are not successful.

### Backend Operation: Creating a Parse

The backend functionality for creating a parse is handled by the addSummaryText( ) function, which acts as an API endpoint, and a helper addSummaryText(id, summaryText, projectID, userID) function for database interaction. When an AJAX POST request is received at the addSummaryText( ) endpoint, it first decodes the claim summary ID, from ‘id’ POST data, and the new summary text, from ‘summaryText’ POST data, from Base64. It then invokes the internal addSummaryText( ) helper function, passing the decoded id, summaryText, along with workspace ID, and user ID.

A helper function addSummaryTexti( ), sanitizes the input summaryText to prevent SQL injection or other harmful characters. It then executes an SQL INSERT query into the tbl_claim_summary table, populating fields such as fk_parent_child_id, summary_text, project_id, and created_by. After insertion, it executes an SQL SELECT query to retrieve all the claim summaries associated with the given fk_parent_child_id, project_id, and created_by (user ID), ensuring that the frontend receives the most up-to-date list. This result set (list of summary entries) is returned by this process.

Back at the API endpoint, if the result from the helper function is not empty, a JSON response with status OK and an updated summary data is returned to the frontend. Otherwise, a JSON response with status BAD_REQUEST and an empty result is returned. Notably, even in the case of certain backend failures, a status 6000 might be returned with an empty result, indicating that the request was processed but yielded no data.

### Editing Parsed Claim Element

### Frontend Operation: Editing a Parse

A frontend function updateTextSummary(ids, updateText, ptNumber, status, rowID), is configured to enable users to edit existing summary text through the interactive Graphical User Interface (GUI). When a user modifies a summary, the ids such as the parsed claim ID pcid and an element ID id, the textual content updateText, patent number ptNumber, status, and rowID, are obtained. Fields such as ids and ptNumber are encoded using Base64. The updateText undergoes a robust encoding process. The updateText is first encoded with UTF-8, then escaped, and finally encoded with Base64. An AJAX POST request common/updateParsedElement is performed for backend processing by sending these encoded data fields.

Upon a successful backend response, the JSON response is parsed. If the response status is 6000, indicating success, an empty <ul> HTML block is initialized. The system then iterates through each summary item in response.result, extracting summary text sumTxt and summary ID id. For each item, a <li> HTML element is appended, comprising a span element displaying the summary text, clickable control to enable edit mode, hidden edit controls, which include a Save button configured to call updateParsedElement( ) upon click, a Cancel button configured to call a disableEdit( ) function, and Delete button configured to call deleteAddedSummBtnFun( ) function.

After the loop, the <ul> block is closed, and the HTML container dRSummaryList_rowID is updated with the new content, ensuring that the user sees the refreshed list of summaries immediately.

### Backend Operation: Editing a Parse

The backend functionality for editing parsed elements is managed by updateParsedElement( ) API and a supporting updateParsedElement(id, pcid, workSpaceID, userID, updateText, status, ptNumber) helper function.

When an AJAX request arrives at the updateParsedElement( ) API, it decodes the incoming data, which includes ids, updateText, status, and ptNumber from their respective encodings (Base64 or UTF-8 escaped then Base64). It then splits the ids string to extract the parsed claim ID pcid and element ID id. These decoded values, along with workSpaceID, userID, updateText, userID, and ptNumber, are passed to the internal updateParsedElement( ) helper function.

A helper updateParsedElement( ) function constructs and executes an SQL UPDATE query to modify the summary_text in the tbl_claim_summary table. The WHERE clause ensures that the update is specific to the record matching the provided id,fk_parent_child_id (pcid), project_id (workSpaceID), and created_by (userID). Upon completion of the update, it fetches the updated records from tbl_claim_summary for the specific fk_parent_child_id, project_id, and created_by, similar to the add operation.

If a status is provided, the helper function updateParsedElement( ) also calls the updateParsesStatus(projectId, pcId, userID, patentNumber) function. This function further ensures data consistency across the system. It fetches a list of analyzed_document_list records for the given projectID and userID where parsedStatus is ‘1’. It then iterates through these documents, decodes their selectedClaimParent JSON array, and checks if any entry within this array contains a key matching the patentNumber. If a match is found, and a checksummaryIdExists confirms that the pcId is relevant to the found summary ID list, the parsedStatus for that specific analyzed_document_list record is set to ‘0’, effectively marking it for re-evaluation or as no longer fully parsed in the current context, perhaps to trigger re-analysis if a dependency changes. Finally, the helper function updateParsedElement returns the fetched updated records.

Back at the API endpoint, if the helper method indicates success, a JSON response with status 6000 and the updated result is returned. Otherwise, a status 6000 with an empty result is returned, indicating that the request was processed but no specific data was returned.

The integrated frontend and backend processes enable auto-parsing of patent claims along with human intervention providing a comprehensive and seamless user experience.

### Server-Side Processing for Concept Extraction

In some embodiments, server-side processing automates concept extraction process from raw textual content of claim elements. A server-side function extractAndCategorizeConcepts(claimText, patentNumber, patentClass) is configured to receive input parameters, such as, but not limited to, claim text claimText, patent number patentNumber and classification code patentClass of the patent.

Upon receiving the input parameters, the function first constructs a valid Uniform Resource Locator (URL) for extracting details of the patent, using the input patent number, from a public patent database, such as Google Patents™. The function then directs the network interface to transmit a request to the server at the constructed URL and receive the corresponding patent webpage as an HTML document. The HTML document is parsed to extract textual content from predefined sections of the patent HTML document, such as, but not limited to, Title, Abstract, and Description. The HTML document is parsed by utilizing libraries such as, but not limited to, BeautifulSoup, and the extracted textual content is combined into a text string fullSpecificationText which is stored in memory for validation.

As next step, the function implements AI-based concept extraction tasks. The function constructs one or more detailed prompts designed for a large language model (LLM) API. The prompt comprises the input parameters such as, claimText, and the patentClass, instructing the LLM API to identify all relevant keywords. The network interface is used to transmit this prompt to the remote LLM API. The function receives response from the LLM API, which is formatted as a single, comma-separated string of keywords. A parsing function within this module splits the response string by the comma delimiter to generate an initialKeywords list, which is stored in memory.

The function performs sequence of steps to filter and refine the concepts. The function first performs a validation check, by iterating through each keyword in the initialKeywords list and performing a case-insensitive search for that keyword within the fullSpecificationText, and adding contextually relevant keyword to validatedKeywords. The resulting validatedKeywords list is then formatted to remove subordinate terms, thereby creating a list of more precise and complete technical concepts. The filtered keywords are then categorized in the order of importance. The final step involves linguistic analysis, by utilizing a Natural Language Processing (NLP) library, such as the Natural Language Toolkit (NLTK), to perform Part-of-Speech (POS) tagging on each concept. The function compares the resulting POS tags against a predefined set of words that are unlikely to be the core concepts, which are removed, leaving a final, clean list of core technical concepts. Finally, all the concepts are categorized, and the function assembles three resulting lists, finalTitleConcepts, finalAbstractConcepts, and finalDescriptionConcepts which is converted into a structured data dictionary. The data dictionary is converted into a JSON formatted string that could be displayed on the interactive Graphical User Interface (GUI).

### Creating or Editing Synonyms

FIG. 40d illustrates an interactive Graphical User Interface (GUI) 4000d for users to create or edit synonyms 4031, in accordance with the present disclosure.

### Frontend Operation: Editing a Synonym

A frontend function getSyn( ) is configured to dynamically fetch and display relevant synonyms in a modal window. The function is triggered by a user action, such as clicking on a concept. Upon initiation, the function gathers critical context data from the current session, including the project identifier id, patent number, the selected document version, and the currently active analysis profile type. It also determines if a temporary, unsaved profile is in use by checking local storage.

An asynchronous POST request is prepared for a server-side API endpoint. The request payload is constructed to include the concept keyword, the element ID, and the encoded context data, comprising project ID, patent number, profile type, selected version. To ensure system responsiveness, a timeout mechanism is implemented using an AbortController, which automatically cancels the request if a response is not received within the specified duration.

While the request is pending, the interactive Graphical User Interface (GUI) is updated to provide user feedback. Any existing modal windows are hidden, and a visual loading indicator is displayed to signify that data is being fetched.

Upon receiving a successful response from the server, the timeout is cleared. The response, which contains a JSON object, is parsed. If the status is 6000, the loading indicator is hidden. The HTML content returned in the result field of the JSON response is dynamically injected into the body of a modal window. This modal is then displayed on the screen, with its position being calculated to appear adjacent to the user-activated element for contextual relevance. On the contrary, if the response status is not 6000, an error alert is displayed to the user, presenting a message provided by the server.

If the request fails due to a network error or the predefined timeout, the loading indicator is hidden, and a timeout or error message is rendered within the modal body to inform the user of the failure.

### Backend Operation: Editing a Synonym

The server-side method comprises of two primary functions. One of the functions retrieves a list of previously saved synonyms, and another function performs persistence of a new synonym selection to a database.

### A. Synonym Retrieval Process

The process of retrieving previously saved synonyms is implemented by a function getSynonymsList( ), which is configured to retrieve synonyms from an external source and compare with stored user selections to generate a pre-populated list for the user. The server receives an AJAX request from the client, authenticates the user based on their session and extracts details from the POST data, comprising of concept, projectID, patentNo, profileType, and selectedVersion, which is thereafter decoded using Base64.

The function invokes an external API with the concept and an associated classCode to get a comprehensive list of synonyms. Concurrently, it queries its internal database to retrieve synonyms already saved earlier for the given concept within the context of the current project, version, and profile. Based on the profileType, a specific database table is queried. For example, temporary selections are fetched from temp_profile_save, while permanent selections are retrieved from tables like analyzed_document_list or tbl_claim_concept_syonyms.

The function iterates through the list of synonyms received from the external API and checks if that synonym exists in the list of previously saved synonymsretrieved from the internal database. Based on this comparison, it generates an HTML string containing a list of checkboxes. A checkbox is rendered as checked if the corresponding synonym was previously saved by the user.

The function generates a HTML string that is converted into a JSON object with a status of OK, and is transmitted back to the client-side to populate the modal window. If no synonyms are found from the external API, a response indicating it is returned.

### B. Synonym Persistence Process

This process of saving or updating selections of a user for a concept and its synonyms in the database is implemented by functions as addChildSynonymInClaim( ) and addSynonymInClaim (jArray, userID, projectID, patentNo, versionID). These functions receive an AJAX request containing the selections made by a user, comprising of the primary concept, conceptCheckBox and the list of selected synonyms, checkBoxList. These functions perform operations such as merging these lists, removing any duplicates, and structuring the data into a predefined JSON format. This JSON object comprises of a list of concepts and a corresponding list of selected synonyms.

The function performs update or insert operations into the database table tbl_claim_concept_syonyms using the projectID, userID, and patentNumber as keys. To perform an update operation, if a record exists, the function retrieves the existing JSON data of synonyms, decodes it, and merges the new user selections with the old data. If new concept is being added, it is appended to the list, and the modified JSON object is then re-encoded and an UPDATE query is executed to save the changes.

To perform an insert operation, if no record exists, the function executes an INSERT query to create a new row in the database, storing the newly structured JSON object containing the concept and its synonyms. During insertion, a color code is assigned with the concept for subsequent highlighting in the interactive Graphical User Interface (GUI).

After the database transaction is complete, a JSON response is sent back to the client with a status of OK and a message confirming that the synonyms were added successfully or updated successfully. The response also includes the final list of saved synonyms for interactive Graphical User Interface (GUI) updates.

### Server-Side Processing for Synonym Generation

In some embodiments, server-side processing automates synonym generation process from keywords and patent classification codes. A server-side function Find_Synonyms(keyword, patentClass)) is configured to receive input parameters, such as, but not limited to, keyword keyword, and patent classification code patentClass. Upon receipt, the function validates the input keyword and proceeds further with AI-based processing of the keyword, if it is a valid input. The function constructs a detailed prompt that instructs a Large Language Model API to find synonyms for the input keyword keyword, and patent classification code patentClass.

The function is configured to execute a loop, transmitting the constructed prompt to the LLM API via the network interface a predefined number of times. For each execution, a creativity parameter, such as, but not limited to, temperature is set to a relatively higher value to generate varied responses and obtain a divers set of synonyms.

After each iteration, the function receives the comma-separated string response, parses it into a list of individual synonym candidates, and appends them to a master raw_synonym_results list stored in memory. A timeout mechanism is implemented to monitor the execution time of this iterative loop. If the total time exceeds a predefined threshold, the process is aborted, and an error state is triggered to ensure system responsiveness.

Once all the iterations are completed, the raw_synonym_results is normalized and filtered. This includes removing duplicate entries from the list and then utilizing a Natural Language Processing (NLP) library to perform lemmatization. For each synonym in the list that consists of a single word, a lemmatizer algorithm converts the word's part of speech to reduce the word to its canonical or root form. For example, connecting, or connected become connect. The original word in the list is replaced by its lemma, or the root work. This step normalizes grammatical variations of the same concept. Another step of de-duplication is applied to the list. Subsequently, the functions perform a heuristic clean up, by iterating through the list to remove entries that are unlikely to be valid synonyms, convert all synonyms to lower case and other custom-defined formatting.

The function constructs a final dictionary data structure, populates it with the list of synonyms, and adds a success status code. The final dictionary is then serialized into a JSON formatted string, which is returned to the interactive Graphical User Interface (GUI).

### Automated Document Processing Module

### A Workflow Process of an Automated Document Processing Module of a System for Patent Claim Analysis and Evidence Identification, Extraction, Analysis, and Charting.

In specialized applications such as patent evidence analysis involved in a patent litigation process, the ability to efficiently and accurately process a wide variety of document types is essential. The disclosed system, method and user display for patent claim analysis and evidence identification, extraction, analysis, and charting 3900 is configured to receive and process a wide variety of evidentiary materials. These materials may include, but are not limited to, patent documents, product manuals, email communications, legal transcripts, and various other forms of structured or unstructured data relevant to intellectual property litigation analysis. Due to the unique internal structure characteristic of each document type, the system implements category-specific processing, extraction, and parsing operations. This tailored approach is critical for accurate and comprehensive extraction of content subsequent analysis. These documents exist in a variety of formats, including but not limited to text-based Portable Document Format (PDF), scanned image-based Portable Document Format (PDF), and word processing document formats (e.g., Microsoft Word®). The inherent diversity of these formats presents significant technical challenges for reliable automated processing. Furthermore, the ever-increasing volume of such documents underscores the critical need for automated solutions capable of efficiently and accurately handling diverse content on a large scale.

Conventional document processing methods encounter challenges in processing varied document formats, resulting in inaccurate data extraction, or missed critical information. Additional technical challenges include assessing machine readability of the document, accurately classifying document types automatically, reliably extracting diverse data such as text, figures, and tables, correcting errors in extracted content, and transforming disparate content into a semantically searchable format. Moreover, the manual classification of these documents into specific categories, and the extraction of pertinent content for patent evidence analysis is a labor-intensive, time-consuming, and error-prone process. Accordingly, a need exists for a robust and adaptive automated document processing method capable of automatically processing a wide variety of document categories, accurately identifying and classifying document, ensuring high accuracy in data extraction and preparing content for advanced analytical workflows, thereby substantially reducing the need for manual review.

### Workflow Process of an Automated Document Processing Module

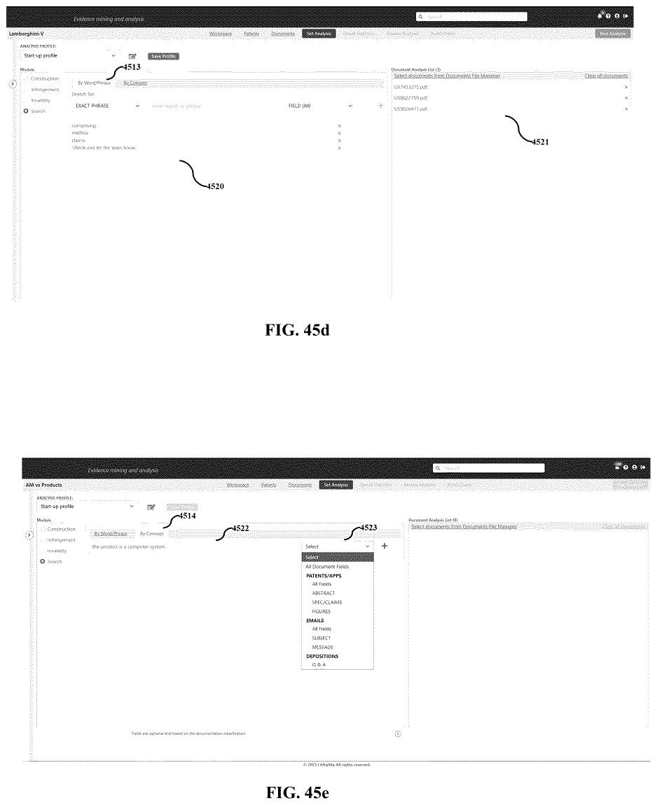

FIG. 41 illustrates a workflow process 4100 of automated Document Processing Module 3904 of a system, method and user displays for patent claim analysis and evidence identification, extraction, analysis, and charting 3900 according to various aspects of the present disclosure. The automated Document Processing Module 3904 of the present disclosure related to the system, method and user displays for patent claim analysis and evidence identification, extraction, analysis, and charting 3900, is configured to process a plurality of document categories by performing document verification, document classification, content extraction, parsing and storing content in a semantically searchable format.

The workflow process 4100 of the automated Document Processing Module 3904 of the present disclosure receives plurality of electronic documents as input document 4101, including, but not limited to, text-based Portable Document Format (PDF) files, scanned image-based PDF files, and word processing document formats. Upon receipt of the documents, the system first verifies the machine readability of each document as part of Document Verification 4102, and then employs a generative Artificial Intelligence model, such as a Large Language Model (LLM) or a large multimodal model (LMM) to accurately determine and classify the category of the document using Document Classification LLM 4105. The document categories may include, without limitation, product brochures, product specifications, product manuals, scientific literature, patent grants, patent applications, emails, and transcripts. Based on the classified document category from Document Classification LLM 4105, the system executes a specialized category-specific workflow process. These workflows leverage a combination of various Application Programming Interfaces (APIs), such as Document Processing API 4106, heuristic algorithms, heuristic formatting 4109 techniques, or heuristic classification 4108 models, Natural Language Processing (NLP) models, object detection models 4107, and generative Artificial Intelligence models, such as a Large Language Model (LLM) or a large multimodal model (LMM) to accurately extract pertinent data, including textual content, embedded figures, tabular data, and citations from the various document structures. Extracted textual content undergoes a series of post-processing operations, including formatting, automated error-correction, and spell-checking. The formatted text is then transformed into high-dimensional numerical vector embeddings and stored in a searchable database to enable advanced semantic search capabilities. Extracted figures and tables are processed, which may involve using Optical Character Recognition (OCR) for image-based elements, and thereafter stored in a segregated manner within a digital asset management system. This multi-step approach ensures high accuracy in data extraction, resilient handling of the complexities of diverse document structures, and efficiently converts raw content into a semantically enriched format suitable for subsequent search and analysis.

The automated document processing workflow as illustrated in FIG. 41 describes the steps performed as part of the workflow process 4100 of the automated Document Processing Module 3904. The workflow process 4100 of the automated Document Processing Module 3904 commences with the receipt of documents by the processing module. Upon receipt of the documents, the module first performs document verification 4102 procedure to determine the characteristics of the document such as its readability, integrity. For example, document verification 4102 determines if the document cannot be processed because the document is corrupted 4103, or if the document is password protected 4104. This document verification 4102 procedure is performed using various document processing libraries, including but not limited to, FITZ, or PyMuPDF library, which is a python library for processing PDF documents. Subsequent to determination that the document is machine readable, the system proceeds to determine and classify the document. Document classification is performed using generative Artificial Intelligence (AI) models, such as a Large Language Model (LLM) or a large multimodal model (LMM). Currently, various large language models, for example, OpenAI® ChatGPT, Microsoft® Bing Chat, Google® Bard, Google® Gemini, and Meta® LLAMA are commercially available. The selected LLM analyzes the content of the document to accurately ascertain the category of the document category such as brochures, manuals, product specifications, transcripts, granted patents, patent applications, or emails.

The automated Document Processing Module 3904 executes a specialized category-specific workflow process as per the document category, to extract, parse and format the content therein. The extracted, parsed and formatted content is then converted to high-dimensional numerical vector embeddings to allow semantic search and analyses, which is further stored in a database.

### Document Processing Workflow for Brochures, Manuals, and Product Specifications

FIG. 41a illustrates a workflow process of a document category of brochure, manuals or product specifications 4100a of the automated document processing load module of a system, method and user displays for patent claim analysis and evidence identification, extraction, analysis, and charting 3900 according to various aspects of the present disclosure.

In one embodiment of the Automated Document Processing Module 3904 of the present disclosure, a specific document processing workflow 4100a is utilized for documents categories as brochures, manuals, or product specifications is further illustrated in FIG. 41a. This workflow employs a PDF document processing Application Programming Interface (API) 4112 such as but not limited to Adobe® PDF services API, hereinafter referred to as Adobe® API to process the input documents 4111 that are generally in a Portable Document Format (PDF). The Document Processing API 4112 is configured to read, process, and extract information from the input document 4111 into a predefined structured format. This process extracts both textual information and any embedded figures or tables present withing the document.

Extracted textual content is further processed and output in a JavaScript Object Notation (JSON) format using Heuristic text formatting rules 4113 which are specifically designed to identify and extract meaningful paragraphs or relevant text excerpts. Subsequent formatting operations, such as auto-correction and spell checks 4114, are performed utilizing an Application Programming Interface (API), such as the Microsoft® Azure API, hereinafter referred to as Azure API or Microsoft® Azure API. The cleaned and formatted textual data is then converted into high-dimensional numerical vector embeddings leveraging advanced pre-trained language models, for example, sentence transformer LLM models 4115 such as Bidirectional Encoder Representations from Transformers (BERT), or any subsequent embedding models. Subsequently, these high-dimensional numerical vector embeddings are stored in a database 4116, thereby enabling efficient semantic search and retrieval.

For all embedded figures and tables identified within the input PDF documents, the systems employ an Optical Character Recognition (OCR) API, such as but not limited to the Google® Cloud Vision API (OCR API) and the like. This OCR API 4117 is utilized to extract figures and tables that are stored in a digital asset management system 4118, which may include, for example, dedicated file systems or content repositories. Subsequent formatting operations, such as auto-correction and spell checks 4114 are performed utilizing an Application Programming Interface (API), such as the Microsoft® Azure API. The cleaned and formatted textual data is then converted into high-dimensional numerical vector embeddings leveraging advanced pre-trained language models, for example, sentence transformer LLM models 4115 such as Bidirectional Encoder Representations from Transformers (BERT), or any subsequent embedding models. Textual content extracted from the tables via OCR API is automatically corrected using the Azure API 4114, and application of further spelling corrections to improve accuracy.

### Document Processing Workflow for Patent Grants and Patent Applications

FIG. 41b illustrates a workflow process of the automated Document Processing Module 3904 for a document category of patent grants and patent applications, of a system, method and user displays for patent claim analysis and evidence identification, extraction, analysis, and charting 3900 according to various aspects of the present disclosure.

In some embodiments, FIG. 41b illustrates a workflow process 4100b of the automated Document Processing Module 3904 for a document category of patent grants and patent applications. For documents falling within these patent-related categories 4121, a heuristic classification model for Patent classification 4122 is first applied to precisely determine the specific type of patent document, namely granted patent or a patent application.

When the category document is identified as a patent grants by the heuristic classification model for Patent classification 4122, the automated Document Processing Module 3904 is configured to initiate a process which employs components such as a vision transformer or an object detection API 4123a to parse the document layout into distinct columns and coordinates. The module programmatically crops the document pages into corresponding column images 4124. Textual content is subsequently extracted from these column images using an OCR API 4125 and converted into a text format. A Heuristic Data Formatting rule 4126 is applied to parse and extract paragraphs along with their line numbers. Finally, these extracted paragraphs are converted into high-dimensional numerical vector embeddings, using sentence transformer LLM-based models 4127 such as but not limited to BERT, and stored into a database 4128 to facilitate semantic search and retrieval.

When the heuristic classification model determines the document category to be a Patent Application, the model utilizes the Adobe® API 4129 to convert the textual content of the document into a JSON format. Simultaneously, embedded figures and tables are processed and parsed employing an Optical Character Recognition OCR API 4125a through document processing API 4123b, and then saved into a digital asset management system 4130 such as file systems. Textual content extracted from said figures and tables is subjected to a Heuristic Data Formatting rule 4129. This content is subsequently converted into high-dimensional numerical vector embeddings using sentence transformer LLM-based models 4127 such as but not limited to BERT models and stored into the database to facilitate semantic search and retrieval.

### Document Processing Workflow for Emails

FIG. 41c illustrates a workflow process of the automated Document Processing Module 3904 for a document category of emails 4100c, of a system, method and user displays for patent claim analysis and evidence identification, extraction, analysis, and charting 3900 according to various aspects of the present disclosure.

In some embodiments, FIG. 41c illustrates a workflow process of the automated Document Processing Module 3904 for a document category of emails 4100c. For documents categorized as emails (input document) 4131, the automated Document Processing Module 3904 utilizes a document extraction algorithm 4132, to extract metadata of the email, including, but not limited to, From, To, Subject, etc., which is extracted and parsed. The document extraction 4132 is performed using document processing libraries such as FITZ, or PyMuPDF library, which is a python library for processing PDF documents and includes tasks, such as but not limited to, verification of document integrity, extraction of data, or validation of data.

The parsed text is then formatted 4133, by each meta-data fields. The main body of the email is then processed utilizing sentence transformer algorithms 4134 which are LLM-based models such as BERT, or any subsequent embedding models to segment the content into sentences. These segmented sentences are then converted into high-dimensional vector embeddings and subsequently stored into a database 4135 for semantic search and retrieval of email content.

### Document Processing Workflow for Transcripts

FIG. 41d illustrates a workflow process of the automated Document Processing Module 3904 for a document category of transcripts 4100d, of a system, method and user displays for patent claim analysis and evidence identification, extraction, analysis, and charting 3900 according to various aspects of the present disclosure.

In some embodiments, FIG. 41d illustrates a workflow process of the automated Document Processing Module 3904 for a document category of transcripts 4100d.

For documents that are transcripts 4141, a heuristic classification model 4142 is employed to identify the document category as transcript. If it is confirmed to be a transcript, the system proceeds with content extraction and formatting. For structured transcript formats, an object detection method or a vision transformer algorithm 4143 is utilized to extract distinct text blocks and their coordinates. This extracted data is further parsed and formatted using document extraction algorithm 4144. The document extraction is performed using various document processing libraries such as, but not limited to FITZ, or PyMuPDF library, which is a python library for processing PDF documents and includes tasks, but not limited to, verifying document integrity, extracting data, or validating data. The formatted content is then processed using sentence transformer 4145, LLM-based models such as BERT, or any subsequent embedding models and converted into high-dimensional vector embeddings which are subsequently stored in a database 4146 for semantic search and retrieval.

### User Interface to Upload Documents in Patent Evidence Analysis Management System

FIG. 41e illustrates an interactive Graphical User Interface (GUI) of the automated Document Processing Module 3904, of a system, method and user displays for patent claim analysis and evidence identification, extraction, analysis, and charting 3900 according to various aspects of the present disclosure.

In one embodiment of the present disclosure, the interactive Graphical User Interface (GUI) 4100e of the automated Document Processing Module 3904, is configured to significantly enhance the management of evidentiary documents by users.

The interactive Graphical User Interface (GUI) 4100e enables users to navigate to Documents tab 4151, from which the users can upload one or more documents 4154 utilizing an upload button 4152. Document submission can be accomplished via a standard File upload functionality or through a drag-and-drop interface. Subsequently, users click on Process button 4153 to initiate document upload and processing by invoking respective front-end and back-end functions as described herein. The status bar 4155 indicates status of the document upload process by the front-end and back-end processing.

APPENDIX X describes the pseudocode for certain functions implemented for the automated Document Processing Module 3904, of a system, method and user displays for patent claim analysis and evidence identification, extraction, analysis, and charting 3900 in accordance with the present disclosure.

FIG. 41f illustrates a database schema 4100f showing technical relationships between at least a portion of the database tables for the functionality related to the automated Document Processing Module 3904 according to various aspects of the present disclosure.

### Client-Side Document Processing

Client-side functions dropUpload( ) and fmUpload( ) detailed in the pseudocode, manage the interactive Graphical User Interface (GUI) workflow for uploading and processing documents. These functions provide a bridge between the user's input actions, i.e. drag-and-drop action, to the initiation of backend processing and API communication.

Function dropUpload( ) Manages Drag-and-Drop Functionality

The dropUpload( ) function is configured to manage the drag-and-drop functionality of the documents through an interactive Graphical User Interface (GUI) supporting various document drop types including, for example, file, text, and HTML. The function then initializes internal variables such as an object variable file, to hold the dropped document, a string variable type, to store the format of the dropped document and another string variable kind, to determine the category of the content of the dropped document. The dropUpload( ) function subsequently identifies and categorizes the dropped document by conducting a series of checks. It ascertains if the content is a document transfer, or constitutes HTML content by inspecting for <img> or <a> tags, or if it is plain text. If none of these specific conditions are met and transferable documents are present, the function defaults the kind to a generic file type. This function prevents redundant self-uploads by rejecting attempts to move a document back to its original location. The function then prepares the identified content for upload by bundling the processed file and the determined type. If a valid file exists, the function invokes a function fmUpload( ), by passing file, type and other relevant information to initiate the upload process. Conversely, if no valid file is identified during the categorization and preparation stages, the dropUpload( ) function displays an error.

Function fmUpload( ) Manages the Document Upload Progress and Outcome

The fmUpload( ) function is configured to manage the entire document upload process, encompassing document upload progress tracking, efficient document transfer, and user feedback. The function is designed to robustly handle both successful upload scenarios and error or failure scenarios. For enhanced user experience, in the feedback, it highlights the newly uploaded document within the current directory if the document is visible to the user; or offers an Open Folder button to enable user to upload to a different target directory, and displays an Upload Complete notification to confirm the successful conclusion of the transfer. Additionally, the fmUpload( ) function is configured to provide real-time progress updates throughout the duration of the document upload process.

### Document Processing for Invoking Server-Side Functions

A set of client-side functions are configured to manage the document upload and preparation process particularly related to PDF and ZIP archives, before initiating server-side functions for further processing.

Function sendFileToProcess( ).
The sendFileToProcess( ) function is configured to manage backend processing of documents. The function performs a series of steps in the below sequence:
The function receives raw JSON data from the frontend, said data comprising information pertaining to the uploaded documents;
The function sets up a unique temporary folder for the storage of uploaded documents;
The function invokes a helper function moveAndExtractZipFile( ), for upload and extraction of uploaded documents;
The function invokes a helper function checkAndRenameExtractedFile( ), for validation and renaming of the extracted files;
The function invokes a helper function addArchiveAndSend( ), to facilitate archiving and sending processed documents to a downstream API for further processing;
Upon successful completion, the function is configured to transmit an HTTP OK status to the frontend along with the path to the extracted folder. Conversely, in the event of a processing failure, an error message is conveyed to the frontend.
   Helper Function moveAndExtractZipFile( ) Handles Uploaded Documents

The helper function moveAndExtractZipFile( ), is configured to handle uploaded documents by iteratively constructing paths for each document. For a PDF document, the function creates a temporary directory and then copies the PDF document into said temporary directory. For a document identified as ZIP archives, the function first performs a validation using the function checkJunkFiles( ), to ensure that the ZIP archive exclusively contains permitted file types, such as PDF documents. If the validation is successful, the function extracts the contents of the ZIP archive into said temporary directory and subsequently deletes the original ZIP archive. Upon completion of its operations, the helper function moveAndExtractZipFile( ) returns a flag indicating either success or failure, along with the name of the temporary directory.

Helper Function checkAndRenameExtractedFile( ) Standardizes Documents

The helper function checkAndRenameExtractedFile( ), is configured to secure and standardize the extracted files from the uploaded document. The function first sets appropriate directory system permissions for the extracted files to ensure data security and integrity. Then, it iterates through each of the extracted files, sanitizing filenames by removing prohibited or special characters while preserving their original file extensions, and renaming them accordingly. Upon completion of these operations, the function returns a flag indicating if any files were renamed, along with the name of the temporary directory.

Helper function addArchiveAndSend( ) performs final processing for API submission

The helper function addArchiveAndSend( ), is configured to finalize processed documents for submission to an external Application Programming Interface (API). This function gathers current session data such as user and project information, and then archives only the processed PDFs into a new ZIP file using a helper function addPdfsInArchive( ). An API request payload is constructed with this ZIP archive, along with the, project and user details, which is then sent to a specified API endpoint via a generic communication function, such as genericCurlCall( ). If the API call is successful, the function updates the status of the document(s) as processing, and cleans up all all the temporary folders. If the API call is unsuccessful, the function is configured to trigger temporary file cleanup operations, and an appropriate error message is displayed to the user. The system maintains compatibility with documents that may be password-protected, ensuring proper handling of the documents throughout the workflow.

### Server-Side Document Processing

### Document Classifier Function:

According to an embodiment, a Document Classifier function is configured to automatically classify PDF documents into predefined types, the output of which is subsequently used for patent evidence analysis. The Document classifier function is adapted to receive PDF documents as an input parameter and then proceeds to classify these documents into predefined categories through the application of various technologies, including Artificial Intelligence (AI) models, Large Language Models (LLM), Image processing libraries, and other processing methodologies. The function further exhibits the capability to process diverse forms of PDF documents that may be text-based, image-based, or a scanned document.

A function classify_pdf_document(pdf_path) is the primary workflow function that performs the entire document classification process. The function begins its execution with an initialization process that includes importing of libraries necessary for processing PDF documents, AI models, image processing and other processes. The function also loads necessary API keys and configuration parameters from a configuration file (config) to initialize respective API clients from the API keys, such as Google® Vision Client, OpenAI Client and the like. The function then performs the following core tasks using several helper functions:
A helper function extract_text_from_pdf(pdf_path) is configured to perform text extraction process in which text from the digital layer of the PDF is extracted. This is particularly efficient method in the case of digitally created PDF documents containing selectable text. According to some embodiments, this function utilizes PyMuPDF Python library to extract text from a PDF document. This function is configured to open the PDF document from pdf_path, and iteratively process each page of the PDF document to extract its integrated textual content, and append it to a string variable (full_text). The function is configured to process within an exception handling block of code such as TRY and CATCH to manage error processing. In the event of any exception occurring during this process, the function is configured to return an empty string.
Another helper function extract_text_with_ocr(pdf_path) is configured to perform textual content extraction for scanned PDF documents or PDF documents that are predominantly image-based. This function initializes an empty string variable (full_text). During this process, the first few pages of the PDF document are converted into a list of digital image objects. Each image object is then converted into a byte stream (e.g., JPEG format) and sent as a request to the Google® Cloud Vision API for text detection. The API processes the submitted image data, and returns the transcribed text along with its structural information. The full transcribed text obtained from the API is then extracted and appended to the string variable (full_text). The combined text is then returned with any leading or trailing spaces removed automatically. This function is configured to process content from non-searchable, image-based PDF documents. The entire process within this function is captured within an exception handling block of code such as TRY and CATCH to robustly manage error processing. In the event of any exception being encountered during this process, an empty string is returned.
Another helper function create_prompt(text) is configured to perform the AI classification process. This function is configured to construct a detailed set of instructions or prompt strings as defined by user preferences for the AI model by embedding the extracted text from the PDF document into a pre-defined template(instruction_template) that comprises specific classification or heuristic rules for document categorization. It comprises a comprehensive list of all possible document categories (e.g., ‘US Patent Granted’, ‘Transcript Document’, ‘Normal Document’), detailed heuristic rules and illustrative examples for identifying each category (e.g., how to recognize a US patent number or a transcript), and clear instructions pertaining to the desired output format. If the input text parameter is determined to be empty or just contains only whitespace characters, an error message is returned.
Another function classify_document_with_llm(prompt) is configured to manage communication with an external Large Language Model (LLM), specifically an OpenAI GPT model for the classification of the document. This function validates the input prompt. If the input prompt indicates an error (e.g., due to empty content), the function returns a corresponding error message. Otherwise, the function prepares a chat completion request, specifying the model (e.g., gpt-4-turbo-2024-04-09, or any subsequent version of GenAI model) to be used, a system role, and a user-generated prompt. This request is then transmitted to the OpenAI Client. Upon receiving a response from the OpenAI Client, the function processes the content from the list of AI generated responses, and the first response is selected, extracted, and cleaned by removing any leading or trailing whitespace characters. The resulting cleaned document category is then returned by the function. An exception handling block is provided for API call errors, returning an error message if classification fails. The function processes within an exception handling block of code such as TRY and CATCH to manage error processing. In the event of any exception during this process, the function is configured to return an empty string.

The main workflow function that manages the entire classification process is performed by classify_pdf_document(pdf_path) function:
Initial Text Extraction: The function first invokes extract_text_from_pdf(pdf_path) which is described in detail herein above. The result is stored in a variable (extracted_text).
Fallback to OCR if Needed: The function performs a check, and if the length of extracted_text is less than a predefined threshold (e.g., 150 characters), indicating that the initial extraction either failed text extraction or yielded insufficient text, the system assumes the PDF document is a scanned or image-based PDF document. In such an event, the extracted_text is updated with the result from the function extract_text_with_ocr(pdf_path), and an isOCRed flag is set to TRUE.
Prepare the Prompt for AI: The extracted_text from the steps of initial text extraction and fallback to OCR if need as described herein above is then passed as an input parameter to the function create_prompt( ), and the resulting final_prompt is stored in database.
AI Classification: The final_prompt is sent to the AI model via a function classify_document_with_llm( ), and the document category returned by the AI model is stored in the database.
Return Result: Finally, the function finally returns the determined category along with the isOCRed flag, indicating whether OCR was used in the process.

This robust, multi-step text extraction process, combined with an intelligent, prompt-engineered AI classification methodology ensures that the system accurately and automatically categorizes a wide variety of PDF documents, thereby significantly enhancing efficiency in document management workflows, particularly where precise document category identification is important.

Content Extraction from a PDF Document:

Various types of documents such as emails, legal transcripts, product brochures, and patent specifications are used for patent evidence analysis. Each document comprises unique structural characteristics, formatting conventions, and distinct types of information that are essential for patent evidence analysis. Generic document processing approaches are often inefficient or fail to capture essential data due to lack of context-awareness. For example, extracting content from an email differs significantly from parsing information from a patent document. There is a need to automatically extract content based on the document category through a scalable and accurate approach, thus avoiding manual analysis.
The content extraction functionality of the automated Document Processing Module is configured to send documents to specialized extraction routines based on their pre-determined classification. After an initial AI-driven classification step that identifies the document category i.e. email, transcript, US patent grant, US application, brochure, etc., the content extraction function employs a structured conditional logic block to route the document to a specific processing function tailored to that category. Each function is specifically configured to extract the most relevant information and structural components that are unique to its designated document category, thereby significantly increasing the efficiency and accuracy of data extraction during the patent evidence analysis process.
The content extraction function of the automated Document Processing Module is configured to invoke specialized processing routines or sub-functions based on the document category. The information extraction process is adapted as per the document category, and these specialized processing routines or sub-functions are central to the document processing workflow particularly for tasks involved in patent evidence analysis.
The content extraction function comprises a string variable (pred_class) that stores the category of the document, i.e., emails, transcripts, US Patent Grant, and other categories. This is determined by a preceding document classification function classify_pdf_document(pdf_path). Subsequently, employing structured conditional block such as IF/ELSE IF construct, the content extraction function invokes a respective routine or sub-function to perform specialized processing based on the variable pred_class.
If the value of the variable pred_class is emails, the content extraction function is configured to invoke a function Process_Email_Document( ) which is configured to parse and extract email meta-data fields such as but not limited to From, To, CC, Date of the email, Subject, and Message body. As emails are often critical evidence for patent evidence analysis, the function Process_Email_Document( ) is further optimized to identify and extract key details pertinent to patent matters, such as dates of invention, collaboration, public disclosure and other key details are extracted from emails.
Alternatively, if the value of the variable pred_class is transcripts, the content extraction function is configured to invoke a function Process_Transcript_Document( ) which parses and extracts Question-and-Answer (Q&A) format and any numbered lines present in the document. Transcripts being one of the types of documents used for patent evidence analysis, the parsing of the transcripts facilitates searching and citations of specific testimony for a thorough analysis.
Alternatively, if the value of the variable pred_class is brochures OR pred_class corresponds to one of the specified documents, EP Patent-Grant, EP Patent-App, Foreign Patent-Grant, Foreign Patent-App, or WIPO Patent-App, the content extraction function proceeds with a grouping approach. This grouping functionality groups together general technical documents such as brochures commonly used in marketing materials, and all non-US patent documents such as European, WIPO, and other foreign or non-English language patents, and indicates that these group of documents are to be considered as prior-art documents for the purpose of patent evidence analysis. While these documents contain valuable technical information, their formats can vary widely and may not exhibit the same standardized format, as for example, US patents. The content extraction function is configured to invoke a function Process_Brochure_Or_Foreign_Patent_Document( ), which parses and extracts technical content without the structural parsing applied to other specific document categories such as emails, transcripts or US patent documents.
Alternatively, if the value of the variable pred_class is US Patent-Grant, US Patent-App, or a broader category such as patents, the content extraction function is configured to invoke a function Process_US_Patent_Document( ) to parse and extract key sections and elements of a patent document. Such sections and elements include, but are not limited to, the claims, abstract, inventor details, filing dates, publication dates, issue dates, embedded images, embedded tables and other specific sections. These US patent grants and applications are often the most critical form of prior-art within US patent law, and possess a highly standardized and predictable structure.
Alternatively, if the value of the variable pred_class does not correspond to any of the aforementioned document categories, the content extraction function defaults the processing to a generalized or catch-all case. This mechanism addresses clsasifications such as a Normal Document or an unexpected classification result. The content extraction function is configured to invoke a function Process_Default_Or_Normal_Document( ) for such cases. This function is configured to log the occurrence of unexpected classifications for subsequent review or apply a default processing step that involves the extraction of basic textual content without the application of specialized structural parsing applied to other document categories.

This comprehensive content extraction process as described herein, significantly increases the efficiency and accuracy of data parsing and extraction for patent evidence analysis. This is due to the ability of the system to automatically apply a precisely tailored and effective processing methodology for each document category.

### Vectorize Evidence Extracts

Subsequent to the content extraction process, it is essential to vectorize large textual content to perform efficient semantic search and analysis during the patent evidence analysis. This is done by generating high-dimensional numerical vector embeddings from large collections of textual data.

Conventional keyword-based search methods often fail to search and extract relevant contextual content from documents or textual data lack exact lexical matches. Such methods frequently fail to identify concept-based relationships. In contrast, vector embeddings transform the semantic meaning of textual data into numerical vectors, thereby providing a reliable and accurate solution for concept-based search and analysis. This approach plays an important role in enhancing the efficacy of patent evidence analysis.

However, generating vector embeddings for large volumes of textual data using Artificial Intelligence (AI) models or Large Language Models (LLMs) presents significant technical challenges. These challenges include, but are not limited to, effectively managing API rate limits, handling network transient failures, processing large data payloads, and ensuring consistent and successful completion of the entire embedding generation process. Consequently, there is an unmet need for a robust and reliable method capable of converting large volumes of textual data into high-quality vector embeddings.

The vectorize evidence extracts functionality of the automated Document Processing Module is configured to convert large volumes of textual data such as, extracts of evidence into high-dimensional numerical vector embeddings. In order to overcome common challenges related to API rate limits and network transient failures, the vectorize evidence extracts functionality of the automated Document Processing Module adopts a two-phase methodology wherein, the function first attempts bulk processing of entire textual data in a single API call to optimize speed and accuracy. Upon failure of this initial attempt, the vectorize evidence extracts functionality falls back to an alternative and robust approach wherein smaller batches of textual data is processed, thereby accommodating the API processing rate limits and mitigating network issues. This two-phase methodology converts large volumes of textual data into high-dimensional numerical vector embeddings, thereby enabling concept-based, context-based or semantic-based search and retrieval during patent evidence analysis.

The functionality that manages the vectorization of evidence extracts of the automated Document Processing Module comprises of a worker function and a manager or orchestrator function as described below:
Worker Function: A worker function get_embeddings_batch(list_of_texts) is one of the helper functions which communicates with an external AI service such as an Azure OpenAI model to convert a batch of textual data into high-dimensional numerical vector embeddings. Upon invocation, the function sets up the API requests which includes configuring parmeters from the configuration file. The function configures the api_url and api_key to config.vector_generation_fallback and config.azure_openai_api_key_fallback respectively. Headers are defined for authentication using api-key and content type as application/json. A payload is constructed, containing the textual data list_of_texts to be vectorized. A POST request is sent to the configured api_url with the defined headers and payload. The response is stored in a response variable, response. If the request is successful as indicated with a HTTP status code, the list of high-dimensional numerical vector embeddings is extracted from the JSON response.data field and the list of high-dimensional numerical vector embeddings is returned. If the API returns an error, an error message is printed, and the string Issues is returned to signal a failure to the calling function. The get_embeddings_batch(list_of_texts) processes within an exception handling block of code statements such as TRY and CATCH block to handle exceptions such as network errors, timeouts or other exceptions and the string Issues is returned to signal a failure.
Main Orchestrator Function: A main orchestrator function or the manger function generate_vectors_doc_process(full_list_of_texts) is configured to ensure that large volumes of textual data is reliably converted into high-dimensional numerical vector embeddings. This reliability is maintained even in scenarios where the external API is temporarily unavailable or is subject to usage limits. It employs a two-phase strategy:
   A. The Optimistic Path: The optimistic path enables the orchestrator function to first attempt to process the complete list of textual data full_list_of_texts in a single batch. This is achieved by invoking the worker function get_embeddings_batch(full_list_of_texts) with the resulting high-dimensional numerical vector embedding stored in an embedding_list. This is an efficient method, particularly when the textual data list_of_texts constitutes a relatively smaller batch and the API operates without issues.
   B. Fallback Logic Path: The Fallback Logic Path is activated if the embedding_list returned from the Optimistic Path indicates Issues. In such instances, the orchestrator function interprets this as a bulk processing failure and subsequently switches to an alternative fallback, chunk-based mechanism in which the function is configured to pause execution for a predetermined duration, thereby allowing for the potential resolution of a temporary issue before invoking the API call.
      Chunk-Based Processing: The embedding_list is re-initialized as an empty list. A chunk_size parameter is defined which is set to a specific maximum number of textual items to be processed per API call. The function then iterates through the full_list_of_texts in defined chunks. In each iteration, a text_chunk, representing, a portion of the complete textual data full_list_of_texts is defined, and the function get_embeddings_batch(text_chunk) is invoked to obtain embeddings for this small chunk. The resulting chunk_embeddings are then appended to the main embedding_list.
      Dynamic Rate Limiting: The function further incorporates a periodic pause for a predetermined duration before invoking the API call, particularly, when the number of processed texts exceeds a larger threshold of textual data. Upon processing each chunk, the current_index is updated to move to the start of the subsequent chunk. This approach of generating chunks of data in smaller batches combined with periodic pause optimizes the API calls by operating withing optimal functional API rate limits, and allowing the system enough time to recover from any transient network or service issues.

Upon completion, the main orchestrator function generate_vectors_doc_process(full_list_of_texts), whether processed from either from The Optimistic Path or the Fallback Logic Path returns the final embedding_list that contains high-dimensional numerical vector embeddings of all input texts, thereby making them available for semantic search, similarity matching, context-based search, or other analytical tasks within the patent evidence analysis workflow.

The storing of evidence extracts functionality of the automated Document Processing Module efficiently stores extracted and parsed textual data and metadata from various types of documents as high-dimensional numerical vector embeddings within a structured relational database, ensuring data integrity, scalability, and optimized performance for patent evidence search, retrieval and analysis.

The patent evidence analysis workflow is complex that involves large volumes of textual data which are extracted, parsed, and subsequently converted into structured data format. It is essential to efficiently store this data in a reliable and robust storage solution, such as a relational database. Therefore, there is a need for a robust and optimized database solution to reliably and efficiently ingest and store large volumes of textual data into a structured database, while supporting high-volume operations, effectively managing long-running database connections and maintaining data integrity.

The storing of evidence extracts functionality of the automated Document Processing Module is configured to efficiently store extracted and parsed textual data and metadata from diverse document categories. This processed information, including high-dimensional numerical vector embeddings, is robustly stored within a structured relational database. This ensures data integrity, scalability, and optimized performance, which is essential for patent evidence search, retrieval and analysis. The storing of evidence extracts functionality comprises specialized functions dedicated to persist classified and processed data from various in-memory formats, such as DataFrames into database tables. Its primary functionality comprises performance focused batch processing utilizing mechanisms such as executemany, transactional integrity with periodic database commits using a function db.commit( ) to prevent data loss, robust connection handling, and proper resource management through explicit cursor and connection closures. This robust architecture enables permanent, efficient, and optimized storage of heterogeneous data such as, but not limited to, textual content, email metadata, patent-specific extracts, and question and answer (Q&A) pairs from transcripts, and other types of content. This comprehensive approach facilitates easy and optimized retrieval during patent evidence analysis workflow.

The storing of evidence extracts functionality of the automated Document Processing Module comprises of several of the following sub-functions, each configured to insert specific type of extracted and parsed data into dedicated database tables, which are optimized for data storage, search and retrieval:
A function insertDftoDb(dataframe) is configured to insert general document analysis results into a review analysis table. This table primarily stores textual data, respective embeddings, and associated metadata corresponding documents classified as Brochures, Foreign Patents, or Normal Documents. The function dynamically selects an appropriate Structured Query Language (SQL) INSERT query based on the number of columns present in the input DataFrame, thereby ensuring flexibility in the database schema.
A function insertEmailDf(email_dataframe) is configured to insert parsed email data into a dedicated table tbl_email. This table stores specific email metadata fields, including, but not limited to, projectID, document_key, email_to, email_from, email_subject, and email_body.
A function patentSearchdftoDb(patent_dataframe) is configured to insert extracted and parsed data from patent documents such as US patents into a dedicated table tbl_patent. This table stores field-specification data, including, but not limited to, high-dimensional numerical vector embeddings of textual data, projectID, extracts of the textual data, and columnType indicating the section of the patent such as claims, abstract, etc.
A function transcript_dftoDb(transcript_dataframe) is configured to insert data extracted from transcripts and parsed in the format of Question-and-Answer into a dedicated table tbl_deposition. This table stores fields relevant to testimony or deposition analysis, including, but not limited to, projectID, document_key, qa (the Q&A pair), speaker, and embedding.
All of these aforementioned functions follow a standardized template Insert_DataFrame_Into_Table(dataframe, query) that is designed to enable robust and efficient database insertions across various data types.

The storing of evidence extracts function of the automated Document Processing Module uses a highly efficient and robust approach to store and retrieve processed data. Key operational features of the storing evidence function of the automated Document Processing Module comprises of:
Batch processing with executemany speeds up insertions of large datasets improving performance. Instead of inserting one row at a time, the system groups a predetermined number of rows and sends to the database in a single command using mycursor.executemany. This approach significantly reduces the number of network round-trips between the application and the database, thus improving speed and performance.
The function ensures transactional integrity by committing batches of rows to the database using db.commit( ) after each successful transfer, which prevents data loss and preserves previously saved work despite processing failures or interruptions.
The function ensures robust connection handling with a logic to check the database connection status using db.is_connected( ) and automatically reconnects if the connection has been dropped due to a timeout, etc. Thereby preventing script failures while processing a large file.
The function performs resource management by invoking functions mycursor.close( ) and db.close( ) after the database operations are complete to ensure that database connection resources are promptly released and prevent resource leaks.

The storing of evidence extracts function of the automated Document Processing Module provides a highly efficient, robust, and well-structured approach to persisting processed document data, enabling effective long-term storage, retrieval, and analysis of variety of information for patent evidence analysis.

### Claim Construction Analysis Module

### A Workflow Process of a Claim Construction Analysis Module of a System for Patent Claim Analysis and Evidence Identification, Extraction, Analysis, and Charting.

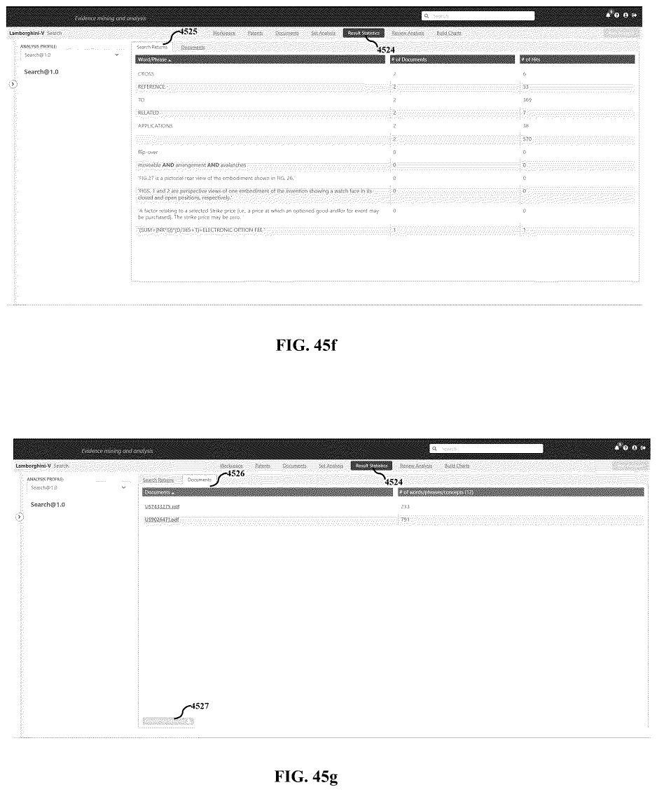

FIG. 42 illustrates a workflow process 4200 of the Claim Construction Analysis Module 3906, of a system, method and user displays for patent claim analysis and evidence identification, extraction, analysis, and charting 3900 according to various aspects of the present disclosure.

In one embodiment of the present disclosure, user initiates the process of claim construction or term construction process by selecting a specific patent 4201. Following patent selection, in step 4202, the user proceeds to select a particular term of interest within the chosen patent and identifies representative claim 4202. In step 4203, the user actively adds one or more term constructions related to the selected term. A term construction may refer to definitions, synonyms, related concepts, or specific phrases associated with the term. Additionally, related documents, such as prior-art, or dictionaries, can be added to a document manager for comprehensive analysis. This enhances the contextual understanding of the selected term. After defining the term constructions and related documents, in step 4204, the user has the option to save the current configuration. This can be done either by saving as a new analysis profile, thereby creating a distinct set of term constructions and documents, or by saving to an existing profile, updating a previously defined analysis configuration. With the analysis profile configured, in step 4205, the user proceeds to run the analysis. This involves processing the selected patent, its designated term, the added term constructions, and any related documents according to the saved profile. The analysis involves natural language processing, semantic matching, or other computational linguistic techniques to identify instances and contexts of the term and its constructions. Upon completion of the analysis, in step 4206, the user is presented with the ability to review the result statistics. This may include metrics such as frequency of the term and its constructions, distribution across claims or sections, and other quantitative data derived from the analysis. This step provides an overview of the analytical output. Finally, in step 4207, the system ranks the evidence and allows users to review the detailed analysis. This involves examining individual instances of the term and its constructions within the documents, evaluating the relevance of identified evidence, and potentially assigning scores or rankings to support the user's interpretive conclusions.

FIG. 42a illustrates an interactive Graphical User Interface (GUI) 4200a of the Claim Construction Analysis Module 3906, of a system, method and user displays for patent claim analysis and evidence identification, extraction, analysis, and charting 3900 according to various aspects of the present disclosure. In the interactive Graphical User Interface (GUI) 4200a, Set Analysis 4211, is configured to enable a user to select a desired type of analysis. The user selects one type of analysis selected from infringement, invalidity, construction, or search, at any given time. Upon selection of Construction 4212 from the Module section by the user, Claim Construction Analysis is initiated. Claim construction, also known as a Markman hearing, is a critical step in patent litigation. This stage requires each party, such as a plaintiff or a defendant, to submit their respective interpretations of terms used in the patent claims. Patentees may advocate narrow claim term definitions when infringement is apparent but prior-art may present validity concerns, whereas accused infringers may propose broader definitions. The evidence submitted to support these claim constructions must emphasize the term's usage within the claim language, the patent's specification, and its prosecution history. Such terms can be supported by intrinsic evidence originating from the patent specification, or extrinsic evidence derived from external documents such as dictionaries, and literature. The terms in this document, claim construction and term construction have herein been used interchangeably.

The Claim Construction Analysis Module 3906 of Set Analysis enables users to create a new analysis profile, herein referred to as a Claim Construction Analysis Profile, and add new term constructions. Alternatively, users may select an existing Claim Construction Analysis Profile to add new term constructions or update existing term constructions. Term construction, as used herein, is a two-step method wherein, the first step involves creating a term by selecting a phrase from the patent claims and associating it with a specific representative claim, and a second step that involves adding a construction to the selected term.

The first step of the two-step method for creating a term construction, involves a user selecting a patent from a drop-down list 4213, and clicking a Create Term 4214 button. This action opens a Create Term pop-up window 4215, which displays a list of all the patent claims. Within this window, the user can select a portion of the claim text, copy it, and paste it into a text box field 4216 to search for the selected phrase within the entire list of patent claims. The search operation retrieves related claim elements where the term or phrase is found. The user then selects one claim from the representative claim drop-down list 4217 and clicks on create a term button 4218 which creates a term and saves in the database the created term and the corresponding selected representative claim 4217.

Once the term is created, the user proceeds to the second step of the two-step method of creating a term construction. This step involves defining one or more constructions for each term. Constructions are herein defined as interpretations of the term within the context of the claim language and the patent's description. These terms can be supported by evidence from the patent specification or from external documents, such, as dictionaries, scientific literature, or other technical documents. The user clicks on the Construction+button 4219. This action opens an Add Construction pop-up window 4220. Within this window, the user adds related synonyms, descriptions, or related terms, in the text field 4221 and then clicks on the Save button 4222 to add new construction to the term. The user may repeat this action to add multiple constructions to a single term. Users may select one or more documents from the document file manager, and the selected documents are then added to a Document Analysis List 4223. Users may save the entire list of terms and constructions for selected patent by creating an Analysis profile 4224. The user can either save the profile 4225 or run the analysis 4226.

Claim construction analysis involves multiple steps. These include, but are not limited to, a user selecting or identifying a patent, selecting or deselecting specific claim elements, highlighting text from various parts of claim elements, adding multiple terms or term construction, and associating them with respective patent claims. Furthermore, this process can extend to one or more patents involved in a patent litigation case. Documents from the document file managers support the terms or term definitions added to each patent.

Conventional manual methods for claim construction analysis are typically tedious, time-consuming, and prone to error. Accordingly, there exists a need for a seamless, efficient, automated, and user-friendly method that enables users to selectively identify patents, add multiple terms or term construction, and perform other user-defined functionalities, and is integrated with an automated backend for accurate data saving and seamless retrieval.

The Claim Construction Analysis Module 3906 of the Set Analysis feature of the present disclosure is configured to integrate the front-end interactive Graphical User Interface (GUI) with backend processing. It interactively manages claim construction features, including patents, patent claims, claim elements, associated terms or term constructions, and related documents from the document manager, on an interactive Graphical User Interface (GUI). Furthermore, it seamlessly stores these selections and relationships in a database.

FIG. 42b illustrates a database schema 4200b showing technical relationships between at least a portion of the database tables for the functionality related to the Claim Construction Analysis Module 3906 of the present disclosure. APPENDIX XI describes pseudocode for frontend and backend functions implemented for Claim Construction Analysis Module 3906, of a system, method and user displays for patent claim analysis and evidence identification, extraction, analysis, and charting 3900 in accordance with the present disclosure.

### Create Term Construction

Users initiate the term construction process by selecting the Construction module within the Set Analysis feature. They choose a specific patent for which new claim terms are to be added and select a new or existing Claim Construction Analysis Profile. Upon clicking the Create Term button, a pop-up modal appears, displaying a list of claims for the selected patent. The user then identifies and inputs the desired term or phrase into a text field and clicks a Find button. The system retrieves and highlights related claim numbers that match the input term or phrase. When the user confirms the creation of the term (e.g., by clicking Yes), the corresponding frontend and backend code is invoked.

### Frontend Code for Term Construction

The frontend code for the Claim Construction Analysis Module within the Set Analysis feature is configured to facilitate user interaction for adding and managing term constructions. An interactive Graphical User Interface (GUI) (UI) comprising various components enables users to create or manage terms.

In one embodiment, a frontend function, such as addTermClaimDta( ), is invoked when a user adds a construction term. This function is configured to receive a plurality of input values from the UI components, including a search keyword, a selected patent number from a dropdown, a claim identifier from the selected claim UI component, and analysis profile details from a profile selection UI component. In this embodiment, these respective input values may be stored in variables referred to as, termKeyword, constructionPatent, claimId, and analysisProfile.

All collected input values are encoded, for example, using Base64 or another suitable content-transfer format, for security and consistency before transmission. Subsequently, an AJAX POST request is then sent to a backend function, such as saveConstructionTermDta( ), to save the term construction data.

Upon successful backend processing, the backend code is configured to return a success status, for example, a status code. In response to the status of success, the frontend function then performs a series updates. These updates include, but are not limited to, saving the patent number to variables such as localStorage for client-side state management, refreshing respective UI components with associated data retrieved from the backend, and clearing input fields utilized during the operation. Furthermore, a second AJAX request is initiated to retrieve updated data, which is then displayed on the UI along with a success message. A variable actionType determines whether the operation is an INSERT or UPDATE for the Claim Construction Analysis Profile type. A client-side function, such as createConstructionTempProfile( ), is invoked with the gathered information to facilitate the insertion or update of data related to the Claim Construction Analysis Profile. In the event of any errors encountered during processing, the backend code returns an error, for example a status code or another designated error code. A corresponding error message is then displayed to the user via one or more notification mechanisms, such as, including pop-up notifications or snackbar notifications.

### Backend Process to Save Newly Created Term Construction

A backend API endpoint, such as saveConstrunctionTermDta( ), is configured to receive requests to save a term construction associated with specific patent claims within a Claim Construction Analysis Profile. This function ensures that duplicate terms are not inserted into the same analysis profile. Upon receiving a request, the function first retrieves the current user identifier from a session (userID) and decodes the request data to extract input parameters. These parameters include a search keyword (searchKeyword), a project identifier (projectID), an identifier of the analysis profile (profileId), a profile type (profileType with values such as ‘TEMP’ or ‘SAVED’), a patentNumber (which is parsed to extract both a patentId and the patentNumber), and the claimId (parsed to extract both a claimId and claimCon).

To prevent the insertion of duplicate terms within the same profile, the function invokes a helper function, such as checkClaimKeyword( ) by passing the searchKeyword, patentNumber, projectID, claimId, profileId, and profileType. If the helper function, checkClaimKeyword( ) indicates that the term already exists within the specified profile context, the function immediately returns a status code along with an appropriate message.

If the term does not already exist within the specified profile context, the helper function proceeds to save new term construction data. It uses a helper function, saveConstructionDta( ), by passing thereto all necessary parameters, including the searchKeyword, patentNumber, claimId, projectID, userID, profileId, and profileType. The helper function saveConstructionDta( ) inserts the new term construction into the database table, tbl_constrction_term_data, and returns the last inserted identifier (last inserted ID) to confirm successful insertion.

### Add Construction

The Claim Construction Analysis, part of the Set Analysis feature, is configured to allow users to add multiple constructions for a single claim term within an analysis profile. These associated constructions, referred to as child term constructions, serve explanations for an existing parent term construction. Within the Set Analysis UI, a user can click on a construction+button to invoke a pop-up modal. This modal enables the user to add a child term construction to a selected parent term of a specific analysis profile. The subsequent frontend and backend code facilitates this process.

### Frontend Code for Adding Child Term Construction

Upon a user's selection to save a child term, the frontend function retrieves all the necessary data from the UI. This data includes a parent ID (parentTermId), the content of the new child term (constructionContent), a claim ID (claimChildId), details of the Claim Construction Analysis Profile (analysisProfile), and a patent number (patentNumber). The function validates that the new content is not empty.

All collected data is then encoded using, for example, Base64 or UTF-8, for transmission and sent via an AJAX POST request to a backend function, such as saveConstructionTermChildData( ). Following a successful response from the backend function, the frontend function parses the JSON response, hides the input modal, and clears the input fields. The function performs a series of delayed actions. The function automatically checks and selects the checkbox of the newly added child term, and triggers a function such as, createConstructionTempProfile( ), to update a temporary analysis profile with the new information.

### Backend Code for Adding Child Term Construction

The backend function, saveConstructionTermChildData( ), is configured to receive the encoded data from the frontend. It decodes and extracts all parameters, including parentId, contentVal, profileId, profileType, claimId, and patentNo. This function validates that the content is not empty and returns an error code 4200 error if it is empty.

The function then invokes a helper function, such as saveConstructionTermChildDta( ), passing all collected parameters. This helper function is responsible for inserting the child construction term into a dedicated database table, establishing a link to its parent term, patent, claim, project, and profile. Finally, the backend function then returns a JSON response to the frontend, indicating success with a status code and the inserted identifier, or failure with an appropriate status code.

### Construction Analysis

The Construction Analysis feature captures user-defined input parameters and supports two distinct user actions: a Save action for inserting the current analytical setup into a database, and a Save and Run action that not only saves the analytical setup but also invokes an external AI/LLM processing pipeline.

In one embodiment, the Construction Analysis feature, implemented as the constructionAnalysis( ) function, manages the setup process of construction analysis.

In response to an AJAX request, a function constructionAnalysis( ) retrieves user and project data, including a user identifier (userID) and a unique hash key (uniqueHashKey), from a session. The function also reads all other required input parameters from the incoming AJAX request, such as a claims key (claimsKey), a zip key (zipKey), a list of documents (documentNameList), an analysis profile name (versionName), a selected module (selectedModule, which is construction in this case), an action type (actionType with values such as ‘Save’ or ‘Save and Run’), a version date (versionDt), a list of selected claim elements (checkedBoxList), a patent number (patentNumber), a profile type (profileType with values such as ‘TEMP’ or ‘SAVED’), and a profile identifier (profileID).

Upon receiving these parameters, the module performs data preparation. This involves, extracting the clean patent number (patentNo from the patentNumber string variable), encoding the checked box list (checkedBoxList) to JSON format if it is not empty, formatting the version name (versionName) by replacing spaces, dots, or other undesirable characters to create a usable file identifier, and generating a unique token using a hashing function to track this specific analysis instance. The module also calls a function, such as getDocumentKeyList( ) function to obtain the actual keys of the selected documents for further processing or linking. A request array is then prepared for subsequent API or database operations.

The function constructionAnalysis( ) performs either a Save or Save and Run analysis based on the actionType variable:
If actionType indicates Save: If the actionType parameter indicates Save, the function constructionAnalysis( ) is configured to invoke a function, such as insertConstructionAnalysedDocs( ) to save the current construction analytical workflow setup, including both document and analysis configuration, into a database. It also invokes a function insertTrackerStatus( ) to save the profile name of the current construction analysis, thereby maintaining a history of the analysis versions. Based on the profleType (‘TEMP’ or ‘SAVED’), the function performs the appropriate action to save or update data on the current construction analysis profile. Finally, a JSON response with an OK status and version information is returned to the frontend.
If actionType indicates Save and Run: If the actionType parameter indicates Save and Run, the user intends to save the current analytical setup and immediately trigger an external AI processing pipeline. In this scenario, the module prepares an API URL and then calls an external API with the prepared data, which includes selected claims, documents, and other parameters. Based on the success or failure of the API call, a JSON response containing a message is returned to the user, as received from the API.

The helper function insertConstructionAnalysedDocs( ) inserts data related to the current construction analysis into a database table (analyzed_document_list table). It receives various parameters, including a list of document names (nameList), zipKey, projectID, userID, versionName, token, originalVersionName, selectedModule, actionType, checkedBoxListDt, and patentNo.

The helper function insertConstructionAnalysedDocs( ) converts the nameList to JSON format and formats it for safe database insertion. It sets variables, such as the current datetime, analysis type, and action type, to appropriate values. It then performs an SQL INSERT query into the database table (analyzed_document_list), populating fields such as the project ID, document name in JSON format, datetime, user ID, version name, token, analysis type, status, original version name, selected module, claim details, and patent number. The primary key of the newly created record (last inserted ID) is retrieved using a database command such as SELECT LAST_INSERT_ID( ). If the insertion is successful, this primary key (last inserted ID) is returned, otherwise, a false value is returned. This function ensures that comprehensive details about each analysis request, including its status and profile information, are accurately stored for version tracking and profile updates.

### Server-Side Processing of Set Analysis—Claim Construction Analysis Module

A Primary Analysis Function of the Set Analysis—Claim Construction Analysis Module of the present disclosure, is configured to perform a comprehensive patent analysis that facilitates the entire workflow process, encompassing data loading, data preparation, analysis execution and the storage of the final results. The Primary Analysis Function incorporates user feedback features to enable iterative refinement and dynamically re-directs the analysis routines to dedicated functions for implementing functionality related to validity, infringement, construction or search. Following the execution of these respective functions, the Primary Analysis Function, transforms raw similarity scores into intuitive, color-coded metrics for user interpretation. The Primary Analysis Function implements a dual-persistence strategy to ensure results are stored into a database while simultaneously converting them to a JSON format for UI access. The Primary Analysis Function is implemented within an error handling block to ensure seamless error management.

The Primary Analysis Function for claim construction includes a semantic search feature with deduplication logic that groups near-duplicate evidence extracts, thereby providing a high-quality ranked list of evidence. High-level summary statistics are then generated from these findings, tailored for different interactive Graphical User Interface (GUI) views to facilitate intuitive visualization.

In one embodiment, The Primary Analysis Function of the Set Analysis—Construction module of the present disclosure, implemented as function Analysis( ), is configured to perform comprehensive patent analyses. The function is configured to receive various input parameters, including projectID, version, documentList, claimsData, userConcepts, previousVersion, buildOptions, analysis_type, and userID.

The Analysis( ) function executes within an exception handling block, ensuring robust error management. The function performs following key steps:

### Setup and Initialization

The function Analysis( ) initiates its operation by establishing a connection to a main database and creating a database cursor for executing queries. It parses input strings such as documentList and claimsData into Python objects or lists. It then creates directory structures on the file server for storing temporary and final results, such as pickle files and highlighted reviews, specific to the current analysis session.

### Data Preparation

The function Analysis( ) merges individual document data, typically from preprocessed pickle files, into a single, master DataFrame object for the current analysis run by invoking a function such as mergeDataFrames( ) by passing documentList, source_folder, destination_folder, and version. The input claims information is converted into a structured DataFrame object (claimsDataFrame), with columns such as patentNo, claimNo, and claimText. An initial summary of the work is generated that includes the calculation of the number of documents and claims to be analyzed, which is stored in a dictionary variable such as docsSummary.

A DataFrame is defined as a two-dimensional, mutable data structure with labeled columns and rows, which is analogous to a spreadsheet or a table in a relational database. In some embodiments, a DataFrame is constructed from a dataset with named columns, thereby allowing its data schema to be easily inferred.

State Management which Includes Incorporating User Feedback from Previous Analysis

The function Analysis( ) stores user preferences by implementing state management. In this implementation, a dictionary variable such as userChoices, is initialized to hold user feedback, specifically Favorites and Deletes from prior analysis versions. A variable such as buildCheckbox_flag is set based on whether a variable such as buildOptions is provided. The variable buildOptions parameter indicates if user intends to build upon a previous analysis.

A value of the variable buildCheckbox_flag as TRUE, indicates that the user intends to build upon the results of a variable such as previousVersion of the analysis. In this scenario:
If ‘Favorites’ or ‘All’ is selected within the variable buildOptions, the function queries a database table (temp_micro_ranking_save) to retrieve records marked by user as Favorite in the variable previousVersion based on a specific value of a variable favourite_status indicator. These retrieved results are then grouped by claim and stored in a variable userChoices[‘Fav’].
If ‘Deletes’ or ‘All’ is selected in the variable buildOptions, the function queries the database table (temp_micro_ranking_save) to retrieve records marked for deletion by the user as indicated by a specific value of a indicator variable active_status. These results are grouped by claim and stored in a variable userChoices[‘Del’].

Features such as Favorites, Deletions, and others enable users to constantly refine their analysis results, thereby significantly enhancing efficiency of detailed patent reviews.

### Core Analysis Execution

The function Analysis( ) loads the master dataset of evidence extracts into a DataFrame (extractsData) from a pickle file created during the data preparation phase. The function dynamically re-directs to respective analysis routine based on the parameter (analysis_type):
If the value of the variable analysis_type is Validity, the function invokes a function perform_validity_analysis( ), by passing parameters such as extractsData, claimsData, userConcepts, userChoices, and other relevant variables. The function perform_validity_analysis( ) performs a validity analysis by comparing patent claims against prior-art to assess novelty and non-obviousness.
If the value of the variable analysis_type is Infringement, the function invokes a function perform_infringement_analysis( ), by passing parameters such as extractsData, claimsData, userConcepts, userChoices, and other relevant parameters. The function perform_infringement_analysis( ) compares patent claims against product descriptions or other evidence to identify potential infringement. The results from the variables such as, docResults and claimResults, are then post-processed. Raw similarity scores are converted into intuitive, color-coded categories such as Green indicating high similarity for similarity scores >0.65, Yellow indicating medium similarity for similarity scores in the range of 0.45-0.649), and Red for low similarity for similarity scores <0.45. These similarity scores can be changed as per user-defined preferences. The results from the variables such as, docResults and claimResults, are formatted into final dictionaries for document-level and claim-level statistics for further user analysis and interaction.

### Finalization and Storage

The function Analysis( ) queries the database for additional metadata, such as the maximum element count for each analyzed patent, which is necessary for User interface display. A results object (data2Send) is assembled, encompassing all document statistics, claim statistics, and summary information. The results object, data2Send is converted into a JSON string (dataToSendJsonified).

The complete analysis results (dataToSendJsonified) are inserted into a database table (tblresultstats), along with parameters such as projectID, version, userID, and other relevant details, for permanent storage. The identifier of this new database row, (tblresultstats_lid) is retrieved. Concurrently, a copy of the variable data2Send is saved to a version-specific JSON file on the server, serving as a quick-access cache for a responsive interactive Graphical User Interface (GUI). Subsequently, a function saveAnalyzedResponseData( ) is called by passing parameters such as, data2Send, tblresultstats_lid, originalVersionName, and analysis_type for subsequent processing with the results. The function returns True, signifying overall success.

### Error Handling and Finalization

The entire workflow is encapsulated within a TRY and EXCEPT block for seamless error management. In the case of an exception, an error and traceback are printed and an error status object with a status of 7000 is created. The function saveAnalyzedResponseData( ) is invoked with the error status object to log the failure to a notification system. The function then returns a message, signifying failure. A FINALLY block ensures that the database cursor and connection are always closed, regardless of whether the process succeeded or failed, thereby preventing resource leaks.

### Core Evidence Ranking and Summary Statistics Generation—Claim Construction Analysis Module

The server-side processing of the Set Analysis—Construction Analysis Module of the present disclosure performs the core evidence ranking and summary statistics generation for user-defined term constructions. These main server-side functions that implement these features are performConstructionRanking( ) and calculateConstructionResultStats( ).

Core Evidence Ranking is Performed by performConstructionRanking( )

A function performConstructionRanking( ), is configured to perform the core processing for term construction. For each user-defined term construction, the function performs a comprehensive semantic search of the entire body of evidence, ranks the findings by semantic similarity, groups near-duplicates, and stores the detailed results in the database.

The function performConstructionRanking( ) initializes a master DataFrame object (parent_df), to collect a summary of all found evidence for final statistics calculation. It filters out very short evidence extracts with words less than a set upper limit to improve result quality.

Main Processing Loop Iterates though each Term Construction: The function performConstructionRanking( ) iterates through each of the variables constructionID and constructionText within the constructionDefinitions data dictionary variable.

Semantic Search: During each iteration, the interactive Graphical User Interface (GUI) is updated with progress and a message such as Construction Element Running . . . is displayed. A unique hash key is generated for the specific construction and analysis version. The variable constructionText is converted into a high-dimensional numerical vector embedding using a function get_embeddings_batch( ). This high-dimensional numerical vector embedding is compared against the high-dimensional numerical vector embeddings of all available evidence extracts using a cosine similarity to calculate similarity scores. A temporary DataFrame object (temp_df), is created containing the evidence and their scores, which is then sorted by a variable Cos_Scores in descending order. This DataFrame object, temp_df is then truncated to top N^{th} results for efficiency in subsequent steps.

Deduplication and Grouping: This is a sophisticated process that groups text extracts that are semantically very similar, also referred to as near-duplicates to avoid cluttering the results. The module calculates the knee point (current_kn) of the similarity score distribution to dynamically determine a cut-off for the most relevant items. An iterative process identifies and groups near-duplicates, wherein the top-ranked unique item is selected as a representative of a new group. This representative item is compared against all other items using a text-based similarity metric, such as Jaccard similarity, and any other item exhibiting a similarity greater than 0.85 or is considered a near-duplicate and added to the same group. This loop continues until all relevant items are grouped. The unique representatives and their grouped near-duplicates are then combined into a final ranked list DataFrame object such as, dataFrame.

Data Assembly for Database Insertion: Human-readable citations are generated for each piece of evidence for end users to view or edit. All detailed data for the current construction, including ranks, text names, document keys, hash key, scores, and group information, are assembled into a dictionary variable, such as rankedData. This detailed ranked list is then inserted into the database table (temp_micro_ranking_save) using a function insert_rankedData( ).

Aggregate Summary for Final Statistics: For every piece of evidence found for the current construction, a summary row (ConstructionID, TextName, DocumentKey, documentName) is inserted to a master DataFrame (parent_df). The interactive Graphical User Interface (GUI) is updated with progress and a message such as Construction Element Completed is displayed.

Transition to Statistics Calculation: After all the constructions have been processed, the interactive Graphical User Interface (GUI) is updated with a message “Calculating Result Statistics . . . ”. The master summary DataFrame, (parent_df), is passed to a function calculateConstructionResultStats( ) to generate final statistics. The interactive Graphical User Interface (GUI) is updated one last time with a message Analysis Completed and the function returns the final statistics.

Summary Statistics Generation is Performed by Function calculateConstructionResultStats( )—

A function calculateConstructionResultStats( ) is configured to process the aggregated summary of all the identified evidence from DataFrame (parent_df) and calculate high level statistics for the two main tabs of the interactive Graphical User Interface (GUI)—Result Statistics and Review Analysis.

Setup: The function begins with initializing a final dictionary (resultstat).

Calculate Construction Return Tab Data: It identifies all unique construction identifiers (ConstructionIDs) from DataFrame (parent_df) that holds all the identified evidence. For each unique Construction identifier (uniqueConstructionID), a dictionary (returnTab), is created to hold its statistics. A subset of DataFrame (parent_df) for the current construction identifier (constructionID) is created. The number of distinct documents (noOfDocument) and the total number of supporting extracts (noOfSupportingCites) are calculated. These statistics are populated into data structure array (returnTab), which is then appended to a data structure array list (returnsTabLis). This creates data structure for display on the interactive Graphical User Interface (GUI), which is organized by claim construction, displaying the documents and the total number of supporting extracts, for each construction.

Calculate Construction Document Tab Data: The function identifies all unique document identifiers (DocumentKeys) from DataFrame (parent_df) that contains any evidence. For each unique document identifier (uniqueDocumentKey, a dictionary (docTab) is initialized. A subset DataFrame (sub_df) of parent_df for the current document identifier (documentKey) is created. The name of the document is retrieved, and the total number of supporting extracts (count) found within this document across all constructions is calculated. These statistics are populated into data structure array docTab, which is then appended to a data structure array list (documentTabLis). This process generates data for display on the interactive Graphical User Interface (GUI), which is organized by source document, showing the count of evidence found in each document for any of the proposed constructions.

Final Assembly: The calculated statistics are assembled into a final nested dictionary structure (resultstat) required for display on the interactive Graphical User Interface (GUI). This nested dictionary structure (resultstat) comprises of the patentNo, constructionReturnTabData (from returnsTabLis), and constructionDocumentTabData (from documentTabLis). The function returns nested dictionary structure (resultstat).

Together, functions performConstructionRanking( ) and calculateConstructionResultStats( ) create a complete and powerful workflow. The function performConstructionRanking( ) performs AI-powered search, ranking, and deduplication, while another function calculateConstructionResultStats( ) acts as a sophisticated reporting layer, transforming complex analytical results into clear, intuitive, and actionable insights for the interactive Graphical User Interface (GUI).

### Infringement Analysis Module

### Infringement Analysis Module, of a System, Method and User Displays for Patent Claim Analysis and Evidence Identification, Extraction, Analysis, and Charting.

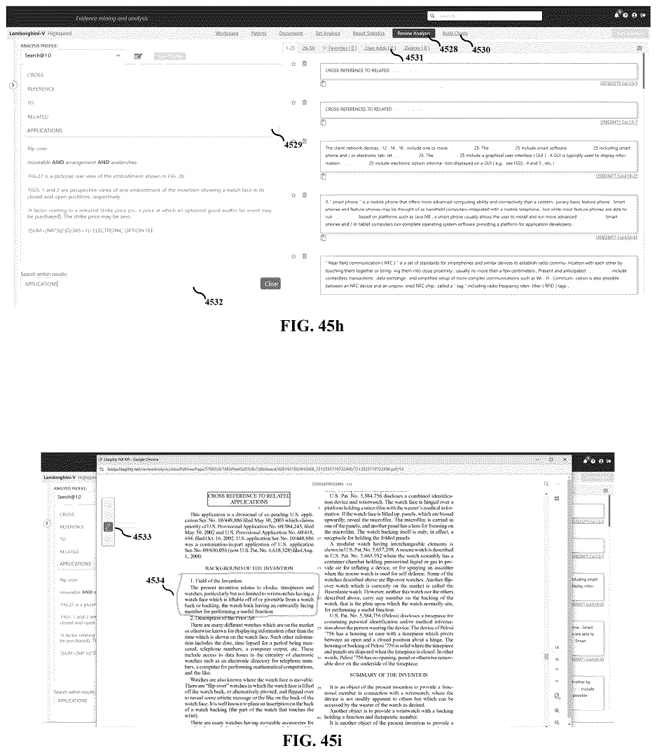

FIG. 43 illustrates a workflow process 4300 of the Infringement Analysis Module 3907, of a system, method and user displays for patent claim analysis and evidence identification, extraction, analysis, and charting 3900 according to various aspects of the present disclosure. An Infringement Analysis Module 3907 of the present disclosure provides a centralized platform for users, such as a plaintiff or a defendant 4302, to organize, manage, and analyze evidence by selecting infringement module 4301. The Infringement Analysis Module 3907 enables a plaintiff 4302 to build an argument for infringement by mapping each element of an asserted patent claim to specific features of an accused product. Conversely, a defendant 4302 may utilize the Infringement Analysis Module 3907 to develop a defensive strategy, whether arguing for non-infringement or invalidity. When user selects run analysis 4305, the Infringement Analysis Module 3907 is configured to automate evidence loading, mining, and matching capabilities, and to facilitate the linking of specific evidence directly to a claim element using hyperlinked citations. A ranking algorithm 4307 (rank the evidence and review analysis) of the Infringement Analysis Module 3907 is configured to match claim elements 4303 (set parsed elements of the selected patent) to relevant evidence excerpts from evidence uploaded in the file manager 4304 and present a visual interface, review result statistics 4306 based on the number of matches categorized such as, Good, Possible, or Weak, with corresponding color-coding or user-defined preferences. Moreover, the ranking algorithm 4307 of the Infringement Analysis Module 3907 matches and displays evidence extracts, and summarizes the total number of elements matched, and the total extracts corresponding to each patent, along with other insights. The interactive Graphical User Interface (GUI) allows documents to be marked as user favorites and indicates matches between elements and documents, along with the identified total number of extracts. The automated process eliminates repetitive tasks, while the interactive Graphical User Interface (GUI) provides a visual comparison of various ranked evidence documents. The interactive Graphical User Interface (GUI) also offers a side-by-side layout of claim elements with matching evidence, allowing users to review and edit with pagination of relevant evidence extracts and eventually build charts 4308. The Deep Infringement Analysis and Statistical Reporting feature performs infringement analysis and statistical reporting. It utilizes a multi-level nested loop to individually analyze each claim element against a substantial body of evidence, employing Large Language Models to semantically score similar text extracts. A unique feature of the module is its stateful analysis, which retrieves and integrates user feedback, such as ones marked as favorites or for deletions from prior sessions, to integrate with the current analysis. The module saves these results to a database, which serves as a state machine for future analyses. It generates multi-faceted statistics, such as Elements Satisfied and Only Element to provide meaningful insights, and formats the output with color-coded metrics and real-time UI updates, thereby transforming raw data into actionable intelligence for users.

FIG. 43a illustrates an interactive Graphical User Interface (GUI) 4300a configured to manage infringement analysis within the system for patent claim analysis and evidence identification, extraction, analysis, and charting 3900, of the present disclosure. The Set Analysis 4309 of the interactive Graphical User Interface (GUI) is configured to allow a user to select a type of analysis to be conducted from among a plurality of available modules. The user may selectively initiate one analysis type at a time, such as infringement, invalidity, claim construction, or prior-art search. Upon selection of the Infringement module 4311 from the module section, it enables the user to conduct infringement analysis of an accused product 4312 as selected by the user. The infringement module 4311, within the Set Analysis interface 4309, allows the user to generate a new analysis profile or select an existing analysis profile, referred to herein as an Infringement Analysis Profile. Within this module, the user may designate the relevant parties, such as a plaintiff or a defendant, input their respective interpretations of claim terms, and define the corresponding claim elements. Additionally, the user may choose to perform analysis between a Parsed elements option or a Claim text 4313 option. The Parsed elements option provides both the claim text and a parsed representation of the selected claim, whereas the Claim text option displays only the patent claim elements. The user selects a settings option associated with the desired patents from the Patents section 4314. In response, a Claim Element Settings pop-up window 4315 is generated on the interactive Graphical User Interface (GUI), enabling the user to designate specific claims for analysis. Within this window, the user may perform several actions such as, but not limited to inserting or modifying parsed elements in accordance with the claim language and corresponding description by selecting a tool icon 4316 available on the interactive Graphical User Interface (GUI). Furthermore, the user is provided with an option to associate synonyms or related terms for the selected keywords by utilizing synonyms feature available within the Claim Element Settings window 4315. Upon completion, the user may save the configured settings. The user can import one or more documents from a document file manager and associate them with the Document Analysis List 4317 for subsequent analysis. The users may select one or more documents from a File Manager 4318 pop-up window. The user is enabled to store the complete configuration of claim settings and required elements associated with the selected patent by creating an Analysis Profile 4310. The user may thereafter either Save Profile 4319 or proceed to Run Analysis 4320

FIG. 43b illustrates an interactive Graphical User Interface (GUI) 4300b of the results statistics page of the Infringement Analysis Module 3907, of a system, method and user displays for patent claim analysis and evidence identification, extraction, analysis, and charting 3900 according to various aspects of the present disclosure. Result Statistics 4321 interactive Graphical User Interface (GUI) is configured to present a summary of the analyzed patents. The user may select a specific patent from the Patents 4322 section to view a corresponding claim analysis summary. Within the Summary 4323 section, the number of claims analyzed is displayed, along with a color-coded rating scheme, such as Green, Yellow and Grey, or any other coding scheme as per user preference, for indicating the relevancy. Upon selection of the Result Statistics 4321, an interactive Graphical User Interface (GUI) 4300b comprising of two tabs—Claims 4324 and Documents 4325 is generated. By selecting the Claims view 4324, the number of claims with respective claim elements that have been analyzed is displayed in separate columns, with each column annotated by the relevant color-coded rating. For example, a Green colored column indicates explicit relevancy with all claim elements, Yellow colored column denotes implicit relevancy, and Grey colored column signifies a lack of relevance.

FIG. 43c illustrates another view 4300c of the interactive Graphical User Interface (GUI) of the results statistics page of the Infringement Analysis Module 3907, of a system, method and user displays for patent claim analysis and evidence identification, extraction, analysis, and charting 3900 according to various aspects of the present disclosure. The Result Statistics 4321 of the interactive Graphical User Interface (GUI) is configured to display a summary of the analyzed patents. When the user selects the Documents view 4325, a list of documents from which data has been extracted is presented. Upon selecting a specific document, the user is enabled to either view the document within the interface or download the selected document by activating the Download 4326 button.

FIG. 43d illustrates an interactive Graphical User Interface (GUI) of the Review Analysis 4300d page of the Infringement Analysis Module 3907, of a system, method and user displays for patent claim analysis and evidence identification, extraction, analysis, and charting 3900 according to various aspects of the present disclosure. The Review Analysis 4327 of interactive Graphical User Interface (GUI), is designed to help users analyze patent claims. To initiate the process, a user selects a patent and a specific claim using the Patent Selection option 4328 and the Claim Selection option 4329, respectively. The interactive Graphical User Interface (GUI) then displays relevant data sequentially, which has been extracted from prior-art documents uploaded through file manager 4317. For each piece of extracted data, the interactive Graphical User Interface (GUI) enables users to mark each piece of extracted data as a favorite by clicking a star icon or to delete it by clicking a delete icon, based on its relevance. For more focused viewing, the Show Favorite Selection Inline option 4333 moves all favorite excerpts to the top of the relevancy data display section. Additionally, the interactive Graphical User Interface (GUI) includes a Favorite section 4331 and a Delete section 4332. By clicking these sections, users can view only the results they have marked as favorites or designated for deletion, thereby providing a streamlined method to manage and review their analysis. Further, the interactive Graphical User Interface (GUI) displays relevant evidences in a paginated format 4330.

FIG. 43e illustrates another view 4300e of the interactive Graphical User Interface (GUI) of the Review Analysis page of the Infringement Analysis Module 3907, of a system, method and user displays for patent claim analysis and evidence identification, extraction, analysis, and charting 3900 according to various aspects of the present disclosure. The Review Analysis 4327 of the interactive Graphical User Interface (GUI), is configured to present a claim analysis window. To add new relevant data from the uploaded documents, the user may navigate to the User Adds section 4334 within the Review Analysis 4327 interactive Graphical User Interface (GUI). The user selects a document via the Document Selection 4335 option, whereupon the selected document is opened as a pop-up window within the interface. The user may then activate a marking icon available in the tool bar 4336 to highlight and select the relevant portion of the text from the selected document as shown in 4337. The selected content is thereby added to the User Adds 4334 repository for inclusion in the claim analysis. User may click on Build Chart 4338 to create or view relevant claim charts.

FIG. 43f illustrates a Build Chart interactive Graphical User Interface (GUI) 4300f of the Infringement Analysis Module 3907, of a system, method and user displays for patent claim analysis and evidence identification, extraction, analysis, and charting 3900 according to various aspects of the present disclosure. The Build Chart interactive Graphical User Interface (GUI) 4300f, is configured to display an analysis profile window 4339. The user may select a specific patent 4340 and the corresponding data tabs 4341 intended for export. Upon activating the Build Chart button 4342, the system compiles the claim chart analysis data and initiates the download of the resulting output.

FIG. 43g illustrates a database schema 4300g showing technical relationships between at least a portion of the database tables for the functionality related to the Infringement Analysis Module 3907 of the present disclosure. APPENDIX XII describes pseudocode for frontend and backend functions implemented for Infringement Analysis Module 3907, of a system, method and user displays for patent claim analysis and evidence identification, extraction, analysis, and charting 3900 in accordance with the present disclosure.

### Frontend Code for Claim Element Selection in Set Analysis

The frontend implementation of the claim element selection functionality within the Set Analysis module is designed to handle the user interaction related to selecting or deselecting elements of a claim for infringement or invalidity analysis. This interaction is facilitated through a dynamic checkbox-based interface, wherein each claim element is represented by a corresponding checkbox rendered within the claim chart UI. After patent claims are automatically extracted and parsed by the Patent Load Module, users are required to precisely select or deselect elements of a claim for further analysis, including infringement analysis, invalidity assessment, or detailed review. There exists a need for a seamless, efficient and user-friendly method that enables users to capture user-based selections of patent claims, and to store and retrieve these selections for analysis.

The primary frontend function saveSelectedClaim( ) is configured to allow users to interactively select or deselect discrete patent claim elements on an interactive Graphical User Interface (GUI). This function is invoked upon user actions such as checking or unchecking claim elements and initializes two arrays: selected and notSelected, to capture the current selection state. The function iterates over all checkbox elements with the class checkBoxListCls, sorting the checked items into the selected array and the unchecked ones into the notSelected array.

To ensure interface consistency, if no checkboxes are selected, the function explicitly unchecks the select all checkbox (chkAll) and applies default visual styles. This avoids user confusion regarding the bulk-selection status.

Once the selection state is gathered, the function retrieves the relevant claim identifier (claimID) from a hidden input field embedded in the UI. A structured AJAX POST request is then performed to a defined URL to the backend, server-side endpoint designed to save the selection state. This request includes the selected array the, notSelected array, and the claimID parameters.

Upon receiving a successful response (HTTP status code) from the backend, the frontend displays a success message in the UI element (#spanMsgDisplay), dismisses a preloader, and sets a timeout to clear the message after a pre-defined time. Additionally, if a specific request type (reqType) is ‘AC’, a function createTempOnChange( ) is called with a claimID and an action type ‘CLAIM’, potentially triggering further backend processing or a temporary data update related to the claim selection. This mechanism ensures a responsive and state-aware interactive Graphical User Interface (GUI) that dynamically reflects claim element selections, thereby enabling accurate construction of infringement and invalidity mappings in real time.

### Backend Process to Save Selected Claim Elements

The backend component of the claim selection system is implemented through an API endpoint saveSelectedClaim( ), specifically designed to process AJAX POST requests originating from the frontend when claim element selections are modified by the user. Upon receiving a request, the backend verifies that it is an AJAX request and disables auto-rendering to optimize performance for this data-only operation. It then extracts essential data points from the incoming request, including a claim identifier (claimID), arrays of selected and unselected element identifiers (selectedID[ ], notSelectedID[ ]), and an optional context marker (page), which may hold values such as, but not limited to, ‘patent’. The core data update logic is handled by a model-layer function, saveSelectedClaim(claimID, selectedID[ ], notSelectedID[ ]). This function performs bulk updates to the database table, tbl_parent_child_data, where each record corresponds to a child claim element. All elements listed in the array selectedID[ ] are updated to reflect a selection status (select_status=1), while those in the array notSelectedID[ ] are marked as unselected (select_status=0). The method constructs SQL queries for efficiency, enabling high-performance updates even for large datasets.

If the request originated from a patent-specific context, the controller invokes a secondary function insertedTempClaim(claimId, selectedID), to maintain a temporary version of the selected elements, which can be used for drafting or iterative analysis workflows.

Subsequently, the backend retrieves the updated selection data by calling the function getSelectedClaimDt(claimID), and then dispatches it to a processing function sendEditedClaims( ), to update or recalculate the claim chart or analytics behind the scenes.

Finally, the backend assembles a JSON response based on the outcome of the database operations, comprising a successful response status of 6000 and a success message, or a failure response status of 7000 and a failure message.

### Backend Model-Layer Claim Selection Update Logic

A backend model-layer function saveSelectedClaim(claimID, selectedID[ ], notSelectedID[ ]), is configured to update the select_status flag in the backend database. For each array:
It first converts the list of selected or unselected element IDs into a comma-separated string for building SQL update queries.
It then constructs two separate SQL UPDATE queries—one to set select_status=1 for the selected IDs, and another to set select_status=0 for the unselected IDs.
Both queries are constructed such that the database key (fk_claim_details_id) matches the provided claimID to ensure updates are made to the currently processed claim.
The model function efficiently performs bulk updates of the selection status of claims in the database table, tbl_parent_child_data using SQL update queries, which offers significantly better performance than individual updates. The method returns true to indicate completion of the update operations.

This backend model-layer function ensures that the selection or deselection of patent claim elements by a user is reliably updated in the database.

### Client-Side Method for Analysis Configuration and Initiation

A client-side function runAnalysisPopUp( ) is initiated through an interactive Graphical User Interface (GUI) and configured to ensure that all necessary parameters are selected and validated before an analysis profile is saved. The process begins by receiving a plurality of user inputs. A primary input is the selection of an analysis module from a predefined set comprising of Infringement, Invalidity, Construction, or Search. The function validates that a module has been selected. Based on the selected module, the function requires additional inputs and validates it. For instance, if the Infringement or Invalidity module is selected, the function requires the selection of one or more patent documents and one or more specific claims within said documents.

The interactive Graphical User Interface (GUI) dynamically renders additional configuration options based on the selected analysis module. These options may include checkboxes for including or excluding specific data types in the analysis, such as, but not limited to, user-defined Favorites, User Additions, or Deletions. Furthermore, an option to base the new analysis on a previous analysis profile may be presented, allowing for iterative analysis builds.

Upon receiving the necessary inputs, the function displays a confirmation modal. This modal prompts the user to enter a unique profile name for the analysis configuration and initiate one of the two user actions, one to Save the configuration as an analysis profile, or to Save and Run Analysis, which saves the profile and immediately initiates the analysis process.

Before executing one of the user actions, the system performs an asynchronous AJAX request to the server to verify that the entered profile name is unique within the project, preventing duplicate entries. Upon successful validation, the client-side script aggregates user selections into a structured data object based on the analysis module as chosen by the user.

The aggregated structured data object is transmitted to a corresponding server-side function via an asynchronous AJAX POST request. The request includes an action type parameter indicating the user action, ‘Save’ or ‘Save and Run Analysis’. During this process, interactive elements of the interactive Graphical User Interface (GUI) are temporarily disabled to prevent conflicting user actions.

Upon receiving a response from the server, the function configures the interactive Graphical User Interface (GUI) elements. Based on the server response, the function displays a confirmation message.

### Server-Side Method for Analysis Processing and Persistence

A server-side function analysis( ) is configured to receive the session data and request payload for further processing and storing an analysis profile or transmitting it to an external API. The server-side function analysis( ) receives the POST request from the client, authenticates the user based on session data and extracts the entire payload, including the selected documents, claims, module type, profile name, and the specified action type. The server-side function analysis( ) queries one or more databases to retrieve data structure for the selected claims and corresponding concept and synonym data that the user has previously saved for the selected patents. The received data structure (datastructure) is compiled into validated request object. Based on the action type, the function determines subsequent steps. If the user chooses to Save, the function saves the entire analysis configuration as a new analysis profile in the database. Alternatively, if the user selects Save and Run, the function first saves the profile and then transmits the configuration to an external API to begin asynchronous processing. In either case, a success response is sent to the user confirming that the profile was saved or that the analysis has been initiated.

A server-side data Persistence Function insertAnalysedDocs( ), is configured to manage the SQL insertion logic. The function receives the complete analysis configuration and formats it for database storage. This includes compiling data into a complex data structures and JSON strings, concatenating lists of patent numbers, and escaping data as needed. A database statement INSERT is executed to store all configuration parameters into a single row in the database table (analyzed_document_list), creating a comprehensive and retrievable analysis profile. The function returns the unique primary key, last inserted ID of the new record.

### Server-Side Processing of Infringement Analysis Module

In one embodiment of the present disclosure, a Main Infringement Analysis Function on the server-side, typically implemented as infringementAnalysis( ), is configured to perform patent infringement analysis. The function facilitates and automates the complete workflow process, including, but not limited to, data initialization, implementation of analysis including, but not limited to, comparison with evidence, calculating similarity scores, incorporating user feedback from previous versions, and generating statistical reports for the interactive Graphical User Interface (GUI) and storing results into a database. The infringementAnalysis( ) function, receives input parameters such as, but not limited to, a master set of evidence extracts (extractsData), structured patent claims (claimsData), concepts (concepts), a unique version identifier (version), project details (projectDetails), feedback from previous analysis runs (userFeedback), and userID.

After initialization and data preparation, the infringementAnalysis( ) function iterates through each patentNumber analyzing every single claim element and corroborating each claim element with evidence.

Initialization and Data Preparation: The function begins by initializing data structures to hold the results of all the patents (finalDict) and claim-level similarity scores (all_patents_results). The function retrieves identified unique patent numbers from claimsData and unique list of all document names from evidence data (extractsData). A tracking DataFrame (track_extracts_df), is initialized to ensure that each piece of evidence is counted only once for aggregate statistics. A highly sophisticated and advanced feature of this embodiment is its state-aware analysis, wherein the function incorporates user feedback (userFeedback) from a previous analysis version. If userFeedback is available, the function extracts a list of favorites and deleted items from a database table (temp_micro_ranking_save) wherein favourite_status is ‘1’ or active_status is ‘1’. This ensures that the system treats each analysis run as an iterative refinement of a prior session, rather than a brand-new task.

Core AI-Powered Analysis: The function performs the following core steps for each claim element in the nested loop:
The function iterates through each patentNumber to be analyzed and retrieves claims for each patent. The function also initializes data structures to store statistical data during processing and a data structure to track documents designated for highlighting on the interactive Graphical User Interface (GUI).
The function further iterates through each claim element while updating a status message regarding the server-side processing on the interactive Graphical User Interface (GUI)

Unique Hash Key Generation: The function generates a unique and repeatable hash key for each specific claim element and analysis version. This unique hash key links the claim element to all the associated ranked evidence in the database.

core Semantic AI Analysis: The function invokes a specialized AI-powered analysis function kpanalyzedInfringement( ), which compares the claim element text against the entire body of evidence extracts, using underlying LLM embedding models to find and score the most conceptually similar text extracts.

Result Filtering: The function filters out low-confidence results, such as, but not limited to, results with a similarity score less than 0.1.

User Feedback Integration: A key differentiator is the ability of the function to incorporate a previous version of the analysis or user feedback from previous analyses into a new analysis version, to ensure that the user's prior work is not lost. The function initializes two data structure lists, final_fav and final_del, to track favorite and deleted items for the current analysis. The function checks if the current claimElementId has any previously saved Favorites. For each of these favorited items from a previous analysis, the function finds a matching evidence extract in the current results. If a match is found, the item is marked as a favorite and a yellow highlight is applied for the interactive Graphical User Interface (GUI). However, if a previously favorited item from the previous analysis cannot be found in the new results, the function re-adds this lost favorite to a temporary list with a low ranking, thereby preserving the previous version of the user feedback.

Similar logic is then applied to items marked for Deletes from a previous analysis. The function infringementAnalysis( ) searches for previously deleted items, marks them within the new results, and applies a blue highlight, thereby preventing them from being accidentally presented again as high-priority matches. This process allows users to iteratively refine their results over time without requiring to restart of the entire analysis.

Data Persistence: After completing the core analysis, the function assembles and stores the results in a relational database. The function adds the user feedback status lists, such as favourite_status and active_status, as new columns to the main DataFrame (analyzed_df). A DataFrame is defined as a two-dimensional, mutable data structure with labeled columns and rows, which is analogous to a spreadsheet or a table in a relational database. In some embodiments, a DataFrame is constructed from a dataset with named columns, thereby allowing its data schema to be easily inferred.

The function infringementAnalysis( ) concatenates lost favorites or deleted items from a previous version, which were temporarily stored in a separate DataFrame (df_additional), back into the primary DataFrame, thereby preserving the previous version of the user feedback. In addition, the function generates citations in a format readable by users, for each piece of evidence, for example, p. 43, lines 10-15 and assembles all the detailed data for the current claim element into a dictionary(rankedData), which includes the project ID, ranks, document keys, hash key, and similarity scores. This rankedData dictionary is then inserted into a database table, temp_micro_ranking_save to permanently store the ranked evidence, for this specific claim element. If a feature for carrying forward user comments is enabled, the system also transfers user comments from the previous version to the new results.

### Calculation of Claim-Level and Document-Level Statistics

Following the core analysis for each claim element, the system calculates and aggregates both claim-level and document-level statistics.

For claim-level statistics, the function infringementAnalysis( ) determines the highest similarity score using the variable such as max_similarity for the current claim element by finding the highest score within the DataFrame analyzed_df. It then appends a summary of the claim, including but not limited to, patentNumber, claimElementText, claimElementId, and max_similarity, to a master results list (for_every_patent).

For document-level statistics, the function infringementAnalysis( ) first identifies and tracks unique evidence extracts to avoid double-counting. It filters the DataFrame analyzed_df to find new extracts not yet present in a master tracking DataFrame (track_extracts_df) and updates the tracking DataFrame with these new unique extracts. For each document, it calculates two key metrics—one is the count of new relevant extracts found for the current claim element (tempTotalExtracts), and a binary value indicating whether the document contained at least one piece of evidence for this claim element (tempTotalSatisfed). The function also identifies if all evidence for a claim element originated from only one document, which is crucial Only Element statistic, and updates a list, totalUniqueList accordingly. These current claim-level statistics are then aggregated into patent-level totals by adding tempTotalExtracts to totalExtractsList and tempTotalSatisfied to totalSatisfiedList.

Bolding logic: A key feature of reporting is the Bolding Logic. Upon completion of processing of all elements of a specific claim, the function checks each document to determine if it satisfies every element of that claim. If total satisfied count of a document matches the number of claim elements, the function flags that document for highlighting. This flag is used to visually emphasize documents in the interactive Graphical User Interface (GUI) that provide supporting evidence for every element of a given claim. While the background processing is performed, real-time progress updates are displayed on the interactive Graphical User Interface (GUI). As each claim element is processed, the system updates a percentage counter and sends a status message, such as Claim Element Completed, back to the frontend. This ensures the user is informed of the task's progress without necessitating a wait for the entire operation to finish.

Patent-Level Finalization: This section of the workflow performs final steps for each patent after all of its claims and claim elements have been analyzed. First, the function sends status updates to the user, indicating that Document Highlighting has commenced. It then calls a function highlightResultStatDocs( ) to generate highlighted versions of the source documents, which is a crucial step for visually presenting the analytical results. A status update is sent to the interactive Graphical User Interface (GUI) to confirm completion of this process. Next, the system initiates the Final Statistics Calculation. It adds bolding information (‘|Y’ or ‘|N’) to the document names, and creates a list, esdocumentnames. This flag, which was determined in a previous step, is used to highlight documents in the interactive Graphical User Interface (GUI) that satisfy all elements of a claim.

The function infringementAnalysis( ) sorts and structures the final statistics or metrics for presentation on the interactive Graphical User Interface (GUI). It creates final dictionaries for three key analytical views:
Elements Satisfied (ES): This metric highlights documents deemed most promising as they contain evidence for the highest number of claim elements.
Total Extracts (TE): This metric indicates documents that are richest in relevant content, providing a measure of the volume of supporting evidence.
Only Element (OE): This metric highlights documents which may be the only source of evidence for a particular claim element, thereby indicating their exceptional importance for the analysis.

The function also programmatically determines which documents have satisfied all elements of a claim, marking them for visual emphasis in the interactive Graphical User Interface (GUI) through features such as bolding or highlighting.

These final statistics dictionaries for the current patent are stored in a master dictionary, such as finalDict, keyed by patentNumber. Finally, a status update is sent to the interactive Graphical User Interface (GUI) to indicate that the analysis for this patent is Completed, and the loop proceeds to the next patent.

### Invalidity Analysis Module, of a System, Method and User Displays for Patent Claim Analysis and Evidence Identification, Extraction, Analysis, and Charting.

In one embodiment, an Invalidity Analysis Module 3908 of the present disclosure provides a centralized platform for a user, such as a plaintiff or a defendant, to organize, manage, and analyze evidence to determine the validity or invalidity of the patents. The Invalidity Analysis Module 3908 enables a user to construct arguments or counter-arguments for determining the validity of a patent by carefully reviewing each prior-art reference and comparing it against the scope of each limitation in the patent claim. In a conventional method, the process is time-consuming and cumbersome.

A need exists for a method and system that enables users to search for and review the most relevant prior-art and compare it with the patent elements. The Invalidity Analysis Module 3908 of the present disclosure, as described herein, accomplishes this and other purposes.

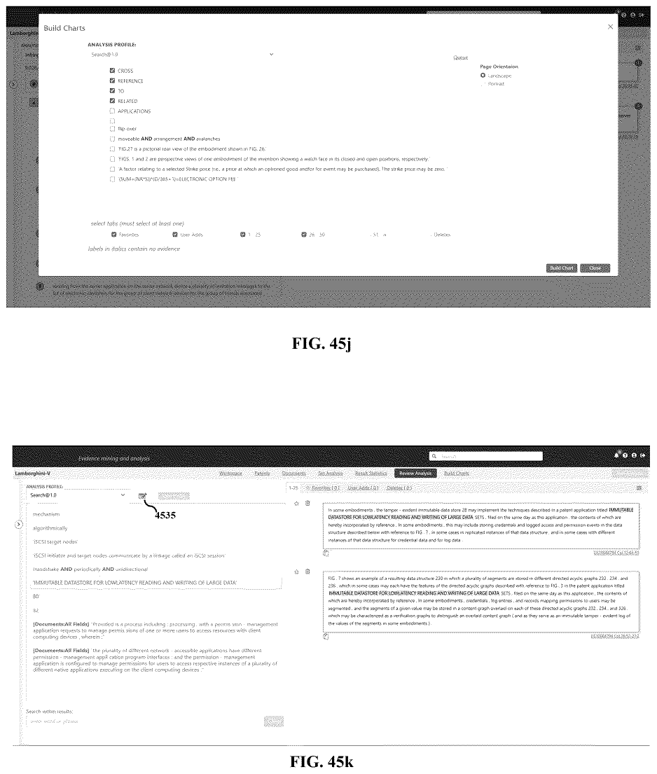

FIG. 44 illustrates a workflow process 4400 of an Invalidity Analysis Module 3908, of a system, method and user displays for patent claim analysis and evidence identification, extraction, analysis, and charting 3900 according to various aspects of the present disclosure.

In one embodiment, Invalidity Analysis Module 3908 provides a centralized platform enabling users to organize, manage, and analyze evidence by selecting 4401 the Invalidity Analysis Module. A user may establish a profile by selecting patents, claim elements, and sets of synonyms 4402, and uploading relevant documents via file manager 4403. The Invalidity Analysis Module 3908 is further configured to automate evidence loading, mining, and matching, and to facilitate linking of specific evidence directly to a claim element through hyperlinked citations when the user initiates a Run Analysis operation 4404.

A ranking algorithm 4406 of the Invalidity Analysis Module 3908 is configured to match claim elements 4402 against relevant evidence excerpts from the documents uploaded into the file manager 4403. The algorithm presents the results through a visual interface and a Review Result Statistics user display 4405, which categorizes the matches, such as Good, Possible, or Weak, with corresponding color-coding schemes, or user-defined preferences. In addition, the ranking algorithm 4406 generates summaries that include the total number of matched elements, and the total number of evidence extracts corresponding to each patent, along with additional analytical insights.

The interactive Graphical User Interface (GUI) allows users to mark excerpts as favorites and provides indicators of matches between claim elements and evidence documents, together with the identified total number of extracts. The automated processing reduces repetitive tasks, while the interactive Graphical User Interface (GUI) provides intuitive, side-by-side comparisons of claim elements and ranked evidence documents. In some embodiments, the interactive Graphical User Interface (GUI) further enables editing, pagination of evidence extracts, and chart generation 4407, thereby facilitating efficient invalidation analysis.

FIG. 44a illustrates an interactive Graphical User Interface (GUI) 4400a configured to manage invalidity analysis within the system for patent claim analysis and evidence identification, extraction, analysis, and charting 3900, of the present disclosure. A Set Analysis interface 4408 is provided to allow a user to select the desired type of analysis from among a plurality of available modules. In some embodiments, the user may initiate one analysis type at a time, such as infringement, invalidity, claim construction, or prior-art search.

Upon selection of the Invalidity module from Module section 4410, it enables the user to conduct invalidity analysis. Within the Set Analysis interface 4408, the interactive Graphical User Interface (GUI) 4400a allows the user to generate a new analysis profile, referred to herein as an Invalidity Analysis Profile. To create such a profile, the user may select an Analysis Profile 4409 option and designate Invalidity as the analysis mode in the Module section 4410. The user may then choose to perform analysis using either a Parsed elements option or a Claim text option 4412. The Parsed elements option provides both the full claim text and a parsed representation of the selected claim, whereas the Claim text option displays only the patent claim elements.

From Patents section 4411, the user may select a settings option associated with the desired patent. In response, a Claim Element Settings pop-up window is generated, enabling the user to designate specific claims for analysis. Within this window, the user may perform several actions, including, but not limited to, inserting or modifying parsed elements in accordance with the claim language and corresponding description by selecting a tool icon available on the interface. Additionally, the user is provided with an option to associate synonyms or related terms with selected keywords using a synonyms feature provided within the Claim Element Settings window. Once configured, the user may save the designated settings.

The system further allows the user to import one or more documents from a document file manager and associate them with a Document Analysis List 4413 for subsequent analysis. Documents may be selected through a File Manager pop-up window.

The user can store the complete configuration of claim settings and required elements associated with the selected patent by creating an analysis profile 4409. Thereafter, the user may save the profile and proceed by initiating a Run Analysis operation 4414.

FIG. 44b illustrates an interactive Graphical User Interface (GUI) 4400b of a Review Analysis interface 4415 of the Invalidity Analysis Module 3908, within a system, method, and interactive Graphical User Interface (GUI) configured for patent claim analysis and evidence identification, extraction, analysis, and charting 3900 according to various aspects of the present disclosure. Upon selection of the Review Analysis option 4415, a user may select a corresponding target patent using a patent selection option 4416 and thereafter select the corresponding claim number using a claims selection option 4417. A claim element panel of 4418 is displayed on the left side of the interactive Graphical User Interface (GUI), presenting the claim elements for the selected patent. Upon selection of a claim, the system automatically parses and segments the claim text into a plurality of individual claim elements 4419, each labeled sequentially (e.g., p, a, b, c, d, e) to facilitate element-level analysis.

When a parsed claim element 4420 is selected, the relevant evidence is extracted from uploaded documents and displayed on the right side 4421 of the interactive Graphical User Interface (GUI) 4400b. The Evidence snippets 4422, comprising textual excerpts from relevant prior-art documents, are presented within this section. For each snippet, the interface allows a user to mark the excerpt as a favorite by selecting a star icon or to delete the excerpt by selecting a delete icon, based on assessed relevance. In response, the evidence snippets 4422 are automatically moved to corresponding categorized sections marked as Favorites or Deletes.

Additionally, the user may manually add evidence by selecting a User Adds option 4423. In such embodiments, the user selects a document via a document selection section 4424 and highlights relevant text using a marker option within a User Add pop-up window. A document identifier 4425 is provided to indicate the source document and the location from which the corresponding evidence snippet was obtained.

FIG. 44c illustrates an interactive Graphical User Interface (GUI) 4400c of the Invalidity Analysis Module 3908, upon selection of a Result Statistics option 4426, within a system, method, and interactive Graphical User Interface (GUI) configured for patent claim analysis and evidence identification, extraction, analysis, and charting 3900 according to various aspects of the present disclosure. In this view, a user selects the Claims section 4427 and thereafter selects a desired claim number within a specific claim selection section 4428, thereby facilitating a direct comparison between prior-art references or other uploaded documents for each selected claim element.

Upon selection of a specific claim element within the claim selection section 4428, a corresponding parsed claim element 4429 is displayed in an associated row 4430. Each row 4430 corresponds to a different prior-art document uploaded into the system. Each prior-art document row 4431 is annotated with a color-coded indicator to visually denote the relevancy of the parsed claim element 4429 relative to the corresponding prior-art document.

The color-coding scheme provides an intuitive representation of relevance levels, such as high, medium, or low, thereby enabling a user to rapidly identify which prior-art documents are most pertinent to a given claim element and for subsequent analysis. The color-coding scheme can be set as per user-defined preferences.

FIG. 44d illustrates an interactive Graphical User Interface (GUI) 4400d presented upon selection of the Result Statistics option 4426 of Invalidity Analysis Module 3908, of a system, method, and user displays for patent claim analysis and evidence identification, extraction, analysis, and charting 3900 according to various aspects of the present disclosure. In this embodiment, a user may select a particular prior-art document from among the displayed rows 4430. Upon such selection, the interface displays the relevancy mapping of all claim elements 4429 for the selected patent, as shown in the patent selection section, with respect to the chosen prior-art document.

Additionally, the interactive Graphical User Interface (GUI) represents a plurality of prior-art document rows 4430, thereby enabling the user to conduct a comparative review across multiple prior-art references. This arrangement facilitates evaluation of claim element relevancy for different prior-art sources, allowing efficient identification of the strongest references for invalidation analysis.

FIG. 44e illustrates an interactive Graphical User Interface (GUI) 4400e presented upon selection of the Result Statistics option 4426 of the Invalidity Analysis Module 3908, within a system, method, and user displays for patent claim analysis and evidence identification, extraction, analysis, and charting 3900 according to various aspects of the present disclosure. In this embodiment, the user selects the Documents section 4432, wherein a table of rows is generated based on the relevancy criteria specified through the Evidence Relevancy Indication Bar 4433.

Upon selection of the desired relevancy fields, such as Good, Possible, or Weak, the tabular data is dynamically updated across multiple columns for each prior-art document. Each row 4434 corresponds to a different prior-art document, while the multiple columns 4435 provide detailed metrics, including:
a Claims column, indicates the number of claims selected from the target patent in the patent selection section for mapping;
an Elmts column, specifies the total number of parsed claim elements of the target patent that were mapped against the corresponding prior-art document;
an Extracts column, represents the total number of evidence excerpts identified for each parsed claim element; and
a Favs & User Adds column, displays the number of relevant evidence snippets marked as favorites or manually added through the user-adds function.
This tabular presentation enables users to systematically evaluate the strength of prior-art documents across multiple dimensions of relevancy and evidence mapping.

FIG. 44f illustrates an interactive Graphical User Interface (GUI) 4400f presented upon selection of a prior-art document, of the Invalidity Analysis Module, within a system, method, and user displays for patent claim analysis and evidence identification, extraction, analysis, and charting 3900 according to various aspects of the present disclosure. In this embodiment, upon selection of a prior-art document from the row 4434, the system displays the total number of claims of the target patent that are mapped, as shown in section 4436. Each mapped claim is presented with color-coded indicators that denote the relevancy of the evidence. For example, green representing good evidence, yellow indicating possible relevancy, and grey representing weak or no relevancy. Section 4437 further illustrates the parsed claim elements, i.e., the parsed divisions of the selected claim, for further analysis.

The Build Chart interface 4438 is configured to display an analysis profile window. Within this window, the user may select a specific patent and the associated data tabs intended for export. Upon activating the Build Chart button, the system compiles the mapped claim chart analysis data and initiates the download of the resulting output, in a manner similar to that described for the infringement analysis module.

APPENDIX XIII describes pseudocode for frontend and backend functions implemented for Invalidity Analysis Module, of a system, method and user displays for patent claim analysis and evidence identification, extraction, analysis, and charting 3900 in accordance with the present disclosure.

FIG. 43g illustrates a database schema 4300g showing technical relationships between at least a portion of the database tables for the functionality related to the Invalidity Analysis Module of the present disclosure.

### Frontend Implementation for Claim and Document Rendering

The frontend of the system is configured to display an interactive claim and document analysis interface, which is dynamically rendered based on data received from a server. This process is initiated by a function getValidityResultStatData( ), which serves as the primary controller for the interactive Graphical User Interface (GUI). Upon invocation, this function first gathers key identifiers related to the user's selected patent, project, version, and claim. It then dispatches a secure, encoded AJAX POST request to a backend endpoint. Upon receipt of a successful response, the frontend commences the rendering process.

The system first handles the claim analysis block. It utilizes functions, such as dynamicClaimRender( ), to construct an HTML representation of the claim's elements, applying specific visual styles and color-coding for clarity. This process also incorporates a threshold value and any previously saved element combinations.

Subsequently, the document analysis block is initiated. The system identifies all currently selected checkboxes and passes their values, along with the document analysis data from the server, to the function dynamicDocRender( ). This function generates a comprehensive HTML view of the prior-art documents. The final rendered HTML for both the claim and document sections is then inserted into the interactive Graphical User Interface (GUI), and final stylistic updates, such as tooltips and highlighting, are applied to present a complete and coherent view.

### Backend Process for Claim and Document Data Retrieval

The backend of the system is configured to respond to the AJAX POST request from a frontend function getValidityResultStatData( ). This backend component is responsible for retrieving and formatting the data required for a complete validity analysis.

Upon receiving the request, the backend extracts the securely encoded identifiers for the claim, project, version, and patent. It then executes a series of database queries and associated processing logic to gather all necessary information.

Claim Data Retrieval: The backend fetches detailed claim information, including the elements of the claim, any associated alphabetic markers, and count data. This data is structured and prepared for transmission to the frontend for the claim analysis block.

Document Data Retrieval: The backend identifies and retrieves all prior-art documents relevant to the patent and claim being analyzed. This data is processed and organized into an object documentAnalysisData.

After gathering all the required information, the backend assembles a JSON response. This response comprises both the claim analysis data and the document analysis data. Upon successful data retrieval, a status code and a success message are returned along with the payload. If an error occurs, an appropriate failure message is returned. This process ensures that the frontend receives all the necessary information in a single, efficient request, thereby enabling a seamless and responsive user experience.

### Server-Side Processing

In one embodiment of the present disclosure, an Invalidity Analysis Module performs server-side processing in two distinct, yet interconnected functions to provide a comprehensive and intuitive visual report on the analysis of patent claims.

The Invalidity Analysis Module, is designed such that a first function performs searching for existing patents and other publications, known as prior-art that could render the patent claims invalid, that leverages Large Language Models to find relevant evidence. A second function organizes this evidence into a user-friendly and intuitive visual format.

The first function Invalidity_Analysis_Initial_Scoring( ) is configured to perform Evidence Retrieval and Initial Ranking through several steps. The function performs initial set up and initialization, followed by iterations through every single claim element of a patent and uses a specialized AI model function kpanalyzedInvalidity( ) to find conceptually similar text within prior-art documents. Key aspects of the function include the following:
The function performs comprehensive searches for each claim element to ensure no part of the claim is overlooked.
The function integrates user feedback such as Favorites or Deletes from previous analyses conducted. Furthermore, the function automatically re-adds any favorite items that are not found in the new results.
The function performs document-level ranking, wherein it ranks evidence within each prior-art document based on similarity scores. Therefore, evidence match in Document A and an evidence match in Document B may both be assigned a similar rank.
The function performs intermediate persistence to ensure that the raw data and ranked evidence are saved to a temporary database.
The function performs Data Aggregation, wherein it prepares the final output as a single, large DataFrame object containing all the raw results, which is then sent to the next phase for processing.

In the second phase, another function Generate_Final_Analysis_Report( ) is configured to perform Data Transformation and Report Generation. The function receives the single, large DataFrame object from the first phase and transforms it into a nested, multi-dimensional JSON structure for display on the interactive Graphical User Interface (GUI). Key aspects of the function include the following:
The function performs data transformation, including data pivoting and preparation. For each claim element and document pair, the function identifies the highest similarity score and the total number of relevant extracts.
The function performs data densification, wherein for each claim element and document pair, it intelligently identifies any gaps and fills with zero-score entries, thereby ensuring that a complete and accurate visual matrix is available to the user.
The function structures the analyses by different views for reporting purposes. For example, the function organizes data by document or by claim for effective rendering of the report to the user.
The function then translates numerical scores into intuitive color codes for effective rendering of the most relevant documents and evidence on the interactive Graphical User Interface (GUI) and returns dictionary objects for the front-end processing.

### Search Analysis Module

### Search Analysis Module, of a System, Method and User Displays for Patent Claim Analysis and Evidence Identification, Extraction, Analysis, and Charting.

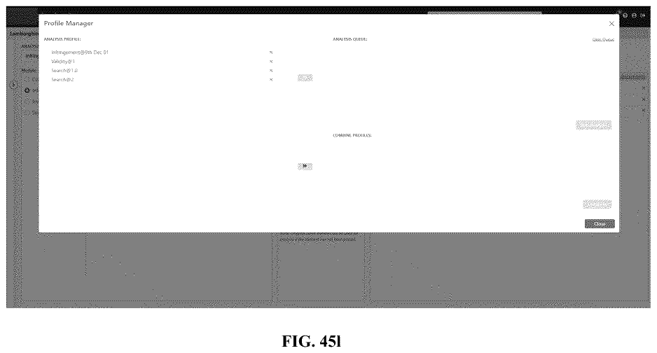

According to various aspects of the present disclosure, FIG. 45 illustrates a workflow process 4500 of a Search Analysis Module configured to search, identify and extract evidence based on a word, phrase, or concept, of a system, method and user displays for patent claim analysis and evidence identification, extraction, analysis, and charting 3900.

In one embodiment of the present disclosure, the workflow 4500 of Search Analysis Module 3909 provides a centralized platform through which a user first selects search module 4501. Thereafter user can organize, manage, and analyze evidence by selecting mode of search, such as, By word/phrase or By concept 4502. The user provides search input parameters such as a word, phrase, or concept, and select one or more corresponding fields 4503 as needed. Documents from which evidence is to be identified and extracted are uploaded into file manager 4504. Based on the provided search input parameters, the workflow 4500 of Search Analysis Module builds evidence mapping by identifying occurrences of the word, phrase, or concept across the uploaded documents 4504, in accordance with the field selection 4503. The workflow 4500 of Search Analysis Module is further configured to automate evidence loading, mining, and matching, and to link specific evidence directly to a word, phrase, or concept through hyperlink citations when the user initiates a run analysis operation 4505.

An algorithm 4507 of the search analysis module is configured to match the provided word, phrase, or concept 4503 with relevant evidence excerpts from the uploaded documents 4504, and to present the results through an interactive Graphical User Interface (GUI), including a Review Result Statistics display 4506. The results may include information such as the number of documents in which the search data appears, as well as the frequency of repetition of the search input parameters within each document. The interactive Graphical User Interface (GUI) further allows users to mark documents or excerpts as favorites, and to visualize matches between elements and documents, along with the total number of identified extracts.

In one embodiment of the present disclosure, the system provides automated processing to reduce repetitive tasks, while the interactive Graphical User Interface (GUI) enables intuitive visual comparison of ranked evidence documents. Additional features may include a side-by-side display of claim elements and matching evidence, pagination of relevant extracts, and editing capabilities, thereby allowing the user to review, refine, and ultimately build charts 4508 representing the analysis.

According to an aspect of the present disclosure, FIG. 45a illustrates an interactive Graphical User Interface (GUI) 4509 configured to search based on a word, phrase, or concept, from uploaded documents, of the Search Analysis Module 3909, within the system, method, and user displays for patent claim analysis and evidence identification, extraction, analysis, and charting 3900.

The Set Analysis interactive Graphical User Interface (GUI) 4510 is configured to allow a user to select a type of analysis to be conducted from among a plurality of available modules. The user may selectively initiate one analysis type at a time, such as infringement, invalidity, claim construction, or prior-art search.

Upon selection of the Search from the Module section 4512, the user is enabled to initiate search analysis within the Set Analysis interactive Graphical User Interface (GUI) 4510. The Search module, within the Set Analysis 4510 of the interactive Graphical User Interface (GUI), allows the user to generate a new analysis or select an existing analysis profile 4511, referred to herein as Search Analysis Profile 4511.

The Search Analysis Module enables users to conduct searches in two approaches, such as, By Word/Phrase 4513 or By Concept 4514.

According to an aspect of the present disclosure, FIG. 45b illustrates the field selection initiated upon user activation of Search For option 4515 within the By Word/Phrase option 4513, of the Search Analysis Module 3909, of a system, method, and user displays for patent claim analysis and evidence identification, extraction, analysis, and charting 3900. The interactive Graphical User Interface (GUI) to conduct search By Word/Phrase enables users to input search parameters, such as words or phrases, and select one or more fields which act as filters to conduct searches across document uploaded in the document manager. One such field enables users to search for words or phrases within documents, by using proximity operators, such as, but not limited to, ANY, ALL, or EXACT PHRASE

According to an aspect of the present disclosure, FIG. 45c illustrates the field selection initiated upon user activation of Field option 4516 within the By Word/Phrase option 4513, of the Search Analysis Module 3909, of a system, method, and user displays for patent claim analysis and evidence identification, extraction, analysis, and charting 3900.

Further, the interactive Graphical User Interface (GUI) enables users to use another document type filter to identify documents and respective sub-sections to conduct search, such as, but not limited to, PATENTS/PATENT APPLICATIONS, EMAILS, or DEPOSITIONS. Users may upload one or more documents to the Documents File Manager, which include, but not limited to, patents or patent applications, emails, or depositions.

The Search Analysis Module 3909 is configured to enable users to input search parameters, select various filters and upload documents. A user may access a Search option 4517 and provide a desired word or phrase to be identified within the uploaded documents. Upon selection of Fields 4516, the ANY field specifies that any one word from the provided phrase will be retrieved if present within the document, the ALL field specifies that all words from the provided phrase must be present, and the EXACT PHRASE field specifies that the complete phrase must be identified within the document. By selecting an Add option 4518, the user may input multiple words or phrases for purposes of evidence identification.

Further, the document type search filter enables the user to specify the location within which the entered word or phrase is to be identified, with selectable categories and sub-sections corresponding to document type. For example, the PATENTS/APPS category includes selectable sub-options such as ALL FIELDS, ABSTRACT, SPEC/CLAIM and FIGURES. Similarly, the EMAILS category includes sub-sections such as ALL FIELDS, TO, FROM, DATE, CC, SUBJECT, ATTACHMENTS, and MESSAGE. These configuration options collectively enable the user to precisely refine the scope of the search across various types of documents and document fields.

According to an aspect of the present disclosure, FIG. 45d illustrates an interactive Graphical User Interface (GUI) 4520 configured to display one or more words or phrases entered by the user, of the Search Analysis Module 3909, of a system, method, and user displays for patent claim analysis and evidence identification, extraction, analysis, and charting 3900. The interface further includes a display portion 4521 configured to present a list of documents uploaded by the user, from which evidence is to be identified and captured.

According to an aspect of the present disclosure, FIG. 45e illustrates an interactive Graphical User Interface (GUI) 4520, of the Search Analysis Module 3909, that is configured to enable user to conduct search based on a concept, within the By concept option 4514, of a system, method, and user displays for patent claim analysis and evidence identification, extraction, analysis, and charting 3900.

In this embodiment, a user may select desired fields through a document type field selection and respective sub-section option 4523 and provide a concept to be identified within document 4522. The Search Analysis Module 3909 is configured to identify the same or similar meaning of the concept, represented by the group of words entered in 4522, within the documents uploaded via the Documents File Manager 4519.

According to an aspect of the present disclosure, FIG. 45f illustrates an interactive Graphical User Interface (GUI), a Search Returns page 4525 of the Result Statistics interface 4524, of the Search Analysis Module 3909, which is configured to display a summary of evidence identified from the uploaded documents, of a system, method, and user displays for patent claim analysis and evidence identification, extraction, analysis, and charting 3900.

In the illustrated embodiment, a Search Returns section 4525 presents the word or phrase entered by the user along with corresponding details, including the number of documents in which the evidence is identified and the frequency of occurrence of the evidence within those documents.

According to an aspect of the present disclosure, FIG. 45g illustrates an interactive Graphical User Interface (GUI), a Result Statistics interface 4524, of the Search Analysis Module 3909, configured to display the uploaded documents within a Documents section 4526, of a system, method, and user displays for patent claim analysis and evidence identification, extraction, analysis, and charting 3900. The Result Statistics interface 4524 also enables the user to download the displayed documents directly from the Documents section 4526 by activating the Download button 4527.

According to an aspect of the present disclosure, FIG. 45h illustrates an interactive Graphical User Interface (GUI), a Review Analysis interface 4528, of the Search Analysis Module 3909, configured to present a word, phrase, or concept analysis window, of a system, method, and user displays for patent claim analysis and evidence identification, extraction, analysis, and charting 3900. Upon selection of a corresponding word, phrase, or concept within section 4529, the interface displays sequentially the associated relevancy data extracted from prior-art documents uploaded via file manager 4519. The user can also search for the word, phare or concept in search bar 4532 which will highlight the search words within the results extracted. For each displayed excerpt, the interface further identifies the document name from which the data has been extracted. In some embodiments, the user is enabled to categorize a given excerpt as a favorite by activating a star icon, or to remove the excerpt by activating a delete icon, based on the assessed relevance of the extracted data.

According to an aspect of the present disclosure, FIG. 45i illustrates an interactive Graphical User Interface (GUI), a User Adds feature 4531 within the Review Analysis interface 4528, of the Search Analysis Module 3909, configured to enable a user to manually add evidence from uploaded documents, of a system, method, and user displays for patent claim analysis and evidence identification, extraction, analysis, and charting 3900. To incorporate new relevant data, the user may navigate to the User Adds section 4531 within the Review Analysis interface 4528 and select a document via a Document Selection option. Upon selection, the corresponding document is opened as a pop-up window within the interface, and the user may then activate a marking icon available in the tool bar 4533 to highlight and select the relevant portion of the text 4534 from the selected document. The highlighted content is then stored within a User Adds repository for subsequent inclusion in the analysis.

According to an aspect of the present disclosure, FIG. 45j illustrates an interactive Graphical User Interface (GUI) of the Search Analysis Module 3909, a Build Charts interface 4530, configured to present an analysis profile, of a system, method, and user displays for patent claim analysis and evidence identification, extraction, analysis, and charting 3900. Within this interface, a user may select one or more words, phrases, and/or concepts, along with corresponding data tabs designated for export. Upon activation of a Build Chart control, the system compiles the selected analysis data into a chart format and initiates download of the generated output.

According to an aspect of the present disclosure, FIG. 45k illustrates another view of an interactive Graphical User Interface (GUI) of the Search Analysis Module 3909, wherein edit option 4535 is configured to enable a user to manage uploaded files, of a system, method, and user displays for patent claim analysis and evidence identification, extraction, analysis, and charting 3900. Through the edit option 4535, the user may remove one or more files from the interface when such files are determined to be unnecessary for the analysis.

According to an aspect of the present disclosure, FIG. 45l further illustrates an interactive Graphical User Interface (GUI), display interface, of the Search Analysis Module 3909, presented upon selection of an edit option 4535 within the Review Analysis interface 4528, of a system, method, and user displays for patent claim analysis and evidence identification, extraction, analysis, and charting 3900. In this embodiment, the interface enables the user to remove previously created files from the analysis environment.

APPENDIX XIV describes pseudocode for frontend and backend functions implemented for Search Analysis Module 3909, of a system, method and user displays for patent claim analysis and evidence identification, extraction, analysis, and charting 3900 in accordance with the present disclosure.

### Client-Side Processing

In one embodiment of the present disclosure, the Search Analysis Module configured to execute, track, and persist complex document analysis configurations. A front-end function saveSearchProfileData(inputValue, type) collects user input, including a set of selected documents, multiple search queries and their corresponding metadata, such as profile type and module, and a unique version name for the analysis profile. A backend processing function, such as searchAnalysis( ), manages the transaction by generating a unique tracking token, translating document names to internal system keys, and persistently logging the analysis profile metadata and associated search terms across several database tables, such as, analyzed_document_list and tbl_search_query_master. The Search Analysis Module is configured to execute queries by dynamically determining the required execution path. For example, word-based queries are processed locally, while concept-based queries are transmitted via an Application Programming Interface (API) call to an external search service. Final processing aggregates the results, merging hit counts for individual documents and compiling summarized statistics (e.g., document-level and query-level hit counts), which are then stored in a dedicated results table, such as, tblresultstats to enable rapid generation of analytical reports.

### Server-Side Processing

In one embodiment of the present disclosure, the server-side processing of the Search Analysis Module is implemented by a function Perform_Concept_Search_and_Ranking( ) which performs an on-demand semantic search to find text extracts conceptually relevant to a user query within a pool of evidence, then intelligently ranks, filters, and saves the results. Following are the key stages of the functionality obtained by the function, include, but not limited to:
The function Perform_Concept_Search_and_Ranking( ) performs a live, on-demand semantic search and ranking of evidence extracts based on a user's query. The process begins with Dynamic Scoping and Filtering of the evidence pool allEvidenceData. This step first determines the target database table based on the search type, such as, but not limited to, tbl_patent, tbl_email, or any other specific database table. If the search is restricted to specific document types or sections, such as, but not limited to, Abstracts, or Claims, or any other section, a pre-filtering step performs a search query to narrow the evidence pool allEvidenceData to filter only the relevant extracts.
To perform the Core Semantic Search, the function Perform_Concept_Search_and_Ranking( ) extracts the plain-text query submitted by the user and converts it into a numerical vector embedding. The function then calculates the cosine similarity between the query embedding and the embedding of all extracts in the scoped evidence pool. The results are created as a ranked list of extracts sorted by descending similarity score.
The function performs Intelligent Result Filtering by calculating the knee point, or elbow of the sorted similarity score distribution. This point represents a dynamic threshold for relevance. The final ranked result set final_ranked_df is then truncated to include only the results at or above an adjusted knee point, optimizing the focus and usefulness of the output.
The function further saves the Search History by assembling and inserting the ranked results, query details, and metadata into a dedicated search history table in the database, enabling users to easily track and review past analyses.
Finally, the function summarizes the results for the interactive Graphical User Interface (GUI). The function groups the final ranked extracts by document, counting the number of hits in each document and returns a summary as document keys, document names, and hit counts) and the target_table_name, enabling the front-end to rapidly display a responsive, high-level overview.

It is to be understood, however, that the present disclosure would not be limited by any means to the components, techniques, and approaches that are not specifically described, and any change and modifications to the components, techniques, and approaches can be made without departing from the spirit and scope described in the present disclosure.

What is claimed is:

1. A method of reducing duplication of data in a data repository configured to store evidence relevant to a patent lawsuit, the method comprising:
generating, on a first user interface, a matrix including a plurality of rows and a plurality of columns, wherein each of the plurality of rows comprise a respective row label, and wherein each of the plurality of columns comprise a respective column label;
identifying a first patent for mapping to the plurality of rows;
identifying a second patent for mapping to the plurality of columns;
retrieving a first plurality of claim elements that correspond to one or more claims of the first patent;
retrieving a second plurality of claim elements that correspond to one or more claims of the second patent;
assigning the first plurality of claim elements to the plurality of rows, wherein each respective row label is configured to display a representation of a respective claim element of the first plurality of claim elements;
assigning the second plurality of claim elements to the plurality of columns, wherein each respective column label is configured to display a representation of a respective claim element of the second plurality of claim elements;
displaying a plurality of cells of the matrix on the first user interface, wherein each cell is primarily defined by a respective row label;
receiving a first user selection of a first cell corresponding to a first row;
responsive to the first user selection, determining a first claim element corresponding to the first row and highlighting the first cell on the first user interface;
while the first cell is highlighted, receiving one or more subsequent user selections of one or more cells in the first row after the first user selection;
identifying one or more second claim elements of the second plurality of claim elements corresponding to respective plurality of columns of the one or more cells selected in the one or more subsequent user selections;
creating a pointer in the data repository linking the one or more second claim elements with the first claim element; and
linking an evidence between the first claim element and the one or more second claim elements based on the created pointer, wherein a copy of the evidence is not duplicated for each of the one or more second claim elements, thereby reducing duplication of data in a data repository.

2. The method of claim 1, wherein the first patent is same as the second patent.

3. The method of claim 2, further comprising illustrating a diagonal portion of the matrix on the first user interface, wherein the diagonal portion splits the matrix into a first portion and a second portion, and wherein the second portion is non-editable by a user, thereby reducing legal errors.

4. The method of claim 1, wherein the first patent is different than the second patent.

5. The method of claim 4, further comprising illustrating four quadrants on the first user interface, wherein each quadrant corresponds to a different combination of mapping across the plurality of rows and the plurality of columns between the first patent and the second patent.

6. The method of claim 5, further comprising a first quadrant that includes the first plurality of claim elements assigned to both the plurality of rows and the plurality of columns, wherein the first quadrant is positioned in a top left portion of the first user interface with respect to rest of the four quadrants.

7. The method of claim 6, further comprising a second quadrant that includes the first plurality of claim elements assigned to the plurality of rows and the second plurality of claim elements assigned to the plurality of columns, wherein the second quadrant is positioned in a top right portion of the first user interface with respect to rest of the four quadrants.

8. The method of claim 7, further comprising a third quadrant that includes the second plurality of claim elements assigned to both the plurality of rows and the plurality of columns, wherein the third quadrant is positioned in a bottom right portion of the first user interface with respect to the rest of the four quadrants.

9. The method of claim 8, further comprising a fourth quadrant that includes the second plurality of claim elements assigned to the plurality of rows and the first plurality of claim elements assigned to the plurality of columns, wherein the fourth quadrant is positioned in a bottom left portion of the first user interface with respect to rest of the four quadrants.

10. The method of claim 9, wherein in the fourth quadrant is non-editable by the user, thereby reducing legal errors.

11. The method of claim 1, further comprising loading only a portion of the matrix in a Document Object Model (DOM) instead of all portions of the matrix.

12. The method of claim 11, wherein the portion of the matrix loaded includes a spacer portion that includes an upper height and a lower height, wherein the upper height and the lower height are a function of number of scrolled items.

13. A system of reducing duplication of data in a data repository configured to store evidence relevant to a patent lawsuit, the system comprising one or more hardware processors configured to:
generate, on a first user interface, a matrix including a plurality of rows and a plurality of columns, wherein each of the plurality of rows comprise a respective row label, and wherein each of the plurality of columns comprise a respective column label;
identify a first patent for mapping to the plurality of rows;
identify a second patent for mapping to the plurality of columns;
retrieve a first plurality of claim elements that correspond to one or more claims of the first patent;
retrieve a second plurality of claim elements that correspond to one or more claims of the second patent;
assign the first plurality of claim elements to the plurality of rows, wherein each respective row label is configured to display a representation of a respective claim element of the first plurality of claim elements;
assign the second plurality of claim elements to the plurality of columns, wherein each respective column label is configured to display a representation of a respective claim element of the second plurality of claim elements;
display a plurality of cells of the matrix on the first user interface, wherein each cell is primarily defined by a respective row label;
receive a first user selection of a first cell corresponding to a first row;
responsive to the first user selection, determine a first claim element corresponding to the first row and highlighting the first cell on the first user interface;
while the first cell is highlighted, receive one or more subsequent user selections of one or more cells in the first row after the first user selection;
identify one or more second claim elements of the second plurality of claim elements corresponding to respective plurality of columns of the one or more cells selected in the one or more subsequent user selections;
create a pointer in the data repository linking the one or more second claim elements with the first claim element; and
link an evidence between the first claim element and the one or more second claim elements based on the created pointer, wherein a copy of the evidence is not duplicated for each of the one or more second claim elements, thereby reducing duplication of data in a data repository.

14. The system of claim 13, wherein the first patent is same as the second patent.

15. The system of claim 13, wherein the one or more hardware processors are configured to illustrate a diagonal portion of the matrix on the first user interface, wherein the diagonal portion splits the matrix into a first portion and a second portion, and wherein the second portion is non-editable by a user, thereby reducing legal errors.

16. The system of claim 13, wherein the first patent is different than the second patent.

17. The system of claim 16, wherein the one or more hardware processors are further configured to illustrate four quadrants on the first user interface, wherein each quadrant corresponds to a different combination of mapping across the plurality of rows and the plurality of columns between the first patent and the second patent.

18. A system of reducing duplication of data in a data repository configured to store evidence relevant to a patent lawsuit, the system comprising one or more hardware processors configured to:
generate, on a first user interface, a first plurality of rows corresponding to a plurality of first claim elements of a first patent document;
generate, on the first user interface, a second plurality of columns corresponding to a plurality of second claim elements of a second patent document, wherein the first plurality of rows and the first plurality of columns are arranged in a matrix format and forming a plurality of cells;
provide a user selectable input area for at least some of the plurality of cells; and
create a pointer in the data repository that links a first claim element of the plurality of first claim elements with a second claim element of the plurality of second claim elements responsive to an input in the user selectable input area.

19. The system of claim 18, wherein the one or more hardware processors are further configured to receive evidence corresponding to the first element and automatically linking the received evidence with the second claim element based on the created pointer, wherein only a single instance of the received evidence is stored in the data repository.

20. The system of claim 18, wherein the first patent document is same as the second patent document and a plurality of self-referential claim elements are disabled for receiving user input.
